(19) United States
(12) Patent Application Publication
(10) Pub. No.: US 2025/0037039 A1
(43) Pub. Date: Jan. 30, 2025

(54) MOLECULAR DATA STORAGE USING COST-FREE MOLECULAR LIBRARIES

(71) Applicant: Brown University, Providence, RI (US)

(72) Inventors: Jacob K. Rosenstein, Providence, RI (US); Brenda M. Rubenstein, Providence, RI (US); Selahaddin GUMUS, North Providence, RI (US); Dana Biechele-Speziale, North Providence, RI (US)

(21) Appl. No.: 18/796,063

(22) Filed: Aug. 6, 2024

Related U.S. Application Data
(63) Continuation-in-part of application No. 17/929,279, filed on Sep. 1, 2022.
Application No. 17/929,279 is a continuation-in-part of application No. 17/378,988, filed on Jul. 19, 2021, now Pat. No. 11,790,280.
Application No. 17/378,988 is a division of application No. 17/253,013, filed on Dec. 16, 2020, now Pat. No. 11,093,865.
(60) Provisional application No. 63/531,208, filed on Aug. 7, 2023.
(60) Provisional application No. 62/687,366, filed on Jun. 20, 2018.
(60) Provisional application No. 62/791,504, filed on Jan. 11, 2019.

(51) Int. Cl. G06N 99/00

(52) U.S. Cl. CPC G06N 99/007

(57) ABSTRACT

The invention provides the uses of chemical waste and byproducts in a chemical library to store digital information, and methods for computing with unknown waste chemicals by encoding digital data into a plurality of chemicals to obtain a dataset; translating the dataset into a chemical form; reading the data set; querying the dataset by performing an operation to obtain a perceptron; and analyzing the perceptron for identifying change in at least one of the chemicals, thereby developing a chemical computational language. The invention demonstrates a workflow for representing abstract data in synthetic metabolomes. Also presented are several demonstrations of kilobyte-scale image data sets stored in synthetic metabolomes, recovered at >99% accuracy.

### CROSS-REFERENCE TO RELATED APPLICATIONS

This disclosure claims priority to U.S. Provisional Patent No. 63/531,208, filed Aug. 7, 2023, the entire contents of which are hereby incorporated by reference herein; this disclosure is a continuation-in part of U.S. Ser. No. 17/929,279, filed Sep. 1, 2022, which is a continuation in-part of U.S. Ser. No. 17/378,988, filed Jul. 19, 2021, now U.S. Pat. No. 11,790,280, granted on Oct. 17, 2023, which is a divisional patent application of U.S. Ser. No. 17/253,013, filed Dec. 16, 2020, now U.S. Pat. No. 11,093,865, granted on Aug. 17, 2021, which is a national phase filing under 35 U.S.C. § 371 of International Application No. PCT/US2019/038301, filed Jun. 20, 2019, which claims the benefit of priority to patent applications U.S. Ser. No. 62/687,366, filed Jun. 20, 2018, and U.S. Ser. No. 62/791,504 filed Jan. 11, 2019, the entire contents of all of the above disclosures are hereby incorporated by reference herein.

### STATEMENT REGARDING FEDERALLY SPONSORED RESEARCH OR DEVELOPMENT

This invention was made with government support under grant number 1941344, awarded by the National Science Foundation, and grant number W911 NF-18-2-0031 awarded by the Defense Advanced Research Projects Agency (DARPA). The government has certain rights in the invention.

### FIELD OF THE INVENTION

This invention generally relates to chemoinformatics, i.e., data processing methods or systems for the retrieval, analysis, visualization, or storage of data, and specifically storage of data within molecules or chemicals.

### BACKGROUND OF THE INVENTION

Biology provides a robust model for molecular memory. RNA and DNA molecules are information-dense, stable over long periods of time, and energy efficient. Reading information from RNA or DNA is cumbersome using stochastic methods, for example by polymerase chain reaction (PCR) and shotgun sequencing, or by using sequential methods, for example, nanopores.

Biomolecular information systems offer many potential advantages over conventional semiconductor technologies. Researchers used DNA for long-term archival information storage. See, U.S. Pat. No. 9,384,320 (Church); Church, Gao & Kosuri, Science 337(6102), 1628 (September 2012); De Silva & Ganegoda, Biomed. Res. Int. 8072463 (2016). One advantage of molecular storage over silicon-based devices is density; DNA achieves about 214 petabytes per gram. Erlich & Zielinski, Science 355, 950-954 (2017).

The metabolome is an information-rich molecular system with diverse chemical dimensions that could be harnessed for information storage and manipulation. The metabolome has an amplified and dynamic relationship to the genome, the transcriptome, the proteome, and the environment. Kell & Oliver, Metabolomics 12(9), 148 (Sep. 2, 2016). This relationship makes the metabolome an information-rich system, with diverse chemical, structural and biological dimensions, and properties. The molecular computing art is formalizing methods for mitigating errors arising from metabolic chemical and structural diversity. Gowda & Djukovic, Methods Mol. Biol. 1198, 3{12 (2014); Matsuda, Mass Spectrom. (Tokyo) 5(2), S0052 (2016).

The molecular computing art has recently made progress in proteomic and metabolic profiling. Cox & Mann, Ann. Rev. Biochem. 80, 273-299 (2011); Nagaraj et al., Molecular Systems Biology 7(1), 548 (2011); Roumpeka et al., Front. Genet. 8, 23 (2017). Thus, it is timely to test the use of metabolites for more dynamic postgenomic information representations, and whether to make use of the higher dimensions of complexity inherent in metabolism to improve data storage in fundamental ways.

Meanwhile, the world is generating more chemical waste and the world is generating more data than it can store. Electromagnetic data storage technologies are approaching atomic limits. Because of this growing information storage demand, data centers continue to expand. But these efforts are still not keeping up with data creation and the electricity required by data centers has detrimental environmental impacts.

Molecular data storage technologies have been introduced that can offer theoretically denser data storage, but both DNA and other non-genomic technologies come with a high raw material cost as well as inefficient and time-consuming synthesis and purification processes.

There is a need in the computational art for a path for molecular data storage to scale in a cost and time-effective manner by using compounds that have no associated cost and do not require synthesis or purification.

### SUMMARY OF THE INVENTION

The invention provides, in some embodiments, a method for computing with chemicals, including the steps of encoding an abstract digital data into a plurality of liquid volumes of a plurality of chemicals to obtain a dataset; translating the dataset into a chemical form; reading the data set using spectrometry, spectroscopy, or both analytical methods; querying the dataset by performing a volumetric operation to obtain a perceptron; and analyzing the perceptron for identifying chemical structure, concentration, or both characteristics, of at least one of the chemicals, thereby developing a chemical computational language.

In some embodiments, the abstract digital data includes a binary computer language. The computer language is selected from the group consisting of programming language, command language, general-purpose language, machine language, markup language, style sheet language, configuration language, construction language, query language, modeling language and simulation language. In the third embodiment, the translating step further includes assembling a library of chemicals in the dataset.

In some embodiments, the volumetric operation is performed robotically. According to some aspects, the volumetric operation further includes a programmed standard volumetric transfer. In some embodiments, the plurality of liquid volumes of the plurality of chemicals is a mixture of different chemical molecules. According to some aspects, the abstract digital data corresponds to the presence or the absence of chemical molecules in the mixture.

In some embodiments, the spectrometry is mass spectrometry. In some embodiments, the spectroscopy is selected from ultraviolet-visible spectroscopy, Rydberg spectroscopy, infrared spectroscopy, fluorescence spectroscopy, and absorption spectroscopy.

The invention also provides, in some embodiments, a method for molecular computing using a chemical perceptron, including the steps of preparing a plurality of distinct mixtures of molecules to obtain a chemical data set, such that the mixtures of molecules are an input unit of the perceptron; writing the data set on an array; applying an operation to the data set for transduction of the input unit; combining the input unit by an operation to obtain an operation product; and detecting a threshold of the operation product, thereby obtaining a product of the chemical perceptron.

In some embodiments, the array is a micro-well plate or a Matrix-Assisted Laser Desorption/Ionization (MALDI) plate. The array is located in or is arrayed in a micro-well plate or a MALDI plate. According to some aspects, the method further includes the step of applying a chemical multiply accumulate (MAC) operation to obtain the mathematical equivalent of the perceptron. In some embodiments, the chemical multiply accumulate operation is z=Lᵢwᵢ·xᵢ+b, such that z is the output of the multiply accumulate operation, wᵢ is the weight of a species, Xᵢ is the initial amount of the species, and b is the bias.

The invention further provides, in some embodiments, a chemical perceptron including a plurality of analytes; an array spectrum; a fluid handling robot; a computer; and a molecule quantifier or a molecule identifier.

In some embodiments, the molecule quantifier or molecule identifier is a high performance liquid chromatography (HPLC) machine, a mass spectrometer, or both assay machines. In the sixteenth embodiment, the array spectrum is at least one selected from a micro-well plate or a MALDI plate.

The invention provides, in some embodiments, a method for obtaining an output of a linear classification operation, including the steps of encoding binary data into a chemical composition of a plurality of liquid samples; receiving an input of binary data; performing multiplication operation by a plurality of fractional volume transfers of the liquid samples into a plurality of micro-wells corresponding to the input and pooling the liquid samples to obtain an output; and analyzing the concentration of the chemicals in the output by HPLC, thereby obtaining the output for the linear classification operation.

In some embodiments, the method further including scaling a classifier weight corresponding to maximum available volume in each of the micro-wells. According to some aspects, the classifier weight corresponds to amount of the plurality of fractional volume transfers of the liquid samples.

In some embodiments, the method further includes performing the plurality of fractional volume transfers by a robot (i.e., a robot performs the transfers). In some embodiments, the liquid samples are nonreactive. According to some aspects, the liquid samples are reactive. In an example, the method further includes performing parallel computing to obtain the output for the linear classification operation.

The invention provides, in some embodiments, a method for coding information with a mixture of product molecules, including the steps of mapping of a plurality of each pixels on an array corresponding to a plurality of known organic chemical entity molecules each in a known location within the array to obtain a pixel map; reacting a selected subset of the molecules corresponding to the pixel map thereby synthesizing the mixture of product molecules; and analyzing the mixture of product molecules to identify the product molecules.

In some embodiments, reacting further includes performing an Ugi reaction to obtain an Ugi product molecule or a first Ugi molecules, or at least one product molecule. In an embodiment, the method further includes creating a new Ugi product molecule or a second product molecule. In the twenty-seventh embodiment, the plurality of known organic chemical entity molecules includes a chemical scaffold.

In some embodiments, the plurality of known organic chemical entity molecules include reaction groups. According to some aspects, the groups are selected from carboxylic acid, ester, acid chloride, amide, nitrile, aldehyde, ketone, alcohol, thiol, amine, alkene, alkyne, alkane, ether, alkyl halide, and nitro. In the twenty-ninth embodiment, reacting further includes substituting the reaction groups. In an example, the reacting step further includes changing pH of at least one of the plurality of known organic chemical entity molecules.

The invention provides, in some embodiments, a method for computing with chemicals, including the steps of encoding digital data into a plurality of chemicals to obtain a dataset and translating the dataset into a chemical form; reading the data set using spectrometry, spectroscopy, or both assay methods; querying the dataset by performing an operation to obtain a perceptron; and analyzing the perceptron for identifying the chemical structure, concentration, or both characteristics of at least one of the chemicals, thereby developing a chemical computational language.

In some embodiments, the operation further includes at least one of a volumetric transfer or a chemical reaction. In the thirty-third embodiment, the operation further includes measuring a rate constant, an equilibrium constant of the chemical reaction, or both characteristics. In an embodiment, the chemical reaction further includes an Ugi reaction to obtain at least one Ugi product molecule.

In some embodiments, the method further includes synthesizing a new chemical entity. According to some aspects, digital data includes a computer language. In some embodiments, the plurality of chemicals further includes a plurality of liquid volumes. In the thirty-eighth embodiment, the plurality of chemicals is a mixture of different chemical molecules.

In some embodiments, the digital data includes presence or absence of chemical molecules in the mixture. According to some aspects, spectrometry includes mass spectrometry. In some embodiments, the spectroscopy method is selected from ultraviolet-visible spectroscopy, Rydberg spectroscopy, Infrared spectroscopy, fluorescence spectroscopy, and absorption spectroscopy. In the forty-second embodiment, the plurality of chemicals includes reaction groups.

In some embodiments, reacting further includes substituting the reaction groups. In certain embodiments of the method, reacting further includes changing a pH of at least one of the plurality of chemicals.

The invention provides, in some embodiments, for the purposeful encoding of information in a metabolome or another mixture of chemicals. The invention provides an implementation using encoded synthetic metabolome. The invention thus provides post-genomic data storage and demonstrates a workflow for representing abstract data in metabolomes, synthetic metabolomes, and molecular mixtures. The invention can use robotic liquid handling for producing chemical data mixtures and mass spectrometry for inherently parallel data readout. Also presented are several demonstrations of kilobyte-scale image data sets stored in synthetic metabolomes, recovered at >99% accuracy.

In some embodiments, the invention provides an information storage system, comprising a solid surface with a plurality of addressable locations, wherein each addressable location comprises a mixture of small molecules, and each mixture contains one set of small molecules per addressable location. According to some aspects, the small molecules are metabolomic elements. Each mixture of small molecules may be selected from a synthetic metabolome. In the forty-seventh embodiment, the solid surface is a MALDI plate.

In some embodiments, the addressable locations comprise at least 1024 independent mixture spots. The inventors wrote more than 100 kbits of image data into synthetic metabolomes; this number is conservative and can be expanded. In the forty-ninth embodiment, the addressable locations comprise thousands of spatially arrayed nanoliter spots. In the fiftieth embodiment, the storage system comprises more than 100 kbits of data. In some embodiments, the storage system comprises a gigabyte of data. Diversified small-molecule approaches have intrinsic capacities for gigabyte-scale data storage. The invention thus provides increased storage density. Increased diversity of chemical information systems has uses where sensitive information should be physically encoded, transported, and easily overwritten in small, zero-power devices.

In some embodiments, the invention provides a method of storing information in a plurality of metabolomic elements. The steps of the method are (a) converting a format of information into a plurality of digital sequences; (b) converting the plurality of digital sequences into a plurality of corresponding metabolomic elements using one bit per metabolomic element, and (c) storing the plurality of corresponding metabolomic elements on a solid surface, where the location of a metabolomic element is an addressable location. In some embodiments, the converting the plurality of digital sequences into a plurality of corresponding metabolomic elements Is performed using robotic liquid handling.

In some embodiments, the invention provides a method of retrieving a format of information from a plurality of metabolomic elements encoding digital sequences of the format of information. The steps of the method are (a) assaying a solid surface comprising a set of metabolomic elements, where the location of a metabolomic element is an addressable location; (b) converting the metabolomic elements to digital sequences; and (c) converting the digital sequences to a format of information. Molecular information can be ‘read’ using a variety of analysis techniques including mass spectrometry, sequencing, chromatography, or spectroscopy, as in FIG. 18. According to some aspects, the assay method is mass-spectroscopy. In some examples, the mass-spectroscopy is MALDI mass spectroscopy.

In some embodiments, retrieving a format of information from a plurality of metabolomic elements results in an information recovery at >99% accuracy. The inventors demonstrated kilobyte-scale image data sets stored in synthetic metabolomes, recovered at >99% accuracy.

In some embodiments, the method has a further step of visualizing the format of information.

In some embodiments, the method has a further step of mitigating errors in the converting of the metabolomic elements to digital sequences. In an embodiment, mitigating the errors includes a logistic regression analysis.

In some embodiments, converting the digital sequences to a format of information is performed using one m/z peak selected per metabolomic element. In some embodiments, converting the digital sequences to a format of information is performed using multiple m/z peaks selected per metabolomic element.

In some embodiments, the invention provides a chemical perceptron, comprising the mathematical framework described for quantifying chemical memory. According to some aspects, the chemical perceptron has autocatalytic thresholding.

In one aspect, the invention provides a path to quantifying the information capacity available from the exponentially larger non-genomic chemical space.

In another aspect, the invention provides a general mathematical framework for quantifying chemical memory, which extends to mixtures of molecules of all types. The theoretical limit for molecular information storage is two orders of magnitude denser by mass than DNA memory storage.

In yet another aspect, the invention provides a general theory of information storage in molecules and in mixtures of molecules. This theory provides a unified description of mixtures of molecules, e.g., small molecules.

As a proof-of-principle of chemical data storage, the inventors chemically encoded several MNIST images of handwritten digits and demonstrate successful chemical-domain classification of the digits using volumetric perceptrons. LeCun et al., Gradient-based learning applied to document recognition. Proceedings of the IEEE, 86(11), 2278-2324 (1998). The inventors quantified the performance of the method with a larger dataset of binary vectors and compare the assay measurements against predicted results.

As a proof-of-principle of postgenomic data storage, the inventors encoded abstract binary data into the chemical composition of thousands of spatially arrayed nanoliter volumes. See, EXAMPLE 6 and FIGS. 23A-23B. Each volume (‘spot’) contains a prescribed mixture of metabolites from a synthetic metabolome library. The presence or absence of each library element in a spot encodes one bit of information. Therefore, the total number of bits stored by one spot is equal to the number of library elements. See, Arcadia et al., Proceedings of the IEEE Conference on Rebooting Computing (ICRC) (2018) [EXAMPLE 2]. The inventors recover the encoded data from metabolic mixtures using mass spectrometry. See, FIGS. 23A-23B. Cf. Duncan et al., Clinical Chemistry 62(1), 134-143 (Nov. 19, 2015); Spraggins et al., Proteomics 6(11-12), 1678-89 (2016). Strategies for optimizing data recovery are presented, along with several examples of chemically encoded digital images. Raw error rates <1% are achieved with kilobyte-scale data sets, demonstrating the viability of both writing and reading metabolomic information.

In some embodiments, the invention provides a technique that enables users to store vast amounts of information in the small volumes occupied by molecules using small molecules in disordered mixtures. These small molecules are more stable to enzymatic and thermal degradation than DNA. These small molecules are also less expensive because they do not rely on synthesizing phosphodiester bonds, which are needed to stitch DNA together. This invention enables information storage in a space-efficient and energy-efficient way, which answers the growing call for small, cheaper storage technologies when the need for storage is rapidly outpacing storage capacity.

In some embodiments, the invention provides a product that enables the storage of vast amounts of information in small volumes. This product is useful for health care companies and institutions, which must store large amounts of patient data, often on the premises, to store data on and within objects. This technique is useful for tracing the history of different products in the supply chain. Molecular storage is inherently much more compact than current two-dimensional (2D) digital media. Molecular storage is three-dimensional (3D), so more can be stored in a more compact space, which is important when more media are being developed that require more memory.

In another advantage, molecular storage using species already existent is much harder to destroy than magnetic storage.

In another advantage, molecular storage can be performed in vivo and in materio since the body and materials are made from molecules. One need not interface CMOS with the body or materials to store information.

In another advantage, small molecule storage can be cheaper than DNA, particularly if the libraries used for storage are pre-made out of easy-to-synthesize molecules. The invention can use any molecules if they differ in stability.

In an example discussion of a brief summary, the technology disclosed herein can be discussed using the following list of features:

Feature 1: An information storage system, comprising: a storage surface with a plurality of addressable storage locations, wherein each addressable storage location comprises a previously unknown molecule mixture of chemical waste or byproducts thereof, and wherein the molecule mixture, wherein each addressable storage location contains a set of molecules from the molecule mixture.

Feature 2: The information storage system of feature 1, wherein the molecule mixture further comprises fluorinated molecules including at least one of polyfluoroalkyl substances, highly stable fluorinated hydrocarbon compounds, per-fluoroalkyl substances, or persistent environmental contaminants, and/or comprises chemical contaminants, contaminant derivatives, perfluoro-1-octanesulfonic acid (PFOS), perfluoro-1-butanesulfonic acid (PFBS), perfluoro-1-hexanesulfonic acid (PFHxS), perfluoro nonanoic acid (PFNA), perfluorooctanoic acid (PFOA), perfluoroheptanoic acid (PFHpA), perfluorohexanoic acid (PFHxA), perfluoropentanoic acid (PFPeA), perfluorobutanoic acid (PFBA), 8:2 fluorotelomer alcohol (8:2 FTOH), 6:2 fluorotelomer alcohol (6:2 FTOH), 4:2 fluorotelomer alcohol (4:2 FTOH), or fluorotelomer-based acrylate or methacrylate esters.

Feature 3: The information storage system of feature 1, wherein the fluorinated molecules comprise at least one of polyfluoroalkyl substances or highly stable fluorinated hydrocarbon compounds, wherein the polyfluoroalkyl substances are synthetic organofluorine chemical compounds containing at least one fluorinated carbon atom, and wherein the highly stable fluorinated hydrocarbon compounds have strong carbon-fluorine bonds.

Feature 4: The information storage system of feature 3, wherein the polyfluoroalkyl substances include at least one of per-fluoroalkyl substances or poly-fluoroalkyl substances, wherein the per-fluoroalkyl substances are synthetic organofluorine chemical compounds in which all hydrogen atoms attached to carbon atoms are replaced by fluorine atoms, and wherein the poly-fluoroalkyl substances are synthetic organofluorine chemical compounds in which some, but not all, of the hydrogen atoms attached to carbon atoms are replaced by fluorine atoms.

Feature 5: The information storage system of feature 1, wherein the fluorinated molecules comprise persistent environmental contaminants, wherein the persistent environmental contaminants are resistant to environmental degradation through chemical, biological, and photolytic processes, have a potential for long-range transport, bioaccumulate in human and animal tissue, biomagnify in food chains, and have potentially significant impacts on human health and the environment.

Feature 6: The information storage system of feature 1, wherein the fluorinated molecules comprise at least one of perfluoro-1-octanesulfonic acid (PFOS), perfluoro-1-butanesulfonic acid (PFBS), perfluoro-1-hexanesulfonic acid (PFHxS), perfluoro nonanoic acid (PFNA), perfluorooctanoic acid (PFOA), perfluoroheptanoic acid (PFHpA), perfluorohexanoic acid (PFHxA), perfluoropentanoic acid (PFPeA), or perfluorobutanoic acid (PFBA), wherein PFOS, PFBS, PFHxS, PFNA, PFOA, PFHpA, PFHxA, PFPeA, and PFBA are synthetic organofluorine chemical compounds and persistent organic pollutants that are found in the environment, wildlife, and humans.

Feature 7: The information storage system of feature 1, wherein each addressable storage location is operable to be prompted by mass spectrometry, ultraviolet-visible spectroscopy, Rydberg spectroscopy, electromagnetic radiation spectroscopy, Infrared spectroscopy, fluorescence spectroscopy, or absorption spectroscopy.

Feature 8: A method of storing information, comprising: providing a storage surface with a plurality of addressable storage locations; and forming a molecule mixture at each addressable storage location, wherein the molecule mixture comprises a previously unknown molecule mixture of chemical waste or byproducts thereof, and wherein forming the molecule mixture comprises containing a set of molecules at each addressable storage location.

Feature 9: The method of feature 8, wherein forming the molecule mixture further comprises including chemical waste or byproducts thereof and fluorinated molecules including at least one of polyfluoroalkyl substances, highly stable fluorinated hydrocarbon compounds, per-fluoroalkyl substances, or persistent environmental contaminants and/or including chemical contaminants or contaminant derivatives in the molecule mixture.

Feature 10: The method of feature 8, wherein the fluorinated molecules comprise at least one of polyfluoroalkyl substances or highly stable fluorinated hydrocarbon compounds.

Feature 11: The method of feature 10, wherein the polyfluoroalkyl substances include at least one of per-fluoroalkyl substances or poly-fluoroalkyl substances.

Feature 12: The method of feature 8, wherein the fluorinated molecules comprise persistent environmental contaminants.

Feature 13: The method of feature 8, wherein the fluorinated molecules comprise at least one of perfluoro-1-octanesulfonic acid (PFOS), perfluoro-1-butanesulfonic acid (PFBS), perfluoro-1-hexanesulfonic acid (PFHxS), perfluoro nonanoic acid (PFNA), perfluorooctanoic acid (PFOA), perfluoroheptanoic acid (PFHpA), perfluorohexanoic acid (PFHxA), perfluoropentanoic acid (PFPeA), or perfluorobutanoic acid (PFBA).

Feature 14: A storage medium, comprising: a storage surface with a plurality of addressable storage locations; and a molecule mixture formed at each addressable storage location, wherein the molecule mixture comprises a previously unknown molecule mixture of chemical waste or byproducts thereof, and wherein each addressable storage location contains a set of molecules from the molecule mixture.

Feature 15: The storage medium of feature 14, wherein the molecule mixture further comprises chemical waste or byproducts thereof and fluorinated molecules including at least one of polyfluoroalkyl substances, highly stable fluorinated hydrocarbon compounds, per-fluoroalkyl substances, and/or persistent environmental contaminants, chemical contaminants or contaminant derivatives.

Feature 16: The storage medium of feature 14, wherein the fluorinated molecules comprise at least one of polyfluoroalkyl substances or highly stable fluorinated hydrocarbon compounds.

Feature 17: The storage medium of feature 16, wherein the polyfluoroalkyl substances include at least one of per-fluoroalkyl substances or poly-fluoroalkyl substances.

Feature 18: The storage medium of feature 14, wherein the fluorinated molecules comprise at least one of persistent environmental contaminants, perfluoro-1-octanesulfonic acid (PFOS), perfluoro-1-butanesulfonic acid (PFBS), perfluoro-1-hexanesulfonic acid (PFHxS), perfluoro nonanoic acid (PFNA), perfluorooctanoic acid (PFOA), perfluoroheptanoic acid (PFHpA), perfluorohexanoic acid (PFHxA), perfluoropentanoic acid (PFPeA), or perfluorobutanoic acid (PFBA).

Feature 19: The storage medium of feature 14, wherein the storage medium is capable of providing a method of storing information in a plurality of molecular mixtures, the method comprising the steps of: (a) converting a format of information into a plurality of digital sequences; (b) converting the plurality of digital sequences into a plurality of corresponding molecular mixtures using one bit per mixture, wherein the molecular mixtures comprise chemical waste or byproducts thereof; and (c) storing the plurality of corresponding molecular mixtures on a solid surface, where the location of each molecular mixture is an addressable location on the storage medium.

Feature 20: The storage medium of feature 14, wherein the format of information is selected from the group consisting of text, image, video, and audio.

### BRIEF DESCRIPTION OF THE DRAWINGS

FIG. 1 is a representation showing a perceptron classifier with inputs xⱼ and weights wⱼ, j=1, 2, . . . , J and output nonlinearity φ( ). The perceptron, consists of a single multiply accumulate primitive, followed by a nonlinearity, as shown in this drawing.

FIG. 2 is a depiction of a master equation (Markov chain) for two species A and B interacting with reagent G. A surfeit of G (large K) results in approximately decoupled equilibria for X and Y.

FIGS. 3A-3D are cartoon representations of the chemical perceptron described in EXAMPLE 1, Theorem 1, which can recognize two patterns (001010 and 10100) corresponding to two different reagents. Pixel cells are mixtures composed of different molecules me- Pixels are exposed according to the inputs, Xⱼ, j=1, 2, . . . , 6, and then “poured” into the pool. A reagent is added to the pool and the reaction proceeds. Darker boxes (green) represent post-reaction above-threshold indicator detection. FIG. 3(a) shows the application of reagent 001010 with input 001010. FIG. 3(b) shows the application of reagent 101000 with input 001010. FIG. 3(c) shows the application of reagent 101000 with input 001010.

FIG. 4 is a graph showing Pₑ′ vs. ζ² for χ∈{2, 4, 8}. Misclassification error rates Pₑ with zero weight noise (N₀=0) are 2.27×10⁻², 3.17×10⁻⁵ and 6.22×10⁻¹⁶ for x=2, 4, 8, respectively. The plots of in this drawing show that performance degradation depends on the baseline (zero weight noise) reliability of the given perceptron.

FIG. 5 is a conceptual block diagram of the chemical computation scheme. Binary datasets are encoded into discretized mixtures of chemicals. Computations can be performed on these chemical mixtures through quantitative sampling, based on the desired classifier's weights, and mixing of their contents. The computation output is initially in the chemical domain and can be assessed using analytical chemistry techniques.

FIG. 6 shows that data can be stored in isolated wells containing quantitative chemical mixtures. The concentrations of these chemicals reflect the values of the binary input data. Each bit address in the input data is assigned to one grid location on a microplate, while the value of each bit is encoded in the concentration of a particular chemical compound at that position. Multiple datasets can be simultaneously stored in the same fluid containers by using multiple distinct chemicals.

FIG. 7 is a schematic of the chemical computation procedure for the chemical mixture based perceptron, as implemented for pattern classification. The perceptron weights (wᵢ∈[−1, 1]) are scaled to correspond to a maximum volume Vₒ, which is chosen based on the available volume in the data wells. All spatially concurrent chemical datasets (x) are operated on in parallel by a single weight matrix (w), whose values are realized as volumetric fluid transfers. Because weights can be positive and negative (wᵢ∈[−1, 1]), a pool for each polarity is made. Each pool is analyzed by liquid chromatography to measure the concentrations of each analyte species. The differential concentration of each analyte is calculated in post-processing and used to determine the appropriate label for the input data. This figure shows the computational scheme for the proposed chemical mixture based perceptron. The perceptron weights (wᵢ∈[−1, 1]) are scaled to correspond to a maximum volume Vₒ, which is chosen based on the available volume in the data wells. Because one can only transfer positive liquid volumes, wells are pooled with positive and negative weights in two separate multiply accumulate (MAC) operations.

FIG. 8 shows three HPLC chromatograms for the three phenols used to encode data in this study. The chemical concentrations in these three samples were 7 mg/mL for analyte 1, 5 mg/mL for analyte 2, and 8.5 mg/mL for analyte 3. The absorbances were measured at 214 nm. The elution time can be used to identify the analyte, while the area under each peak can be related to the amount of the compound in the sample.

FIG. 9 shows three HPLC concentration calibration curves for the three analytes used in EXAMPLE 2. Using the known elution time of each compound, the area under the absorbance peak is measured and plotted for each analyte at various concentrations.

FIG. 10 shows a chemical classification of MNIST handwritten digits. Three 16×16 (256-bit) binary images were chemically encoded, in parallel, on a 384-well plate. The overlaid chemical images were then classified by three different perceptrons which had been previously trained to identify either digit ‘0’, ‘1’, or ‘2’. The results are shown in a table format as class matches (zₘ>0) or mismatches (zₘ<0). All nine chemical classifier outputs were correct (3 true positives, 6 true negatives). The chemical dataset is based upon the results of a microplate, where each well in the plate contains 60 μL of liquid whose chemical composition represents the values of one pixel across three images.

FIG. 11 shows differential concentration, as described by Arcadia et al., Proceedings of the IEEE Conference on Rebooting Computing (ICRC) (2018) [EXAMPLE 2].

FIG. 12 shows an exemplary Ugi four-component reaction.

FIG. 13 shows memory demonstration using the methods described. Data useful for training and recognition, e.g., of MNIST handwriting dataset (see, LeCun et al., Gradient-based learning applied to document recognition. in, Proceedings of the IEEE, 86(11), 2278-2324 (1998)), TIMIT audio recordings, and NOAA sensory datasets. Use molecules to calculate weighted sums, enables classification, filtering, and matrix algebra.

FIG. 14 is a cartoon representation of the computer-aided design (CAD) software suite. Automating repetitive or statistical tasks, and understanding and optimizing tradeoffs among error rate, time constraints, capacity, cost, yield, and complexity.

FIG. 15 is a schematic representation of the molecular perceptron concept. See, Arcadia et al., Proceedings of the IEEE Conference on Rebooting Computing (ICRC) (2018) [EXAMPLE 2].

FIG. 16 are chemical image arrays. See, Arcadia et al., Proceedings of the IEEE Conference on Rebooting Computing (ICRC) (2018) [EXAMPLE 2].

FIG. 17 shows perceptron weight matrices. The images are binary, but the perceptron weight matrix is real-valued. Each pixel has a weight which is a real number between −1 and +1. These matrices are trained in simulation to separate the target classes. (The weight magnitude is linearly mapped to a volume, e.g., 0 to 10 microliters.). Pixels with positive weights are pooled separately from pixels with negative weights. See, Arcadia et al., Proceedings of the IEEE Conference on Rebooting Computing (ICRC) (2018) [EXAMPLE 2].

FIG. 18 is a flow diagram showing how information is coded into a mixture of molecules from a predetermined library of chemicals. Reading a chemical memory corresponds to classifying it as one of exactly Ω values. The shapes of the analysis vectors are different from the shape of the data, but the number of possible states (Ω) is finite and the same at every stage.

FIG. 19 is a chart showing the information capacity of a mixture as a function of the maximum number of molecules present (Q), from a library of M molecules. When duplication carries no information, the capacity asymptotically approaches C₂=M bits.

FIGS. 20A-20B are a pair of flow diagrams (a) and a chart (b). The flow diagrams in (a) show mixture sparsity and DNA address-payload representations in molecular datasets. By requiring that each mixture contains exactly one kind of molecule per address space (addressable location), one can balance the benefits of smaller data mixtures against a reduced total information capacity for a given library. Chart (b) shows that increasing mixture sparsity (S) produces mixtures with fewer molecules and confers more information per unique molecule present. The maximum total capacity corresponds to the densest mixtures because the information per molecule scales only logarithmically with the sparsity.

FIG. 21 is a chart showing the information capacity of molecular mixtures. Plotting the capacity for several different sparsities shows the potential of complex chemical mixtures for large-scale data storage. The capacity of one molecule scales logarithmically with the library size (M), while the capacity of a mixture scales linearly. Accordingly, all of the digitized information produced in the world each year could theoretically be stored in one unordered mixture of short 40-nt DNA molecules.

FIGS. 22A-22B are a pair of diagrams. Diagram (a) is an illustration of a detection confusion matrix, for M=2 and Ω=4. The confusion probabilities P_{ij (i≠j)} describe the likelihood of errors reading the chemical data and reduce the effective information capacity. Diagram (b) shows an example of channel coding or error correcting codes (ECC) in molecular information systems. Diagram (b) demonstrates that reduced sets of valid codewords help to mitigate the effects of noise and errors in reading the chemical data.

FIGS. 23A-23B are a set of images showing the apparatus and methods for writing and reading data encoded in mixtures of metabolites. Image (a) shows that binary data from the flag of the State of Rhode Island and Providence Plantations is mapped onto a set of metabolite mixtures, with each bit determining the presence/absence of one compound in one mixture. For example, a spot mapped to four bits with values [0 1 0 1] may contain the 2^{nd} and 4^{th} metabolite at that location. Image (b) shows small volumes of the mixtures that were spotted onto a MALDI steel plate, and with the solvent evaporated. This chemical dataset is analyzed by MALDI mass spectrometry. See, the bottom of the image of FIG. 23(b). Using the observed mass spectrum peaks, one can make decisions about which metabolites are present. These decisions are then assembled from the array of spots to recover the original flag.

FIGS. 24A-24B show the process of assaying chemical data plates using mass spectrometry. Chart (a) shows a positive mode MALDI-FT-ICR mass spectrum of one spot containing guanosine (go) and 9-aminoacridine (9A) as the matrix compound. Automated analysis of each spot used 4× averaging of 1-second acquisitions. Guanosine ions (2, 3, 4, 5, in red) are present, along with two protonated matrix peaks (1, 6, in blue). Matrix (b) graphically shows the intensity of the protonated matrix (peak 1) at m/z=195.0916±0.001 for a MALDI plate with 1024 independent mixture spots. Protonated aminoacridine is positively identified in 1020 spots (99.6%).

FIGS. 25A-25D show the apparatus and method for spectral background and noise considerations. Matrix (a) shows a heatmap of the standard deviation of the MALDI-FT-ICR-MS spectral background noise from 240 different spots. Below in (a) is a histogram of the background intensity standard deviation. Chart (b) shows the spectra for six metabolites, normalized by the noise standard deviation. The m/z is cropped to six ranges of interest. Six one-hot mixtures are plotted, one for each metabolite. To assign presence/absence, the inventors choose an intensity threshold at an appropriate m/z. Chart (c) shows a 36 threshold applied to the [2Mtp+K]⁺ tryptophan peak yielded a discrimination accuracy of 96%. Matrix (d) shows a hit map of the same tryptophan peak illustrating recovery using the 36 threshold. Interestingly, the few errors are clustered at the edges of the plate.

FIG. 26 is a set of images showing the process of identifying discriminating peaks. Chart (a) shows the fraction of correct presence/absence detections over 1024 locations. See, glutamic acid (ga). At least 19 separate glutamic acid-affiliated masses were each found to yield a detection error of <10%. Chart (b) is a histogram of the adducts associated with peaks which accurately identify the six metabolites from FIGS. 25A-25D. After m/z peaks were ranked by accuracy, adducts were found by subtraction of integer multiples of the monoisotopic mass of each metabolite. This statistical metric often automatically finds H, Na, Na—H and K adducts. For each metabolite, the inventors plot the number of peaks achieving a given detection accuracy. Chart (c) shows that, except for sorbitol, each metabolite has at least 10 identifying peaks with >97% accuracy. Chart (d) shows the error of the single best performing peak for each metabolite. Chart (e) shows, using only the best performing mass from chart (d), the error rate for the six metabolites across 1024 locations (6144 bits) as a function of the SNR cutoff. These mixtures encoded the 6142-bit ibex image shown in image (f). Image (g), shows the ibex image that the inventors recovered the with a 2.56 decision threshold, producing approximately 2% cumulative read/write error.

FIG. 27 is a set of images showing the process of logistic regression for multi-peak molecular data readout. Improvements over single-peak classification can be achieved with logistic regression utilizing multiple identifying masses per metabolite. For the cat images (a), image (i) shows 17,424-bit image written into 1452 mixtures from a 12-metabolite library. Cat image (ii) shows an image recovered using one discriminating mass per metabolite. Cat image (iii) show an image recovered using a regression combining 16 peaks per molecule. Chart (b) shows that some compounds achieve low error rates even with single peaks. Other molecules (e.g., sorbitol) do not have an isolated m/z peak that shows high accuracy by themselves. For these compounds, multi-peak logistic regression significantly improves classification. Chart (c) shows cumulative read error rates for the two images as a function of the number of masses used in the logistic regression. The 6,142-pixel ibex image improves from 98% to 99.5% accuracy, while the 17,424-pixel cat image improves from 95.5% to 97.7%.

FIG. 28 is a histogram showing error rates for each component of the synthetic metabolome. The data is derived from a directly encoded 1400 spot plate, where each metabolite was patterned pseudo-randomly as present or absent (1400×36=50.4 kbits). Each spot contained a mixture of 3 present metabolites and 33 absent, and so the error rates shown consider a degree of mixture error due to metabolic conversion. 8/36 metabolites have single-best-peak error rates >10%, possibly due to poor uptake and solvation in dimethyl sulfoxide. About half of the compounds yield error rates <2%.

FIG. 29 is a graph showing spectral accuracy and mass discrimination power. Eight repetitions of MALDI mass spectral acquisition are shown centered at m/z=195.0916 (protonated 9-aminoacridine, 4× averaged t=1 s positive mode). Each repetition is from a unique deposition of 40 nL of 18.25 mM matrix in dimethyl sulfoxide, air/vacuum dried. The entirety of the peak above background is captured within the spectral window range M±0.001 m/z, regardless of signal intensity.

FIG. 30 is a set of images showing the justification of logistic regression from partially correlated errors. Plot (a) shows the SNR intensity of the [2M+K]⁺ peak of guanosine from 1024 locations is shown plotted against the SNR intensities of other ions for the same compound. SNRs clustered into present and absent states. Matrix (b) shows that each feature mass produces a list of SNRs across all locations. An autocorrelation map is shown for all guanosine feature mass lists correlated with each other. There are clustered groupings of highly correlated SNR lists, but correlations are imperfect. Plot (c) shows the read error for each feature mass is shown plotted against its mean correlation with other guanosine features. Masses which yield the lowest errors are typically more correlated (dotted ellipse).

FIG. 31 shows the experimental realization of information storage in small-molecule mixtures by the inventors. See also FIG. 26. FIG. 31a is a 6,142-pixel binary image of a Nubian ibex. FIG. 31b is a table showing the binary data mapped onto mixtures of five small organic compounds. FIG. 31c is a diagram showing the chemical structures and masses of the five compounds. FIG. 31d is a mass spectrum of one of the mixtures, representing the five bits ‘10101.’ FIG. 31e is a histogram of the measured sodiated peak intensities for one of the compounds which shows a clear separation between the present (‘1’) and absent (‘0’) compounds. FIG. 31f is an image that was reconstructed with an error rate of 4/6142=0.065%. FIG. 31g is an image of the 1229 data mixtures, spotted on a steel plate for analysis by mass spectrometry (MS).

FIG. 32 is a comparison of storage and computing metrics for DNA and small molecules. Note a assumes a 10 kcal/mol activation energy barrier must be surpassed. Note b assumes dehybridization barriers of 5-10 kcal/mol represent the largest intrinsic energy barriers. Note c is a theoretical estimate based off the probability of a reaction overcoming a 10 kcal/mol barrier at room temperature. For note d, see Allentoft et al., Proceedings of the Royal Society B: Biological Sciences (2012). Note e assumes the volume of a small molecule storing one bit is 125° A3 or less. For note f, see Service, Science (2017).

FIG. 33 is a diagram showing the space of proposed molecules.

FIGS. 34A-34C are flow charts showing a data storage approach. The diagram on the left concerns storage beyond molecular identity using information-conveying molecular libraries.

FIG. 35 is a figure showing data storage achievements made by the practice of the invention.

FIG. 36 is a figure showing the use of composite data mixture (Ugi) libraries and the production of binary outputs.

FIG. 37 is a flow chart for the use of multicomponent reaction sequences, for example, a synthesis sequence designed with 1 of N reagents in each time slot.

FIG. 38 is also a flow chart for the use of multicomponent reaction sequences, for example, a synthesis sequence designed with 1 of N reagents in each time slot.

FIG. 39 is also a flow chart for the use of multicomponent reaction sequences.

FIG. 40 is also a flow chart for the use of multicomponent reaction sequences, showing the readout (classification) accuracy of each slot after training one classifier per slot.

FIG. 41 is an expanded flow chart for the use of multicomponent reaction sequences, showing the readout (classification) accuracy of each slot.

FIG. 42 is a further flow chart for the use of multicomponent reaction sequences, showing the readout (classification) accuracy of each slot.

FIG. 43 is an analysis of the multicomponent reaction sequences, showing the correlations between actual sequence and readout.

FIG. 44 is a further analysis of the multicomponent reaction sequences, showing the correlations between actual sequence and readout.

FIG. 45 is a continuing analysis of the multicomponent reaction sequences, showing the correlations between actual sequence and readout.

FIG. 46 is a dot chart summarizing the analysis of the multicomponent reaction sequences to show a trend.

FIG. 47 is a visualization of the overall process of encoding, writing, analysis, and recovery of data in molecular mixtures. Step 1 (top, left) is the encoding of data including the Turbo error correction bits and the application of a permutation matrix to disperse errors. Step 2 (top, right) shows the mapping of the encoded data onto chemical library elements. Step 3 (bottom, right) demonstrates the use of chemical analysis techniques to identify the chemical contents of each spot. Step 4 (bottom, left) involves the use of supervised learning to interpret the chemical contents and recover the data.

FIG. 48 is a flow chart of the writing process (top) and reading process (bottom) of the encoded data. Step a shows the encoded sustainability logo. Step b shows a % Turbo error correction bits incorporated into the dataset. Step c shows that a permutation matrix was applied. Step d shows that a training set was included at the top. Step e shows the raw data prediction after readout. Step f shows that the dataset was un-permuted. Step g shows the recovery of the encoded image before error correction. Step h shows the recovered image after error correction.

FIG. 49 is a mass spectrum that highlights the features belonging to some chemical library elements that encode for these seven bits of information: 1101010.

FIG. 50 is a bar graph showing a comparison of logistic and random forest regression models for recovering encoded data. Each model is represented with varying complexity as defined by the number of classifying peaks or trees to determine the model and complexity that results in the greatest accuracy of data recovery.

FIG. 51 is a bar graph showing the accuracy of recovery for each individual waste mixture. The inventors also produced a visualization of the physical location of the errors on MALDI plates.

FIG. 52 is a bar graph showing the number of compounds.

FIG. 53 is TABLE 9, showing the content analysis of each library element.

FIG. 54 shows an example method of computer using unknown chemical compounds or waste.

FIG. 55 shows a MALDI positive ionization mass spectrum for a sample that encodes the 7 bits of information “1101010”. Below the spectrum is a visualization of 10 features that the classifier models have associated with the presence of each of the 7 library elements. A lighter bar indicates the presence of the individual feature in this particular spectrum, and a black bar represents the absence of that feature.

FIG. 56 shows comparison of logistic and random forest regression models for recovering encoded data. The raw bit accuracy was determined by comparing the binary representation of the encoded sustainability logo with that of the decoded logo prior to Turbo decoding. Since the data was encoded with redundancy and error tolerance, any model that exceeded 86% raw bit accuracy was sufficient to recover the data payload with 100% accuracy.

FIG. 57A shows (a) Raw bit accuracy (before error correction) for each individual waste mixture and FIG. 57B shows visualization of the physical location of the raw bit errors on the MALDI plate. The color bar represents the number of errors on a blue-to-red scale, where blue represents fewer errors and red represents the highest number of errors.

FIG. 58 shows the distribution of the number of library elements in each spot in the dataset.

FIG. 59 shows the accuracy within the experimental test dataset reported as a function of the number of compounds present per well. For example, if there were 200 wells which happened to have 2 compounds present, then above we group those wells and plot their raw bit recovery accuracy (before Turbo decoding). The data is shown for each of the 5 representative classification algorithms.

FIG. 60 shows raw bit accuracy comparison of the five regression architectures, on each of the seven library elements.

### DETAILED DESCRIPTION OF THE INVENTION

### Industrial Applicability

An ever-increasing worldwide demand for digital data storage, alongside a looming slowdown of semiconductor technology scaling, has led to growing interest in molecular-scale platforms for information storage and computing. Molecular data systems have the potential to store information at a dramatically higher density than existing electronic media. Some of the first assay demonstrations of this idea used DNA, but nucleic acids are only one of the ways to use chemicals to preserve, process, and transmit information.

Chemical computation can be useful in ultra-low-power systems, extreme environments, and as complements to electronic computing systems. Adleman, Molecular computation of solutions to combinatorial problems, Science, 266(5187), 1021-1024 (1994). Similarly to how DNA archival data storage may complement traditional electronic media and neural-inspired computing has revolutionized how to process large datasets, chemical-domain computations may provide entirely new ways of leveraging the information processing capabilities of the natural world.

Modern information technology is moving towards a more unified vision of computation and memory, and fluid molecular mixtures offer an intriguing space for future generations of computing systems that take advantage of the natural complexity and intrinsic statistics of chemical systems. Arcadia et al., Proceedings of the IEEE Conference on Rebooting Computing (ICRC) (2018) [EXAMPLE 2]; Chen et al., Natural Computing, 13(4), 517-534 (2014); Jiang et al., IEEE Design and Test of Computers 21-31 (May/June 2012); Kennedy et al., Applied Physics Letters, 112(26), 264103 (June 2018); Rose et al., 2018 IEEE International Symposium on Information Theory (ISIT) (Vail, CO, June 2018), pp. 2236-2240 [EXAMPLE 1]; and Soloveichik et al., Proceedings of the National Academy of Sciences, U.S.A., 107(12), 5393-5398 (2010). Quantifying the information capacity of chemical mixtures is an advance in this direction.

A molecule contains enough molecular information to be a secret input to a chemical hash function. Boukis et al., Nature Communications, 9(1), 1439 (2018); Sarkar et al., Nature Communications, 7:11374 (May 2016). Two-dimensional arrays containing single compounds per grid position can encode digital data by photochemical or electrochemical means. Green et al., Nature, 445:414 (January 2007); Malinakova, Reports in Organic Chemistry, pages 75-90 (2015); Thomas et al., Proceedings of the National Academy of Sciences, U.S.A., 106(23), 9147-9150 (June 2009).

DNA sequences have previously been useful for storing abstract digital data. Church, Gao & Kosuri, Science 337(6102), 1628 (September 2012); Zhirnov et al., Nature Materials, 15:366 (March 2016). DNA can be an information carrier because of the combinatorial complexity that can exist within one molecule. Cartwright et al., Phil. Trans. Roy. Soc. of London A: M., Phys. and Eng. Sci. 374(2064) (2016). Scientists synthesized complex pools of DNA oligomers representing hundreds of megabytes of text, images, videos, and other media files and retrieved the data using commercial high-throughput sequencing instruments. Blawat et al., Procedia Computer Science, 80:1011-1022 (2016); Erlich & Zielinski, Science, 355(6328), 950-954 (March 2017); Goldman et al., Nature, 494:77, (January 2013); Grass et al., Angewandte Chemie International Edition, 54(8), 2552-2555 (February 2015); Organick et al., Nature Biotechnology, 36:242 (February 2018).

DNA memory studies often offer net bits per nucleotide (nt) as a metric for comparison but reaching 2 bits/nt is not the final goal. Demonstrations of DNA data storage exceeded 200 megabytes or 3.2 million unique ≈110-nt sequences. Organick et al., Nature Biotechnology, 36:242 (February 2018). Although this amount stretches today's synthesis capabilities, it represents a tiny fraction of the potential of molecular data storage. This is a mixture with a sparsity (S) of only one out of every ≈1059 molecules from the library.

The metabolome is diverse and contains many coexisting molecules that can interact and react in complex ways. Sung et al., Nature Communications 8, 15393 (2017). DNA achieves about 214 petabytes/gram, while an encoded metabolome written using a large metabolic library could theoretically improve on this number by up to two orders of magnitude. See Erlich & Zielinski, Science 355, 950-954 (2017); Rosenstein et al., Theory of information storage in molecular mixtures; EXAMPLE 6. The intuition underlying this potential is similar to that which posits that information density can be increased by expanding beyond the four canonical DNA bases. The higher degrees of chemical diversity, afforded by large metabolic libraries, can increase information capacity. While a polymer is processed serially, a metabolome is an inherently parallel system, with many energetic dimensions (each of the independent reactions having their own free energy barriers) of varying coupling. While DNA and proteins are often large molecules which exist in relatively small numbers, metabolites are smaller in mass, higher in number, and more structurally diverse.

By developing a formal theory of the information capacity of mixtures of molecules, the inventors show how information can be represented by any chemical library. For new synthetic molecular information systems, the inventors show that long polymers are neither required nor necessarily desirable to maximize total information capacity. Mixtures of molecules offer far greater potential capacity, even when the constituent molecules are polymers themselves.

In non-genomic (or “post-genomic”) chemical space, working within the assumptions that led to an estimate of 1060 drug-like small molecules (see, Bohacek et al., Medicinal Research Reviews, 16(1), 3-50 (September 1996), the selection of one 500 Da molecule could represent as much as log₂1060≈200 bits. To represent the same amount of information in DNA requires a molecule with a mass of 65,000 Da. Thus, there are opportunities for chemical information systems with up to two orders of magnitude lower mass than DNA, and with far greater chemical diversity.

### Definitions

For convenience, the meaning of some terms and phrases used in the specification, examples, and appended claims, are listed below. Unless stated otherwise or implicit from context, these terms and phrases have the meanings below. These definitions are to aid in describing embodiments and are not intended to limit the claimed invention. Unless otherwise defined, all technical and scientific terms have the same meaning as commonly understood by one of ordinary skill in the art to which this invention belongs. For any apparent discrepancy between the meaning of a term in the art and a definition provided in this specification, the meaning provided in this specification shall prevail.

Abstract digital data or digital data is data that is represented using the binary number system of ones (1) and zeros (0), as opposed to analog representation. Abstract digital data can correspond to real objects.

Address has the computer art-recognized meaning. An address is a location for data. Each location has an address (a unique number) assigned to it. By specifying a memory address, those skilled in the molecular computing art can access particular data. An addressable location can be a location on a solid surface containing a mixture of molecules, e.g., small molecules.

Addressable locations have the computer art-recognized meaning. An addressable location is a location whose position in a storage medium is precisely defined and can be accessed.

Array spectrum has the computer art-recognized meaning. An array spectrum is an array of entities ordered in accordance with the magnitudes of a common physical property.

Binary code has the computer art-recognized meaning. Binary code represents text, computer processor instructions, or any other data using a two-symbol system. The two-symbol system used is often “0” and “1” from the binary number system. The binary code assigns a pattern of binary digits, also known as bits, to each character, instruction, etc. In computing and telecommunications, binary codes are used for various methods of encoding data, such as character strings, into bit strings. Those methods may use fixed-width or variable-width strings. In a fixed-width binary code, each letter, digit, or other character is represented by a bit string of the same length; that bit string, interpreted as a binary number, is usually displayed in code tables in octal, decimal or hexadecimal notation. There are many character sets and many character encodings for them.

Binary computer language is a computer language written in binary code. The computer language can be selected from the group consisting of programming language, command language, general-purpose language, machine language, markup language, style sheet language, configuration language, construction language, query language, modeling language and simulation language.

Binary data has the computer art-recognized meaning. Binary data is data whose unit can take on only two possible states, traditionally labeled as 0 and 1 in accordance with the binary numeral system and Boolean algebra. Binary data occurs in many different technical and scientific fields, where it can be called by different names: bit (binary digit) in computer science, truth value in mathematical logic and related domains, binary variable in statistics.

Chemical perceptron is the implementation of a perceptron in an artificial (simulated) chemistry. A perceptron is a machine learning algorithm that helps provide classified outcomes for computing. A perceptron is the simplest system capable of learning (inspired by the functioning of a biological neuron). See, Banda et al., Online Learning in a Chemical Perceptron. Artificial Life, 19(2), 195-219, (Spring 2013); Banda et al., Journal of the Royal Society Interface, 11(93) (April 2014). A perceptron algorithm is a supervised classification because the computer is aided by the human classification of data points. See, Arcadia et al., Proceedings of the IEEE Conference on Rebooting Computing (ICRC) (2018) [EXAMPLE 2] and Rose et al., 2018 IEEE International Symposium on Information Theory (ISIT) (Vail, CO, June 2018), pp. 2236-2240 [EXAMPLE 1].

Chemical scaffold has the chemical art-recognized meaning. A chemical scaffold is a molecular core to which functional groups are attached.

Dataset is, when working with machine learning methods, a collection of instances.

Ground truth has the computer art-recognized definition. In machine learning, the term refers to the accuracy of the training set's classification for supervised learning techniques. This is used in statistical models to prove or disprove. The related term ground truthing refers to the process of gathering the proper objective (provable) data for this test. A synthetic metabolome has ground truth. A metabolome from a living organism may obtain ground truth as a result of the progress of science and the useful arts.

HPLC is high-pressure liquid chromatography. In HPLC, a liquid sample is injected into a stream of solvents. Together, the sample and solvents are forced, at high pressure, through an analytical column. Depending on the type of column and solvents, some chemicals can exit the column at different times. At the end of the column is an ultraviolet (UV) light source and a photodetector. When an appropriate wavelength is selected, the analyte can be detected by a change in absorbance as it exits the column. The absorbance is plotted over time as a chromatogram. See, Karger, Journal of Chemical Education, 74(1), 45 (1997).

In-memory computing, also known as In-memory computation, has the computational art-recognized meaning of the technique of running computer calculations entirely in computer memory, e.g., in RAM.

In-situ processing, also known as in-storage processing (ISP), has the computational art-recognized meaning of processing data where it resides.

Linear classification is the identification to which class (or group) it belongs based upon an object's characteristics, where the classification decision is based upon on the value of a linear combination of the characteristics.

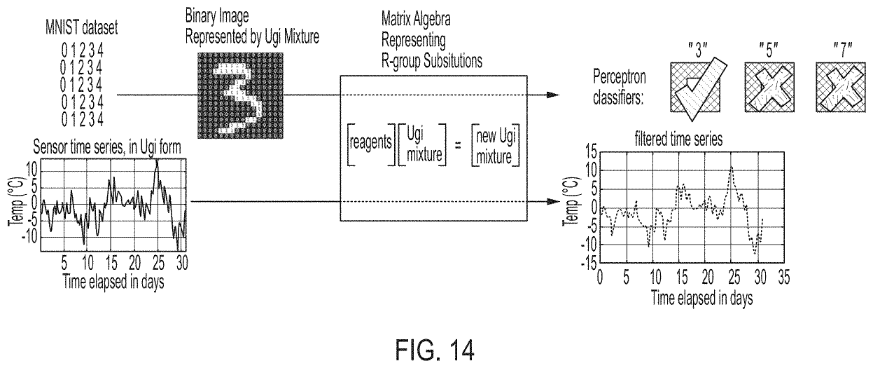

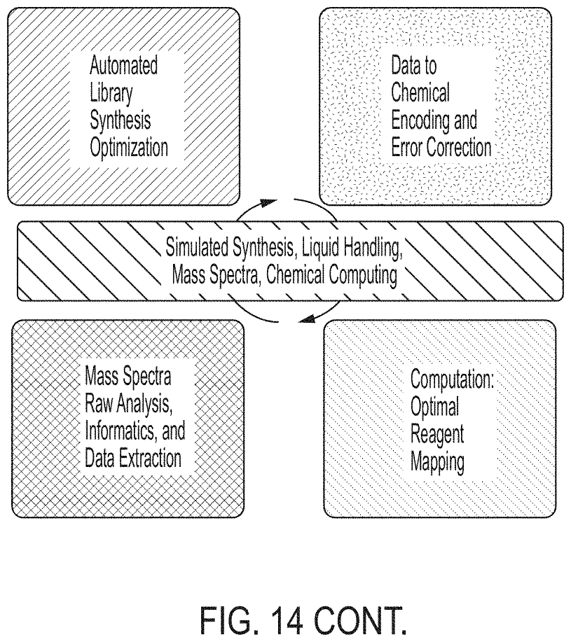

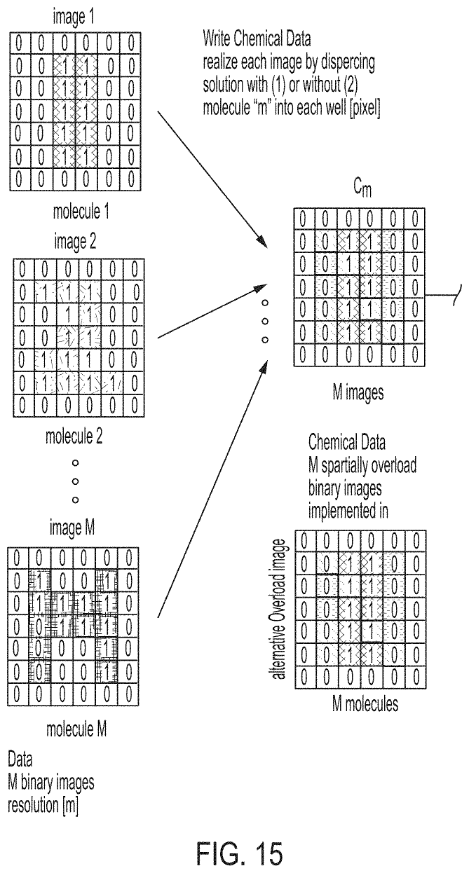

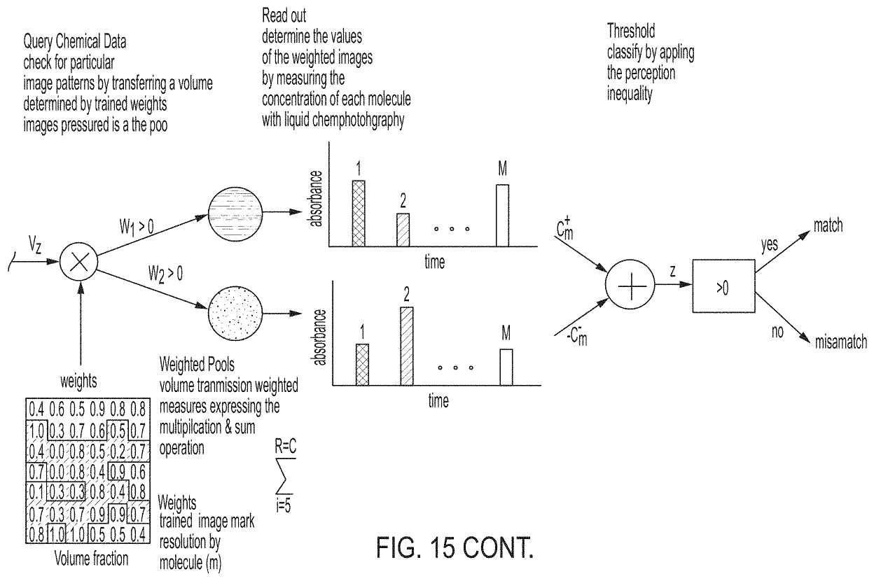

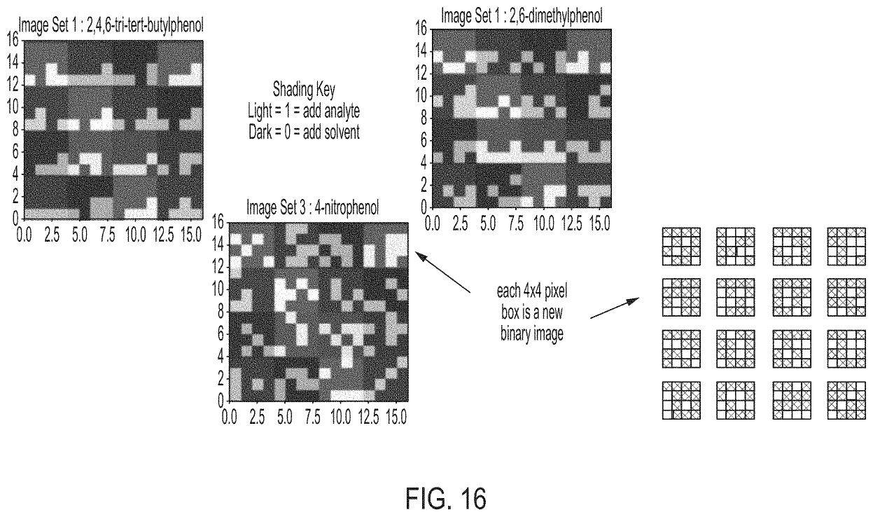

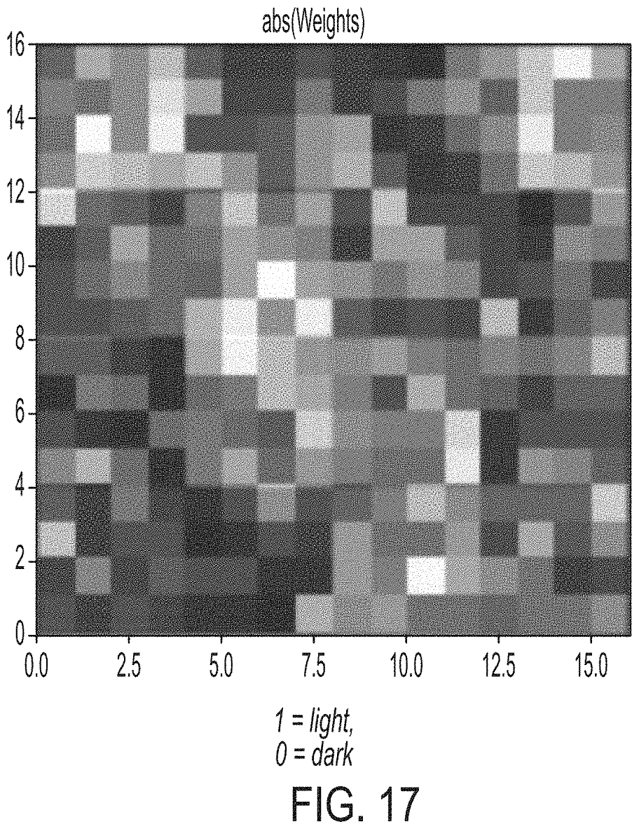

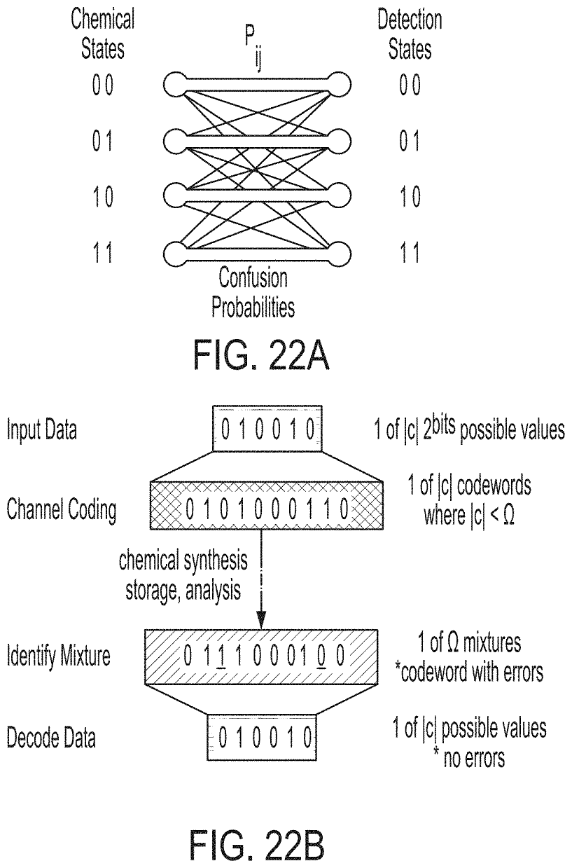

Logistic regression analyses are computer art-recognized algorithms to solve a classification problem, where the algorithm involves a linear discriminant separating the classes. A classification problem occurs when independent variables are continuous, and a dependent variable is in categorical form, i.e., in classes like positive class and negative class. To check the performance of logistic regression analyses, those skilled in the computing art can use a confusion matrix (see, FIGS. 22A-22B) or an Area Under the Curve-Receiver Operating Characteristics (AUC-ROC) Curve. See, EXAMPLE 4, FIG. 14, and FIG. 17.

MALDI mass spectroscopy is described in U.S. Pat. No. 7,084,396 (Schneider). Mass spectrometry (MS) fundamentally consists of three components: ion sources, mass analyzers, and ion detectors. The three components are interrelated; some ion sources may be better suited to a particular type of mass analyzer or analyte. Certain ion detectors are better suited to specific mass analyzers. Electrospray (ESI) and matrix-assisted laser-induced desorption (MALDI) ionization sources are widely used for organic molecules, particularly biomolecules and are generally preferred for the ionization of non-volatile organic species. ESI is widely practiced because it can be readily coupled with liquid chromatography and capillary electrophoresis for added discrimination capability. MALDI techniques are widely practiced on large molecules (e.g., proteins) that can be difficult to solubilize and volatize in ESI. The principal advantage of MALDI is the small number of charge states that arise from molecules with a multiplicity of ionizable groups.

Mass spectrometry (MS) is an analytical technique that ionizes chemical species and sorts the ions based on their mass-to-charge ratio. Accordingly, a mass spectrum measures the masses within a sample. Mass spectrometry is useful for broad and high-throughput metabolic screening. Zampieri et al., Current Opinion in Chem. Bio. 36, 15-23 (2017). Advances in statistical tools and databases support mass spectrometry. Brown et al., Analyst. 134(7), 1322-32 (2009); Wishart et al., Nucleic Acids Res. 4(46), 608{617 (2018).

Metabolome is all the molecules (e.g., small molecules) present in each organism, including metabolites and the products of catabolism. See, U.S. Pat. No. 7,329,489 (Kaddurah-Daouk et al.). The metabolome refers to the complete set of small-molecule chemicals found within a biological sample. The biological sample can be a cell, a cellular organelle, an organ, a tissue, a tissue extract, a biofluid or an entire organism. Metabolites are biologically ubiquitous, and their primary pathways and processes are highly conserved across species and historical epoch. Peregrin-Alvarez et al., Genome Biol. 10(6), R63 (2009). The whole human metabolome has ˜125,000 elements. Wishartet al., HMDB 4.0: the human metabolome database for 2018. Nucleic Acids Res. 4(46), 608-617 (2018). By analogy, if DNA is the ‘hard drive’ of living systems, then the surrounding molecules are the logic and RAM. DNA represents only ≈1% of the mass of a cell. The remaining 99% also confers important information.

Metabolomic element is an element (e.g., a small molecule) in a metabolome.

Microwell plate is a flat plate with multiple “wells” used as small test tubes. A microplate is a standard tool in analytical research and clinical diagnostic testing laboratories. Robots have been developed specifically to handle microplates for high-throughput assays. Ultra-low attachment (ULA) plates that support 3D cell culture are commercially available, e.g., from ThermoFisher Scientific, Waltham, MA, USA.

Molecular computing has the computational art-recognized meaning of computing that uses DNA, biochemistry, and molecular biology hardware, instead of traditional silicon-based computer technologies.

Molecular memory has the computational art-recognized meaning of data storage technologies that use molecular species as the data storage element, rather than e.g., circuits, magnetics, inorganic materials, or physical shapes. In a perfect molecular memory device, each individual molecule contains a bit of data, leading to massive data capacity.

Multiply accumulate (MAC) operation is a common step in computing, especially digital signal processing, that computes the product of two numbers and adds that product to an accumulator.

Nanoscale refers to having dimensions measured in nanometers (10⁻⁹ meters). Nanomolar (nM) is 10⁻⁹ mol/L (10⁻⁶ mol/m³). Nanoliter is 10⁻⁹ L.

One-hit has the computer art-recognized definition. A one-hit has a single positive bit in a digital sequence. A one-hit is useful as a basis for further molecular computing.

Parallel computing is a type of computation in which many calculations or the execution of processes are carried out simultaneously. Large problems can often be divided into smaller ones, which can then be solved at the same time.

Perceptron is a flexible and universal pattern classification structure and a key element of neural network systems that handle large data sets. See, Courbariaux et al., arXiv:1602.02830 (Mar. 17, 2016). Mathematically, a perceptron is a dot product between a real input vector x and a real weight vector w, both of dimension J, followed by a nonlinearity ø(w•x) where ø(•) is a sigmoidal, non-decreasing thresholding function with a rapid transition between two discrete levels. Accordingly, a perceptron is a binary classifier which separates inputs into two groups.

Pixel map is a video display technique applicable to devices with native fixed pixels, such as LCD monitors and plasma displays. A monitor that has been set to 1:1 pixel mapping displays an input source without scaling it, such that each pixel received is mapped to a single native pixel on the monitor.

Reaction groups or functional groups has the chemical art-recognized meaning. Reaction groups are specific substituents or moieties within molecules that are responsible for characteristic chemical reactions of those molecules. The same functional group undergoes the same or similar chemical reaction regardless of the size of the molecule of which it is a part.

Small molecule has the biological art-recognized definition. The NCI Dictionary of Cancer Terms defines a small molecule as A substance that can enter cells easily because it has a low molecular weight. Inside the cells, it can affect other molecules, such as proteins. This characteristic is different from drugs that have a large molecular weight, such as monoclonal antibodies, which cannot get inside cells very easily.

Spectrometry is an instrumental method for identifying the chemical constitution of a substance by means of the separation of gaseous ions according to their differing mass and charge.

Spectroscopy is the branch of science concerned with the investigation and measurement of spectra produced when matter interacts with or emits electromagnetic radiation. The term spectroscopy includes ultraviolet-visible spectroscopy, Rydberg spectroscopy, Infrared spectroscopy, fluorescence spectroscopy, and absorption spectroscopy.

Zettabyte is 10²¹ bytes. See, Cisco, The Zettabyte Era: Trends and Analysis (2016).

### Methods of the Invention

The invention provides a method of computing using chemical manipulations to store and process abstract digital information. The invention provides methods for chemical encoding, computational processing and readout. The invention provides a method for encoding binary data into the chemical composition of liquid samples. The invention provides a method for storing multiple datasets in parallel by multiple co-existing chemicals. The inventors used programmable robotic liquid handling sequences to perform volumetric multiply accumulate (MAC) operations on parallelized chemical datasets. The inventors used high-performance liquid chromatography (HPLC) to read and verify the results of the chemical MAC calculations. Several images of handwritten digits from the MNIST database (LeCun et al., Proceedings of the IEEE, 86(11), 2278-2324 (1998)) were chemically encoded and successfully implemented on several single layer volumetric chemical perceptrons to classify the images. The inventors quantified the performance of the methods with a larger dataset of binary vectors. The inventors demonstrate herein the accurate linear classification of several MNIST images and Boolean data vectors.

A perceptron is a simple linear classifier which can be trained to determine whether or not an input belongs to a certain class. Rosenblatt, Psychological Review, 65(6), 386 (1958); Minsky et al., Perceptrons: An Introduction to Computational Geometry (MIT Press, 2017); Bishop, Pattern Recognition and Machine Learning (Springer, 2006). A perceptron uses a set of constant coefficients to compute a weighted sum of input features and thresholds the result to produce a Boolean label. The computation can be written as:

$$𝓏 = {\sum }_{i = 1}^{N} {w}_{i} \cdot {x}_{i} + b \qquad [ Equation I ]$$

where N is the number of input features (e.g., pixels in an image or dimensions of a vector), xᵢ and wᵢ are the i^{th} feature and its corresponding weight, and b is a scalar bias. When the bias is nonzero, it is common to fold b into w by introducing an additional input feature whose value is always 1. The summation result z determines the class label, [symbol] , of the input according to the following threshold:

$$ℓ = \{ \begin{matrix}match , & if 𝓏 > 0 \\ mismatch , & otherwise\end{matrix} \qquad [ Equation II ]$$

For a linearly separable dataset, the training for a perceptron is guaranteed to converge such that a set of weight values is found that correctly classify all training points. While a perceptron is a simple classifier, it can be used as a building block for larger discriminative models, such as multilayer perceptrons [Gibson & Cowan, Proceedings of the IEEE, 78(10), 1590-1594, (1990)] and support vector machines [Fu et al., IEEE Transactions on Neural Networks, 21(12), 1963-1975, 2010] that can realize more complicated decision boundaries.

A perceptron can be designed to classify an MNIST handwritten digit image into one of two groups such as “zero” vs. “not a zero.” LeCun et al., Proceedings of the IEEE, 86(11), 2278-2324 (1998). By controlling the values of the weights, one can change the classification operation. One advantage of using perceptron-based computation is that the weights can be flexibly designed; another advantage is that the computations are error tolerant. For instance, the precision of the weights can be flexibly set in floating point, fixed point, or even binary (−1|1 or 0|1), but nevertheless, the classification outcome can still be accurate because the training process can compensate for the reduction in precision and “heal” the perceptron. See, Rastegari et al., CoRR, abs/1603.05279 (2016); Courbariaux et al., arXiv:1602.02830 (Mar. 17, 2016); Lin et al., CoRR, abs/1510.03009 (2015); Gupta et al., CoRR, abs/1502.02551 (2015). Such flexibility and error tolerance are useful given the underlying discrete nature of the input-coding disclosed here and the stochastic nature of chemical reactions.

### Materials and Methods

A person of ordinary skill in the computational art can use these materials and methods as guidance to predictable results when making and using the invention:

Materials and reagents. The solvent dimethyl sulfoxide (DMSO, anhydrous, ≥99.9%, MilliporeSigma) was used to prepare all solutions in the library and data plates. Analytical grade α-cyano-4-hydroxycinnamic acid (HCCA, ≥99.0%, MilliporeSigma) was used as the matrix material for all MALDI samples. The library of 1500 Ugi products was constructed with the following five amines: benzylamine, 4-methylbenzylamine, p-methoxybenzylamine, 4-chlorobenzylamine, 4-tertbutylbenzylamine; five aldehydes: cyclohexanecarboxaldehyde, 3-cyclohexylpropanal, valeradlehyde, isovaleraldehyde, cyclopentanecarboxaldehyde; 12 carboxylic acids: Boc-glycine, Boc-proline, Boc-N-methyl-L-valine, Boc-L-asparagine, Boc-L-beta-homoleucine, Boc-L-methionine, Boc-L-beta-homoglutamine, Boc-L-betahomo-methionine, Boc-L-phenylalanine, Boc-N-alpha-N-epsilon-formyl-L-lysine, Boc-N-methyl-L-phenylalanine, Boc-O-methyl-L-tyrosine; and five isocyanides: cyclohexyl isocyanide, ethyl isocyanoacetate, benzyl isocyanide, 2-naphthyl isocyanide, methyl isocyanoacetate. These compounds were obtained at synthesis grade or higher and used as received from their vendors (Chem-Impex for the carboxylic acids and MilliporeSigma for the others).

Library preparation (I). Each reagent can be dissolved in dimethyl sulfoxide to a concentration of 500 mM and placed into a 384-well plate. Using an acoustic fluid handler, one dispenses the reagents, 200 nL per inclusion, into a 1536-well plate to enumerate all possible four-component Ugi reactions. The array of reagent mixtures was left to react at room temperature for one-two days. After reacting, dimethyl sulfoxide was added to each library well to reach a final volume of 4 μL.

Chemical library preparation (II). Reagent grade samples of thirty-six distinct metabolic compounds were diluted in dimethyl sulfoxide (anhydrous), each to a nominal concentration of 25 mM. Some metabolites were initially dissolved in an alternative solvent (deionized water with or without 0.5M or 1M hydrochloric acid) to facilitate solvation in dimethyl sulfoxide. 10 μL of each compound was aliquoted into a 384-well microplate (Labcyte 384LDV).

Ugi product library synthesis (III). To make a library, the reagents are manually prepared as 500 mM solutions in dimethyl sulfoxide and 60 μL of each is pipetted into a 384-well plate. To level the fluid menisci, one spins the plate in a centrifuge for five minutes at 2,500 rpm. The reagent plate is then placed into an Echo 550 acoustic liquid dispenser, surveyed to check volume levels, and finally used to prepare the reaction wells according to a pre-generated list of transfers. The reagents are added by class, in the following order: amines, aldehydes, carboxylic acids, and lastly isocyanides. The resulting reaction wells, filled with 200 nL of each reagent solution (800 nL in total), are left to react. After an incubation period of about 24-48 hours, dimethyl sulfoxide solvent is added to bring the final product volumes to 4 μL. The inventors generally use these library elements for data storage without further purification. Over the course of this EXAMPLE, the inventors ran over 10,000 Ugi reactions, up to 1,500 at a time.

Library validation. To identify successful reactions, a small volume (20 nL) from each library well was spotted to a unique location on a stainless steel plate (78 mm×120 mm) along with matrix (20 nL of 176.2 mM α-cyano-4-hydroxycinnamic acid in dimethyl sulfoxide). The plated samples were allowed to dry overnight (˜10 h) into round crystals (˜800 μm in diameter), before analysis via mass spectrometry. In the resulting mass spectra, one looks for peaks corresponding to expected Ugi product masses and used peak height as a coarse measure of reaction yield. Since the Ugi products have similar ionization profiles, the inventors performed a global statistical analysis of the library spectra, using the SNR of their sodiated peaks. A common threshold (T) was found using receiver operator characteristic (ROC) curve analysis. To construct the ROC curve, one looks for the sodiated product peaks across all reaction wells, applies a given SNR threshold to assess the presence or absence of these peaks, tallies detected library peaks to estimate the true positive (TPR) and false positive (FPR) rates, and repeat this process for all candidate thresholds. Because there should be exactly one product per well, if the expected product is detected, the product is counted as a true positive (TP), and if not, then it is marked as a false negative (FN). Similarly, if other products are detected in the well, they are counted as false positives (FP) and otherwise as true negatives (TN). The products with masses that overlap with that of the expected product are counted as TPs or FNs. Error rates can be calculated as TPR=TP/(TP+FN) and FPR=FP/(FP+TN), and used to find an optimal SNR threshold, by minimizing the distance to the (0,1)-corner: [(0−FPR(SNR))²+(1−TPR(SNR))2]^{1/2}. The Ugi products whose SNR exceeds this threshold (SNR-T) are declared present.

Library subset selection. The data storage examples described have all used a subset of the compound library, due in large part to the limited write speed. To select a subset, one begins with the list of library products having confirmed M+Na peaks. In the example below, 90% (1346=1500) were detected. One then sorts these compounds by sodiated peak intensity. Starting from the strongest peak, one includes each successive compound when its monoisotopic mass has a distance of at least 0.008 Da from any previously selected compounds. For an exemplary thirty-two products, the average mass separation was 3.970 Da and the average SNR was approximately 10,000. The inventors note that by using multi-peak detection, one can distinguish library elements with overlapping monoisotopic masses.

Data plate preparation. First, a digital file is converted into a one-dimensional binary vector. This vector is then encoded, either with a direct or sparse mapping, into an M×N compound-presence matrix, where M is the number of compounds to be used, and N is the number of independent mixtures to be made. The value of element pmn in this matrix indicates the presence (“1”) or absence (“0”) of the nth compound in the nth mixture. To physically generate the mixtures, 2.5 nL droplets are transferred from the 1536-well library plate to their appropriate locations on a MALDI plate. Finally, 30 nL of matrix solution (176.2 mM α-cyano-4-hydroxycinnamic acid in dimethyl sulfoxide) is added to each data mixture spot. The overall time to write a data plate ranged from 0.3 to 7.9 hours, varying with the encoding scheme and file size. Once all transfers are complete, the data plate is left to dry in a fume hood overnight or a vacuum chamber for about two hours. The resulting dried mixture spots are typically 1 mm in diameter. Currently, the number of compounds that can be included in each mixture is limited by the layout of samples on a MALDI plate. For a 1536-well grid, spots can contain up to 200 nL of solution before they begin to merge with adjacent samples. For more complex samples, mixing would have to be done in an intermediate well plate.

Data plate analysis. During plate preparation, the matrix solution is spiked with a reference Ugi molecule which is used to calibrate for small offsets in the recorded masses. After offset calibration, raw mass spectra are resampled to a common m/z grid to construct a single analysis-ready matrix containing the mass spectra of all spots on a plate. For single peak detection, the sodiated adduct intensities for a product are simply one row in the spectral matrix, and this vector can be thresholded to determine, which mixtures contain the compound. The detection threshold for each compound was found using ROC analysis of labeled training data, as previously described for library validation. Recovering the data file from the presence matrix depends on the encoding method. For direct mapping, the matrix is simply reshaped to obtain the stored data. For sparse mappings, each matrix row was matched to the nearest valid key and converted to the corresponding binary data value.

For multi-peak detection, a similar procedure was followed, except that the presence matrix was found by applying a regression model trained to identify each compound based on multiple spectral features. To reduce computational overhead, instead of building the models on the entire mass spectra matrix, masses whose average intensities were close to the noise floor were discarded, reducing the feature space to <1% of its original size, from four million initial points to at most 20,000 candidate masses. For logistic regression, these features were further refined based on AUROC scores. This additional filtering was not needed for random forest regression since it automatically performs feature selection. The Python library Scikit-learn51 was used to construct a regression model for each compound. Logistic regressions were configured to use 64 spectral peaks, while random forest regressions were configured to use 300 trees of unlimited depth and at most 20,000 spectral features. The regression models used a 30/70 train/test split.

Synthesis; Multicomponent Reactions: Data encoded in molecules produced via Ugi reactions are high-yielding, combinatorial, soluble in reaction solvents (acetonitrile, methanol; water), with yield stable, nonpolar products, readily characterized by NMR and mass spectrometry, and amenable to tandem reactions, like peptides.

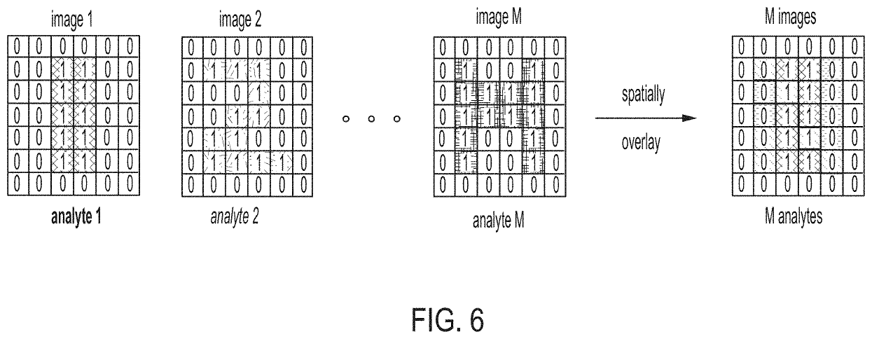

Data storage. To write a dataset, compounds from a library plate are used to create mixtures corresponding to the data to be stored, by dispensing droplets with an acoustic liquid handler. The time required to write a dataset depends on the several factors, including the size of the data, the encoding scheme, the rate of droplet dispensing, and the time that the liquid handler takes to move between library wells. FIG. 6a illustrates the write process. The liquid transfer lists are sorted by library source well and then destination well, to save time. The transfer rate was about four compounds/second, which corresponded to a write speed of 18 bits/second for this dataset.

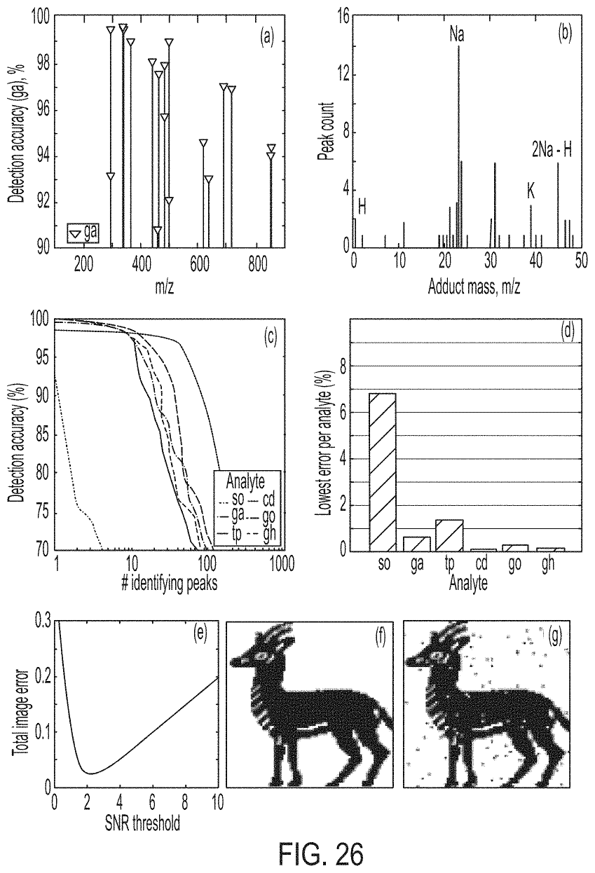

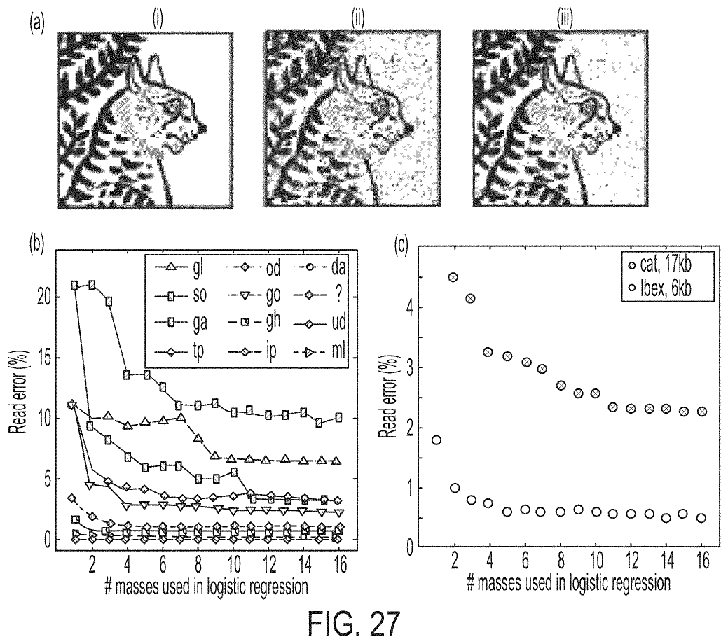

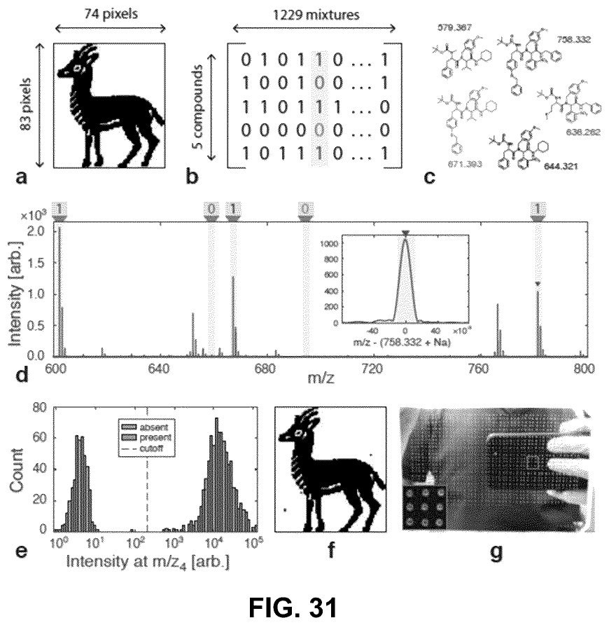

Long-term storage. Usually, one measures data plates within two weeks of writing them. However, the datasets are stable for much longer than that. One of the earliest data plates (Ibex, see FIG. 26 and FIG. 31), has been read multiple times over the course of its year-long existence with no significant change in readout quality. Because the solvent has been evaporated and the molecules are trapped within matrix crystals, the stored data should remain intact if the samples are kept under reasonable environmental conditions. Some parameters which may affect the lifetime of stored data include:

Temperature. The melting points of the matrix and encoding compounds represent a limit to the temperature a data plate can be exposed to before crystal integrity becomes compromised. The matrix (α-cyano-4-hydroxycinnamic acid) melting point is 252° C. The Ugi products are highly stable, due to their peptide-like amide bonds and are reported to have melting points around 200° C. Simulations using OCHEM models predict the average melting and boiling points of the synthesized Ugi library to be around 113° C. and 810° C., respectively.

Humidity. Because both α-cyano-4-hydroxycinnamic acid and the Ugi products are soluble and stable in water, individual spots should take on water for a short period without affecting the data they store, though the samples should be dried before reading. The amide bonds in the Ugi products will slowly degrade by hydrolysis over time. This process can be drastically accelerated in the presence of certain enzymes. Keeping the samples in a dry and sterile environment is recommended.

Light and radiation. The Ugi products, specifically their amide bonds, are to some extent susceptible to dissociation under UV and X-ray radiation and should be stored in a dark or LED lit room, without direct sunlight.

Mass spectrometry. Mass spectra were acquired with a Fourier transform ion cyclotron resonance (FT-ICR) mass spectrometer in positive ion mode. Samples were crystallized in matrix, using an ˜100:1 ratio of matrix to Ugi product. Samples were ionized using matrix-assisted laser desorption ionization (MALDI). Spectra produced by FT-ICR are particularly high resolution, often reaching peak widths of 0.001 Da or smaller. To ensure the accuracy of peak assignment, a mass calibration is performed before each run using sodium trifluoroacetate as a reference. One typically acquires spectra for 1.5 seconds, which results in a resolving power of 1.3×10⁵ at 600 Da. The instrument serially addresses each crystallized spot and takes about four hours to record all 1,536 spots on a plate. Each measurement is made by ionizing a portion of a sample with a laser configured to take 500 shots at 1000 Hz, over a scan area of 500-900 μm, with medium focus, and ×4 averaging. One converts the raw data files from the instrument into a custom HDF5 file, for more efficient querying and ease of access. To normalize signals across measurements, the inventors often convert the raw intensity values of a spectrum to signal-to-noise ratios (SNR) according to the following shift-and-scale relation: SNR=(I−μ)/σ, where I is an intensity and μ and σ are the mean and standard deviation of the spectrum's background.

One can assume molecule identification via mass spectrometry, a widespread and powerful analytical technique in which molecules are ionized and accelerated in an electromagnetic field, reaching speeds which depend on their masses. Typically, an instrument produces a “mass spectrum” identifying the abundance of molecules across a range of measured mass-to-charge ratios. Several types of mass spectrometers exist, with different tradeoffs between resolution, speed, and complexity. Analyzing a solution with exactly one pure Ugi product, one expects to see several identifiable peaks in the mass spectrum, corresponding to atomic isotopes and adducts of sodium ions present in the solution. The base mass of the Ugi molecule is approximately equal to the sum of the masses of its four reactants, and the multiple peaks appear at consistent offsets from this base mass, though their relative amplitudes may vary. For simplicity, each molecule has two isotopes and two possible adducts, allocated in a random fraction. Each peak appears with a finite width determined by the resolution of the instrument, having a standard deviation between I to 0.001 m/z. The total detected peak heights vary with chemical preparation and ionization yield, and for these purposes one assumes a log normal distribution.

¹H NMR spectroscopy is a technique that probes hydrogen electron distributions. The inventors used this technique to predict chemical shifts and splittings using counter-propagation neural networks. MAE=0.25 ppm. This technique takes minutes to run, usually entirely online when rescripted to run on clusters. See Aires-de-Sousa, Hemmer, & Gastinger, Anal. Chem., 74(1), 80-90 (2002).

Infrared (IR) spectroscopy is a technique that probes molecules' vibrations, the characteristic infrared stretch frequencies in organic molecules. The inventors used this technique and modeled Using B3LYP/6-31G* Basis. Geometries were taken from RDKit, relaxed, and rescaled based upon fitting to the known dataset. The time used for this technique is measured in hours. See Werner et al., Molpro. WIRES Comput. Mol. Sci. (March/April 2012).

Mass spectrometry. Spectrum acquisition. To analyze the chemical makeup of many samples per day, one can use a Fourier-transform ion cyclotron resonance (FT-ICR) mass spectrometer with matrix assisted laser desorption ionization (MALDI). During a measurement, a small fraction of each spot's material is re-moved by a laser, and ions are excited into orbit in a high vacuum and a strong magnetic field. The orbital frequencies are a function of the mass and charge of each ion. The mass-to-charge ratio (m/z) of the ions can be found by taking the Fourier transform of the detected time-domain signal. Because the ions can be kept in orbit for several seconds, corresponding to millions of orbital cycles, FT-ICR mass spectra have exceptionally high resolution, often reaching peak widths of 0.001 Da or less. One typically acquires spectra for 1.5 seconds which results in a resolving power of 1.3×105 near 600 Da.

FT-ICR mass spectrometry. Fourier-Transform Ion Cyclotron Resonance (FT-ICR) mass spectrometer for detection, determines mass based upon Lorentz's Law: F=qv×B. Mass resolution: 10⁶. Mass range: 100-10000 Da. Loading: 10⁶ to 10⁷ charges. Minimum number of ions for detection: ˜100. ˜10⁴ to 10⁵ compounds per loading. See, e.g., Bruker Daltonics SolariX XR 7T FT-ICR.

Mass calibration. To ensure the mapping from cyclotron frequency to mass-to-charge ratio is done as accurately as possible, the mass spectrometer is calibrated with a sample having several known masses across the measurable range of 150-3000 Da. One can perform this calibration before each MALDI plate measurement, using a solution of sodium trifluoroacetate (NaTFA): 0.05 g L⁻¹ NaTFA dissolved in a 1:1 water:methanol mixture. The solution is injected into the instrument via electrospray ionization (ESI) and peaks are observed across the spectra which correspond to Naₓ(CF₃CO₂)_{y}. The measured positions of these peaks are then adjusted to their known values with a quadratic model, as are the rest of the m/z values.

Additionally, a small offset calibration is performed within each spectrum using a common known mass. One can spike the α-cyano-4-hydroxycinnamic acid matrix solution with a manually purified Ugi product (F13) at a concentration of about 8 mM. This peak, commonly referred to as a mass lock, appears in all measured spectra, and is used to correct for fine offsets in each measured spectra ±0.01 Da or less.

Repeated reads. Each read from a MALDI spot removes a portion of the original sample. To quantify how a spot degrades
after repeated measurement, one can perform a series of spot burnout tests at various laser powers. The Ugi product (purified H6) and matrix concentrations in these samples were 1.56 mM and 88 mM, respectively. Each measurement was performed with 500 shots of the laser which was at medium focus and set to fire at 1000 Hz, while the scan region width was set to 500 μm. For most of the tested laser powers, the product could still be detected after 100 repeated reads.

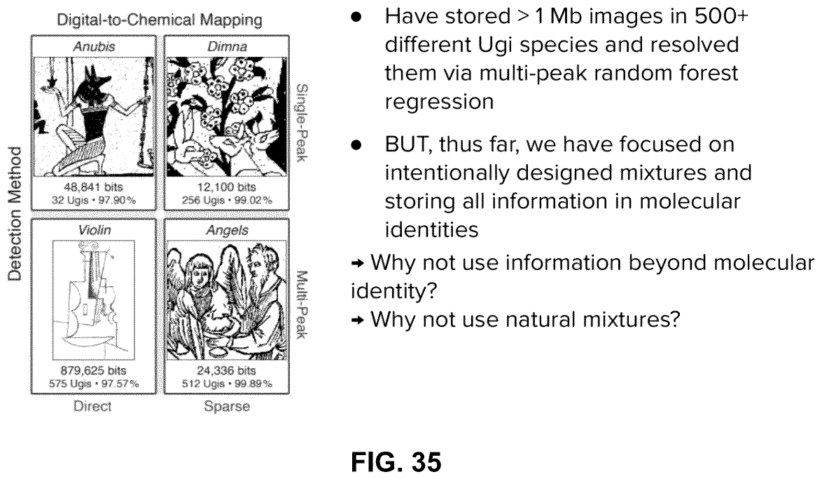

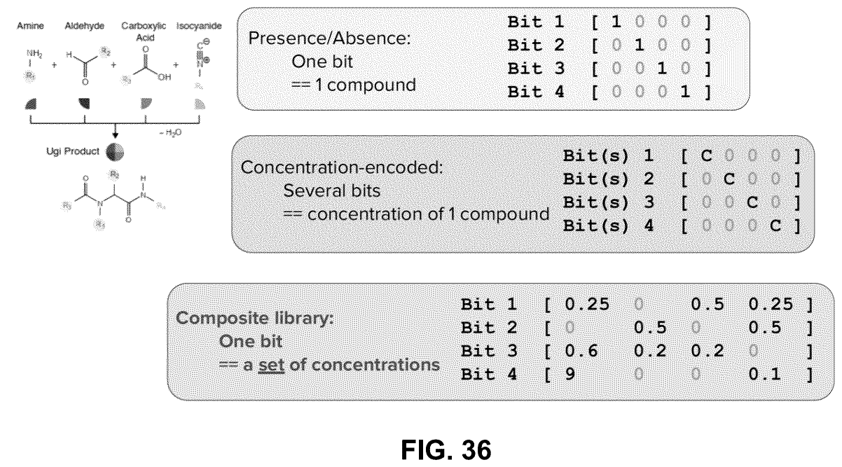

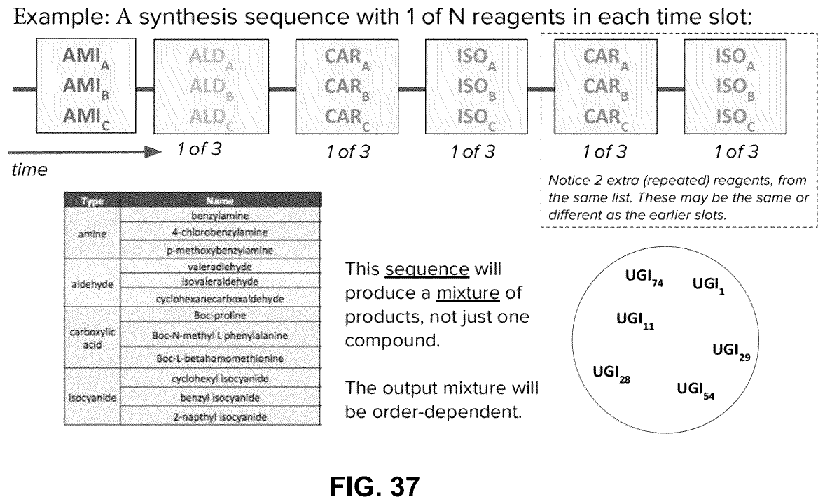

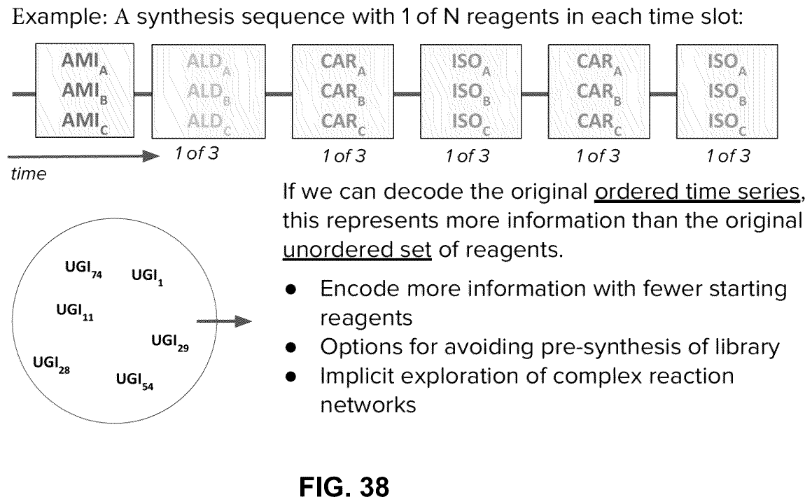

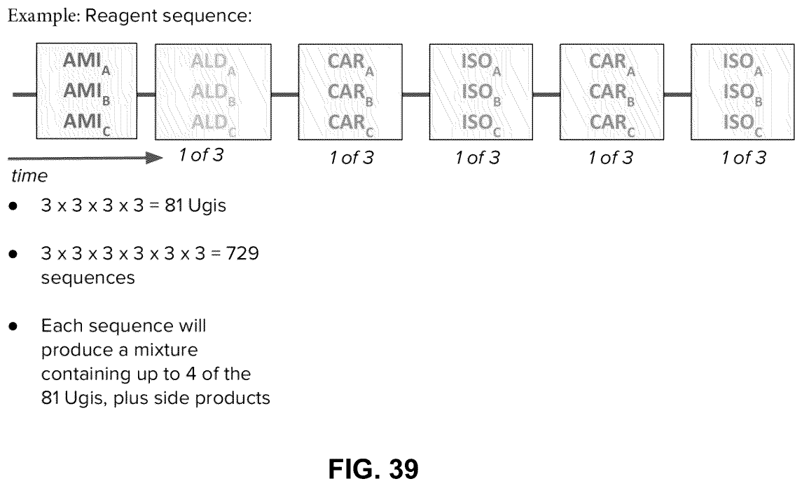

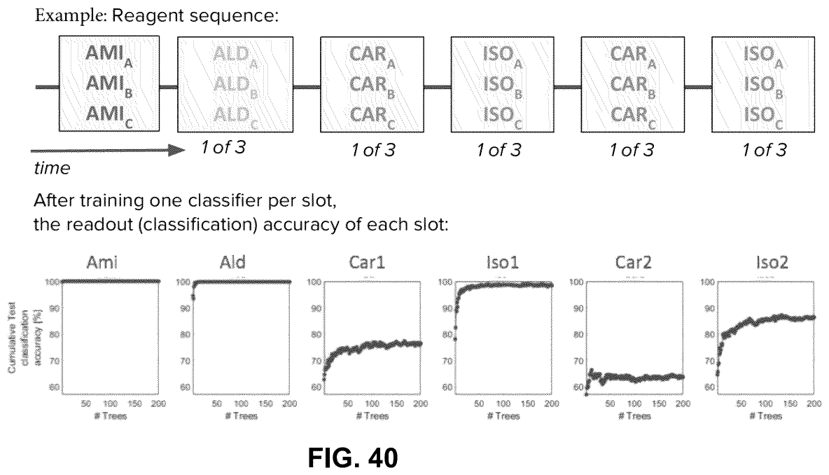

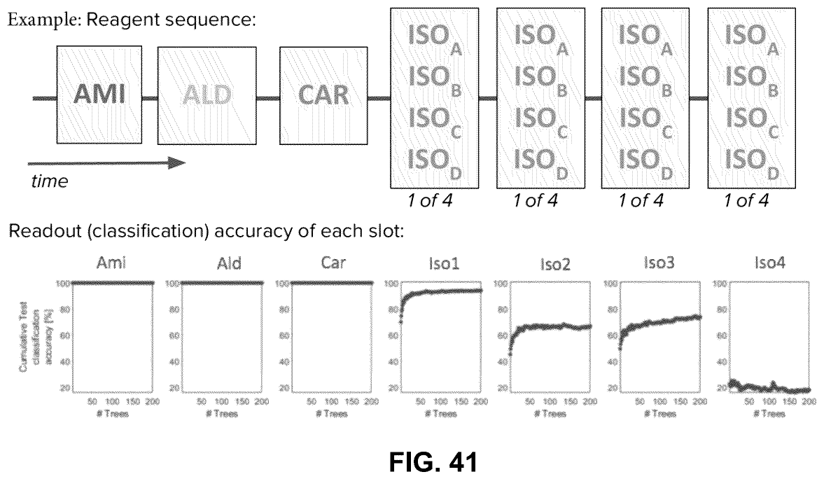

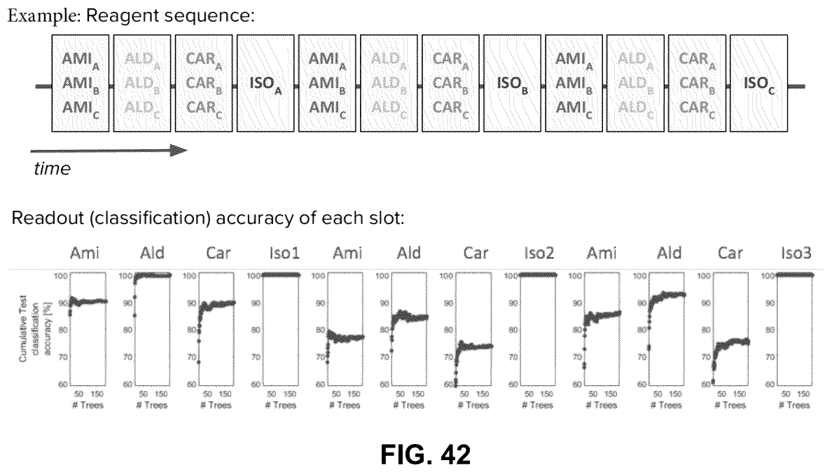

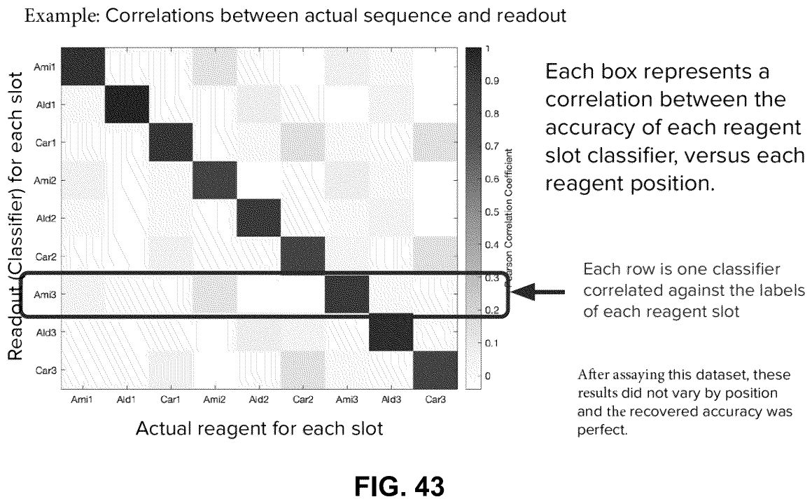

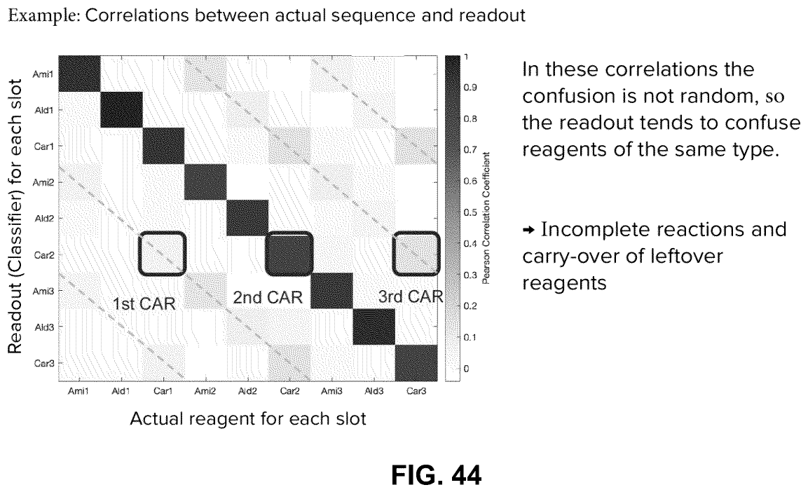

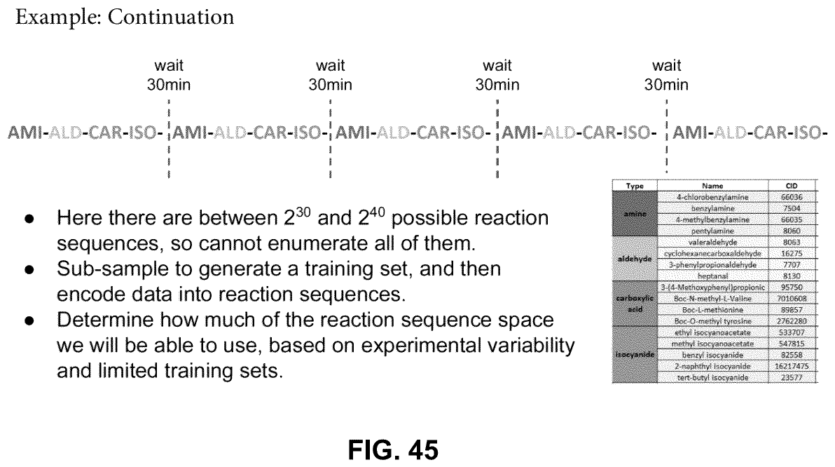

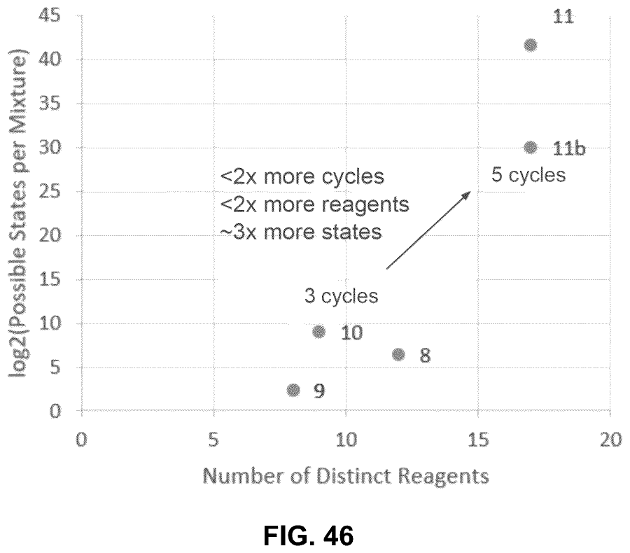

Using the burned out region, one can estimate the amount of matrix material ionized per spectral recording. From the Anubis data plate (see FIG. 35), the height of a dried spot was coarsely measured, using in-plane microscope imaging, to be about 10 μm. Assuming the spots here are roughly the same height and that most of this was irradiated during the burn tests, then volume of the burned out region is 0.00239 mm3. Since this volume was lost over the course of 100 reads, each measurement uses 23,900 μm3 of the sample, which amounts to 0.24% of the total spot volume. Based on this ablation rate, the amount of Ugi product and matrix ionized per read is about 10 fmol (6 pg) and 13 pmol (2 ng), respectively. This approach could readily scale down to spatial dimensions of tens of microns without a loss in spectrum quality.

Parametric sweeps. There are numerous experimental parameters that can be adjusted in these MALDI mass spectrometry measurements, such as acquisition duration and mass range, laser settings (power, diameter, frequency, shot count), scan settings (walk type, width, grid increment), and spot composition (sample and matrix concentrations, masses, spot size). Some of the tests were done to select key parameters are shown here. Fortunately, the Ugi products in our library tend to respond similarly, and most of these parameters can be kept constant once a satisfactory configuration is found. However, to account for run-to-run and plate-to-plate variability, and to ensure high signal-to-noise ratios, a few parameters, such as laser shot count and power, are often manually tuned before measuring an entire plate, by selecting a single spot on the plate and tuning its total ion current (TIC) to the 108-109 range. If the TIC is made much higher than this, spectra begin to degrade due to increased ion-ion interactions.

Data mixture preparation. The chemical data mixtures were prepared on a 76×120 mm² stainless steel MALDI plate. An acoustic liquid handler (Labcyte Echo 550) was used to transfer the compounds from the library well-plate onto the MALDI plate. The nominal droplet transfer volume is 2.5 nL, but to reduce variability, one can use two droplets (5 nL) per compound. The destinations of the droplets are programmed to match a standard 2.25 mm pitch 1536-spot (32×48) target.

After spotting the compounds to the MALDI plate, a MALDI matrix material was added to each location. The inventors selected 9-aminoacridine for its compatibility with metabolite libraries, its low background in the small molecule regime, and its support for both positive and negative ion modes. The MALDI plate is left to dry and crystallize overnight (˜10 hours). After being dried, the plate can be stored in a humidity controlled cabinet or analyzed by MALDI-FT-ICR mass spectrometry.

Mass analysis of data plates. A Fourier-transform ion cyclotron resonance (FT-ICR) mass spectrometer (SolariX 7T, Bruker) was used to analyze the crystallized metabolite data mixtures. The exact resolution is a function of the measurement time allocated per spectrum. For these assays, one can use 0.5⁻¹ sec, for a resolution of <0.001 Da. The instrument is run in MALDI mode and is configured to serially measure the mass spectrum of each mixture on the 48×32 grid. Acquisition for a full plate takes less than two hours.

To read the encoded data from the mass spectra, one models the probability of a metabolite being present as a combination of multiple predictor masses. A multinomial logistic regression considers the natural exponent of an offset plus the sum of all identifying mass signal-to-noise ratios (SNRs), where each signal-to-noise ratio is multiplied by a trained weight coefficient. A limited-memory Broyden-Fletcher-Goldfarb-Shanno (BFGS) algorithm was used to predict the logistic accuracy scores given an input of the n best peaks per metabolite. The inventors iterated this process for all metabolome constituents.

Encoding data in chemical mixtures. To carry out computation in the chemical mixture domain, one first creates a representation for the data. Because chemically expressed data is stored in microwell plates, one maps each well position to one bit in the input data. The value of the data at a given position is represented by a high concentration (‘1’) or low concentration (‘0’) of a designated chemical. This strategy can be extended to multi-bit concentration coding schemes, with the trade-off of reduced noise margin. To enable parallel data storage and processing, one uses the diversity of chemical compounds and overlay (concurrently encode) features from multiple input datasets in the same set of microplate wells. One can take many binary images and realize all pixels with the same position in a single well, by assigning a unique chemical species to each image. FIG. 6 shows this multiple input storage format for M binary image inputs. To construct data in this parallel format, one obtains a set of compatible chemical compounds. The following criteria should be met by all species in a chemical set for the proposed data storage scheme: (1) The chemicals should be miscible in the chosen solvent. (2) The chemicals should be stable, relatively inert, and should not react with one another. (3) The chemicals should be compatible with analytical chemistry tools that can quantify their concentrations.

Method for chemical computing. A high-level summary of the proposed computation scheme is shown in FIG. 5, which shows the encoding the ones and zeros of a binary dataset into a pattern of chemicals in an array of isolated fluid volumes. After translating the data to chemical form, one queries the chemical dataset by performing the volumetric multiply accumulate (MAC) operations needed to implement a single layer perceptron. The chemical output of the MAC stage is analyzed to measure the concentrations of its information-carrying compounds. Finally, one thresholds the concentrations of each compound in the output pools to produce the perceptron's Boolean labels.

Liquid-phase robotic synthesis. Robotics enables scaling with minimal labor by performing multicomponent reactions in wells and using robotics to form desired mixtures, e.g., Labcyte Echo Liquid Handling System with a 384-well plate.

Software, modeling tools, and comparisons. Molecular systems with many components have undesired or unintended cross-reactivity among the reactants, which introduces noise into the results. One can perform comprehensive simulations and assays to identify feasible cascades of basic reactions, accounting for cross-reactivity. The inventors develop “Molecular Simulation Link”—or “MolLink”—a software tool that compiles the different computational reactions into building blocks that can be combined to build robust larger computations. The tool automates the selection of appropriate reactions for target functions and algorithms; optimize the reagents to minimize cross-reactions; and minimize the number of steps required to achieve the target results. It also performs simulation and validation and provide visualization functions.

Computer-aided design (CAD) software can optimize synthesis, select optimal chemical encodings of datasets, and automate statistical data recovery from multi-dimensional datasets.

Data and metadata standards. Molecular data can be maintained in standard formats including those specified in METLIN Gen2. This data can be managed as Unix files and in SQL databases. The contextual details needed to make the data meaningful are visualizations and graphs. Graphs can be made using the “Matplotlib” python package. 3D visualizations of molecular interactions can be created using the package “3dMol.js.” When graphs are presented on the website, links can be provided for the raw plotting commands, as wells as for downloading the underlying data.

In some embodiments, the technology disclosed herein relate to an information storage system, including a solid surface with plurality of addressable locations, wherein each addressable location includes a mixture of molecules; wherein the mixture of molecules include chemical waste or byproducts thereof; and wherein each mixture of molecules contains one set of molecules per addressable location.

In some aspects, the techniques described herein relate to an information storage system, wherein mixture of molecules include PFAS substances.

In some aspects, the techniques described herein relate to a method for computing with chemicals, the method including the steps of: (a) encoding an abstract digital data into a plurality of liquid volumes of a plurality of chemicals to obtain a dataset, wherein the plurality of chemicals include chemical waste or byproducts thereof; (b) translating the dataset into a chemical form; (c) creating the data set using spectrometry, spectroscopy, or a combination of both assay methods; (d) querying the dataset by performing a volumetric operation to obtain a perceptron; and (e) analyzing the perceptron for identifying chemical structure, concentration, or another characteristic of at least one of the chemicals, thereby developing a chemical computational language.

In some aspects, the techniques described herein relate to a method, wherein plurality of chemicals include PFAS substances.

In some aspects, the techniques described herein relate to a method, wherein translating further includes assembling a library of chemicals in the dataset.

In some aspects, the techniques described herein relate to a method, wherein spectrometry includes mass spectrometry.

In some aspects, the techniques described herein relate to a method, wherein spectroscopy includes at least one of ultraviolet-visible spectroscopy, Rydberg spectroscopy, Infrared spectroscopy, fluorescence spectroscopy, and absorption spectroscopy.

In some aspects, the techniques described herein relate to a method for computing with chemicals, the method including the steps of: (a) encoding digital data into a plurality of chemicals to obtain a dataset, wherein the plurality of chemicals include chemical waste or byproducts thereof; (b) translating the dataset into a chemical form; (c) reading the data set using spectrometry and/or spectroscopy and querying the dataset by performing an operation to obtain a perceptron; and (d) analyzing the perceptron for identifying chemical structure, concentration, or another characteristic of at least one of the chemicals, thereby developing a chemical computational language.

In some aspects, the techniques described herein relate to a method, wherein plurality of chemicals include PFAS substances.

In some aspects, the techniques described herein relate to a method, wherein spectrometry includes mass spectrometry.

In some aspects, the techniques described herein relate to a method, wherein spectroscopy includes at least one of: ultraviolet-visible spectroscopy, Rydberg spectroscopy, Infrared spectroscopy, fluorescence spectroscopy, and absorption spectroscopy.

In some aspects, the techniques described herein relate to a method of storing information in a plurality of chemical elements, including the steps of: (a) converting a format of information into a plurality of digital sequences; (b) converting the plurality of digital sequences into a plurality of corresponding chemical elements using one bit per metabolomic element, wherein the chemical elements include chemical waste or byproducts thereof; and (c) storing the plurality of corresponding metabolomic elements on a solid surface, where the location of a metabolomic element is an addressable location.

In some aspects, the techniques described herein relate to a method, wherein plurality of chemicals include PFAS substances.

Molecular Data Storage Using Molecular Libraries Made from Chemical Waste

The technology herein also provides the uses of chemical waste and byproducts in a chemical library to store digital information. The technology can even be implemented if the chemicals are unknown from the outset.

In some embodiments, the invention provides molecular data storage using low-cost or cost-free molecular libraries redirected from chemical waste streams. The choice of compounds and use of compounds for use for this molecular data storage do not require synthesis, purification, or prior knowledge of the molecular identities of the chemical library. The chemical libraries can be implemented using low-cost or zero-cost raw materials.

The invention advantageously provides a denser, more sustainable, and more durable alternative to conventional data storage technology. The invention offers a lower cost, more sustainable, and more durable approach than other molecular data storage demonstrated, i.e., DNA, Ugi, metabolites, synthetic polymers, etc. Using these waste chemicals, information can be written and read using the same methods as described, e.g., in U.S. Pat. Publ. 2022/0012646.

In some embodiments, while the technique is agnostic about the exact molecular contents of its inputs, the invention provides, and the inventors confirmed by chemical analysis, that some sources can contain per-fluoroalkyl and poly-fluoroalkyl substances (PFAS). These PFAS substances are nicknamed “forever chemicals” because they are highly stable in the natural environment. Some of the waste samples used in this demonstration consisted of PFAS chemicals which have been shown to be durable for decades or hundreds of years, providing a path for these contaminants to be sourced from contaminated environmental sites and reused as a data storage medium. Redirecting such waste streams for molecular data storage could offer extremely durable information storage and environmental benefits. The cost advantage of this approach is compelling because DNA and other molecular libraries are orders of magnitude too expensive. This invention also contributes to circular economics due to the reuse of chemical and biological waste that would otherwise be destined to the environment.

The inventors demonstrated that molecular data storage can be achieved using inputs that do not require pre-processing, including synthesis and purification, or prior knowledge of molecular identity. Using unpurified waste chemicals, the inventors encoded a 3,249-pixel digital image payload, plus redundancy for error correction (9,751 raw bits including coding redundancy). Complete recovery of the data succeeded despite not knowing the identity or concentration of compounds within each sample. With a training overhead of 8.41% (128 out of 1521 spots), the inventors trained random forest models that achieved a raw error rate of 1.78%, which was well within the error correction capabilities of the Turbo code. Previous molecular data storage demonstrations have used Reed-Solomon and fountain code. Blawat et al., Procedia Comput. Sci. 80, 1011-1022 (2016); Grass et al., Angew. Chem. Int. Ed., 54, 2552-2555 (2015); Erlich & Zielinski, Science, 355, 950-954 (2017). Here the inventors used Turbo codes for their ability to tolerate potentially higher error rates from complex, unknown library mixtures.

The seven library elements were then analyzed using a non-targeted mass spectrometry analysis The complexity of the inputs varied significantly, with each waste sample containing between thirteen and 109 identified compounds. The invention's ability to tolerate a wide range of complex unknown mixtures thus provides possibilities for encoding data using many different environmental and industrial inputs as library sources.

Two library samples contained several compounds belonging to the PFAS family. Compared to DNA, certain PFAS are more stable under ambient conditions. Due to the inherent susceptibility of its chemical nature to many environmental factors including temperature, humidity, and pH, DNA degradation can occur through several mechanisms. Matange, Tuck, & Keung, Nature Commun. 12, 1358 (2021); Chatterjee & Walker, Environ. Mol. Mutagen., 58, 235-263 (2017). The rate of DNA degradation through these mechanisms is substantially increased with an increase in temperature or a change in pH. Bonnet et al., Nucleic Acids Res. 38, 1531-1546 (2010). Many PFAS are stable up to 200-600° C. Some PFAS also require high pH values for significant degradation. Xiao et al., Environ. Sci. Technol. Lett., 7, 343-350 (2020). The presence of PFAS in these samples suggests that these datasets could be created from library sources which are extremely stable and may retain their form for much longer than DNA. There could be value created by removing these contaminants from the environment and using them for long-term molecular data storage.

Data can be encoded in unknown molecular mixtures of varying complexity and recovered using chemical analysis. This contrasts with demonstrated molecular data storage systems that are DNA, synthetic-polymer, or small molecule-based. Synthesis has been a significant obstacle to realizing the commercial potential of DNA data storage because it is largely inefficient and produces hazardous waste from excess reagent use. Phosphoramidite chemistry commonly uses at least 20-molar excess of reagents to achieve a 99.5% coupling efficiency. And even at this high efficiency, the synthesis of a 200-mer full-length product yields 36.9% before purification. ATDBio, Solid-phase oligonucleotide synthesis. To obtain a pure product, common recoveries of a 200-mer full-length product are in low single-digit product yields.

The advances in the synthesis of DNA through microarrays lowered the excessive material use. However, DNA data storage still costs $0.001 per bit. Dong et al., Natl. Sci. Rev., 7, 1092-1107 (2020). This cost compares to $0.000000000001 per bit for modern electronic storage. The inventors demonstrated data storage with zero-cost raw materials.

Some waste streams may be inappropriate for this approach, if they are too dilute, or too complex, or too similar to one another. Despite these potential limitations, the ability to store data in waste samples without the need for processing, synthesis, prior knowledge of identity, or high material costs could make this a promising and sustainable process to realize molecular data storage. This could provide a path for the data storage industry, which has long been recognized for its unsustainable practices, to contribute positively to a circular economy while also providing the high data density and durability that molecular data storage can offer.

In some aspects, the techniques described herein relate to an information storage system, including: a storage surface with a plurality of addressable storage locations, wherein each addressable storage location includes a previously unknown molecule mixture of chemical waste or byproducts thereof, and wherein the molecule mixture, wherein each addressable storage location contains a set of molecules from the molecule mixture.

In some aspects, the techniques described herein relate to an information storage system, wherein the molecule mixture further includes fluorinated molecules including at least one of polyfluoroalkyl substances, highly stable fluorinated hydrocarbon compounds, per-fluoroalkyl substances, or persistent environmental contaminants, and/or includes chemical contaminants, contaminant derivatives, perfluoro-1-octanesulfonic acid (PFOS), perfluoro-1-butanesulfonic acid (PFBS), perfluoro-1-hexanesulfonic acid (PFHxS), perfluoro nonanoic acid (PFNA), perfluorooctanoic acid (PFOA), perfluoroheptanoic acid (PFHpA), perfluorohexanoic acid (PFHxA), perfluoropentanoic acid (PFPeA), perfluorobutanoic acid (PFBA), 8:2 fluorotelomer alcohol (8:2 FTOH), 6:2 fluorotelomer alcohol (6:2 FTOH), 4:2 fluorotelomer alcohol (4:2 FTOH), or fluorotelomer-based acrylate or methacrylate esters.

In some aspects, the techniques described herein relate to an information storage system, wherein the fluorinated molecules include at least one of polyfluoroalkyl substances or highly stable fluorinated hydrocarbon compounds, wherein the polyfluoroalkyl substances are synthetic organofluorine chemical compounds containing at least one fluorinated carbon atom, and wherein the highly stable fluorinated hydrocarbon compounds have strong carbon-fluorine bonds.

In some aspects, the techniques described herein relate to an information storage system, wherein the polyfluoroalkyl substances include at least one of per-fluoroalkyl substances or poly-fluoroalkyl substances, wherein the per-fluoroalkyl substances are synthetic organofluorine chemical compounds in which all hydrogen atoms attached to carbon atoms are replaced by fluorine atoms, and wherein the poly-fluoroalkyl substances are synthetic organofluorine chemical compounds in which some, but not all, of the hydrogen atoms attached to carbon atoms are replaced by fluorine atoms.

In some aspects, the techniques described herein relate to an information storage system, wherein the fluorinated molecules include persistent environmental contaminants, wherein the persistent environmental contaminants are resistant to environmental degradation through chemical, biological, and photolytic processes, have a potential for long-range transport, bioaccumulate in human and animal tissue, biomagnify in food chains, and have potentially significant impacts on human health and the environment.

In some aspects, the techniques described herein relate to an information storage system, wherein the fluorinated molecules include at least one of perfluoro-1-octanesulfonic acid (PFOS), perfluoro-1-butanesulfonic acid (PFBS), perfluoro-1-hexanesulfonic acid (PFHxS), perfluoro nonanoic acid (PFNA), perfluorooctanoic acid (PFOA), perfluoroheptanoic acid (PFHpA), perfluorohexanoic acid (PFHxA), perfluoropentanoic acid (PFPeA), or perfluorobutanoic acid (PFBA), wherein PFOS, PFBS, PFHxS, PFNA, PFOA, PFHpA, PFHxA, PFPeA, and PFBA are synthetic organofluorine chemical compounds and persistent organic pollutants that are found in the environment, wildlife, and humans.

In some aspects, the techniques described herein relate to an information storage system, wherein each addressable storage location is operable to be prompted by mass spectrometry, ultraviolet-visible spectroscopy, Rydberg spectroscopy, electromagnetic radiation spectroscopy, Infrared spectroscopy, fluorescence spectroscopy, or absorption spectroscopy.

In some aspects, the techniques described herein relate to a method of storing information, including: providing a storage surface with a plurality of addressable storage locations; and forming a molecule mixture at each addressable storage location, wherein the molecule mixture includes a previously unknown molecule mixture of chemical waste or byproducts thereof, and wherein forming the molecule mixture includes containing a set of molecules at each addressable storage location.

In some aspects, the techniques described herein relate to a method, wherein forming the molecule mixture further includes including chemical waste or byproducts thereof and fluorinated molecules including at least one of polyfluoroalkyl substances, highly stable fluorinated hydrocarbon compounds, per-fluoroalkyl substances, or persistent environmental contaminants and/or including chemical contaminants or contaminant derivatives in the molecule mixture.

In some aspects, the techniques described herein relate to a method, wherein the fluorinated molecules include at least one of polyfluoroalkyl substances or highly stable fluorinated hydrocarbon compounds.

In some aspects, the techniques described herein relate to a method, wherein the polyfluoroalkyl substances include at least one of per-fluoroalkyl substances or poly-fluoroalkyl substances.

In some aspects, the techniques described herein relate to a method, wherein the fluorinated molecules include persistent environmental contaminants.

In some aspects, the techniques described herein relate to a method, wherein the fluorinated molecules include at least one of perfluoro-1-octanesulfonic acid (PFOS), perfluoro-1-butanesulfonic acid (PFBS), perfluoro-1-hexanesulfonic acid (PFHxS), perfluoro nonanoic acid (PFNA), perfluorooctanoic acid (PFOA), perfluoroheptanoic acid (PFHpA), perfluorohexanoic acid (PFHxA), perfluoropentanoic acid (PFPeA), or perfluorobutanoic acid (PFBA).

In some aspects, the techniques described herein relate to a storage medium, including: a storage surface with a plurality of addressable storage locations; and a molecule mixture formed at each addressable storage location, wherein the molecule mixture includes a previously unknown molecule mixture of chemical waste or byproducts thereof, and wherein each addressable storage location contains a set of molecules from the molecule mixture.

In some aspects, the techniques described herein relate to a storage medium, wherein the molecule mixture further includes chemical waste or byproducts thereof and fluorinated molecules including at least one of polyfluoroalkyl substances, highly stable fluorinated hydrocarbon compounds, per-fluoroalkyl substances, and/or persistent environmental contaminants, chemical contaminants or contaminant derivatives.

In some aspects, the techniques described herein relate to a storage medium, wherein the fluorinated molecules include at least one of polyfluoroalkyl substances or highly stable fluorinated hydrocarbon compounds.

In some aspects, the techniques described herein relate to a storage medium, wherein the polyfluoroalkyl substances include at least one of per-fluoroalkyl substances or poly-fluoroalkyl substances.

In some aspects, the techniques described herein relate to a storage medium, wherein the fluorinated molecules include at least one of persistent environmental contaminants, perfluoro-1-octanesulfonic acid (PFOS), perfluoro-1-butanesulfonic acid (PFBS), perfluoro-1-hexanesulfonic acid (PFHxS), perfluoro nonanoic acid (PFNA), perfluorooctanoic acid (PFOA), perfluoroheptanoic acid (PFHpA), perfluorohexanoic acid (PFHxA), perfluoropentanoic acid (PFPeA), or perfluorobutanoic acid (PFBA).

In some aspects, the techniques described herein relate to a storage medium, wherein the storage medium is capable of providing a method of storing information in a plurality of molecular mixtures, the method including the steps of: (a) converting a format of information into a plurality of digital sequences; (b) converting the plurality of digital sequences into a plurality of corresponding molecular mixtures using one bit per mixture, wherein the molecular mixtures include chemical waste or byproducts thereof; and (c) storing the plurality of corresponding molecular mixtures on a solid surface, where the location of each molecular mixture is an addressable location on the storage medium.

In some aspects, the techniques described herein relate to a storage medium, wherein the format of information is selected from the group consisting of text, image, video, and audio.

### Supplemental Advantages, Definitions and Description of Industrial Applicability

Molecular data storage offers the intriguing possibility of higher theoretical density and longer lifetimes than today's electronic memory devices.

Much recent research on molecular data storage focuses on DNA as a storage media. But bottlenecks in nucleic acid synthesis continue to make DNA data storage orders of magnitude more expensive than electronic storage media. And despite its potential for long-term storage, DNA faces durability challenges from environmental degradation.

### Durability Comparison of DNA and PFAS.

Advantage of using PFAS as a data medium compared to DNA. Compared to DNA, certain PFAS are more stable under ambient conditions. Due to the inherent susceptibility of its chemical nature, DNA degradation can occur through several mechanisms. Hydrolysis is one common mechanism of information loss in digitally-encoded DNA. Hydrolysis can lead to deamination reactions, in which cytosine is converted to uracil and depurination, in which glycosidic bond cleavage can further lead to strand breaks. The rate of DNA degradation through these mechanisms is substantially increased with an increase in temperature or a change in pH. Theoretical rates of these mechanisms are meager at ambient temperatures and pH. Bonnet et al., Nucleic Acids Res. 38, 1531-1546 (2010); An et al. PLoS One, 9, e115950 (2014). Many DNA data storage processes that require temperatures that exceed 37° C. and often even 70° C. because polymerases operate optimally at these elevated temperatures. Changes in pH also impact the integrity of DNA. The degradation rate of DNA can increase by an order of magnitude due to a change from pH 6 to pH 5 and by over three orders of magnitude at 70° C. Bonnet et al., Nucleic Acids Res. 38, 1531-1546 (2010). Many PFAS are stable up to 200-600° C., depending on the chain length and functional group, because of the strength of carbon-fluorine bonds. Xiao et al., Environ. Sci. Technol. Lett., 7, 343-350 (2020).

Perfluoro-1-octanesulfonic acid (PFOS) was detected in one of the library elements in this analysis. PFOS is one of the most environmentally ubiquitous PFAS, is stable up to 450° C. Xiao et al., Environ. Sci. Technol. Lett., 7, 343-350 (2020). Certain PFAS also requires high pH values for significant degradation. Gar Alalm & Boffito, Chem. Eng. J. 450, 138352 (2022). Current methods of degrading PFAS are all reliant upon harsh physical and chemical conditions. Most require the use of catalysts. This high durability under ambient conditions makes environmentally-sourced PFAS a candidate for archival molecular data storage.

### Definitions

For convenience, the meaning of some terms and phrases used in the specification, examples, and appended claims, are listed below. Unless stated otherwise or implicit from context, these terms and phrases shall have the meanings below. These definitions aid in describing particular embodiments but are not intended to limit the claimed invention. Unless otherwise defined, the technical and scientific terms have the same meaning as commonly understood by persons having ordinary skill in the computational art. A term's meaning provided in this specification shall prevail if any apparent discrepancy arises between the meaning of a definition provided in this specification and the term's use in the computational art.

Abstract digital data or digital data is represented using the binary number system of ones (1) and zeros (0) instead of analog representation. Abstract digital data can correspond to real objects.

Address has the computational art-recognized meaning. An address is a location for data. Each location has an address (a unique number) assigned to it. Persons having ordinary skill in the computing art can access particular data by specifying a memory address. An addressable location can be on a solid surface containing a mixture of molecules, e.g., small molecules.

Addressable locations have the computational art-recognized meaning. An addressable location is a location whose position in a storage medium is precisely defined and can be accessed.

Array spectrum has the computational art-recognized meaning. An array spectrum is an array of entities ordered in accordance with the magnitudes of a common physical property.

Binary code has the computational art-recognized meaning. Binary code represents text, computer processor instructions, or any other data using a two-symbol system. The two-symbol system is often “0” and “1” from the binary number system. The binary code assigns a pattern of binary digits, also known as bits, to each character, instruction, etc. In computing and telecommunications, binary codes encode data, such as character strings, into bit strings. Those methods may use fixed-width or variable-width strings. In a fixed-width binary code, each letter, digit, or other character is represented by a bit string of the same length; that bit string, interpreted as a binary number, is usually displayed in code tables in octal, decimal, or hexadecimal notation. There are many character sets and many character encodings for them.

Binary computer language is a computer language written in binary code. The computer language can be selected from the group consisting of programming language, command language, general-purpose language, machine language, markup language, style sheet language, configuration language, construction language, query language, modeling language, and simulation language.

Binary data has the computational art-recognized meaning. Binary data is data whose unit can take on only two possible states, traditionally labeled as 0 and 1, in accordance with the binary numeral system and Boolean algebra. Binary data occurs in many technical and scientific fields. It can be called by different names: bit (binary digit) in computer science, truth value in mathematical logic and related domains, and binary variable in statistics.

Chemical perceptron is the implementation of a perceptron in an artificial (simulated) chemistry. A perceptron is a machine learning algorithm that helps provide classified outcomes for computing. A perceptron is the simplest system capable of learning (inspired by the functioning of a biological neuron). See Banda et al., Online Learning in a Chemical Perceptron. Artificial Life, 19(2), 195-219, (Spring 2013); Banda et al., Journal of the Royal Society Interface, 11(93) (April 2014). A perceptron algorithm is a supervised classification because the human classification of data points aids the computer. See Arcadia et al., Proceedings of the IEEE Conference on Rebooting Computing (ICRC) (2018) [EXAMPLE 2] and Rose et al., 2018 IEEE International Symposium on Information Theory (ISIT) (Vail, CO, June 2018), pp. 2236-2240.

Chemical scaffold has the chemical art-recognized meaning. A chemical scaffold is a molecular core to which functional groups are attached.

Dataset is, when working with machine learning methods, a collection of instances.

Ground truth has the computational art-recognized definition. In machine learning, the term refers to the accuracy of the training set's classification for supervised learning techniques. This term is used in statistical models to prove or disprove. Ground truthing refers to gathering the proper objective (provable) data for this test. A synthetic metabolome has ground truth. A metabolome from a living organism may obtain ground truth because of the progress of science and the useful arts.

Image processing is crucial to many applications such as classification, feature extraction, multi-scale signal analysis, pattern recognition, etc. Image processing is computationally intensive, involving many multiply-accumulate operations—for which chemical computation shows better scaling.

In-memory computing, also known as In-memory computation, has the computational art-recognized meaning of the technique of running computer calculations entirely in computer memory, e.g., in RAM.

In-situ processing, also known as in-storage processing (ISP), has the computational art-recognized meaning of processing data where it resides.

Linear classification identifies which class (or group) it belongs based on an object's features. The classification decision is based on the value of a linear combination of the features.

Logistic regression analyses are computational art-recognized algorithms to solve a classification problem, where the algorithm involves a linear discriminant separating the classes. A classification problem occurs when independent variables are continuous and a dependent variable is in categorical form, i.e., in positive and negative classes. To check the performance of logistic regression analyses, those skilled in the computing art can use a confusion matrix (see FIGS. 22A-22B) or an Area Under the Curve-Receiver Operating Characteristics (AUC-ROC) Curve. See EXAMPLE 4, FIG. 14, and FIG. 17.

MALDI mass spectroscopy is described in U.S. Pat. No. 7,084,396 (Schneider). Mass spectrometry (MS) consists of three components: ion sources, mass analyzers, and ion detectors. The three components are interrelated. Some ion sources may be better suited to a particular mass analyzer or analyte type. Some ion detectors are better suited to specific mass analyzers. Electrospray (ESI) and matrix-assisted laser-induced desorption (MALDI) ionization sources are widely used for organic molecules, particularly biomolecules, and are generally preferred for ionizing non-volatile organic species. ESI is widely practiced because it can be readily coupled with liquid chromatography and capillary electrophoresis for added discrimination capability. MALDI techniques are widely practiced on large molecules, e.g., proteins, that can be difficult to solubilize and volatize in ESI. The principal advantage of MALDI is the small number of charge states that arise from molecules with a multiplicity of ionizable groups. Using MALDI mass spectrometry means that the technique depends on the ionization efficiency of the compounds in the library sources, in addition to their diversity and abundance.

Mass spectrometry (MS) is an analytical technique that ionizes chemical species and sorts the ions based on their mass-to-charge ratio. A mass spectrum measures the masses within a sample. Mass spectrometry is useful for broad and high-throughput metabolic screening. Zampieri et al., Current Opinion in Chem. Bio. 36, 15-23 (2017). Advances in statistical tools and databases support mass spectrometry. Brown et al., Analyst. 134(7), 1322-32 (2009); Wishart et al., Nucleic Acids Res. 4(46), 608{617 (2018).

Microwell plate is a flat plate with multiple “wells” used as small test tubes. A microplate is a standard tool in analytical research and clinical diagnostic testing laboratories. Robots have been developed specifically to handle microplates for high-throughput assays. Ultra-low attachment (ULA) plates that support 3D cell culture are commercially available, e.g., from ThermoFisher Scientific, Waltham, MA, USA.

Molecular computing has the computational art-recognized meaning of computing that uses DNA, biochemistry, and molecular biology hardware, instead of traditional silicon-based computer technologies.

Molecular memory has the computational art-recognized meaning of data storage technologies that use molecular species as the data storage element, rather than, e.g., circuits, magnetics, inorganic materials, or physical shapes. In a perfect molecular memory device, each individual molecule contains a bit of data, leading to massive data capacity.

Multiply accumulate (MAC) operation is a common step in computing, especially digital signal processing, that computes the product of two numbers and adds that product to an accumulator.

Nanoscale refers to having dimensions measured in nanometers (10⁻⁹ meters). Nanomolar (nM) is 10⁻⁹ mol/L (10⁻⁶ mol/m³). Nanoliter is 10⁻⁹ L.

One-hit has the computational art-recognized definition. A one-hit has a single positive bit in a digital sequence. A one-hit is useful for further molecular computing.

Parallel computing is a type of computation in which many calculations or the execution of processes are carried out simultaneously. Large problems can often be divided into smaller ones, which can be solved simultaneously.

Perceptron is a flexible and universal pattern classification structure and a key element of neural network systems that handle large data sets. See, Courbariaux et al., arXiv:1602.02830 (Mar. 17, 2016). Mathematically, a perceptron is a dot product between a real input vector x and a real weight vector w, both of dimension J, followed by a nonlinearity ø(w·x) where ø(·) is a sigmoidal, non-decreasing thresholding function with a rapid transition between two discrete levels. A perceptron is a binary classifier that separates inputs into two groups. Also, for the purposes of this invention, a perceptron can be a simple linear classifier that can be trained to determine whether an input belongs to a particular class. Rosenblatt, Psychological Review, 65(6), 386 (1958); Minsky et al., Perceptrons: An Introduction to Computational Geometry (MIT Press, 2017); Bishop, Pattern Recognition and Machine Learning (Springer, 2006). A perceptron uses a set of constant coefficients to compute a weighted sum of input features and thresholds the result to produce a Boolean label. A ‘perceptron’ is a general-purpose binary classifier that can operate on any linearly separable input data. A perceptron is the simplest artificial neural network, but one can prove that multiple connected perceptrons can compute any function.

PFAS has the chemical art-recognized meaning highly stable fluorinated hydrocarbon compounds (per-fluoroalkyl and poly-fluoroalkyl substances) that are persistent environmental contaminants. PFAS were dubbed “forever chemicals” owing to their long half-lives of up to 1000 years in ambient conditions. Russell, Berti, Szostek, & Buck, Environ. Sci. Technol., 42, 800-807 (2008); Washington et al., Environ. Sci. Technol., 43, 6617-6623 (2009). Perfluoro-1-octanesulfonic acid (PFOS), perfluoro-1-butanesulfonic acid (PFBS), perfluoro-1-hexanesulfonic acid (PFHxS), and perfluorononanoic acid (PFNA) are highly stable fluorinated hydrocarbon compounds that are persistent environmental contaminants. PFOS is one of the most widely studied chemicals in the PFAS group. Despite its industrial phase-out in the early 2000s, it is ubiquitously found in the environment and in humans.

Pixel map is a video display technique applicable to devices with native fixed pixels, such as LCD monitors and plasma displays. A monitor set to 1:1 pixel mapping displays an input source without scaling it, such that each pixel received is mapped to a single native pixel on the monitor.

Reaction groups or functional groups have the chemical art-recognized meaning. Reaction groups are specific substituents or moieties within molecules responsible for characteristic chemical reactions of those molecules. The same functional group undergoes the same or similar chemical reaction despite the size of the molecule of which it is a part.

Small molecule has the biological art-recognized definition. The NCI Dictionary of Cancer Terms defines a small molecule as a substance that can enter cells easily because it has a low molecular weight. Inside the cells, it can affect other molecules, such as proteins. This characteristic differs from drugs with a large molecular weight, such as monoclonal antibodies, which cannot enter cells easily.

Spectrometry is an instrumental method for identifying the chemical constitution of a substance with the separation of gaseous ions according to their differing mass and charge.

Spectroscopy is the branch of science concerned with investigating and measuring spectra produced when matter interacts with or emits electromagnetic radiation. The term spectroscopy includes ultraviolet-visible, Rydberg, Infrared, fluorescence, and absorption spectroscopy.

Ugi reaction is a multicomponent reaction in organic chemistry involving a ketone or aldehyde, an amine, an isocyanide, and a carboxylic acid to form a bis-amide. See Ugi et al., Multicomponent reactions in organic chemistry. Endeavour, 18(3), 115 122 (1994). The Ugi reaction is exothermic and usually complete within minutes of adding the isocyanide.

Zettabyte is 10²¹ bytes. See Cisco, The Zettabyte Era: Trends and Analysis (2016).

Unless otherwise defined, scientific and technical terms used with this application shall have the meanings commonly understood by persons having ordinary skill in the computational art. This invention is not limited to the method, protocols, reagents, etc., described herein and can vary.

This specification does not concern a process for cloning humans, methods for modifying the germ line genetic identity of humans, uses of human embryos for industrial or commercial purposes, or procedures for modifying the genetic identity of animals likely to cause them suffering with no substantial medical benefit to humans or animals resulting from such processes.

Guidance from Materials and Methods

Persons having ordinary skill in the computational art can use these materials and methods as guidance to predictable results when making and using the invention:

Methods to encode and recover data were described in U.S. Pat. Publ. 2022/0012646. Using these waste chemicals, information can be written and read using the same methods as described in U.S. Pat. Publ. 2022/0012646.

Chemicals and reagents. Ammonium acetate solution (5 M, LC-MS grade) was purchased from Sigma-Aldrich (St. Louis, MO, USA). Ultrapure water (UHPLC-MS grade) and acetonitrile (UHPLC-MS grade) were purchased from ThermoFisher Scientific (Waltham, MA, USA). Certified PFAS reference standards and internal standards were purchased from Wellington Laboratories (Overland Park, KS, USA) (Part numbers PFAC30PAR, L-PFDoS, PFAC-MXI, PFAC-MXG, and PFAC-MXJ; internal standards: MPFAC-24ES, d-N-MeFOSA-M, d-N-EtFOSA-M, d7-N-MeFOSE-M, d9-N-EtFOSE-M, and M3HFPO-DA).

Materials and reagents. Seven waste chemical mixtures were used. Five of the waste mixtures were obtained from Dr. Ming Xian's laboratory in the Chemistry Department at Brown University. Two biological waste samples were obtained from Dr. Jessica Plavicki's lab in the Pathology and Molecular Medicine Department at Brown University. All samples obtained were byproducts collected after their respective analyses concluded. All samples obtained would have otherwise been deemed waste.

The solvent dimethyl sulfoxide (DMSO, anhydrous, 99.9%, MilliporeSigma) was used to dilute all solutions in the library. Analytical grade α-cyano-4-hydroxycinnamic acid (HCCA, 99.0%, MilliporeSigma) was the matrix material for all MALDI samples.

Library preparation. Each waste mixture was filtered through a 0.2-micron nylon syringe filter before being dissolved in dimethyl sulfoxide. The waste chemicals from Dr. Xian's lab were dissolved in DMSO using a 1:2 ratio of DMSO to waste mixtures. The waste chemicals from Professor Plavicki's laboratory were dissolved in DMSO using a 3:1 ratio of DMSO to waste mixtures. Each waste mixture was finally diluted in HCCA solution (20 mg of HCCA in 1 mL DMSO) using a 1:2 ratio of HCCA solution to waste mixtures. They were placed into a 384-well plate as each row represents a distinct waste mixture.

Data plate preparation. The image of a sustainability logo (57×57 pixels), Rate 1/3 turbo code bits. The training set for the data plate was converted into a one-dimensional binary vector. Turbo code bits were double the size of the image bits. All distinct combinations of seven waste mixtures (27 combination spots represented by 896 bits) were the training data. Then this vector was encoded with a direct mapping scheme into an M×N matrix, where M represents the number of waste mixtures, and N represents the number of independent mixtures. The presence (“1”) or absence (“0”) of the m^{th} compound in the n^{th} mixture was indicated as the value of the library element in the matrix. Using the values from the matrix, multiple 2.5 nL droplets of the waste mixtures were transferred from the 384-well library plate to their appropriate locations on a metal MALDI plate using an acoustic liquid handler. Up to 210 nL of library elements was transferred in each location. After all transfers are complete, the data plate is left to dry in a fume hood overnight. The resulting dried mixture spots are typically 1 mm in diameter.

Mass spectrometry. Mass spectra were acquired with a Fourier transform ion cyclotron resonance (FT-ICR) mass spectrometer in positive ion mode. To obtain accurate peak assignment, a mass calibration is performed through Electrospray Ionization (ESI) before each run using sodium trifluoroacetate as a reference. Samples were ionized using matrix-assisted laser desorption ionization (MALDI). The sample run was automated. The typical spectra were acquired for 1.5 seconds. During the automation process, the instrument serially addresses each crystallized spot and takes about four hours to record all 1,536 spots on a plate. Each measurement is made by ionizing a portion of a sample with a laser configured to take 500 shots at 1000 Hz, over a scan area of 500-900 μm, with medium focus, and ×4 averaging.

The raw data from the run was converted into a custom HDF5 file, for ease of access through the readout algorithm.

Library analysis. Data was collected on a high-resolution Thermo QExactive HF-X Orbitrap MS equipped with a Vanquish ultra-high-performance liquid chromatograph. The inventors analyzed the samples two times, once with positive electrospray ionization (ESI, +) and once in negative ESI (ESI, −). For both ionization modes, the inventors used the same chromatography scheme. Sample components were separated on a Thermo Hypersil Gold Vanquish C18 column (100 mm×2.1 mm×1.9 μm) with two mobile phases. The mobile phase A consisted of 2 mM ammonium acetate in 5% acetonitrile. The mobile phase B consisted of 2 mM ammonium acetate in 100% acetonitrile. The total run time was fifteen minutes. Data was acquired using data-dependent (dd) MS² acquisition. Fragmentation was performed in the HCD collision cell filled with N₂ (produced by a Peak Scientific Nitrogen Generator, Genius NM32LA). All spectral data files were saved in the .RAW file format and NTA/SSA was performed in Thermo Compound Discoverer (CD) 3.3 software. For ESI,+, and ESI,− data, peaks were detected with 10 ppm mass tolerance, 1,000,000 minimum peak intensity, and signal-to-noise threshold of 1.5. Compounds were grouped with 5 ppm mass tolerance and 0.1 min retention time tolerance. Compound annotations were assigned using the following data sources in ranked order: mzCloud search, mzVault search, mass list search, predicted compositions, and ChemSpider search. The peak area for each putatively identified compound detected was exported to Microsoft Excel after processing the raw data and before data filtering.

Compounds that were identified to have a minimum of 70% spectral match, as determined by mzCloud, were summed to determine the relative complexity of each element. The inventors found that complexity varied significantly between each library element. The inventors discovered that two samples contained several compounds belonging to the PFAS family, including perfluoro-1-octanesulfonic acid (PFOS), perfluoro-1-butanesulfonic acid (PFBS), perfluoro-1-hexanesulfonic acid (PFHxS), and perfluorononanoic acid (PFNA), which are highly stable fluorinated hydrocarbon compounds that are persistent environmental contaminants. The inventors identified that three of the library elements' most abundant peaks came from an identical compound. In some elements, only two compounds were unique to that mixture.

Data plate analysis. The custom HDF5 file with spectral information from the data plate was used for data analysis. Random forest regression was configured to use 300 trees of unlimited depth and at most 20,000 spectral features to build classifiers for each library element using the labeled training data. Test data predictions from the regression model were thresholded to determine the presence or absence of the library elements. To recover the data from the direct mapping encoding scheme, the matrix was reshaped to its original form. The permutation and error correction processes were undone in the reverse order.

Analysis of library element composition. All library elements were analyzed for composition after the experiment to determine the relative complexity of each sample. The inventors discovered that the library elements that were obtained from the biological laboratory contained compounds belonging to the PFAS family that was recently highlighted by the EPA due to their long-term persistence in the environment and in drinking water. This long-term durability across biological and ambient environments could make this class of compounds long-term data storage candidates. Companies worldwide are filtering out PFAS from environmental sources to reduce their environmental abundance, but there are limited options for disposal. Because archival data is stored for decades or longer, using environmentally-sourced PFAS compounds as molecular data storage media could provide alternative value to PFAS that would keep them in circulation for the duration of their half-life.

### Repurposing Waste Chemicals for Sustainable and Durable Molecular Data Storage

Molecular data storage offers the intriguing possibility of higher theoretical density and longer lifetimes than today's electronic memory devices. Some demonstrations have used deoxyribonucleic acid (DNA), but bottlenecks in nucleic acid synthesis continue to make DNA data storage orders of magnitude more expensive than electronic storage media. Additionally, despite its potential for long-term storage, DNA faces durability challenges from environmental degradation. In this work, we demonstrate nongenomic molecular data storage using molecular libraries redirected from chemical waste streams. This approach requires no synthetic effort and can be implemented by using molecules that have a minimal associated cost. While the technique is agnostic about the exact molecular content of its inputs, we confirmed that some sources contained poly fluoroalkyl substances (PFAS), which persist for long periods in the natural environment and could offer extremely durable information storage as well as environmental benefits. These demonstrations provide a perspective on some of the valuable possibilities for nongenomic molecular information systems. In some embodiments, the technology can utilize chemical waste wherein the chemicals are not known (qualitatively) from the outset.

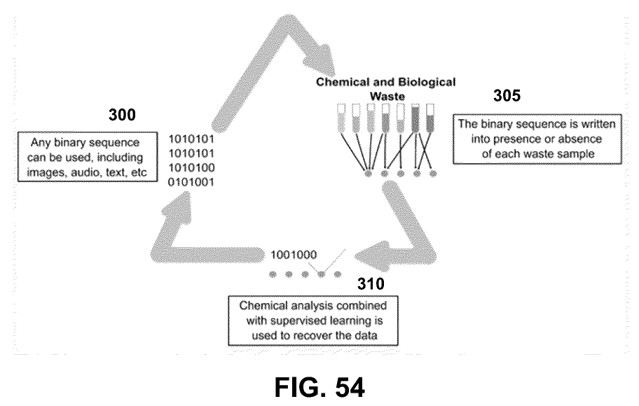

FIG. 54 shows an example method of computer using unknown chemical compounds or waste. At step 300 any binary sequence is obtained and is encoded into (unknown) chemical and/or biological waste wherein the binary sequence is written (step 305) into presence or absence of each waste sample. Then at step 310 a chemical analysis combined with supervised learning (machine learning or AI) is used to recover the data from the writing in step 305.

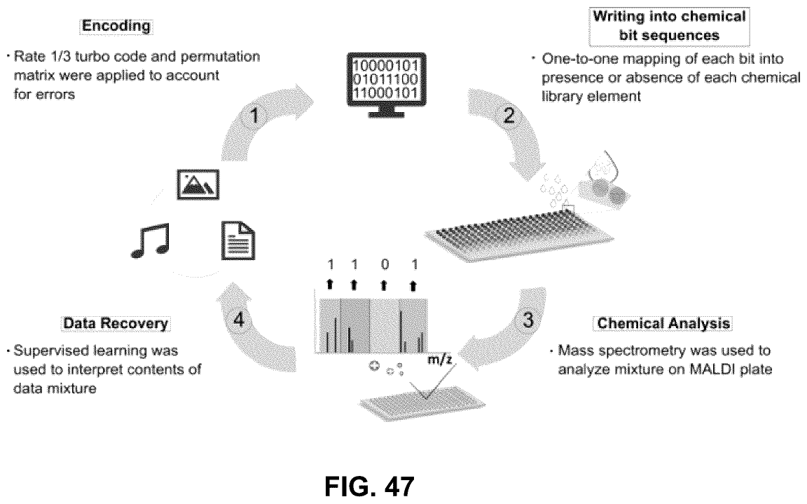

FIG. 47 shows a visualization of the overall process of encoding, writing, analysis, and recovery of data in molecular mixtures. Step 1 involves the encoding of data, including the Turbo error correction bits and the application of a permutation matrix to disperse errors. Step 2 shows the mapping of the encoded data to chemical library elements. Step 3 demonstrates the utilization of chemical analysis techniques to identify the chemical contents of each spot. Step 4 involves the use of supervised learning to interpret the chemical contents and recover the data

INTRODUCTION: Molecular data systems have been proposed as a path to meet some of the world's ever-growing demands for information storage while reaching greater information density, durability, and sustainability than electromagnetic memory. However, existing molecular storage methods are limited in information capacity by practical scaling challenges associated with the cost and complexity of their chemical synthesis. In this work, we demonstrate that data storage can be achieved with chemicals requiring no explicit synthesis, purification, or prior knowledge of the molecular structure. We encoded digital data using chemical waste sources containing mixtures of unknown byproducts. This work highlights a path for molecular data storage to utilize low-cost chemical waste while avoiding complicated synthesis or purification. In order for any chemical information system to succeed and scale, it will need to overcome the synthesis, purification, and cost bottlenecks that are associated with all previously reported demonstrations, spanning from DNA to synthetic polymers to several families of small molecules. Discussions of molecular information on them begin with deoxyribonucleic acid (DNA), whose role in biology makes it a natural candidate for synthetic molecular data systems.

However, although the chemical synthesis of DNA has been used and improved upon for decades, DNA oligomer synthesis and purification are still material-intensive, resulting in low yields and producing significant waste. In part, these challenges are inherent to the serial nature of long polymers. For example, even if the yield of a single base incorporation was 99%, the yield of a 150-mer would be only 22%. To reduce such losses, DNA synthesis chemistries commonly use 20× excess of phosphoramidites and tetrazole-based activators, as well as an excess of solvents to wash between each serial synthesis step.7 Material wastes from DNA synthesis include the protecting group, dimethoxytrityl, which is 35% of the weight of each phosphoramidite; tetrazole, which is explosive; acetonitrile; amidites; pyridine; among others. In addition to costing money and time, many of these inputs and intermediates that do not make it into final products end up in waste streams, with associated environmental and economic impacts. A potential transition to enzymatic DNA synthesis could mitigate some of these costs if new advances can achieve competitive error rates, reliability, and throughput. Another theoretically valuable feature of DNA is its durability. However, many environmental factors can cause DNA degradation or reactivity, which could result in information loss. These factors include the pH, ionizing radiation and ultraviolet light exposure, the salt concentration of the medium, the presence of nucleases, and hydrolysis, among others. Hydrolysis is the dominant mechanism for instability and can lead to information loss through depurination, deamination, and backbone cleavage. To maintain the integrity of data stored in DNA, it needs to be maintained in carefully controlled environments and dried, frozen, or encapsulated. These treatments limit potential commercial markets and can reduce the information density by orders of magnitude.

Some alternative research directions have explored nongenomic molecules for information storage. For example, alternative sequence-defined polymers offer different synthetic paths and a larger library of monomers, which allow for a greater information density using the same polymer length. (However, the upper limit of de novo sequencing of digitally encoded polymers is currently on the order of 77 units) Demonstrations of synthetic polymers have used oligo(triazole amides), oligourethanes, poly(phosphodiester)s, 16 poly-(alkoxyamine amide)s, and poly(l-lactic-co-glycolic acid)s (PLGAs), among others.

Small nonpolymeric molecules can also be used to encode digital information. Previously, we demonstrated the use of synthetic metabolite mixtures to store digital information, showing that digital data could be encoded in the presence or absence of vitamins, nucleotides, amino acids, sugars, and other small molecules. A similar encoding scheme was used by other groups to encode digital data using mixtures of oligopeptides and fluorescent dyes. Further extending these methods, we encoded larger digital data sets in organic small molecules using combinatorial chemistry with multicomponent Ugi products, and applied sparse encoding schemes for redundancy and improved error tolerance, and worked toward secret messaging on common objects. While these studies have established the concept of small molecule-based data storage, they usually still require the synthesis of a starting chemical library, which can be time-consuming or costprohibitive for larger data sets.

In this work, we demonstrate that molecular data storage can be achieved without any synthesis or purification steps and that data can even be stored using compounds that are available from waste sources at no material cost. This is a general approach that can work with sources whose exact chemical makeup is unknown to the user. An overview of the data storage process is shown in FIG. 47, highlighting the ease and scalability of the process. A digital image was encoded by using complex mixtures of unknown waste chemicals. These waste sources were organic synthesis byproducts and toxicology research byproducts, which were later shown to include perand poly fluoroalkyl substances (PFAS), among other compounds. In addition to providing improved cost and resource efficiency, given appropriate chemical inputs, it can also encode data using highly durable compounds whose stability and lifetime can exceed that of DNA under ambient conditions.

RESULTS: Turning Chemical Waste into Digital Data. To offer a solution to the synthesis-related challenges and costs of molecular data storage, we set out to encode data using chemicals diverted from waste streams. Several waste sources were obtained from two academic laboratories: one developing organic synthesis methodology and one studying the developmental effects of exposure to environmental contaminants. In contrast with most other molecular data storage systems, prior knowledge of the chemical makeup of the source materials was not required for their use. The samples were diluted in dimethyl sulfoxide (DMSO), and a matrix-assisted laser desorption ionization (MALDI) matrix was added to the mixtures.

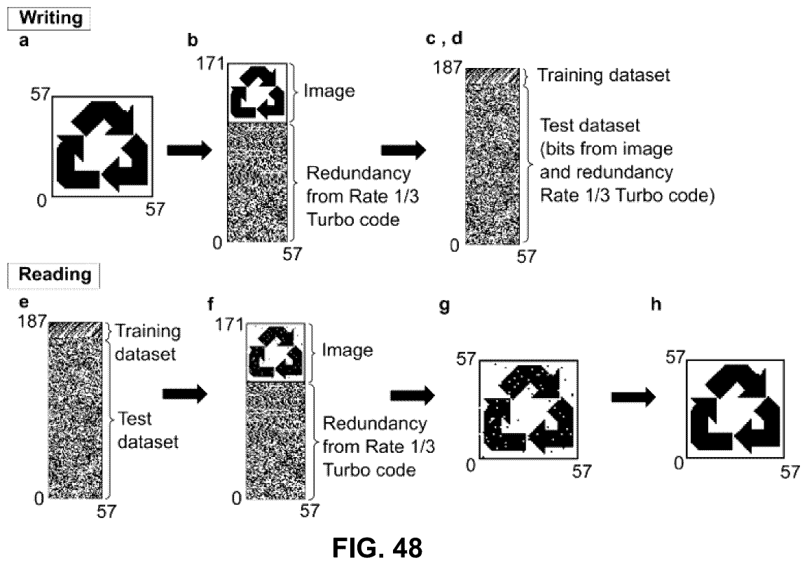

In previous work, we encoded information in small-molecule samples using the presence or absence of each library element to represent binary values of “1” and “0”.6 In this work, we used seven waste samples as library elements, and thus, each mixture could represent up to 7 bits of information. Since the waste samples themselves contained many compounds, the resulting encoded data was a set of “mixtures of mixtures”. FIG. 48 shows the process of encoding a 3249-pixel digital image.

FIG. 48 shows writing and reading processes of the encoded data. (a) Encoded sustainability logo. (b) 1/3 Turbo error correction bits incorporated into the data set. (c) Permutation matrix was applied. (d) Training set was included at the top. (e) Raw data prediction after readout. (f) Data set was unpermuted. (g) Recovery of the encoded image before error correction. (h) Recovered image after error correction.

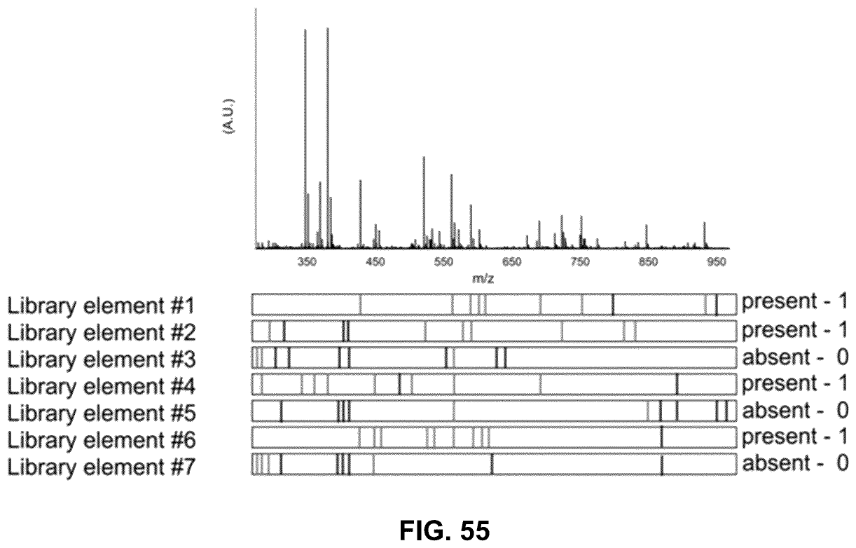

FIG. 55 shows MALDI positive ionization mass spectrum for a sample that encodes the 7 bits of information “1101010”. Below the spectrum is a visualization of 10 features that the classifier models have associated with the presence of each of the 7 library elements. A blue bar indicates the presence of the individual feature in this particular spectrum, and a black bar represents the absence of that feature.

To provide redundancy and support error correction, the digital image was processed with a Rate 1/3 Turbo code24 (FIG. 48 at b) and a permutation matrix (FIG. 48 at c). To assist with the recovery of the data, a training set of all 27=128 enumerated binary mixtures was concatenated with the encoded data set (FIG. 48 at d). The whole data set, including the training and test data, was rearranged as a 1521×7 matrix, where each column corresponded to a unique library element (one of the seven waste mixtures). Each row of the matrix was mapped to a unique location on a standard metal MALDI target data plate. For each element of the matrix, if the value was 1, an acoustic liquid handler was instructed to dispense 30 nL of the appropriate waste mixture to the designated location. If the value was 0, then no transfer was performed. This process resulted in 1521 mixtures of subsets of the 7 sources; in each mixture, the presence (1) or absence (0) of each waste source encoded the data. The mixtures were dried overnight, leaving crystalline spots behind. This process is scalable to thousands of unique mixtures per data plate.

Reading Back Data from the Encoded Waste Mixtures. To recover the digital data from the chemical samples, each mixture on the data plate was analyzed with a Fourier transform ion cyclotron resonance (FT-ICR) MALDI mass spectrometer in positive ionization mode. Each spectrum contained a varying number of peaks based on the complexity of the mixture. The training set of 27=128 enumerated combinations of the library elements was used to train supervised learning algorithms to identify the presence of each library element in each location on the data plate. The analysis began by extracting candidate features from the training samples by averaging all of the training spectra and identifying the locations of the most significant peaks in the averaged spectrum. For each of the 7 library elements, this list of candidate peaks was ranked by discrimination power, using the area under each peak's receiver operating characteristics curve (AUC/ROC).

The highest-ranked features were used to train supervised learning classifiers for each library element. The trained classifiers were then applied to the remaining data mixture spots and used to make soft decisions about the presence or absence of each library element. The classifiers predicted whether each library element was present (1 atom) or absent (“0”) in each data mixture. FIG. 55 shows an example of one spectrum obtained during the analysis. This spectrum contains thousands of data points and hundreds of peaks. The classifiers associate each of the library elements with a “fingerprint” of some subset of spectral features that correlate with the presence of that library element in the training mixtures. In FIG. 55, we annotate the top 10 features that the model associated with the presence of each library element. Four of the seven library elements are present, and this spectrum encodes the 7 bits of information “1101010”.

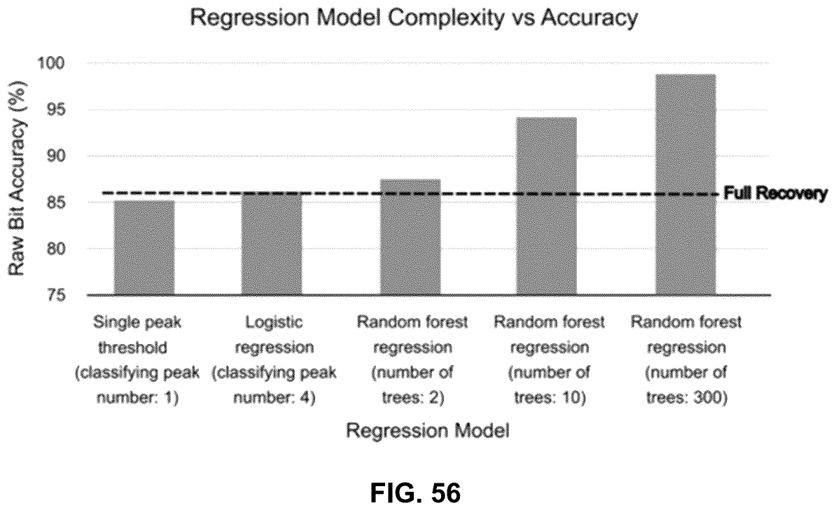

For the supervised classifier models, we tested two common architectures, logistic regression and random forest regression, with varying levels of complexity. Since the data is encoded with redundancy and error tolerance, it is interesting to consider what level of complexity is required to achieve full recovery of the data payload (FIG. 56). Seven classifier models were trained, with one binary classifier for each library element. The parameters for each model are as follows: the single peak threshold used 1 classifying peak from the largest 50 features, the logistic regression model used 4 classifying peaks from 50 features, and the random forest regression models used 2, 10, and 300 trees with 1000, 1000, and 3000 features, respectively. Although the library mixtures are highly complex, even a simple logistic regression with 4 peaks achieved 86% raw accuracy, which was sufficient to achieve perfect recovery of the data payload after Turbo decoding (FIG. 56). Based on simulations, the Rate 1/3 Turbo code was able to correct up to 14% raw bit error rates. Indeed, after Turbo decoding, we achieved 100% recovery of the encoded image (FIG. 48 at h).

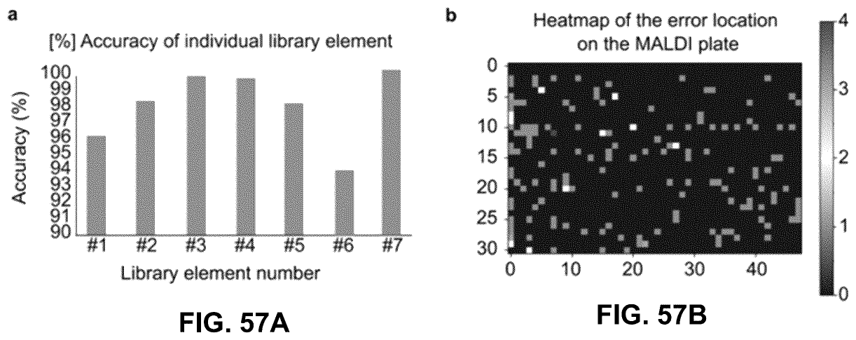

Recovery of Data. With the largest random forest regression model tested, the overall raw bit error rate was approximately 2%, but these errors were not uniformly distributed. As shown in FIG. 57A, each of the chemical library elements was identified with more than 93% accuracy. However, the individual accuracies varied significantly; the total error from library element 7 was 0.07%, while the error from library element 6 was 6.39%. There were some spatial trends as well, with errors overrepresented near the left edge of the plate, where 2% of the mixtures were responsible for 17% of the total errors (FIG. 57B). This could be attributed to mechanical errors or alignment errors in either the liquid handler or the mass spectrometer.

FIG. 56 shows comparison of logistic and random forest regression models for recovering encoded data. The raw bit accuracy was determined by comparing the binary representation of the encoded sustainability logo with that of the decoded logo prior to Turbo decoding. Since the data was encoded with redundancy and error tolerance, any model that exceeded 86% raw bit accuracy was sufficient to recover the data payload with 100% accuracy.

FIG. 57A shows (a) raw bit accuracy (before error correction) for each individual waste mixture and FIG. 57B shows visualization of the physical location of the raw bit errors on the MALDI plate. The color bar represents the number of errors on a blue-to-red scale, where blue represents fewer errors and red represents the highest number of errors.

DISCUSSION: In this study, we demonstrated that molecular data storage can be achieved using inputs that do not require synthesis, purification, or even prior knowledge of their molecular contents. Using unpurified waste chemicals, we encoded a 3249-pixel digital image payload, plus redundancy for error correction (9751 raw bits including coding redundancy). Complete recovery of the data was successful despite not knowing the identity or concentration of the compounds within each sample. This construction is possible because training samples are included alongside the molecular data samples. With a training overhead of 8.41% (128 out of 1521 spots), we trained models that achieved a raw bit error rate as low as 2.04%, which was well below the 14% raw error rate tolerated by the Turbo code. There is always a trade-off between error correction capabilities and total payload capacity. Previous molecular data storage demonstrations have used Reed-Solomon and fountain codes, but here, we chose to use Turbo codes for their ability to tolerate potentially higher error rates from complex, unknown library mixtures.

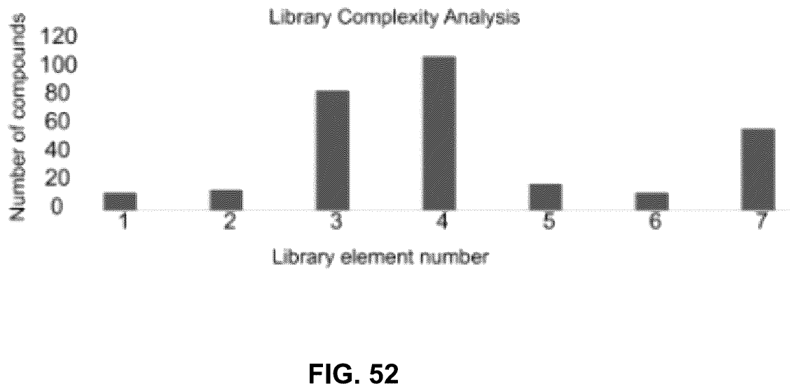

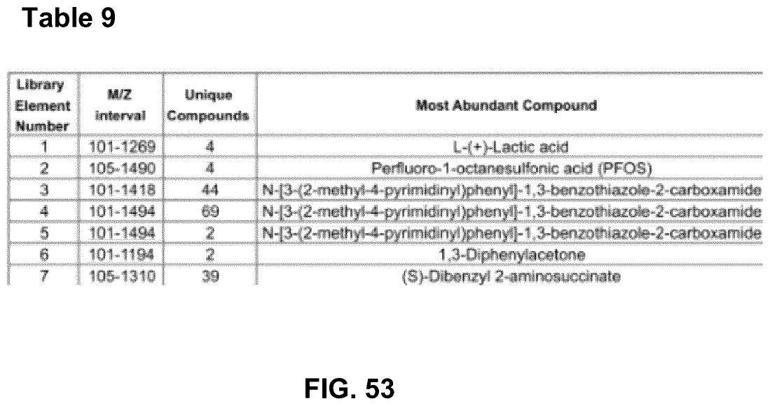

In FIG. 52 and FIG. 53, all library elements were analyzed for composition after the experiment to determine the relative complexity of each sample. We discovered that the library elements that were obtained from the biological laboratory contained compounds belonging to the PFAS family that was recently highlighted by the EPA due to their long-term persistence in the environment and in drinking water. PFOS is one of the most widely studied chemicals in the PFAS group, and despite its industrial phase-out in the early 2000s, it is ubiquitously found in the environment and in humans. This long-term durability across biological and ambient environments could make this class of compounds long-term data storage candidates. Companies worldwide are filtering out PFAS from environmental sources to reduce their environmental abundance, but there are limited options for disposal. Because archival data is stored for decades or longer, using environmentally-sourced PFAS compounds as molecular data storage media could provide alternative value to PFAS that would keep them in circulation for the duration of their half-life.

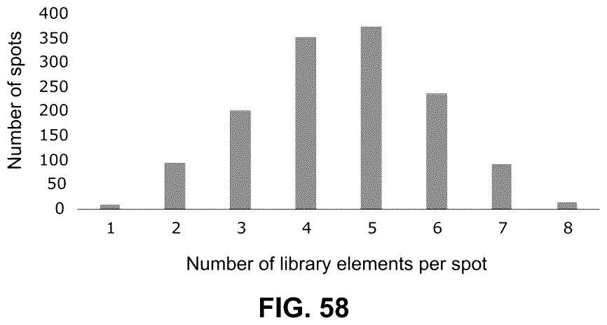

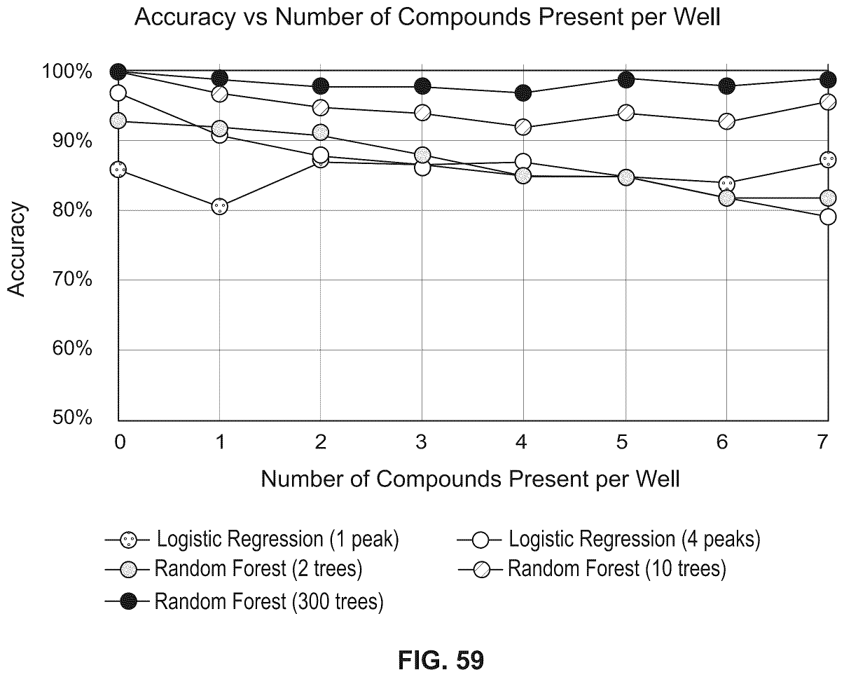

FIG. 58 shows the distribution of the number of library elements in each spot in the dataset. FIG. 59 shows the accuracy within the experimental test dataset reported as a function of the number of compounds present per well. For example, if there were 200 wells which happened to have 2 compounds present, then above we group those wells and plot their raw bit recovery accuracy (before Turbo decoding). The data is shown for each of the 5 representative classification algorithms.

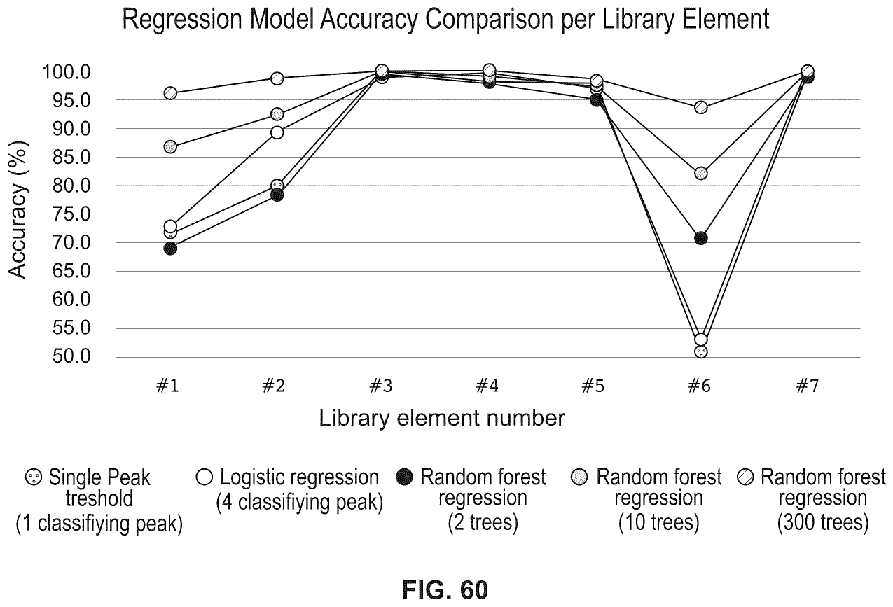

FIG. 60 shows raw bit accuracy comparison of the five regression architectures, on each of the seven library elements.

To appreciate the contents of the waste input samples, the seven library elements were subsequently analyzed using nontargeted mass spectrometry analysis (FIG. 52, FIG. 53). The complexity of the waste sources varied significantly, with each sample containing between 13 and 109 identified compounds. Some of the waste inputs were quite similar to each other, containing up to 90% overlap in the lists of identified compounds. Conceptually, it should not matter how many similarities exist between the library elements as long as they also have identifiable differences. The ability to tolerate a wide range of complex unknown mixtures suggests possibilities for encoding data by using many different environmental and industrial inputs as library sources. Two library samples contained several compounds belonging to the PFAS class, which are highly stable fluorinated hydrocarbon compounds that are persistent in the environment. As a class, PFAS are less chemically reactive and more stable than DNA under ambient conditions. DNA degradation can occur through several mechanisms, and the rate of DNA degradation increases substantially with temperature or pH. In contrast, many PFAS are stable up to 200-600° C. and certain PFAS also can tolerate very high pH before significant degradation.

PFAS are nicknamed “forever chemicals” owing to their long half-lives of up to 1000 years under ambient conditions. The presence of PFAS in these samples suggests that library inputs that are partly or entirely composed of PFAS compounds could be chosen to produce data sets that are extremely stable and may retain their form for longer than DNA. Additionally, there could be value created by removing these contaminants from the environment and using them for long-term molecular data storage.

This study shows that digital information can be encoded in molecular mixtures without prior knowledge of their molecular contents and that the digital data can be fully recovered using chemical analysis. The absence of any explicit library synthesis steps is in contrast to previously demonstrated molecular data storage systems that are based on DNA, synthetic polymers, or small molecules. Despite advanced microarray synthesis platforms, DNA data storage still costs $0.001 per bit, compared to $0.000000000001 per bit for modern electronic storage. In this work, we demonstrated data storage using molecules that had no associated cost. On a larger scale, there may be costs associated with the transportation and storage of chemical waste streams.

There are a wide range of different molecular information storage approaches, with trade-offs between density, capacity, complexity, and speed. This work lies at one extreme, representing what it could mean to write molecular data without any library synthesis at all. This clearly creates some asymmetries, potentially making it more difficult to read back the data and limiting the information density to the limits of the chemical printing and chemical analysis tools used for writing and reading. It is also important to recognize the limitations of encoding data by using waste streams as input sources. Although this approach lowers some material costs, writing data still incurs costs from liquid handling and has similar throughput and latency as other molecular data storage approaches. If scaled up, it would be important to maintain consistency of the source material streams, and some waste streams may be inappropriate for this approach if they are too dilute, acutely hazardous, complex, or similar to one another. Even if many of the molecules in a sample are very stable, some degradation is inevitable over time and some components in a given library element may cross react with components of another library element. Our approach of including every distinct combination of library elements in training samples and embedded error tolerance should allow for some degradation and potential cross reactivity to be naturally accommodated when it is time for the data to be read. This demonstration should be taken as an illustration of one way that molecular data storage can be generalized to accommodate nearly any chemical input source, even those that have impurities or variable contents. This work highlights opportunities for molecular data storage to contribute positively to a circular economy while also providing low cost and long-term durability.

METHODS Instrument parameter examples are in Table 10. Materials. A total of seven waste chemical mixtures were used. Five of the waste mixtures were obtained from Dr. Ming Xian's lab in the Chemistry Department at Brown, and two of the biological waste samples were obtained from Dr. Jessica Plavicki's lab in the Pathology and Molecular Medicine Department at Brown University. All samples obtained were byproducts that were collected after their respective experiments had concluded and would have otherwise been deemed waste. Dimethyl sulfoxide (DMSO, anhydrous, 99.9%, MilliporeSigma) was used as a solvent to dilute all of the solutions in the library. Analytical grade α-cyano-4-hydroxycinnamic acid (HCCA, 99.0%, MilliporeSigma) was used as the matrix material for all MALDI samples.

Library Preparation. Each waste mixture was filtered through a 0.2-μm nylon syringe filter before being dissolved in DMSO. The waste chemicals from Dr. Xian's lab were dissolved in DMSO using a 1:2 ratio of DMSO to waste mixture. The waste chemicals from Prof. Plavicki's lab were dissolved in DMSO using a 3:1 ratio of DMSO to waste mixture. Each waste mixture was finally diluted in MALDI matrix solution (20 mg of HCCA in 1 mL of DMSO) using a 1:2 ratio of matrix solution to waste mixture. They were pipetted into a 384-well plate, with each row representing a distinct waste mixture.

Data Plate Preparation. The digital image of a sustainability logo (57×57 pixels) was encoded using a Rate 1/3 Turbo code, multiplied by a permutation matrix, concatenated with the training set, and converted into a onedimensional binary vector. The training spots are a set of 27=128 enumerated binary mixtures, which is represented in the binary vector as 128×7=896 bits. The assembled onedimensional (1-D) vector was reshaped into an M×N matrix, where M represents the number of waste mixtures and N represents the number of independent mixtures. For each true (“1”) value in the matrix, 30 nL (12 2.5 nL droplets) of the mth waste mixture was transferred from the 384-well library plate to the nth location on a metal MALDI plate using an acoustic liquid handler (Echo 550, Beckman Coulter). This implies that each location was a mixture of up to 7 library elements and contained up to 210 nL. Once all transfers are complete, the data plate was left to dry in a fume hood overnight. The resulting dried mixture spots were typically 1 mm in diameter.

Mass Spectrometry. Mass spectra were acquired with a Fourier transform ion cyclotron resonance (FT-ICR) mass spectrometer in positive ion mode. To obtain accurate peak assignment, a mass calibration is performed through electrospray ionization (ESI) before each run using sodium trifluoroacetate as a reference. Samples were ionized by using matrix-assisted laser desorption ionization (MALDI). The sample run was automated, and the typical spectra were acquired for 1.5 s. During the automation process, the instrument serially addresses each crystallized spot and takes about 4 h to record all 1536 spots on a plate. Each measurement is made by ionizing a portion of a sample with a laser configured to take 500 shots at 1000 Hz, over a scan area of 500-900 μm with a medium focus and ×4 averaging.

Nontargeted Analysis of the Chemical Library Elements. After the chemical data experiment was complete, we performed a separate nontargeted analysis of the waste samples. All instrument parameters, including the chromatography scheme, source settings, full scan parameters, and data dependent (dd) MS2 settings, for both negative and positive ESI, are provided in detail (Table 10). Data was collected on a high-resolution Thermo QExactive HF-X Orbitrap MS equipped with a Vanquish ultrahigh-performance liquid chromatograph. We analyzed the samples two times: once with positive electrospray ionization (ESI, +) and once in negative ESI (ESI, −). For both ionization modes, we used the same chromatography scheme. Sample components were separated on a Thermo Hypersil Gold Vanquish C18 column (100×2.1×1.9 μm3) with two mobile phases. Mobile phase A consisted of 2 mM ammonium acetate in 5% acetonitrile, and Mobile phase B consisted of 2 mM ammonium acetate in 100% acetonitrile. The total run time was 15 min. Data was acquired using data-dependent (dd) MS2 acquisition. Fragmentation was performed in an HCD collision cell filled with N2 (produced by a Peak Scientific Nitrogen Generator, Genius NM32LA). All spectral data files were saved in the. RAW file format, and NTA/SSA was performed in the Thermo Compound Discoverer (CD) 3.3 software. For ESI,+, and ESI,− data, peaks were detected with 10 ppm mass tolerance, 1,000,000 minimum peak intensity, and a signal-to-noise threshold of 1.5.

Compounds were grouped with 5 ppm mass tolerance and 0.1 min retention time tolerance. Compound annotations were assigned using the following data sources in ranked order: mzCloud search, mzVault search, mass list search, predicted compositions, and ChemSpider search. The peak area for each putatively identified compound detected was exported to Microsoft Excel after processing the raw data and prior to data filtering. Compounds that were identified to have a minimum of 70% spectral match, as determined by mzCloud, were summed to determine the relative complexity of each element. We found that complexity varied significantly between each library element (FIG. 52, FIG. 53). We discovered that two samples contained several compounds belonging to the PFAS family, including perfluoro-1-octanesulfonic acid (PFOS), perfluoro-1-butanesulfonic acid (PFBS), perfluoro-1-hexanesulfonic acid (PFHxS), and perfluorononanoic acid (PFNA) (all Level 1 annotations on the Schymanksi Scale), which are highly stable fluorinated hydrocarbon compounds that are persistent environmental contaminants. Moreover, we identified that three of the library elements' most abundant peaks came from an identical compound, and in some elements, only 2 compounds were unique to that mixture.

Data Plate Analysis. Spectra from the FT-ICR mass spectrometer were exported for analysis in Python. The dedicated training spots were used to train 7 binary classifiers, one per library element. Logistic regression models or random forest models were trained as described in the main text. At different levels of complexity, the models used between 1 and 20,000 spectral features as inputs. After training binary classifiers on the 128 training spots, the models were applied to predict the presence or absence of the 7 library elements in the remaining 1393 spots. To recover the digital image payload, the classifiers' prediction matrix was unpermuted, reshaped, and Turbo decoded using the CommPy toolkit.

Durability Comparison of DNA and PFAS Compared to DNA, certain PFAS are more stable under ambient conditions. Due to the inherent susceptibility of its chemical nature, DNA degradation can occur through several mechanisms1,2. Hydrolysis is one common mechanism of information loss in digitally encoded DNA. Hydrolysis can lead to deamination reactions, in which cytosine is converted to uracil, as well as depurination, in which glycosidic bond cleavage can further lead to strand breaks. The rate of DNA degradation through these mechanisms is substantially increased with an increase in temperature or a change in pH3. Although theoretical rates of these mechanisms are meager at ambient temperatures and pH4, there are numerous DNA data storage processes that require temperatures that exceed 37° C., and often even 70° C., as polymerases operate optimally at these elevated temperatures1. Additionally, changes in pH significantly impact the integrity of DNA. The degradation rate of DNA can increase by an order of magnitude due to a change from pH 6 to 51. On the other hand, many PFAS are stable up to 200-600° C., depending on the chain length and functional group, owing to the strength of carbon-fluorine bonds5. PFOS, which was detected in one of the library elements in this study and is one of the most environmentally ubiquitous PFAS, is stable up to 450 degrees Celsius. Certain PFAS also require high pH values for significant degradation6. Current methods of degrading PFAS are all reliant upon harsh physical and chemical conditions, and most require the use of catalysts. This high durability under ambient conditions could make environmentally-sourced PFAS a candidate for archival molecular data storage.

Specific elements of any of the foregoing embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure. The methods and devices disclosed herein can be combined in any way into systems to address the current data emergency.

The machine learning methods and artificial intelligence methods described herein can be implemented in any suitable computing system. The computing system can be implemented as or can include a computer device that includes a combination of hardware, software, and firmware that allows the computing device to run an applications layer or otherwise perform various processing tasks. Computing devices can include without limitation personal computers, workstations, servers, laptop computers, tablet computers, mobile devices, wireless devices, smartphones, wearable devices, embedded devices, microprocessor-based devices, microcontroller-based devices, programmable consumer electronics, mini-computers, main frame computers, and the like and combinations thereof.

Processing tasks can be carried out by one or more processors. Various types of processing technology can be used including a single processor or multiple processors, a central processing unit (CPU), multicore processors, parallel processors, or distributed processors. Additional specialized processing resources such as graphics (e.g., a graphics processing unit or GPU), video, multimedia, or mathematical processing capabilities can be provided to perform certain processing tasks. Processing tasks can be implemented with computer-executable instructions, such as application programs or other program modules, executed by the computing device. Application programs and program modules can include routines, subroutines, programs, scripts, drivers, objects, components, data structures, and the like that perform particular tasks or operate on data.

Processors can include one or more logic devices, such as small-scale integrated circuits, programmable logic arrays, programmable logic devices, masked-programmed gate arrays, field programmable gate arrays (FPGAs), application specific integrated circuits (ASICs), and complex programmable logic devices (CPLDs). Logic devices can include, without limitation, arithmetic logic blocks and operators, registers, finite state machines, multiplexers, accumulators, comparators, counters, look-up tables, gates, latches, flip-flops, input and output ports, carry in and carry out ports, and parity generators, and interconnection resources for logic blocks, logic units and logic cells.

The computing device includes memory or storage, which can be accessed by a system bus or in any other manner. Memory can store control logic, instructions, and/or data. Memory can include transitory memory, such as cache memory, random access memory (RAM), static random-access memory (SRAM), main memory, dynamic random-access memory (DRAM), block random access memory (BRAM), and memristor memory cells. Memory can include storage for firmware or microcode, such as programmable read only memory (PROM) and erasable programmable read only memory (EPROM). Memory can include non-transitory or nonvolatile or persistent memory such as read only memory (ROM), one-time programmable non-volatile memory (OTPNVM), hard disk drives, optical storage devices, compact disc drives, flash drives, floppy disk drives, magnetic tape drives, memory chips, and memristor memory cells. Non-transitory memory can be provided on a removable storage device.

A computer-readable medium can include any physical medium that is capable of encoding instructions and/or storing data that can be subsequently used by a processor to implement embodiments of the systems and methods described herein. Physical media can include floppy discs, optical discs, CDs, mini-CDs, DVDs, HD-DVDs, Blu-ray discs, hard drives, tape drives, flash memory, or memory chips. Any other type of tangible, non-transitory storage that can provide instructions and/or data to a processor can be used in the systems and methods described herein.

The computing device can include one or more input/output interfaces for connecting input and output devices to various other components of the computing device. Input and output devices can include, without limitation, keyboards, mice, joysticks, microphones, cameras, webcams, displays, touchscreens, monitors, scanners, speakers, and printers. Interfaces can include universal serial bus (USB) ports, serial ports, parallel ports, game ports, and the like.

The computing device can access a network over a network connection that provides the computing device with telecommunications capabilities Network connection enables the computing device to communicate and interact with any combination of remote devices, remote networks, and remote entities via a communications link. The communications link can be any type of communication link including without limitation a wired or wireless link. For example, the network connection can allow the computing device to communicate with remote devices over a network which can be a wired and/or a wireless network, and which can include any combination of intranet, local area networks (LANs), enterprise-wide networks, medium area networks, wide area networks (WANS), virtual private networks (VPNs), the Internet, cellular networks, and the like. Control logic and/or data can be transmitted to and from the computing device via the network connection. The network connection can include a modem, a network interface (such as an Ethernet card), a communication port, a PCMCIA slot and card, or the like to enable transmission to and receipt of data via the communications link. A transceiver can include one or more devices that both transmit and receive signals, whether sharing common circuitry, housing, or a circuit boards, or whether distributed over separated circuitry, housings, or circuit boards, and can include a transmitter-receiver.

The computing device can include a browser and a display that allow a user to browse and view pages or other content served by a web server over the communications link. A web server, sever, and database can be located at the same or at different locations and can be part of the same computing device, different computing devices, or distributed across a network. A data center can be located at a remote location and accessed by the computing device over a network. The computer system can include architecture distributed over one or more networks, such as, for example, a cloud computing architecture. Cloud computing includes without limitation distributed network architectures for providing, for example, software as a service (SaaS).

The technology described herein is further illustrated by the following examples which in no way should be construed as being further limiting. The Examples are provided to demonstrate examples of future planned work, which in some experiments is emergency work. Although methods and materials similar or equivalent to those described herein can be used in the practice or testing of this disclosure, suitable methods and materials are described below.

### EXAMPLES

The following Examples are provided to illustrate the invention and should not be considered to limit its scope in any way.

### Example 1

Computing with Chemicals: Perceptrons Using Mixtures of Small Molecules

Introduction and summary. Computation that can use the Avogadrian numbers of molecules in heterogeneous solutions, and the even larger number of potential interactions among these molecules, is useful and beneficial. In principle, molecules can be used for realizing levels of parallelism orders of magnitude beyond what is achievable in silica, while requiring substantially less energy. See, Frank. IEEE Spectrum, 54(9), 32-37 (September 2017). However, the lack of precise specificity and control of chemical interactions has previously made computation that can use the Avogadrian numbers of molecules in heterogeneous solutions very difficult or impossible. Molecules in solution can react in a stochastic fashion because of diffusion, which depends both upon ambient conditions and also upon what other molecules and reagents are present. This inherent stochasticity has made chemistry a challenging field, but also makes chemical computation useful and beneficial. For more information, see Rose et al., 2018 IEEE International Symposium on Information Theory (ISIT) (Vail, CO, June 2018), pp. 2236-2240, which is incorporated by reference.

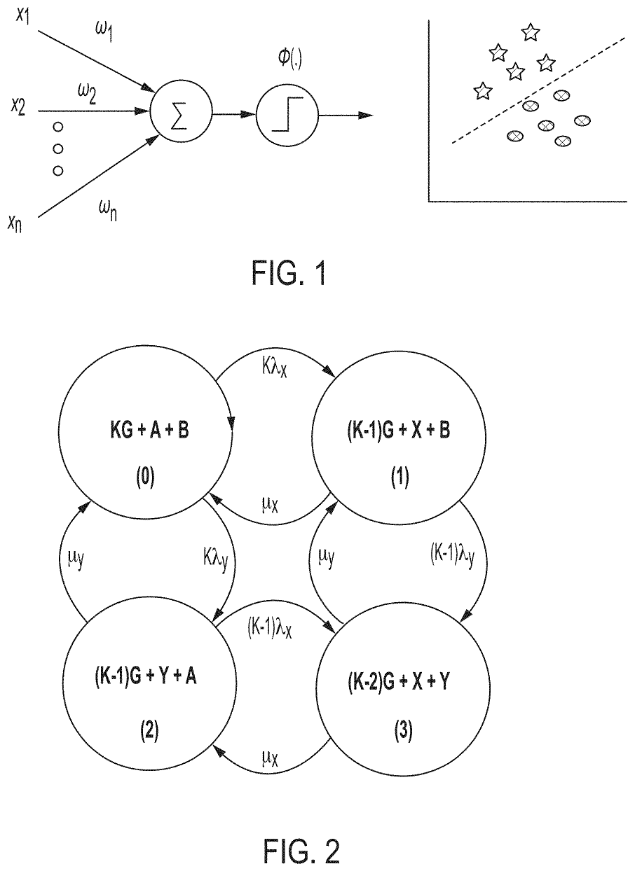

This EXAMPLE 1 provides computational systems that perform classification and signal processing on massive data sets by using the inherent parallelism of solution phase chemical reactions. The target architecture is the perceptron, which is a flexible and universal pattern classification structure and a key element of neural network systems that handle large data sets. See, Courbariaux et al., arXiv:1602.02830 (Mar. 17, 2016). In this EXAMPLE 1, the perceptron is a single multiply accumulate primitive followed by a nonlinearity, as shown in FIG. 1. More complex neural networks are buildable from multiple layers of perceptrons.

This EXAMPLE 1 demonstrates how relatively simple chemistry can produce a ubiquitous computational primitive (the multiply accumulate (MAC) operation) that supports a single layer neural network called a perceptron. This perceptron is produced using distinct chemical mixtures whose inclusion/exclusion in a pool is controlled by a binary input vector, applying different reagents/processes to the pooled inputs, and reading the result through simple indicators such acidity, alkalinity, or fluorescence emission. Using distinct mixtures as inputs and different reagents as operations, this EXAMPLE 1 shows how to produce the perceptron MAC operation and read out the result using simple indicators such as pH or fluorescence. With a moderately large chemical library, the number of potential inputs can be Avogadrian, so that reagent addition implicitly performs a concomitantly large number of MAC operations in parallel. Because implementations may be noisy, due to stochastic reactions or weight quantization errors, this EXAMPLE derives a signal-to-noise-like figure of merit to predict expected perceptron performance under a weight uncertainty.

This EXAMPLE 1 first reviews perceptron structure. This EXAMPLE 1 then briefly describes the small molecules upon which the scheme is built. Based upon the presence or absence of small molecule mixtures as inputs, this EXAMPLE 1 next describes how, for a given desired perceptron weight set, mixture compositions can be found so their collective interaction with different reagents produces the desired perceptrons and the desired indicator outputs.

This EXAMPLE 1 shows how to implement chemical perceptrons using small molecules composed of reactive groups (R-groups), and reagents which act differentially (but without impractical exquisite specificity) upon them. Given multiple reagents with differing R-group reactivity, the inventors can realize multiple independent perceptrons (one per reagent) assuming there are no more reagents than R-groups. This EXAMPLE 1 has also characterized the effects weight quantization error and reaction uncertainty to perceptron performance by deriving a signal-to-noise-like figure of merit. From the quantization perspective, high fidelity representation of given perceptrons seems possible. To determine whether similarly high fidelity representation is possible under reaction uncertainty, work must be done to identify chemical systems and characterize their associated Γ and/or Γ′ and Kr. Data for Γ can likely be gathered from the literature, but chemical system characteristics such as Γ′ and K_{Γ} rarely are studied or reported. Chemical training (see, Banda et al., Artificial Life, 19(2), 195-219 (Spring 2013); Banda et al., Journal of the Royal Society Interface, 11(93), (April 2014)) and layering into larger networks are the subjects of ongoing work.

The number of possible inputs to the perceptron is combinatorically large. The ongoing Ugi synthesis work (see EXAMPLE 3 below) produces a library of about 3×10⁴ different molecules, implying 230000-1 non-empty mixtures. The number of simultaneous multiply accumulate (MAC) operations (inputs×weights to produce an indicator product) implemented by reagent addition can also be extremely large, even after selecting only for mixtures which implement a set of weights. Because small molecules are used and operation relies upon the natural promiscuity of liquid phase chemical reactions, the physical size of these perceptrons is limited only by the amount of indicator product that can be reliably detected.

Larger libraries (2×10⁶) are possible. Tan et al., Journal of the American Chemical Society, 120(33), 8565-8566 (1998). The number of simultaneous multiply accumulate (MAC) operations (inputs×weights to produce an indicator product) implemented by reagent addition can also be extremely large even after selecting only for mixtures which implement a given set of weights.

Perceptrons through differential reactivity. Concept overview. De novo design of exquisitely specific reactions that can select for (each of) one and only one molecule has remained an outstanding challenge for synthetic chemistry. Until now, selecting individual molecules from a mixture to react without affecting other molecules has been untenable, meaning that mapping individual molecules to inputs in the perceptron model has been untenable.

Instead of using the presence or absence of distinct molecules as perceptron inputs, this EXAMPLE 1 uses distinct mixtures of molecules as units of input, then combine these mixtures as dictated by the binary input vector x, resulting in a mixture of mixtures (a pool). The inventors then apply a reagent or process to the pool to perform the multiply accumulate (MAC) operations. Next, the inventors follow with a threshold detection of a detectable reaction product to produce the perceptron output.

The individual molecules comprise different “R-groups,” which are molecular species with different chemical properties that can be attached to some chemical backbone. The number of R-groups comprising a molecule is some fixed K. While the chemistry may allow for multiple copies of the same R-group per molecule, the inventors make some restrictions, so a R-group can appear only once per molecule. The multiplicity of potential R-groups and the size of K means that the number of different molecules is combinatorial and thus can be very large.

A specific reagent interacts differently with different R-group types. When a reagent Gᵢ reacts with R-group [symbol] ₙ and replaces [symbol] ₙ with a different detectable R-group (that may be a fluorophore or have a different acidity, polarity, or charge) with a given yield. Then, Gᵢ is also assumed to affect other R-groups with varying degrees of specificity/affinity. When one assumes that the reagent is plentiful and accessible to all molecules in a mixture given sufficient mixing and/or diffusion, then one can define an operator Gᵢ (•) where Gᵢ( [symbol] ₙ)=γᵢₙ∈[0,1] is the equilibrium proportion of R-group [symbol] n replaced by indicator Tᵢ under application of reagent Gᵢ. Given N different R-groups, any given reagent Gᵢ has an associated R-group replacement “equilibrium/yield vector” γᵢ defined as:

$${γ}_{i} = [ \begin{matrix}{γ}_{i} 1 \\ ⋮ \\ {γ}_{i} N\end{matrix} ] .$$

When the skilled artisan could design a reagent Gᵢ that would react only with R-group [symbol] ₙ, always replacing it completely by Ti, then γᵢ=eₙ, then the canonical unit vector is [symbol] ^{N}. However, the lack of precise ligand/receptor specificity between R-groups and reagents makes such a scenario unlikely. So, the replacement vector associated with reagent Gᵢ contains an assortment of non-negative numbers between zero and one. γ might be stochastic (with known statistics). γ is defined by assuming that all the related reactions achieved equilibrium. While γ varies with time as reactions proceed, one need only consider final γ values in this EXAMPLE 1.

When molecules {μₘ}, comprise K R-groups [symbol] ₘ₁, [symbol] ₘ₂, . . . [symbol] _{mK}, each molecule μₘ is represented as an integer N-vector where nonzero entries in position [symbol] Indicates the number of [symbol] contained in μₘ. For molecules constructed of K R-groups, one must have ∥μₘ∥₁=K, but the structure of μₘ may be further constrained depending upon how molecules are constructed. For instance, perhaps a given R-group can appear only once per molecule so that μₘ is always a binary vector. Further, one might also have K distinct classes of R-groups where each class may be represented only once.

Reagent-Rich Reactions. One can assume throughout that reagent is plentiful relative reaction targets (R-groups). This assumption allows us to effectively decouple competition between R-groups for reagent. One can consider the reactions between R-groups A and Band reagent G, developing an approach to realizing perceptrons (and thence more complex neural networks) which does not depend on carefully matched ligand/receptor chemistry is desirable. Thus, instead of using the presence or absence of distinct molecules as perceptron inputs, the inventors use distinct mixtures of molecules as units of input and combine these mixtures as dictated by the binary input vector x resulting in a mixture of mixtures the inventors call a pool. The inventors then apply some reagent (or process) to the pool to perform the necessary multiply-accumulate operations and follow with threshold detection of a detectable reaction product to produce the perceptron output.

To demonstrate, consider the reactions between R-groups A and B and reagent G. See:

$$A + G {⇌}_{{μ}_{X}}^{{λ}_{X}} X , and \qquad [ Equation 1 ]$$

$$B + G {⇌}_{{μ}_{Y}}^{{λ}_{Y}} Y \qquad [ Equation 2 ]$$

where the forward and backward reaction rates are specified above and below the =respectively.

A “master equation” such as [Equation 1] implies a Markov chain with states A+G and X and the equilibrium yield value γx is the steady state probability of being in state X. For such two state Markov chains, one therefore has:

$${γ}_{X} = \frac{{λ}_{X}}{{λ}_{X} + {μ}_{X}} = \frac{{ρ}_{X}}{{ρ}_{X} + 1} , and \qquad [ Equation 3 ]$$

$${γ}_{Y} = \frac{{λ}_{Y}}{{λ}_{Y} + {μ}_{Y}} = \frac{{ρ}_{Y}}{{ρ}_{Y} + 1} , \qquad [ Equation 4 ]$$

after defining ρ_{X}=λ_{X}/μ_{X} and ρ_{Y}=λ_{Y}/μ_{Y}.

Now, consider the equation

$$A + B + 2 G ⇌ X + Y , \qquad [ Equation 5 ]$$

Owing to competition for reagent between A and B, the equilibrium constants for [Equation 5] can differ from the γₓ and γ_{y} obtained in isolated reactions. Such equilibrium yield constant coupling (or “interference”) would complicate the design problem owing to the combinatorial multiplicity of competing reactions which must be characterized.

So, consider the Markov chain of FIG. 2 which depicts the reaction of [Equation 5] assuming K≥2 available reagent molecules. The diagram implies a differential equation of the form:

$$\dot{Π} = A Π \qquad [ Equation 6 ]$$

where Π is the 4-vector state probabilities and A is:

$$A = [ \begin{matrix}- K ( {λ}_{X} + {λ}_{Y} ) & {μ}_{X} & {μ}_{Y} & 0 \\ K {λ}_{X} & - ( K - 1 ) {λ}_{Y} - {μ}_{X} & 0 & {μ}_{Y} \\ K {λ}_{Y} & 0 & - ( K - 1 ) {λ}_{X} - {μ}_{Y} & {μ}_{X} \\ 0 & ( K - 1 ) {λ}_{Y} & ( K - 1 ) {λ}_{X} & - ( {μ}_{X} + {μ}_{Y} )\end{matrix} ] \qquad [ Equation 7 ]$$

If we define

$${ρ}_{X} = \frac{K {λ}_{X}}{{μ}_{X}} and {ρ}_{Y} = \frac{K {λ}_{Y}}{{μ}_{Y}} ,$$

the zero-eigenvalue eigenvector of A is,

$${ϕ}_{0} = [ \begin{matrix}1 \\ {ρ}_{X} \\ {ρ}_{Y} \\ \frac{K - 1}{K} {ρ}_{X} {ρ}_{Y}\end{matrix} ] \qquad [ Equation 8 ]$$

The steady state probability vector II* is then:

$${Π}^{⋆} = \frac{{ϕ}_{0}}{1 + {ρ}_{X} + {ρ}_{Y} + \frac{K - 1}{K} {ρ}_{Y} {ρ}_{Y}} \qquad [ Equation 9 ]$$

However, for large K, as befits a reagent-rich assumption, one has

$${Π}^{⋆} \approx \frac{1}{1 + {ρ}_{X} + {ρ}_{Y} + {ρ}_{Y} {ρ}_{Y}} [ \begin{matrix}1 \\ {ρ}_{X} \\ {ρ}_{Y} \\ {ρ}_{X} {ρ}_{Y}\end{matrix} ] \qquad [ Equation 10 ]$$

One can then find:

$${γ}_{X} = {π}_{1}^{⋆} + {π}_{3}^{⋆} \approx \frac{{ρ}_{X} ( 1 + {ρ}_{Y} )}{( 1 + {ρ}_{X} ) ( 1 + {ρ}_{Y} )} = \frac{{ρ}_{X}}{1 + {ρ}_{X}} , and \qquad [ Equation 11 ]$$

$${γ}_{Y} = {π}_{2}^{⋆} + {π}_{3}^{⋆} \approx \frac{{ρ}_{Y}}{1 + {ρ}_{Y}} \qquad [ Equation 12 ]$$

The Mathematics of Mixture Composition. In this EXAMPLE 1, one assumes the entries are non-negative integers that sum to K. If reagent-rich R reactions are effectively independent, then consider molecules, {μₘ}, composed of L R-groups [symbol] ₘ₁, [symbol] ₘ₂, . . . , [symbol] _{mL}. The inventors represent each molecule Uₘ as an integer R-vector where nonzero entries in position r indicate the number of [symbol] | contained in Uₘ. For molecules constructed of L R-groups, one must have ∥μₘ∥₁=L, but the structure of Uₘ may be further constrained depending upon how molecules are constructed. For instance, perhaps a given R-group can appear only once per molecule so that Uₘ is always a binary vector. Further, one might also have L distinct classes of R-groups where each class may be represented only once. However, for now assume the entries are non-negative integers that sum to L.

An N×M molecule matrix, U, is:

$$U = [ {μ}_{1} , {μ}_{2} , ⋯ {μ}_{M} ] , \qquad [ Equation 1 ] [ Equation 13 ]$$

which contains the “universe” of M distinguishable molecules, m₁, . . . , m_{M}.

Each component of a particular group of molecular mixtures, {Mⱼ}, j=1, . . . , J, can be defined by a binary M-vector θⱼ whose components are 0|1, corresponding to which molecules are absent|present in Mⱼ (at presumed unit concentration). A matrix θ, each column of which specifies the molecules that comprise input j, can be defined as:

$$Θ = [ {θ}_{1} , {θ}_{2} , ⋯ {θ}_{J} ] , \qquad [ Equation 2 ] [ Equation 14 ]$$

where J≤2^{M} is the number of inputs to the perceptron. Mixture j is present in the pool when perceptron input xⱼ=1 and is not present when xⱼ=0. Because M can be very large (libraries as large as 2×10⁶ have been built in other contexts), the number of distinct mixtures (and therefore, potential inputs) is essentially limitless.

Because reagents act on R-groups, one obtains the results of reagent application by translating Θ into a corresponding collection of R-group mixtures, {rⱼ}, upon whose components the γᵢₙ can operate. The inventors define the N×J matrix [symbol] as:

$$= U Θ , \qquad [ Equation 3 ] [ Equation 15 ]$$

Note that

$$= [ {r}_{1} , ⋯ {θ}_{J} ] , and {r}_{j} = [ \begin{matrix}{r}_{j} 1 \\ ⋮ \\ {r}_{j} N\end{matrix} ]$$

where the integer rⱼₙ indicates the number of [symbol] ₙ's in mixture j. Because the action of reagent Gᵢ on molecule μₘ is γiᵢ^{T}μₘ, applying reagent Gᵢ to a given mixture Mj results in non-negative indicator “weight”:

wᵢⱼ=γᵢ^{T}Uθⱼ

Finally, when the presence or absence of Mⱼ in the pool is defined by the binary variable xⱼ, the indicator amount produced by applying reagent Gᵢ to the pool is:

$$‖ {T}_{i} ‖ = {Σ}_{j = 1}^{J} {w}_{ij} {x}_{j} = {w}_{i}^{⊤} x = {y}_{i}^{⊤} U Θ x , where \qquad [ Equation 4 ] [ Equation 16 ]$$

$${w}_{i} = [ \begin{matrix}{w}_{i 1} \\ ⋮ \\ {w}_{iJ}\end{matrix} ] ,$$

and each wᵢⱼ≥0. Then:

$${w}_{i} = {Θ}^{⊤} {U}^{⊤} {y}_{i} . \qquad [ Equation 5 ] [ Equation 17 ]$$

To summarize this as a theorem:

Theorem 1 (Chemical Perceptron (Reagent-Rich Decoupling)): Assuming the presence or absence of each of an ensemble of molecular mixtures as binary inputs, xⱼ, the scalar ∥Tᵢ∥ as given in [Equation 4] [Equation 16] represents a chemical multiply accumulate operation on the xⱼ using weights wᵢⱼ≥0. Applying a threshold operator φ( ) to ∥Tᵢ∥ results in the mathematical equivalent of the perceptron structure in FIG. 1. [When reagent is plentiful, then the yield of reagent G applied to a mixture of R-groups Σₙ [symbol] ₘ is approximately equal to the sum of individual unmixed- [symbol] ₘ yields with similarly plentiful reagent.]

Proof [Theorem 1]: See the mathematical development leading to the statement of Theorem 1.

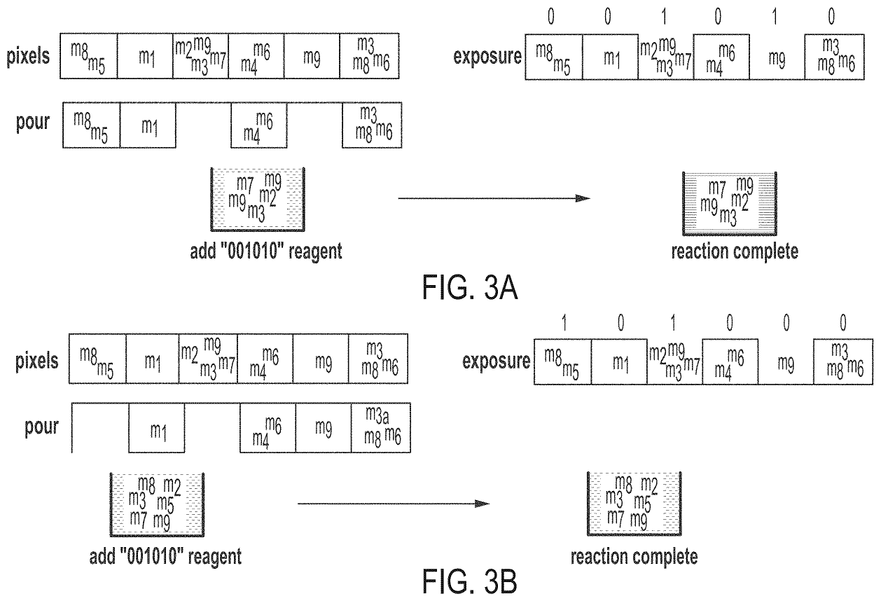

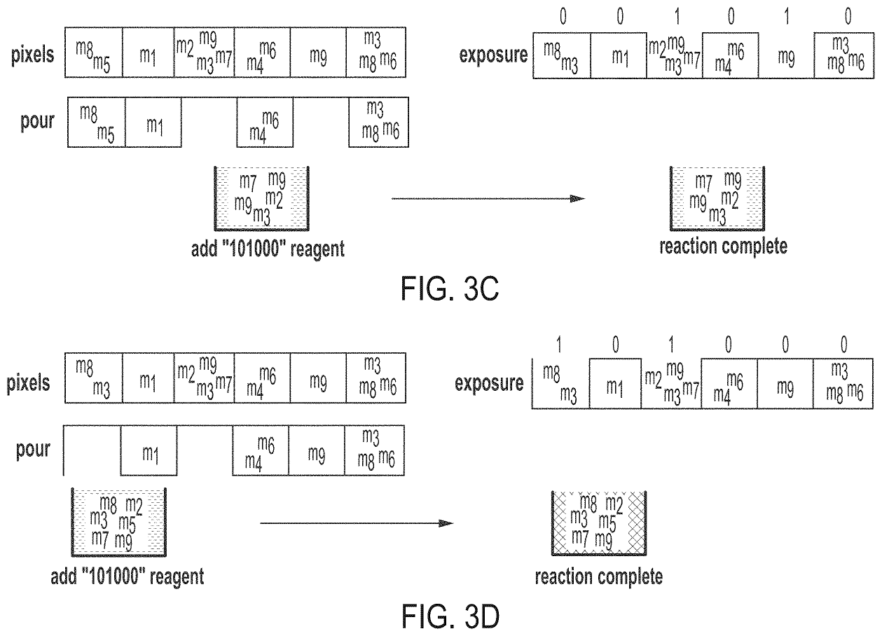

FIG. 3 is a cartoon representation of the chemical perceptron described in Theorem 1. Let us now consider the appropriate design of input mixtures to realize different perceptron weight-sets under the action of different reagents.

Designing the input composition, Θ. Assuming R-groups, molecules, and reagents have been chosen, one is then presented with at least two mathematical problems:
(a) How does one choose input mixture compositions to produce some desired weight pattern w₁?
(b) Because the ensemble of input mixture compositions represents real data, can one choose a single input mixture set where application of reagent
{Gₚ}, p=1, 2, . . . , P represent P different perceptrons with weight sets
{w_{P}}, p=1, 2, . . . , P?

Let weight set, wᵢ, corresponding to application of reagent Gᵢ:

$${y}_{i}^{⊤} R = {y}_{i}^{⊤} U Θ = [ {w}_{i 1} ⋯ {w}_{iJ} ] = {w}_{i}^{⊤}$$

First consider non-negative weight sets. Let w_{P} correspond to application of reagent G_{P} so that:

$${y}_{p}^{⊤} R - {y}_{p}^{⊤} U Θ - [ \begin{matrix}{w}_{p 1} & … & {w}_{pJ}\end{matrix} ] - {w}_{p}^{⊤}$$

Now, let:

$$Γ = [ \begin{matrix}{γ}_{1} & … & {γ}_{P}\end{matrix} ]$$

where P is the number of different perceptrons required of a given data set corresponding to the set of input mixtures, M₁, j=1, . . . , J. One then has:

$${Θ}^{⊤} {U}^{⊤} Γ = {R}^{⊤} Γ = [ \begin{matrix}{w}_{1} & … & {w}_{P}\end{matrix} ] = W \qquad [ Equation 6 ] [ Equation 20 ]$$

and then solves for Θ.

However, before considering specific approaches, some useful general observations can be made from the structure of [Equation 6] [Equation 20]. When any column of Γ, γ_{q} depends linearly on another set of columns { [symbol] }, set of constants { [symbol] } exists so:

$${γ}_{q} = {\sum }_{ℓ \neq q} {α}_{ℓ} {γ}_{ℓ}$$

By [Equation 5] [Equation 17]:

$${W}_{q} = {\sum }_{ℓ \neq q} {α}_{ℓ} {W}_{ℓ} \qquad [ Equation 7 ] [ Equation 21 ]$$

so that at least one of the weight sets that comprises W cannot be chosen independently from others.

Note:

$$R = [ \begin{matrix}{r}_{1} & … & {r}_{j}\end{matrix} ]$$

$${r}_{j} = [ \begin{matrix}{r}_{j} 1 \\ ⋮ \\ {r}_{j} R\end{matrix} ]$$

Theorem 2 (Independent Perceptron Limit): The number, P, of perceptrons that can be independently composed by choice of Θ is less than or equal to N, the number of R-groups.

Proof [Theorem 2]: By [Equation 7] [Equation 21], the number, P, of independent weight sets wₚ that can be composed by choice of Θ is upper-bounded by the number of independent [symbol] which is identically the column rank of Γ. The number of independent { [symbol] } is upper-bounded by the dimension, N, of the { [symbol] } which completes the proof.

U is fixed and Γ is a deterministic or random (with known density) vector. In either case, solution of (or approximation to) [Equation 5] [Equation 17] can be approached as an optimization over binary matrices {Θ} using some norm such as component-wise mean square error between Θ^{T}U^{T}Γ (or R^{T}Γ) and some target W. When the thresholding function ø(•) can be adjusted or when different thresholding functions −øᵢ(•) can be used after application of reagent Gᵢ then one can choose a set of nonzero constants {aₚ}, p=1, 2, P to relax [Equation 5] and obtain:

$${Θ}^{⊤} {U}^{⊤} Γ = {R}^{⊤} Γ = [ \begin{matrix}{α}_{1} {w}_{1} & … & {α}_{P} {w}_{P}\end{matrix} ] = WA , where \qquad [ Equation 8 ]$$

$$A = [ \begin{matrix}{α}_{1} & 0 & … & 0 \\ 0 & {α}_{2} & ⋱ & ⋮ \\ ⋮ & ⋱ & ⋱ & 0 \\ 0 & … & 0 & {α}_{P}\end{matrix} ]$$

Rewriting [Equation 8]:

$${Θ}^{⊤} {U}^{⊤} Γ = {R}^{⊤} Γ = WA \qquad [ Equation 9 ]$$

Theorem 3 (Chemical Perceptron): Assuming the presence or absence of each of an ensemble of molecular mixtures as binary inputs, x J, the scalar Tᵢ as given in Equation 5] [Equation 16] represents a chemical multiply accumulate operation on the x1 using weights WᵢJ 0. Applying a threshold operator ø( ) to Tᵢ results in the mathematical equivalent of the perceptron structure in FIG. 1.

Proof: [Theorem 3]: See the mathematical development leading to the statement of Theorem 2 and 3.

Accommodating positive and negative weights is straightforward because any weight vector w can be represented as:

$$w = {w}^{+} - {w}^{-} \qquad [ Equation 18 ]$$

where both w⁺ and w⁻ are non-negative as required by the development. One can therefore imagine:
One reagent G applied to two separate and different input mixture ensembles, e⁺ and e⁻.
Two regents G⁺ and G⁻ applied to duplicates of a single mixture ensemble 8.

In both cases one obtains indicators T⁺=x^{T}w⁺ and T⁻=x^{T}w⁻. so that:

$$T = {T}^{+} - {T}^{-} = {x}^{⊤} ( {w}^{+} - {w}^{-} ) {x}^{⊤} w \qquad [ Equation 19 ]$$

Before considering specific approaches, some useful general observations can be made from the structure of [Equation 6] [Equation 20]. When any column of Γ, γ_{q} depends linearly on another set of columns { [symbol] }, set of constants { [symbol] } exists so:

$${γ}_{q} = {\sum }_{ℓ \neq q} {α}_{ℓ} {γ}_{ℓ}$$

By [Equation 5]:

$${W}_{q} = {\sum }_{ℓ \neq q} {α}_{ℓ} {W}_{ℓ} \qquad [ Equation 7 ] [ Equation 21 ]$$

so that at least one of the weight sets that comprises W cannot be chosen independently from others.

Note:

$$R = [ \begin{matrix}{r}_{1} & … & {r}_{j}\end{matrix} ]$$

$${r}_{j} = [ \begin{matrix}{r}_{j} 1 \\ ⋮ \\ {r}_{j} R\end{matrix} ]$$

$${γ}_{q} = {\sum }_{ℓ \neq q} {α}_{ℓ} {γ}_{ℓ}$$

By [Equation 17], one must then have:

$${W}_{q} = {\sum }_{ℓ \neq q} {α}_{ℓ} {W}_{ℓ} \qquad [ Equation 21 ]$$

so that at least one of the weight sets that comprises W cannot be chosen independently from others. To state the implication of [Equation 21] as a theorem:

Theorem 4 (Independent Perceptron (Weight Set) Limit): The number, P, of weight sets that can be independently composed by choice of e is less than or equal to R, the number of R-groups.

Proof [Theorem 4): By [Equation 21], the number, P, of independent weight sets w_{P} that can be composed by choice of Θ is upper-bounded by the number of independent [symbol] which is identically the column rank of r. The number of independent { [symbol] } is in turn upper-bounded by the dimension, R, of the { [symbol] } which completes the proof.

U is fixed and F is a deterministic or random (with known density) vector. In either case, the solution of (or approximation to) [Equation 5] [Equation 17] can be approached as an optimization over binary matrices {e} using some norm such as component-wise total square error between Θ^{T}U^{T}Γ (or R^{T}Γ) and some target W. When the thresholding function ø(•) can be adjusted or when different thresholding functions ø₁(•) can be used after application of reagent G; then one can choose a set of nonzero constants {αₚ}, p=1, 2, . . . P to relax [Equation 17] and obtain:

$${Θ}^{⊤} {U}^{⊤} Γ = {R}^{⊤} Γ = [ \begin{matrix}{α}_{1} {w}_{1} & … & {α}_{P} {w}_{P}\end{matrix} ] = WA , where \qquad [ Equation 22 )$$

$$A = [ \begin{matrix}{α}_{1} & 0 & … & 0 \\ 0 & {α}_{2} & ⋱ & ⋮ \\ ⋮ & ⋱ & ⋱ & 0 \\ 0 & … & 0 & {α}_{P}\end{matrix} ] \qquad [ Equation 23 )$$

When only one threshold function ø(•) can be used, then one can choose arbitrary αₚ=α∈ [symbol] ⁺, p=1, 2, . . . P.

Rewriting [Equation 22] as:

$${Θ}^{⊤} {U}^{⊤} Γ = {R}^{⊤} Γ = WA \qquad [ Equation 24 ]$$

so that the total square error, e², between WA and its approximation Θ^{T}U^{T}Γ can be written

$${e}^{2} = Trace [ {( {Θ}^{⊤} {U}^{⊤} Γ - WA )}^{⊤} ( {Θ}^{⊤} {U}^{⊤} Γ - WA ) ] \qquad [ Equation 25 ]$$

which one can also write as

$${e}^{2} = Trace [ ( {Θ}^{⊤} {U}^{⊤} Γ - WA ) {( {Θ}^{⊤} {U}^{⊤} Γ - WA )}^{⊤} ] \qquad [ Equation 26 ]$$

because Trace[z^{T}zJ=Trace[zz^{T}J for any matrix Z. [Equation (25) and Equation (26) are definitions of the Frobenius norm |e^{T}u^{T}r−WA|_{f}²) When one then defines W′=WA, the optimization is:

$${d}_{o} = {min}_{( Θ , A )} Trace [ ( {Θ}^{⊤} {U}^{⊤} Γ - w ) {( {Θ}^{⊤} {U}^{⊤} Γ - w )}^{⊤} ] \qquad [ Equation 12 ] [ Equation 27 ]$$

One can also pursue a less constrained optimization over R:

$${d}_{R} = {min}_{( R , A )} Trace [ ( {R}^{⊤} Γ - w ) {( {R}^{⊤} Γ - w )}^{⊤} ] \qquad [ Equation 13 ] [ Equation 28 ]$$

because the possible R are constrained by the Θ, d_{θ}≤d_{R}.

While chemical realization constraints confine R and Θ to be non-negative matrices, nothing in the mathematical development precludes their having both positive and negative elements. Going forward, relax the non-negativity constraint and show how [Equation 18) can realize general weight sets with positive and negative elements.

Input composition optimization; optimization for fixed A. One first shows that for fixed A the minimizations [Equation 13] [Equation 28] and [Equation 12] Equation 27] are convex in continuous R and Θ, respectively, whether or not one restricts their component vectors to the non-negative orthant.

Theorem 5 (d_{R} and d_{θ}; convexity in R and Θ): When A is fixed, d_{R} and d_{θ} are convex optimizations in continuous R and Θ, respectively, over convex search spaces. d_{R} and d_{Θ} are strictly convex with unique solutions iff there are R linearly independent yield vectors, γₚ.

Proof [Theorem 5): Let A∈(0,1). When one sets R=λR₁+(1−λ)R₂, convexity of d_{R} requires

$$Trace [ ( {R}^{⊤} Γ - \tilde{W} ) {( {R}^{⊤} Γ - \tilde{W} )}^{⊤} ] \leq λ Trace [ ( {R}_{1}^{⊤} Γ - \tilde{W} ) {( {R}_{1}^{⊤} Γ - \tilde{W} )}^{⊤} ] + ( 1 - λ ) Trace [ ( {R}_{2}^{⊤} Γ - \tilde{W} ) {( {R}_{2}^{⊤} Γ - \tilde{W} )}^{⊤} ] \qquad [ Equation 29 ]$$

for any two different R₁ and R₂.

Strict convexity further requires equality iff A=0 or A=1. Expansion and rearrangement of [Equation 29] produces the inequality:

$$- λ ( 1 - λ ) Trace [ {( {R}_{1} - {R}_{2} )}^{⊤} {ΓΓ}^{⊤} ( {R}_{1} - {R}_{2} ) ] \leq 0 \qquad [ Equation 30 ]$$

which is satisfied because Trace[ZZ^{T}] 0 for any real matrix Z. Therefore, d_{R} is convex. Furthermore, d_{R} is strictly convex iff [symbol] has rank ′R, to preclude (R₁−R₂)^{TΓ}=0 for some choice of R₁≠R₂. [symbol] has rank [symbol] iff [symbol] [symbol] linearly independent γ_{P} which comprise r. The structure of d_{θ} is identical to that of d_{R}. So, assuming continuous Θ, the same argument for convexity of d_{θ} applies.

Finally, the rⱼ and θⱼ which comprise R and Θ, respectively, are confined to the non-negative orthant—a convex search space for R and Θ. When the positivity constraint on R and Θ is relaxed, the search space is still convex. Thus, d_{R} and d_{θ} are convex optimizations over convex spaces. Strict convexity implies unique solutions, thus completing the proof.

Because d_{R} and d_{θ} are convex, efficient numerical methods exist to find optimizing continuous R* and Θ*. Feasible solutions for [Equation 12] [Equation 27] and [Equation 13] [Equation 28] are integer matrices. But once continuous R* and Θ* are identified, the continuity of d_{R} and d_{θ} in their arguments allow us to examine feasible discrete solutions within the neighborhoods of R* and Θ*. The quality of these discrete solutions (essentially quantization) depends upon their coarseness regarding the metrics' variation in the continuous search space. Therefore, solutions can be improved through choice of A.

Choosing A. Consider R′ a continuous solution to [Equation 13] [Equation 28] for an arbitrary A which produces minimum error:

$${( {e}^{⋆} )}^{2} = Trace [ ( {( {R}^{⋆} )}^{⊤} Γ - \tilde{W} ) {( {( {R}^{⋆} )}^{⊤} Γ - \tilde{W} )}^{⊤} ]$$

Then, the integer approximation Ř* to R* is obtained by rounding. Define Δ so R*=Ř+Δ and note that each element of Δ cannot have magnitude larger than 1. Then consider that when W̌ is replaced by αW̌, the optimizing R* becomes α R* and the integer matrix solution obeys αR*=Ř+Δ. Applying Ř to [Equation 13] [Equation 28] produces:

$${e}^{2} = Trace [ ( {( {R}^{⋆} - \frac{Δ}{α} )}^{⊤} Γ - \tilde{W} ) {( {( {R}^{⋆} - \frac{Δ}{α} )}^{⊤} Γ - \tilde{W} )}^{⊤} ]$$

As α→∞, e²→(e*)². Thus, larger a produces better discrete approximation of R*. As [Equation 12] [Equation 27] is structurally equivalent to [Equation 13] [Equation 28], the same argument applies to integer approximations of Θ*. Therefore, one can seek continuous solutions to [Equation 12] [Equation 27] and [Equation 13] [Equation 28] for A=I and then scale its elements until performing the integer matrix approximation is sufficiently close to that of the optimal continuous solution, at least within practical limits of chemical mixture composition. The choice of the αₚ in [Equation 23] depends on the coarseness with which the corresponding R^{T}γₚ and Θ^{T}U^{T}γₚ approximate wₚ. The choice of the αₚ depends upon the coarseness with which the corresponding rₚ and θₚ approximate wₚ.

Optimization with random Γ. For the case of random equilibrium vectors γ_{P} the optimizations are still convex, as stated in the following lemma:

Lemma 1 (Random Γ): When r is random with mean f′ and correlation E[ΓΓ^{T}]=K_{Γ}, then the optimizations d_{R} and d_{θ} remain convex, and strictly convex iff the K_{Γ} is positive definite.

Proof [Lemma 1]: When the equilibrium vectors γₚ are random, the optimizations d_{R} and d_{θ} are replaced with optimizations of E[d_{R}] and E[d_{θ}] respectively. The optimizations are still convex because ΓΓ^{T} in the proof of Theorem 5 is replaced by the positive semi-definite correlation matrix E[ΓΓ^{T}]=K_{Γ} so that [Equation 30] is still satisfied. When K_{Γ} is positive definite (full rank) then the optimizations are strictly convex.

The inventors again formulate the optimization problem because one must understand how r randomness can affect perceptron performance. [Equation 13] [Equation 28] becomes

$$E [ {d}_{R} ] = {min}_{R , A} E [ Trace [ ( {R}^{⊤} Γ - \tilde{W} ) {( {R}^{⊤} Γ - \tilde{W} )}^{⊤} ] ] \qquad [ Equation 31 ]$$

Expanding and regrouping, one obtains

$$E [ {d}_{R} ] = {min}_{R , A} Trace [ {R}^{⊤} {C}_{Γ} R + ( {R}^{⊤} \tilde{Γ} - \tilde{W} ) {( {R}^{⊤} \tilde{Γ} - \tilde{W} )}^{⊤} ] \qquad [ Equation 32 ]$$

When one requires an unbiased W estimator, then the optimizing R* must obey:

$$E [ {( {R}^{⋆} )}^{⊤} Γ - \tilde{W} ] = {( {R}^{⋆} )}^{⊤} \overline{Γ} - \tilde{W} = 0$$

The optimization of [Equation 32] then becomes:

$$E [ {d}_{R} ] = {{min}_{R , A}}_{{R}^{⊤} \overline{Γ} = \tilde{W}} Trace [ {R}^{⊤} {C}_{Γ} R ] \qquad [ Equation 33 ]$$

Evaluating [Equation 32] with the optimum R* produces a minimum total squared weight error of:

$$E [ {d}_{R} ] = Trace [ {( {R}^{⋆} )}^{⊤} {C}_{Γ} {R}^{⋆} ] \qquad [ Equation 34 ]$$

The optimization in Θ [Equation 27] can be similarly formulated and a similar expression for E[d_{Θ}] derived.

Realization of Weight Sets With ±Values. While the chemistry precludes single-pot direct realization of W with negative weights (γ elements cannot be negative), the preceding mathematical development was general. When one allows two pots—one representing positive weights and the other representing negative weights as in [Equation 18] and [Equation 19]—one can realize general weight matrices by:
using one input mixture set and two reagents per perceptron, or
using two different input mixture sets and one reagent per perceptron.

Because reaction characterization could be time-intensive, one considers only the second possibility of duplicate multiple input mixtures.

Thus, let R=R⁺−R⁻ where the R^{±} are non-negative. Substituting R=R⁺−R⁻ into [Equation 28] produces:

$$Trace [ ( {( {R}^{+} - {R}^{-} )}^{⊤} Γ - \tilde{W} ) {( {( {R}^{+} - {R}^{-} )}^{⊤} Γ - \tilde{W} )}^{⊤} ] \qquad [ Equation 35 ]$$

Given the optimization of [Equation 28] is convex, the optimization in non-negative orthant R⁺ is convex for fixed R⁻, as is the optimization of non-negative orthant R⁻ for fixed R⁺. The joint optimization in R⁺ and R⁻ is convex. The same argument applies to the optimization of [Equation 27] for Θ=Θ⁺−Θ⁻.

To implement W with positive and negative values one can either find an unconstrained R which minimizes [Equation 28] and decompose it directly into non-negative R⁺ and R⁻ (as opposed to separately approximating W^{±} with non-negative R^{±} which in general could be suboptimal). Alternatively, one could:
fix R⁻(Θ⁻) and find the corresponding optimal non-negative R⁺(Θ)⁺)
fix R⁺(Θ⁺) and find the corresponding optimal non-negative R⁻(Θ⁻)
repeat until convergence.

Direct decomposition is efficient while iterative search can allow additional chemistry-related constraints to be applied to where the [symbol] ^{±} separately.

Noisy Weight Sets. Weight approximation can be coarse and chemical reactions are stochastic processes. Thus, R^{T}r realization may not be identically equal to the target W owing to approximation error, yield randomness, or both causes. The weights can likely be noisy and such noise can cause misclassification of inputs.

Assuming a simple weight noise model and an equally simple binary classification problem, one can derive an expression for the excess error imposed by noisy weights.

To begin, consider that a perceptron distinguishes between two classes A and B by the decision rule:

$${x}^{⊤} w \begin{matrix}A \\ ≷ \\ B\end{matrix} β \qquad [ Equation 36 ]$$

Where β∈E [symbol] is some threshold. With no loss of generality, assume β=0. Thus, the weight set vector w defines a plane:

$${x}^{⊤} w = 0 \qquad [ Equation 37 ]$$

above or below which one assign inputs to A and B, respectively. The {x} which satisfy [Equation 37] are orthogonal to w. Thus, the vector:

$$\hat{p} = \frac{w}{\vert w \vert}$$

is exactly the unit normal to the decision plane, P, and a given input's distance to P is then:

$$d ( x , P ) = {x}^{⊤} \hat{p}$$

When the training set inputs are drawn from the following simple i.i.d. Gaussian distributions centered on ±z as in:

$${f}_{X} ( x \vert A ) = {( \frac{1}{\sqrt{2 {πσ}^{2}}} )}^{J} {e}^{- \frac{{\vert x - z \vert}^{2}}{2 {σ}^{2}}} , and \qquad [ Equation 38 ]$$

$${f}_{X} ( x \vert B ) = {( \frac{1}{\sqrt{2 {πσ}^{2}}} )}^{J} {e}^{- \frac{{\vert x + z \vert}^{2}}{2 {σ}^{2}}} \qquad [ Equation 39 ]$$

where z=bp, b>0 being a measure of how distinguishable the hypotheses are.

When the hypotheses are equiprobable, the optimal decision rule for guessing A or B is exactly [Equation 3] and the irreducible probability of classification error is:

$${P}_{e} = \frac{1}{\sqrt{2 π}} {\int }_{\frac{b}{σ}}^{∞} {e}^{- {s}^{2} / 2} ds ≡ Q ( \frac{b}{σ} ) \qquad [ Equation 40 ]$$

One defines the ratio b/σ as the classification signal-to-noise ratio, χ.

For simplicity, the weight set is perturbed by a zero mean i.i.d. Gaussian noise vector n, each element of variance N₀. Then the perturbed weight set w is:

$${f}_{N} ( n ) = {( \frac{1}{\sqrt{2 π {N}_{0}}} )}^{J} {e}^{- \frac{{\vert n \vert}^{2}}{2 {N}_{0}}} \qquad [ Equation 41 ]$$

The perturbation effectively rotates the nominal decision plane so given n, the probability of error becomes:

$${P}_{e \vert n} = \frac{1}{2} {\int }_{{x}^{⊤} ( w + n ) < 0} {( \frac{1}{\sqrt{2 {πσ}^{2}}} )}^{J} {e}^{- \frac{{\vert x - z \vert}^{2}}{2 {σ}^{2}}} dx + \frac{1}{2} {\int }_{{x}^{⊤} ( w + n ) > 0} {( \frac{1}{\sqrt{2 {πσ}^{2}}} )}^{J} {e}^{- \frac{{\vert x + z \vert}^{2}}{2 {σ}^{2}}} dx \qquad [ Equation 42 ]$$

However, taking the decision plane perspective, one sees that noise rotates the antipodal points±z regarding the decision plane. Symmetry (noise and point set) dictate that the probability of misclassification depends only on the distance between the points±z and the noisy plane P′:

$$d ( z , {P}^{′} ) = {z}^{⊤} {\hat{p}}^{′} , where {\hat{p}}^{′} = \frac{\tilde{w}}{\vert \tilde{w} \vert} .$$

And such rotation can only increase the probability of misclassification.

Therefore, the probability of misclassification becomes above or below which one assigns inputs to A and B, respectively. The {x} which satisfy [Equation 37] are orthogonal to w. Thus, the vector is exactly the unit normal to the decision plane, P, and a given input's distance to P.

The probability of misclassification becomes:

$${P}_{e \vert n} = Q ( \frac{{z}^{⊤} {\hat{p}}^{′}}{σ} ) = Q ( x ( \frac{\vert w \vert + {w}^{⊤} \frac{n}{\vert w \vert}}{\vert w + n \vert} ) ) \qquad [ Equation 43 ]$$

Rewriting:

$$\frac{\vert w \vert + {w}^{⊤} \frac{n}{\vert w \vert}}{\vert w + n \vert} = \frac{1 + {\hat{p}}^{⊤} \frac{n}{\vert w \vert}}{\vert \hat{p} + \frac{n}{\vert w \vert} \vert} ,$$

and then noting that because |\hat{p}^{T}n|≤|n|′,

$${( \frac{1 + {\hat{p}}^{⊤} \frac{n}{\vert w \vert}}{\vert \hat{p} + \frac{n}{\vert w \vert} \vert} )}^{2} = \frac{1 + 2 \frac{{\hat{p}}^{⊤} n}{\vert w \vert} + \frac{{( {\hat{p}}^{⊤} n )}^{2}}{{\vert w \vert}^{2}}}{1 + 2 \frac{{\hat{p}}^{⊤} n}{\vert w \vert} + \frac{{\vert n \vert}^{2}}{{\vert w \vert}^{2}}} \leq 1 ,$$

one can define:

$$δ ( n ) = \frac{1 + {\hat{p}}^{⊤} \frac{\vert n \vert}{\vert w \vert}}{\vert \hat{p} + \frac{n}{\vert w \vert} \vert} \qquad [ Equation 44 ]$$

as the excess error factor which multiplies the minimum error coefficient x so that:

$${P}_{e \vert n} = Q ( {x}^{δ} ( n ) )$$

P_{e|n} is minimized when σ(n)=1, maximized when σ(n)=−1, and for σ(n)=0, classification is random (P_{e|n}=0.5).

Because of noise symmetry, one can with no loss of generality set w=|w|e₁ where eₖ is the k^{th} canonical unit vector with 1 in the k^{th} dimension and zero elsewhere. [For exquisite classification (x=8), weight imprecision much beyond 9% results in poor performance. However, when the perceptron is only 98% accurate to start (x=2), then only 25% weight precision is necessary.] One then has p=e₁ so that:

$${P}_{e \vert n} = Q ( x ( \frac{1 + \frac{{n}_{1}}{\vert w \vert}}{\vert {e}_{1} + \frac{n}{\vert w \vert} \vert} ) ) \qquad [ Equation 45 ]$$

where n₁ is the first component of n. The magnitude term in the denominator of [Equation 45] can then be written as:

$${\vert {e}_{1} + \frac{n}{\vert w \vert} \vert}^{2} = [ {( 1 + \frac{{n}_{1}}{\vert w \vert} )}^{2} + {\sum }_{j = 2}^{J} {( \frac{{n}_{j}}{\vert w \vert} )}^{2} ]$$

However, for very large J, the law of large numbers implies that:

$$\frac{1}{J} {\vert {e}_{1} + \frac{n}{\vert w \vert} \vert}^{2} \approx \frac{1}{J} {( 1 + \frac{{n}_{1}}{\vert w \vert} )}^{2} + \frac{{N}_{0}}{{\vert w \vert}^{2}} ,$$

so that when one defines:

$${ξ}^{2} = \frac{{\vert w \vert}^{2}}{E [ {\vert n \vert}^{2} ]} = \frac{{\vert w \vert}^{2}}{{JN}_{0}} ,$$

then

$$\frac{\frac{1}{J} {( 1 + \frac{{n}_{1}}{\vert w \vert} )}^{2}}{\frac{1}{J} {\vert {e}_{1} + \frac{n}{\vert w \vert} \vert}^{2}} \approx \frac{{( 1 + \frac{{n}_{1}}{\vert w \vert} ) )}^{2}}{{( 1 + \frac{{n}_{1}}{\vert w \vert} )}^{2} + \frac{1}{{ξ}^{2}}} ,$$

so, the overall expected probability of error owing to weight approximation noise is roughly:

$${P}_{e}^{′} \approx {( \frac{{ξ}^{2}}{2 π} )}^{1 / 2} {\int }_{- ∞}^{∞} Q ( \frac{x ( 1 + x )}{\sqrt{{( 1 + x )}^{2} + \frac{1}{{ξ}^{2}}}} ) {e}^{- \frac{{x}^{2} {ξ}^{2}}{2}} dx \qquad [ Equation 46 ]$$

One can also apply [Equation 46] when weight uncertainty is owed to stochastic reactivity rather than quantization (or other estimation) error. When Γ is a random matrix, the total square error from [Equation 34] provides a measure of how well the perceptron implementation is likely to perform. When one equates E|d_{R}|+PJN₀, and define the average weight energy as:

$${\vert \overline{w} \vert}^{2} = \frac{1}{P} {\sum }_{p = 1}^{P} {\vert {w}_{p} \vert}^{2} = \frac{1}{P} {\vert W \vert}_{f}^{2} ,$$

then one can write

$${ξ}^{2} = \frac{{\vert W \vert}_{f}^{2}}{Trace [ {( {R}^{*} )}^{⊤} {C}_{Γ} {R}^{*} ]} \qquad [ Equation 47 ]$$

and use [Equation 46] as a performance predictor of chemical perceptron realizations with random yield matrices as well input composition construction imprecision.

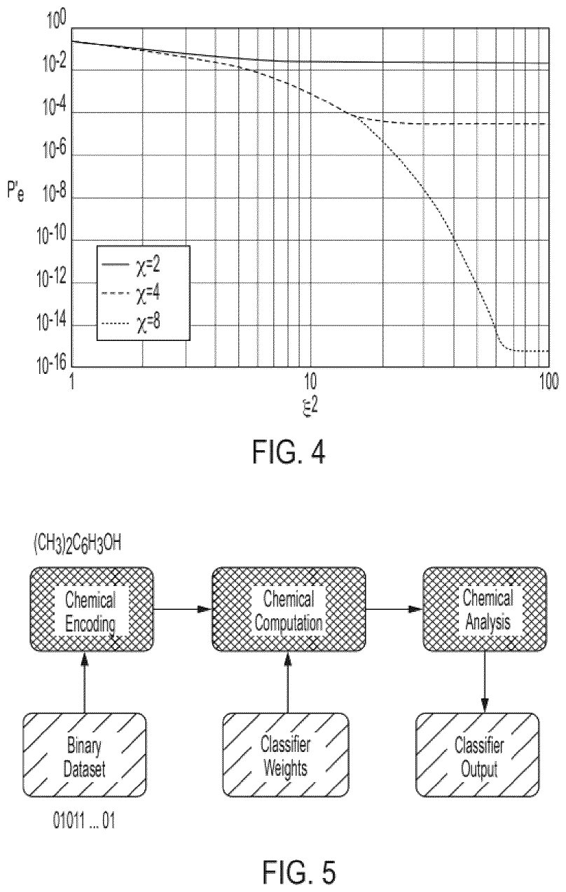

Plots of [Equation 46] are provided in FIG. 4, where performance degradation depends on the baseline (zero weight noise) reliability of the given perceptron. For instance, for exquisite classification (x=8), weight imprecision much beyond 9% results in poor performance. When the perceptron is only 98% accurate to start (x=2), then only 25% weight precision is necessary.

Thus, [Equation 46] serves both as a guide for the choice of A to keep quantization noise within accept-able bounds, and as an indicator of achievable performance when reaction yields are uncertain.

Numerical example. For a two-perceptron system based on 8 available R-groups and two reagents G₁ and G₂ with reaction product matrix Γ:

$$Γ = [ \begin{matrix}\frac{1}{8} & \frac{1}{4} & \frac{3}{8} & \frac{1}{2} & \frac{5}{8} & \frac{3}{4} & \frac{7}{8} & 1 \\ 1 & \frac{7}{8} & \frac{3}{4} & \frac{5}{8} & \frac{1}{2} & \frac{3}{8} & \frac{1}{4} & \frac{1}{8}\end{matrix} ]$$

The Γ is illustrative, but exact Γ values may be taken from the literature for different types of reactions. Then assume that molecules mₘ are 2-mers with distinct R-groups, so that the total number of different molecules is 28 (i.e., ₂⁸) and the total number of (non-zero) mixtures is 2²⁸−1.

A weight matrix for 4-input perceptrons with values chosen randomly between zero and one can be:

$${( W )}^{⊤} = [ \begin{matrix}0.4 & 0.76 & 0.5 & 0.39 \\ 0.77 & 0.55 & 0.12 & 0.68\end{matrix} ]$$

Numerically solving the implicit quadratic programming problem of [Equation 13] [Equation 28] with A=I yields:

$${R}^{*} = [ \begin{matrix}0.462 & 0.013 & 0 & 0.294 \\ 0 & 0.356 & 0 & 0.0125 \\ 0.129 & 0.0005 & 0 & 0.0074 \\ 0.046 & 0.0001 & 0 & 0.516 \\ 0.2799 & 0.238 & 0 & 0.0635 \\ 0.0968 & 0.014 & 0.009 & 0.00005 \\ 0.0193 & 0.261 & 0.39 & 0.055 \\ 0.00595 & 0.281 & 0.152 & 0.0005\end{matrix} ] ,$$

so that:

$${\hat{W}}^{⊤} = [ \begin{matrix}0.3995 & 0.759488 & 0.5 & 0.389 \\ 0.769319 & 0.549563 & 0.119875 & 0.678569\end{matrix} ]$$

Producing the integer matrix approximation to R* is then a matter of scaling. Scaling by 10⁵ can produce the same precision as the original in this EXAMPLE, though scaling by a smaller number may also provide sufficient weight approximation given the robustness of neural networks.

When the number of R-groups is set at [symbol] =10, the number of perceptron inputs J=10 and the number of perceptrons P=2. Then, for the following J×P weight matrix W, each element chosen i.i.d. N (0, 1):

$$W = [ \begin{matrix}0.78 & 1.368 \\ 1.743 & 0.387 \\ - 0.101 & 0.078 \\ 0.627 & 0.453 \\ - 0.866 & - 1.16 \\ - 1.45 & - 0.297 \\ - 2.847 & 0.222 \\ 1.851 & - 2.177 \\ 0.867 & 0.744 \\ 0.372 & 0.291\end{matrix} ]$$

Reagent yield matrix Γ, each element chosen i.i.d. from a uniform distribution on (0,1):

$$Γ = [ \begin{matrix}0.613 & 0.426 \\ 0.287 & 0.703 \\ 0.836 & 0.91 \\ 0.098 & 0.068 \\ 0.653 & 0.707 \\ 0.13 & 0.183 \\ 0.544 & 0.617 \\ 0.897 & 0.01 \\ 0.962 & 0.862 \\ 0.219 & 0.648\end{matrix} ]$$

Numerical calculation of the optimal continuous [symbol] ^{±} according to [Equation 35] (shown here to three decimal places) yields:

$${( {R}^{+} )}^{⊤} = [ \begin{matrix}0.078 & 0.372 & 0.324 & 0.012 & 0.251 & 0.078 & 0.228 & 0 & 0.251 & 0.358 \\ 0.365 & 0 & 0.183 & 0.059 & 0.145 & 0 & 0.094 & 1.123 & 0.387 & 0 \\ 0 & 0.051 & 0.01 & 0 & 0.007 & 0.008 & 0.01 & 0 & 0 & 0.063 \\ 0.108 & 0.022 & 0.13 & 0.017 & 0.101 & 0.018 & 0.083 & 0.195 & 0.16 & 0.01 \\ 0 & 0 & 0 & 0 & 0 & 0 & 0 & 0.088 & 0 & 0 \\ 0 & 0.271 & 0 & 0 & 0 & 0.011 & 0 & 0 & 0 & 0.298 \\ 0 & 0.877 & 0 & 0 & 0 & 0.078 & 0 & 0 & 0 & 0.929 \\ 0.573 & 0 & 0 & 0.094 & 0 & 0 & 0 & 2.921 & 0.244 & 0 \\ 0.142 & 0.081 & 0.203 & 0.023 & 0.158 & 0.033 & 0.133 & 0.101 & 0.228 & 0.065 \\ 0.063 & 0.023 & 0.081 & 0.01 & 0.064 & 0.012 & 0.053 & 0.1 & 0.096 & 0.016\end{matrix} ] and$$

$${( {R}^{-} )}^{⊤} = [ \begin{matrix}0 & 0 & 0 & 0 & 0 & 0 & 0 & 0.295 & 0 & 0 \\ 0 & 0.313 & 0 & 0 & 0 & 0.011 & 0 & 0 & 0 & 0.345 \\ 0.028 & 0 & 0 & 0.005 & 0 & 0 & 0 & 0.132 & 0.016 & 0 \\ 0 & 0 & 0 & 0 & 0 & 0 & 0 & 0 & 0 & 0 \\ 0.112 & 0.259 & 0.287 & 0.018 & 0.223 & 0.062 & 0.197 & 0 & 0.255 & 0.243 \\ 0.306 & 0 & 0.147 & 0.049 & 0.117 & 0 & 0.074 & 0.951 & 0.321 & 0 \\ 0.658 & 0 & 0.125 & 0.107 & 0.104 & 0 & 0.021 & 2.405 & 0.578 & 0 \\ 0 & 1.441 & 0.331 & 0 & 0.249 & 0.192 & 0.302 & 0 & 0 & 1.475 \\ 0 & 0 & 0 & 0 & 0 & 0 & 0 & 0 & 0 & 0 \\ 0 & 0 & 0 & 0 & 0 & 0 & 0 & 0 & 0 & 0\end{matrix} ]$$

Note that:

$${W}^{+} = [ \begin{matrix}0.78 & 1.368 \\ 1.743 & 0.387 \\ 0 & 0.078 \\ 0.627 & 0.453 \\ 0 & 0 \\ 0 & 0 \\ 0 & 0.222 \\ 1.851 & 0 \\ 0.867 & 0.744 \\ 0.372 & 0.291\end{matrix} ]$$

differs from:

$${( {R}^{+} )}^{⊤} Γ = [ \begin{matrix}1.044 & 1.371 \\ 1.91 & 0.832 \\ 0.051 & 0.106 \\ 0.627 & 0.453 \\ 0.079 & 0.001 \\ 0.144 & 0.385 \\ 0.465 & 1.233 \\ 3.217 & 0.49 \\ 0.867 & 0.744 \\ 0.372 & 0.291\end{matrix} ]$$

although there may exist some R^{±} which separately provide good approximations to W^{±} besides providing jointly good approximations to W.

Then, consider the weight estimation accuracy |RTΓ−W|_{f}² for different R precisions and the corresponding ζ2 as shown in TABLE 1. According to FIG. 4 (via [Equation 46]), multiplying W by 100 (A=102I) and rounding the optimal R± results to the nearest integer would yield an accurate integer implementation of perceptrons designed for high quality classification.

TABLE I

| R^{±}-precision | \|R^{T}Γ − W\|_{f}² | ξ² |
|---|---|---|
| Full | 2.1 × 10⁻³⁰ | 1.4 × 10³¹ |
| 3 decimal digit | 5.5 × 10⁻⁶ | 5.2 × 10⁶ |
| 2 decimal digit | 4.4 × 10⁻⁴ | 6.5 × 10⁴ |

Weight error and ξ² for different precision approximations to the optimal continuous R.

Now consider Θ^{±} which is produced by assuming each molecule is formed with 4 of 10 different R-groups for a total of 210 molecules. Then, compose the binary (10×210) matrix U to obtain the least squares solution to [Equation 27].

TABLE 2 is the analog to TABLE 1 for different precision Θ^{±} derived from the continuous Θ. Here, according to FIG. 4 (via [Equation 46]), multiplying W by 1000 (A=10³I) and rounding the optimal Θ result to the nearest integer would yield an accurate integer implementation of perceptrons designed for near perfect classification. Then, attribute the poorer precision tolerance of Θ relative R to the granularity induced by the relative paucity of different molecules (210) in this 10 R-group construction.

TABLE II

| Θ^{±}-precision | \|Θ^{T}U^{T}Γ − W\|_{f}² | ξ² |
|---|---|---|
| Full | 1.1 × 10⁻²⁹ | 4.8 × 10²⁹ |
| 3 decimal digit | 2.5 × 10⁻³ | 1.1 × 10⁴ |
| 2 decimal digit | 2.5 | 11 |

Weight error and ξ² for different precision approximations to the optimal continuous Θ.

### Example 2

Parallelized Linear Classification with Volumetric Chemical Perceptrons

Introduction and summary. This EXAMPLE 2 introduces a linear classifier that is implemented in a chemical form. This EXAMPLE 2 also discloses an encoding technique that simultaneously represents multiple datasets in an array of microliter-scale chemical mixtures. Parallel computations on these datasets are performed as robotic liquid handling sequences. These outputs are analyzed by high-performance liquid chromatography.

This invention combines aspects of chemical and electrical information systems. Paired with appropriate chemical analysis tools, this approach can operate with increasingly parallel datasets. This invention provides computational efficiency and massive parallelism comes with computing in chemical domains.

For more information, see Arcadia et al., Proceedings of the IEEE Conference on Rebooting Computing (ICRC) (2018), which is incorporated by reference.

This EXAMPLE 2 presents a method for implementing linear classification operations using chemical mixtures. Binary input data is encoded in the chemical composition of an array of liquid samples, and a robotic fluid handler is programmed to perform multiplications and additions as fractional volume transfers and pooling operations. The chemical coding enables parallel computation and allows for increased information density. The result of the volumetric operations is represented in the concentration of chemicals in output pools, which are analyzed using high performance liquid chromatography. The inventors used this system for parallel classification of several 16×16 binary MNIST images of handwritten digits (see, LeCun et al., Proceedings of the IEEE, 86(11), 2278-2324 (1998)), as well as a set of pseudo-random binary vectors. Thus, the inventors demonstrated the overall accuracy of the method, producing 55 correct classifications out of 57 tests.

This EXAMPLE 2 provides a class of chemical-domain computational engines which can operate on increasingly parallel datasets. Chemical computation can find applications in ultra-low-power systems, extreme environments, and as complements to electronic computing systems. Adleman, Science, 266(5187), 1021-1024 (1994). DNA archival data storage can complement traditional electronic media. See, Church, Gao, & Kosuri, Science, 337(6102), 1628 (September 2012); Bornholt et al., ACM SIGOPS Operating Systems Review, 50(2), 637-649, (2016); and Goldman et al., Nature, 494(7435), 77 (2013). Neural-inspired computing provided the ability for those skilled in the molecular computing art to process large datasets. See, Krizhevsky et al., Advances in Neural Information Processing systems, (2012), pp. 1097-1105; Graves et al., Acoustics, Speech and Signal Processing (ICASSP), 2013 IEEE International Conference on. IEEE (2013), pp. 6645-6649; Lawrence et al., IEEE Transactions on Neural Networks, 8(1), 98-113 (1997); Tann et al., Flexible deep neural network processing, arXiv, 2018. Chemical-domain computation thus provides an advantageous ways of leveraging the information processing capabilities of natural elements.

An electrical system cannot fully recreate the massive parallelism and emergent properties that come from the diversity of subtle molecular interactions and coexistence of thousands of unique chemical compounds. See, Rose et al., 2018 IEEE International Symposium on Information Theory (ISIT), (June 2018), pp. 2236-2240 [EXAMPLE 1]; Kennedy et al., Applied Physics Letters, 112(26), 264103 (2018); Huang et al., Sensors and Actuators B: Chemical, 239, 704-710 (2017); Salehi et al., IEEE Transactions on Molecular, Biological and Multi-Scale Communications, 1(3), 249-264 (2015). See also, Erlich & Zielinski, Science, 355(6328), 950-954 (2017); Shipman et al., Nature, 547(7663), 345 (2017). Organick et al., Nature Biotechnology, 36(3); 242 (2018).

Accordingly, this EXAMPLE 2 is directed toward develop a computational framework to concurrently process digital information represented in solutions of chemical compounds. This EXAMPLE 2 provides methods for chemical encoding, computation, and readout.

This EXAMPLE 2 also provides an approach to computing with chemical solutions. This EXAMPLE 2 provides a method to encode binary data into the chemical composition of liquid samples. This EXAMPLE 2 provides shows that multiple datasets can be stored in parallel with multiple coexisting chemicals.

This EXAMPLE 2 uses programmable robotic liquid handling sequences to perform volumetric multiply accumulate (MAC) operations on parallelized chemical datasets. This EXAMPLE 2 uses high-performance liquid chromatography to read and verify the results of the chemical calculations. This EXAMPLE 2 provides a description of the system developed to perform these functions.

This EXAMPLE 2 demonstrates linear classification of several MNIST images and Boolean test vectors. This EXAMPLE 2 demonstrates the chemically encoding of several images of handwritten digits from the MNIST database and implements several single layer volumetric chemical perceptrons which successfully classify the images. This EXAMPLE 2 additionally quantifies the performance of the method with a larger set of binary vectors.

This EXAMPLE 2 provides ways to scale and extend the chemical computation scheme.

This EXAMPLE 2 is intended as an advance towards realizing general-purpose chemical-domain computational tools. By demonstrating that the proposed method can reliably perform these operations, chemical mixtures are shown to provide an interesting basis for alternative computing.

Mass conservation in chemical mixtures. When working with well-mixed solutions and there are no chemical reactions in these solutions, then the simplest constraint is the conservation of mass. When two or more volumes containing the same chemical are combined, the final mixture can have a concentration that is a linear function of the concentrations of that chemical in each of the sources.

When a mixture of N sources, each containing a concentration Cᵢ of a certain chemical, is formed by transferring a volume Vᵢ from each source to a common destination, then the final concentration can be given as:

$${C}_{f} = {\sum }_{i = 1}^{N} \frac{{V}_{i}}{{V}_{f}} \cdot {C}_{i} \qquad [ Equation A ]$$

where Vᵢ·Cᵢ is the total mass of the chemical added to the destination and V_{f} is the final total volume in the destination. Compare this [Equation A] to [Equation I]. This [Equation A] can be extended through linear superposition to mixtures of different chemical species if they do not interact with each other. This simple relationship forms the basis for parallel chemical computation.

Analogies between electrical and chemical domains. In TABLE 3, ANALOGIES BETWEEN ELECTRICAL AND CHEMICAL DOMAINS, the parameters of a chemical mixture-based system relate to familiar electrical terms. An advantage of data storage and processing with chemicals is the parallelism that can be achieved by operating with multiple coexisting chemical species.

ANALOGIES BETWEEN ELECTRICAL AND CHEMICAL DOMAINS

| Domain | Electrical | Chemical |
|---|---|---|
| Information Carrier | Electrons | Molecules |
| Digital ‘1’ | High Voltage | High Concentration |
| Digital ‘0’ | Low Voltage | Low Concentration |
| Transport Medium | Conductor | Solvent |

This potential is realized in many biological contexts, such as in bacterial communication [Taga & Bassler, Proceedings of the National Academy of Sciences, U.S.A., 100(suppl. 2), 14549-14554, (2003)] and neural signaling [Bloom, American Journal of Physiology-Cell Physiology, 246(3), C184-C194 (1984)]. Another benefit of chemical data storage is its potentially high information density, as has been noted for DNA [Church et al, Science, p. 1226355 (2012); Bornholt et al., ACM SIGOPS Operating Systems Review, 50(2), 637-649 (2016)].

The advantages of computing with chemical mixtures stem from the ability for many datasets to coexist in parallel. In the case of overlaid chemical images, any operation on a single well can simultaneously be applied to the corresponding pixel in all images. As such, this encoding scheme can support massively parallel storage and computation.

TABLE 4, COMPUTATIONAL COST OF CLASSIFYING M BINARY INPUTS, EACH CONTAINING N BITS, IN A TRADITIONAL VERSUS VOLUMETRIC PERCEPTRON shows a comparison of the number of operations for a perceptron with a traditional computer versus the proposed mixture-based technique. The number of operations to be performed with chemical mixtures scales only with the number of input features and is independent of the number of input instances.

| | Scalar Single | Parallel Chemical |
|---|---|---|
| Operations | Core Silicon | Mixtures |
| Additions | M · N − 1 | N |
| Multiplications | M · N | |
| Total | 2 · M · N − 1 | N |

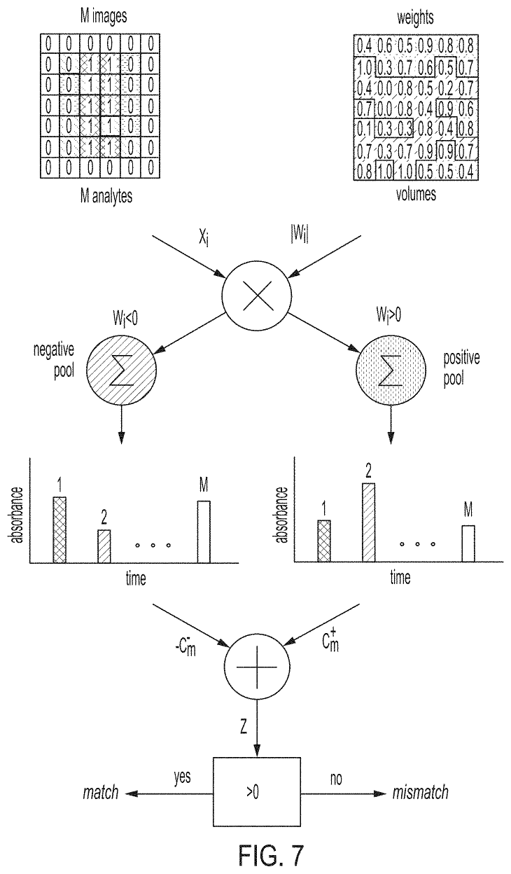

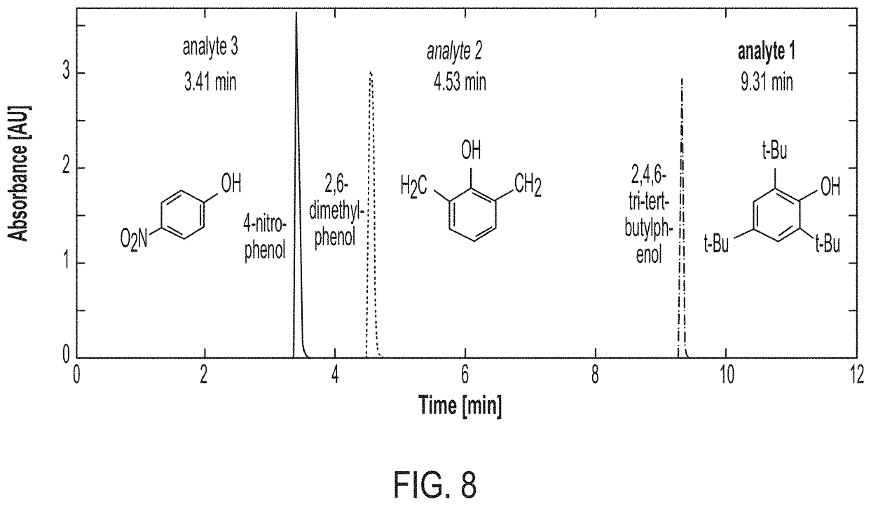

Computing with chemical mixtures. FIG. 7 shows the computational scheme for the proposed chemical mixture based perceptron. The perceptron weights (wᵢ∈[−1, 1]) are scaled to correspond to a maximum volume Vₒ, which is chosen based on the available volume in the data wells. Because one can only transfer positive liquid volumes, the inventors pool wells with positive and negative weights in two separate MAC operations.

The total volume transferred from the i^{th} well can be: Vᵢ=|wᵢ|·Vₒ. The scaling of the transfer volume represents a multiplication and the pooling of volumes into a common well represents an addition. Because bits from different datasets may be stored in the same well, these pooling operations allow for parallel multiply accumulate operations on all concurrently stored datasets. There is zero marginal computational cost to increasing parallelism, because, regardless of the complexity of the chemical mixtures, one can perform the pooling transfers once. To show that the system shown in FIG. 7 realizes the perceptron classifier, it is instructive to work backwards from the output of the system. One can write the output for the data represented by molecular species m as:

$${z}_{m} = Δ {C}_{m} = {C}_{m}^{+} - {C}_{m}^{-} \qquad [ Equation B ]$$

where Cₘ⁺ and Cₘ⁻ are the concentrations of species m in the positive and negative weight pools, respectively. According to [Equation A] the concentration of molecule m at the output of each MAC can be expressed as:

$${C}_{m}^{+} = {\sum }_{\begin{matrix}i = 1 \\ {w}_{i} > 0\end{matrix}}^{N} \frac{{V}_{i}}{{V}_{p}^{+}} \cdot {C}_{mi} = {\sum }_{\begin{matrix}i = 1 \\ {w}_{i} > 0\end{matrix}}^{N} \frac{\vert {w}_{i} \vert \cdot {V}_{o}}{{V}_{p}^{+}} \cdot {C}_{mi} , and \qquad [ Equation C ]$$

$${C}_{m}^{-} = {\sum }_{\begin{matrix}i = 1 \\ {w}_{i} < 0\end{matrix}}^{N} \frac{\vert {w}_{i} \vert \cdot {V}_{o}}{{V}_{p}^{-}} \cdot {C}_{mi} \qquad [ Equation D ]$$

where Vₚ⁺ and Vₚ⁻ are the total volumes in each pool, i is the index of the data well, Vᵢ=|wᵢ|·Vₒ is the weighted volume transferred from the i^{th} well, and Cₘᵢ is the concentration of molecule m in the i^{th} well. One can then expand [Equation B] as:

$${z}_{m} = {\sum }_{\begin{matrix}i = 1 \\ {w}_{i} > 0\end{matrix}}^{N} \frac{\vert {w}_{i} \vert \cdot {V}_{o}}{{V}_{p}^{+}} \cdot {C}_{mi} - {\sum }_{\begin{matrix}i = 1 \\ {w}_{i} < 0\end{matrix}}^{N} \frac{\vert {w}_{i} \vert \cdot {V}_{o}}{{V}_{p}^{-}} \cdot {C}_{mi} \qquad [ Equation E ]$$

If the pooled volumes are intentionally set to be equal after weighted pooling (V⁺=V⁻=Vₚ), by appropriately adding pure solvent, one can collect the summations as:

$${z}_{m} = {\sum }_{i = 1}^{N} \frac{{w}_{i} \cdot {V}_{o}}{{V}_{p}} \cdot {C}_{mi} = {\sum }_{i = 1}^{N} {w}_{i} \cdot {x}_{mi} \qquad [ Equation F ]$$

where the features have been defined to be the scaled data [pixel] concentrations: xₘᵢ=(V₀/V_{P})·cₘᵢ. This yields the original form of the pre-classification output.

Reading the Results of Chemical Mixture Computations. To verify the output of the computations, one can determine the amount of each component present in the liquid samples. The inventors used high performance liquid chromatography (HPLC). A liquid sample is injected into a stream of solvents known as the mobile phase. The mobile phase, now containing the sample to be analyzed, flows through a column containing a solid adsorbent, the stationary phase. Components in the sample interact with the adsorbent to varying degrees based on their chemical properties, causing different chemicals to leave the column (to ‘elute’), at different times. These retention times are used to identify individual components. When a compound that absorbs UV light elutes from the column and passes the detector, a peak in optical absorbance is observed, and the area of this peak is proportional to the relative abundance of the compound in the sample. The resulting absorbance time series, known as a chromatogram, can be used to both identify and quantify the chemicals in a mixture.

The laboratory setup and data flow used for the assays in this EXAMPLE 2. Weight matrices were trained in simulation and then converted, along with test data, into sequences of pipetting instructions for a robotic liquid handler. Analytes were dispensed into a 384-well microplate to form the chemical dataset and then collected in volume fractions corresponding to the classifier weight matrix. The outputs were analyzed by HPLC to produce class labels.

Operational setup. Binary input data and classifier weights are first trained through simulations on a desktop computer, in a Python environment. Before chemically encoding the input data, concentrated stock solutions are prepared of each analyte, at 62.5 mg/mL in dimethyl sulfoxide (DMSO, Macron Fine Chemicals 4948-02). To write the chemical data to a 384-well plate, the binary datasets are converted to pipetting instructions for a fluid handling robot (Andrew Alliance 1000G pipetting robot). For each input data bit whose value is ‘1’, the robot is instructed to transfer 20 μL of the corresponding analyte to the appropriate well. When the input data is ‘0’, it transfers 20 μL of dimethyl sulfoxide solvent instead. After the chemical datasets are created, the classifier weights are converted into additional pipetting instructions which the robot uses to perform the weighted-summation operations, placing the pooled outputs into an empty well plate.

Weighted pools. After the positive and negative weight pools are generated, each output is analyzed using high performance liquid chromatography (HPLC). The analytes representing each dataset exit the instrument at different times, allowing separate estimations of the output concentration of each component. For each paired output [analyte], the differential concentration ((ΔCm) is calculated. When the differential concentration is greater than zero, then the data contained in the well plate is classified as a match; otherwise, the data is classified as mismatch.

Chemical selection. The inventors selected three similar phenol compounds to encode the data: 2,4,6-tri-tert-butylphenol (analyte 1, 98%, Sigma Aldrich T49409), 2,6-dimethylphenol (analyte 2, ≥99.5%, Sigma Aldrich D174904), and 4-nitrophenol (analyte 3, ≥99%, Sigma Aldrich 241326). Phenols were selected due to their established UV absorbance and well-defined HPLC peak shapes. Mateos et al., Journal of Agricultural and Food Chemistry, 49(5), 2185-2192 (2001); Montedoro et al., Journal of Agricultural and Food Chemistry, 40(9), 1571-1576 (1992) The inventors initially also considered benzoates and other aromatics. However, phenol compounds also offer a range of chemical functionalization options through acylation [Murashige et al., Tetrahedron, 67(3), 641-649 (2011)], protection with benzyl [Kuwano & Kusano, Organic Letters, 10(10), 1979-1982 (2008)] or tert-butyloxycarbonyl [Cheraiet et al., Green Chemistry Letters and Re-views, 6(3), 211-216 (2013)], silylation [Sefkow & Kaatz, Tetrahedron Letters, 40(36), 6561-6562 (1999)], or even methylation [Ouk et al., Tetrahedron Letters, 43(14), 2661-2663 (2002)]. This introduces the possibility of increasing parallelism through simple chemical manipulations, which would generate numerous related com-pounds with similar UV sensitivity.

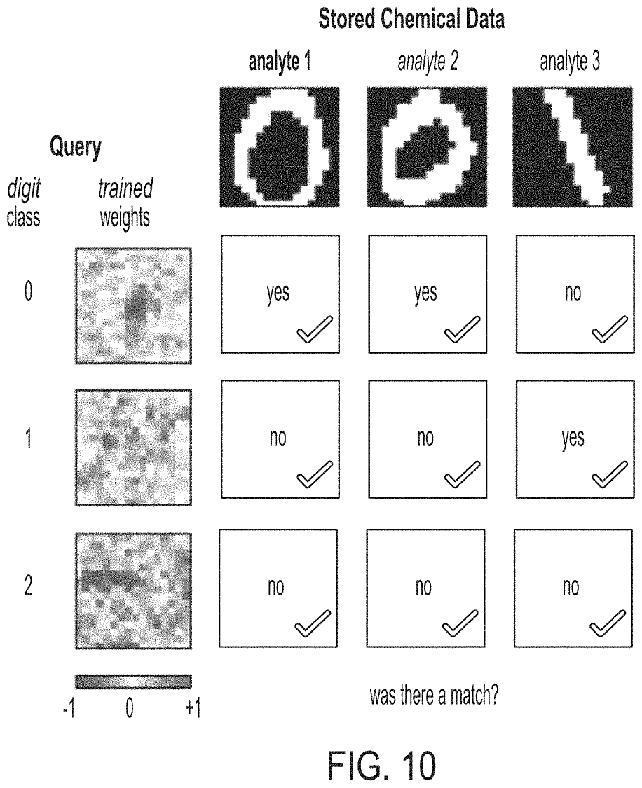

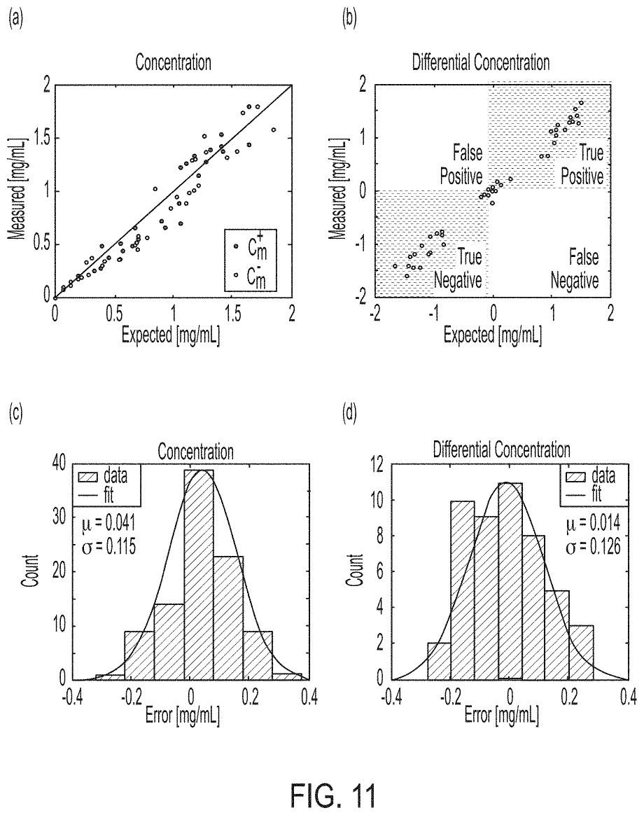

Measurement calibration. The HPLC used in this work was an Agilent 1260 infinity series model with a quaternary pump, a standard autosampler, a thermostatted column compartment, and a variable wavelength detector that was set at 204, 214, and 254 nm with bandwidths of 4 nm. To identify the characteristic elution time of each analyte, the three compounds were measured independently using a C18 reversed phase column (Agilent Poroshell 120 EC-C18, 699975-902, 4.5 mm×50 mm, 2.7 μm particle size). A gradient flow program was run with a two-part mobile phase comprised of water (A) and acetonitrile (B), where the volume ratios at each gradient time endpoint were set to 95%-A & 5%-B at 0 min, 5%-A & 95%-B at 9 min, 5%-A & 95%-B at 10 min, 95%-A & 5%-B at 11 min, and 95%-A & 5%-B at 12.5 min. Chromatograms for the three analytes are shown in FIG. 10. The elution times were determined to be 3.41 minutes, 4.53 minutes, and 9.31 minutes, and the pulse width for each species was approximately 9 seconds. While the proof of concept assays used only three analytes, the narrow pulse width implies that as many as eighty analytes could be independently quantified using this HPLC protocol.

FIG. 11 shows calibration curves for the three analytes, which relate the true concentration to the area under the measured HPLC chromatogram peak. A concentrated equimolar mixture (12 mg/mL of each of the three analytes) was prepared and serially diluted to obtain samples with varying concentrations. Using 11 serial 2:1 dilutions, the concentrations were varied from 6 mg/mL to 0.006 mg/mL. Each of the diluted samples was analyzed with HPLC, and the areas of the chromatogram peaks were calculated. For each compound, the inventors performed a simple zero-intercept linear fit to relate peak area and compound abundance. Although photodetector saturation causes noticeable nonlinearity at higher concentrations, the technique relies on differential concentrations, and thus achieving the correct classification output only requires that the detector output be monotonic.

MNIST image classification. For a demonstration, the inventors used images derived from the well-known MNIST database of handwritten digits [LeCun et al., Proceedings of the IEEE, 86(11), 2278-2324 (1998)]. The original images were grayscale at 28×28 pixel resolution, but for these assays, the inventors binarized and resized the images to 16×16. The inventors trained three one-versus-all classifiers on a computer a priori for three foreground classes, representing the digits ‘0’, ‘1’, and ‘2’. Each classifier was trained using 100 foreground class images and 100 background class images which were randomly selected from the MNIST training set. For example, the classifier with the digit ‘0’ foreground class was trained using 100 images of the digit ‘0’ and 100 images of other digits ‘1’ through ‘9’. Color maps of the trained weight matrices are shown in FIG. 11.

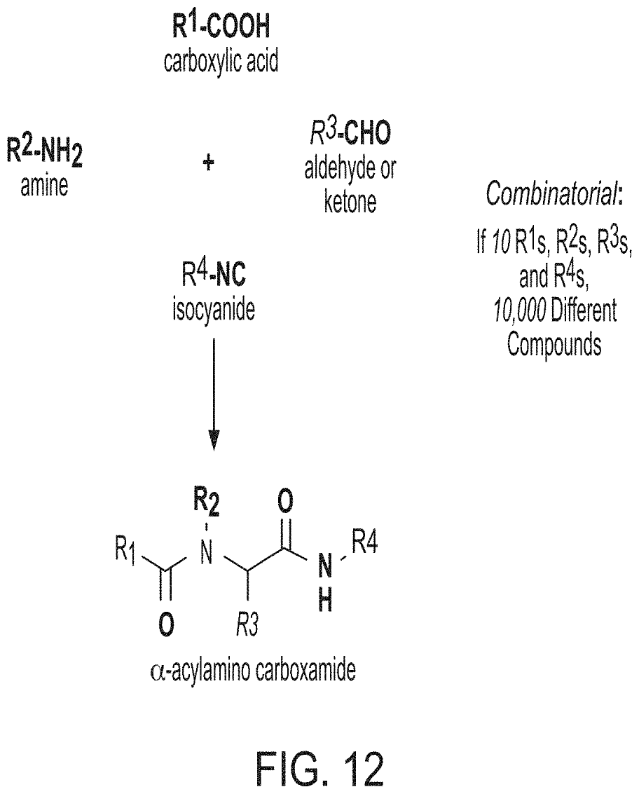

The inventors constructed a dataset of three overlaid MNIST images (see, LeCun et al., Proceedings of the IEEE, 86(11), 2278-2324 (1998)), consisting of two distinct ‘0’ images and one image of ‘1’. These images were mapped onto a well plate and encoded with the three previously discussed analytes. The resulting microplate is shown in FIG. 12, where the chemically encoded images are faintly visible due to the colors of the analyte solutions (particularly analyte 3). The inventors used the three perceptron classifiers to operate on this chemical data, and the resulting MNIST classifications are shown in FIG. 12. The ‘0’ classifier correctly identified the two images with zeros, and the ‘1’ classifier correctly identified the image of a one. In total, all 9 of the MNIST perceptron outputs were correctly labeled.

While these perceptrons performed well, the aim is to reproduce the perceptron operations using chemical computations.

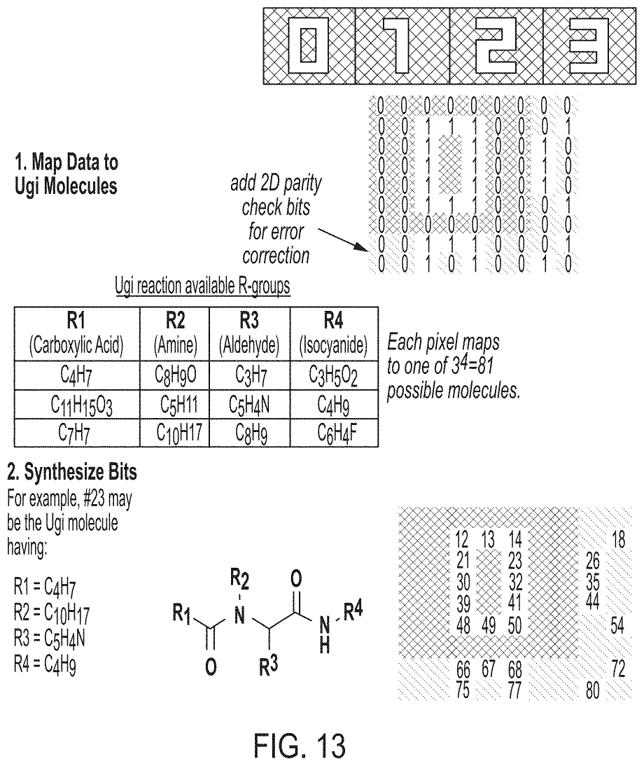

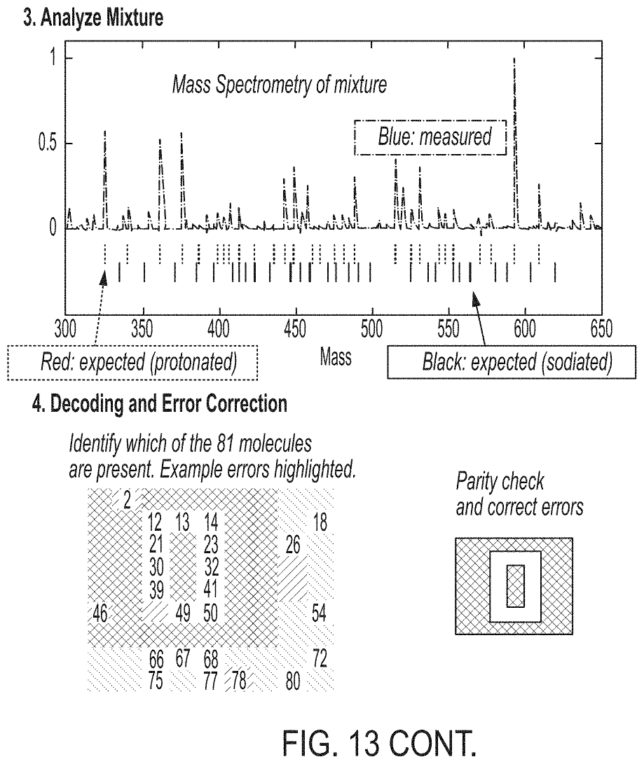

Performance evaluation. Chemical computation is not limited to images and is extensible to linear classification of any binary dataset. To evaluate the robustness of the computations, the inventors performed a set of assays using smaller pseudo-random binary vectors. Sixteen 16-element weight vectors (w∈[−1, 1]) were selected at random, as shown in FIG. 13. For each w, the inventors chose three 16-bit data vectors, selected such that one vector is classified with large margin as a mismatch ( [symbol] =0), one vector is easily classified as a match ( [symbol] =1), and one vector is near the classifier's boundary.

The expected and HPLC-measured concentrations of the positively and negatively weighted pools are shown in FIG. 14. The expected and measured values of the differential concentration are also shown. In both cases, deviations from a straight line (y=x) represent errors in the chemical encoding, computation, or measurement. In FIG. 14b, points which appear in the upper left quadrant are false positives, while points which appear in the lower right quadrant are false negatives. Histograms of these errors are also shown.

The classification output is robust to moderate assay variations, but the exact output concentrations are affected by several sources of assay variability. Inconsistent pipetting volumes during the initial dataset creation, as well as the tolerance of the weighted summing volumes, cause variations in the pooled output. Additionally, the HPLC is sensitive to small changes in its sample injection volume, and the chromatogram calibration can drift slightly over time. In total, the inventors observed errors on the scale of 10% of the expected outputs, which naturally has a larger effect on decisions closer to the classifier boundary. The mean differential concentration error was close to zero (0.041 mg/mL), and the 3-spread was approximately 0.3 mg/mL. The overall chemical classifier accuracy was 96%, correctly classifying 46 out of 48 test vectors.

The utility of this method as a valuable alternative computing model is provided by its ability to scale up to operating in parallel on many datasets. In this EXAMPLE 2, the scale of the demonstrations is limited by the throughput of the automated liquid handler. Between assembling the dataset and performing the classifications, the MNIST demonstration required a total of 1,716 liquid transfers, used 697 disposable pipette tips, and took 24 hours to complete. While this is a considerable amount of time, it does not represent a physical limit, as higher throughput liquid handling systems are common in pharmaceutical laboratories. Moving forward, improved robotics can allow an increase in the computational throughput by several orders of magnitude.

The parallelism of the chemical analysis is another important avenue for improvement. The demonstrations used a set of only three compounds, but the current system could be readily scaled to several dozen. This would not impact the inference or readout time, but the time to prepare the input data wells would increase. Putting aside the dataset creation time, scaling up to hundreds or thousands of parallel computations would likely require supplementing HPLC with other analytical techniques such as mass spectrometry. Zeng & Kassel, Analytical Chemistry, 70(20), 4380-4388 (1998); Shockcor et al., Analytical Chemistry, 68(24), 4431-4435 (1996).

The finite volume of the chemical datasets implies a limit to the number of times that data can be sampled and processed. In the MNIST tests, each well began with a volume of 60 μL, and the classifier weights were scaled to transfer between 0-6.25 μL from each well. Thus, the current system can operate on each data well approximately twenty times. With improved liquid handling tools, the sample volumes can be reduced to make more efficient use of each chemical dataset. These current demonstrations require analyzing two chemical output pools and electronically calculating the differential concentrations of their analytes. To scale up the scope and complexity of the chemical computational system, one can implement methods approaches for cascading multiple computing stages and integrating other operations beyond linear volumetric additions and multiplications.

This EXAMPLE 2 presented a scheme for implementing linear classification operations using chemical mixtures. Binary data is encoded into the chemical composition of an array of liquid samples, and a robotic fluid handler is programmed to perform multiplications and additions as fractional volume transfers and pooling operations. The chemical encoding increases information density and enables parallel computation. The result of these operations is represented in the concentration of chemicals in pooled outputs, which are analyzed using high performance liquid chromatography (HPLC). This EXAMPLE 2 used this system to classify several 16×16 binary MNIST images of handwritten digits, as well as to classify a set of pseudo-random binary vectors. The method's accuracy was demonstrated, producing 55 correct classifications out of 57 operations.

THIS EXAMPLE 2 first step towards a new class of chemical-domain computational engines which can operate on increasingly parallel datasets.

### Example 3

### Memory Using Mixtures of Small Molecules

Summary Molecular data systems can store information at dramatically higher density than existing electronic media. Molecular memory has previously been based upon custom-built long-chain oligomers (like RNA or DNA). The concomitant needs for readout using somewhat cumbersome processes like shotgun sequencing and the like, or even the more modern nanopore sequential readout method.

This EXAMPLE 3 presents a general framework for quantifying chemical memory, which is not limited to polymers and extends to mixtures of molecules of all types. This EXAMPLE 3 shows that the theoretical limit for molecular information is two orders of magnitude denser by mass than DNA. This EXAMPLE 3 demonstrates kilobyte-scale information storage in mixtures of small synthetic molecules and considers some of the new perspectives that are necessary to harness the information capacity available from the vast non-genomic chemical space.

This EXAMPLE 3 demonstrates the coding of information using mixtures of small molecules and subsequent eₙ masse readout using combinations of spectrometry, chromatography, and spectroscopy. This EXAMPLE 3 used memory representation to formulate the readout problem as a multi-user signature specification/detection problem in suitable signal spaces. This EXAMPLE 3 shows how to detect mixtures of 10⁶ molecules in one pass at relatively high speed.

Introduction. RNA and DNA are information-dense, stable over long periods of time, and energy efficient. Reading information from RNA and DNA is currently cumbersome, whether stochastic methods such as polymer chain reaction (PCR) and shotgun sequencing or emerging more elegant sequential methods using nanopores are used.

This EXAMPLE 3 instead considers the molecular information storage problem with an eye not only toward high information density, but also highly parallel, speedy memory interrogation. The inventors apply bulk probes such as mass spectrometry, spectroscopy, chromatography, and other methods to enable readout of megabits or more within seconds or less.

This EXAMPLE 3 first considers information storage using molecules and mixtures of molecules (specifically avoiding long oligomeric approaches such as RNA, DNA, or proteins) in a way that can be applied to any chemical system. This EXAMPLE 3 avoids long oligomers (or lattices), instead using natural intermolecular interaction promiscuity available in gas/solution phase mixtures of smaller molecules. This EXAMPLE 3 then considers readout of molecular mixtures as a classification problem in some high dimensional signal space, deriving empirical bounds on the rate at which information can be extracted from the system. This EXAMPLE 3 then applies this thinking to models of a particular chemical system (Ugi molecules) using mass spectrometry as the interrogation method.

Theoretical foundation of molecular information capacity. Where D is the total number of different distinguishable system states, then the memory capacity is upper-bounded by logₙ. Embedded in this statement is the readout problem (the notion of distinguishability) which is quantified for any given system, as discussed below.

By neglecting potentially resolvable differences in the conformational, vibrational, rotational, and electronic states of the molecules, the enumeration of system state is queried by three simple questions:
(1) Which marbles are present?
(2) How many of each marble is present?
(3) Where are the marbles?

This formulation is sufficiently robust and accurate for capturing the capacity of any molecular memory, even when the quantum states of the molecules are also considered.

Counting the states. The number of unique possible states that a system can realize (regardless of what parameters make the states unique) sets an upper bound on memory capacity. Where there are n distinguishable states overall, then the system can code at most log₂ₙ bits. Thus, establishing memory capacity is a question of counting the distinguishable states and the three questions enumerated above allow us to answer this question.

Linear oligomers, such as nucleic acids or proteins, are a well-known form of molecular information storage/representation. For RNA or DNA, there are four bases, so the number, M, of possible N-monomer strands is 4N. When those skilled in the molecular computing art ask which of the M molecules is present, a given strand represents 2N bits. For proteins, N bases drawn from an “alphabet” of twenty amino acids carry log₂(20^{N})=4.3N bits.

These “beads on a necklace” representations are themselves an instance of “where are the marbles?” memory coding in that position, as well as base identity, provides information. Persons skilled in the molecular computing art understand two-dimensional or three-dimensional structures, where each position in a lattice represents information. These structures become necessarily large and their interiors less accessible to easy interrogation as memory size grows. Planar lattices could allow easier interrogation, but a subtext of the approach is a desire to utilize the natural promiscuity of molecule interactions in liquid/gas phase for computation. Thus, this EXAMPLE 3 focuses on small molecules (although persons skilled in the molecular computing art can use larger scale spatial ordering of molecular mixtures as an information dimension).

For a mixture of molecules where position information is inaccessible or inconsequential owing to molecular motion, but where those skilled in the molecular computing art can identify the presence or absence of different molecules in a mixture, then for given M molecule types, there are 2M possible system states. Thus, the system can store NI bits.

How many of each type of molecule is present?Persons skilled in the molecular computing art can use up to Q molecules for storage. That is, a given “bag” can contain any number between zero and Q marbles. This is a typical bin-packing problem [Papoulis, Probability, Random Variables, and Stochastic Processes (McGraw-Hill, New York, third edition, 1991); Feller, An Introduction to Probability Theory and Its Applications, Volume I. (Wiley, third edition, 1968)] that results in:

$$n = {( Q + M - 1 )}_{M - 1} \qquad [ Equation G ]$$

possibilities. For analytic clarity, let us assume that M>>10 and that Q−M>>10 so that Stirling's approximation is reasonably accurate and:

$$Ω \approx \frac{{( Q + M - 1 )}^{Q + M - 1} {e}^{- ( Q + M - 1 )} \sqrt{2 π ( Q + M - 1 )}}{{Q}^{Q} {e}^{- Q} \sqrt{2 π Q} {( M - 1 )}^{( M - 1 )} {e}^{- ( M - 1 )} \sqrt{2 π ( M - 1 )}} , \qquad [ Equation H ]$$

so that

$$\begin{matrix}log Ω \approx ( Q + M - 1 ) log ( Q + M - 1 ) - Q log Q \\ - ( M - 1 ) log ( M - 1 ) + \frac{1}{2} log ( \frac{Q + M - 1}{2 π Q ( M - 1 )} )\end{matrix} \qquad [ Equation I ]$$

Let us define Q=αM. This definition results in:

$$\begin{matrix}log Ω \approx ( α + 1 ) M log ( α + 1 ) M - α M log α M \\ - ( M - 1 ) log ( M - 1 ) + \frac{1}{2} log ( \frac{( α + 1 ) M}{2 π α M ( M - 1 )} )\end{matrix} , \qquad [ Equation J ]$$

which reduces to

Storage Capacity and Density Comparisons. In TABLE 5, MOLECULAR STORAGE CAPACITY FOR UGI TRIMERS (K=8) WITH 10, 30 AND 90 R-GROUPS PER SITE. C₃(N^{K}, m) IS CALCULATED FOR m=1, 10, 100, the inventors compare the storage capacities C₂ and C₃ (M,m) as a function of N with K=S sites, which corresponds an Ugi “trimer”, made from three conjoined Ugi monomers.

TABLE 5

| bits/mixture | N = 10 | N = 30 | N = 90 |
|---|---|---|---|
| C₂ | 10⁸ | 6.6 × 10¹¹ | 4.3 × 10¹⁵ |
| C₃ (N^{K}, 1) | 2 × 10⁸ | 1.3 × 10¹² | 8.6 × 10¹⁵ |
| C₃ (N^{K}, 10) | 4.8 × 10⁸ | 3.2 × 10¹² | 2 × 10¹⁶ |
| C₃ (N^{K}, 100) | 8.1 × 10⁸ | 5.3 × 10¹² | 3.5 × 10¹⁶ |

A mixture of Ugi trimers can store nearly a gigabit of information with just N=10 unique R-groups. This is much more than a mixture of comparable Ugi monomers (K=4 and N=10), which can store only tens of kilobits. Ugi trimers furthermore have a molecular space-filling volume on the order of 125A³. When the information storage density is 2 bits/molecule, then for Ugi trimer mixtures this implies a maximum storage density of approximately 2×10¹⁸ bytes/mm³. This tremendous information density led us to focus on Ugi trimers, sufficiently long, yet synthetically tractable Ugi oligomers, for the GB-scale molecular storage system.

Location: The position of each molecule: Theoretically, an infinite amount of information could be stored via position as it is, for all intents and purposes, a continuous variable. However, several practical concerns limit fine position as a chemical information storage mechanism including the need for a rigid supporting lattice, molecular vibration and the (relatively large) probe wavelengths which limit location resolution. Moreover, this project is concerned not only with memory but also with computation which implies a need to foster interactions between molecules. Thus, one focusses primarily on unordered mixtures of molecules as an information storage mechanism.

When two solutions are physically separated (or encapsulated), they can contain different sets of molecules so that the information capacity grows linearly with the number of separate mixtures, when one mixture in P separate mixtures represent P×C bits.

Memory capacity motifs and quantum issues. In quantifying molecular memory capacity, two important motifs emerged. First, memory capacity scales linearly in each degree of freedom. Each spatial dimension adds a degree of freedom. However, “tranche” properties of the constituents of molecules such as sensitivity to specific probe types (frequency, reactivity) could also be used as dimensions to increase memory capacity. Second, the numbers of identifiable molecules only increase capacity as the log of those numbers. While quantities like concentration can increase capacity, they do so less efficiently than through adding more degrees of freedom.

When one has M different molecule types, each of which can be stably put into S quantum states where typically S<<1\1 because the combinatorial complexity of molecules which drives M can be high while the number of stable and accessible quantum states is generally much smaller. The memory capacity of such a system is log SM=log S+log M. So, whether the design (and probing) of those S stable quantum states should be pursued is a question of how difficult it is to increase S as compared to M.

Quantum entanglement can vastly increase the capacity of any system because the state is defined by the values of the entangled state probabilities. When each element can occupy one of two states, an N-element system has 2N states, each of which is specified by a complex constant. Even when one supposes those constants are constrained to either 0 or 1, the N-element system represents 22˜1 bits. So, quantum entanglement is a powerful method of memory storage. For the chemical systems here, controllable entanglement between constituent atoms beyond a single bond-length is unlikely, so that while N might be 2, the gain in distinguishable molecules (a factor of 8, or 3 bits) is minimal.

Comparing the various methods suggests that simple “presence/absence” coding wherein information is represented by the presence or absence of each of M molecule types in a mixture is a good first approach.

Memory and detection using Ugi chemistry. A specific chemical substrate can allow one to formulate the memory storage problem in concrete terms, from coding through detection using mass spectrometry. Because the synthesis of large numbers of different molecules is difficult, consider theoretical collections of small organic molecules that can be synthesized by multicomponent reactions, such as Ugi reactions. The Ugi reaction is a popular reaction in which four reactants combine to form a new molecule which condenses the four elements onto a peptide-like backbone, while retaining nearly all the atoms of the original inputs. Dömling & Ugi, Angewandte Chemie International Edition, 39(18), 3168-3210 (2000); Ugi et al., Endeavour, 18(3), 115 122, (1994); Ugi et al., Molecules, 8(1), 53-66 (2003).

Consider a set of Ugi molecules created from combinatorial sets of four appropriate reagents available from the Sigma-Aldrich catalog. Using thirty isocyanides, nineteen carboxylic acids, twelve amines, and seventeen ketones, one can create I 16,280 (30×19×12×17) theoretical Ugi products.

### Example 4

### Chemical CPUs: Chemical Computational Processing Via Ugi Reactions

Technical approach. The program goals of this EXAMPLE 4 are (1) to store abstract digital data by taking advantage of small molecule chemical diversity; (2) to develop leading-edge synthesis and analysis techniques that can scale to billions of molecules/day; and (3) to establish scalable strategies for solution-phase information processing using small-molecule reactions.

Regarding combinatorial synthesis. Prior methods: Split pool synthesis of 2.18 million compounds (Schreiber group; see, Schreiber, Int. J. Mass. Spec. (2000)); fully-populated library only; and verification of 456 compounds (0.02%).

This EXAMPLE 4: Synthesis of 30,000 Unique Mixtures of 30,000 compounds via robotics and multicomponent reactions; 30K×30K=900 million synthesis features; create arbitrary library subsets; including 100% quality control (QC).

Regarding mass spectrometry. Prior methods: Identification of >120,000 compounds in 12 hours (Marshall group); amortized 3 compounds/second.

This EXAMPLE 4: Enumeration of 30,000 mixtures×30,000 compounds in 24 hours; >10,000 compounds/second.

Regarding molecular computing; storage. Prior methods (DNA): Stored 200 MB subdivided among DNA oligonucleotides (Strauss/Ceze/Seelig); Data+payload representation; Reed-Solomon codes for error correction; 13 million˜150-base oligos carrying >100 bits of data per molecule.

This EXAMPLE 4: To store >1 billion bytes in unordered small molecules; not inherently sequence-based; 1-100 bits of data per Ugi-derived molecule

Regarding molecular computing; computing. Prior methods (DNA): Relies on hybridization interactions, optimized by evolution; solutions to several-destination Hamiltonian path and SAT problems (Adelman/Lipton); several-bit digital logic circuits based on strand displacement (Soloveichik/Bruck) See, Zielinski, Science (2017); Adelman, Scientific American (1998); Qian, Science (2011).

This EXAMPLE 4: Use 1-to-many reactions to perform highly parallel matrix algebra and pattern classification.

Mitigation of possible risks: (1) Use of heteroatoms to synthesize Ugi molecules to reduce a risk of too many isomers. (2) Smaller mixtures with non-mass dimensions to reduce a risk of too many isomers. (3) Direct storage of mixtures on MALDI plates to reduce risk from fluid handling speeds of 100 Mmb/day (the Labcyte Echo can handle >750,000 transfers/day). (4) Storage of pre-formed mixture libraries; parallel fluid transfers; specialized robotics to reduce risk from fluid handling speeds of 100 Mmb/day. (5) Careful preliminary studies of reaction networks; optical strategies, to reduce the risk of reaction-based computation.

Summary: This EXAMPLE 4 shows how to (1) store digital images, digital audio, and digital weather datasets in mixtures of synthetic small molecules; (2) synthesize data molecules by combinatorial multi-component Ugi reactions; (3) automate synthesis fluid handling can be automated with robotics and high density well plates; (4) use high-performance FT-ICR mass spectrometry for analysis; (5) use reactions targeting specific R-groups to compute on chemical datasets and build classifiers; and (6) optimize the data encoding, synthesis automation, and statistical analysis for error rates and time constraints using custom computer-aided design (CAD) software.

### Example 5

### Chemical CPUs: Chemical Computational Processing Via Ugi Reactions

Technical approach. The program goals of this EXAMPLE 5 are (1) to store abstract digital data by taking advantage of small molecule chemical diversity; (2) to develop leading-edge synthesis and analysis techniques that can scale to billions of molecules/day; and (3) to establish scalable strategies for solution-phase information processing using small-molecule reactions.

Regarding storage: This EXAMPLE 5 shows that one can store and detect kilobits of information in hundreds of Ugi compounds.

Regarding computation: This EXAMPLE 5 shows that the inventors developed a parallel molecular perceptron for image recognition.

Regarding theory: This EXAMPLE 5 shows that the inventors developed new molecular computing algorithms and analyzed chemical space (see Rose et al., 2018 IEEE International Symposium on Information Theory (ISIT) (Vail, CO, June 2018), pp. 2236-2240 [EXAMPLE 1]; Arcadia et al., Proceedings of the IEEE Conference on Rebooting Computing (ICRC) (2018) [EXAMPLE 2]:

$${w}_{i} = {Θ}^{⊤} {U}^{⊤} {γ}_{i} \qquad [ Equation L ]$$

Regarding multicomponent synthesis. Prior methods: Split pool synthesis of 2.18 million compounds (Schreiber group; see, Schreiber, Int. J. Mass. Spec. (2000)); sparse verification of 456 compounds (0.02%).

This EXAMPLE 5: Completed synthesis and characterization of 300 unique Ugi compounds using basic pipetting robot; roughly 1 kilobit of data; characterized nearly all compounds; established concept of using multicomponent reactions for chemical diversity. Continued improved scaling using advanced liquid handling robotics (Labcyte Echo).

Regarding mass spectrometry. Priormethods: Identification of >120,000 compounds in 12 hours (Marshall group); amortized 3 compounds/second.

This EXAMPLE 5: Completed measurements of hundreds of samples, up to 48 compounds in each mixture.

Regarding automation. This EXAMPLE 5: Performed CAD automation of synthesis; significant progress automating analysis of spectra; with improved reliability, repeatability, with 1000 steps/day with 200 nL resolution.

Prior methods (DNA): Stored 200 MB subdivided among DNA oligonucleotides (Strauss/Ceze/Seelig); millions of unique sequences of ˜150 base pair polymers.

This EXAMPLE 5: Performed >1 Kbit of data in a diversity of small compounds.

Regarding computing. Prior methods (DNA): Relies on hybridization interactions, optimized by evolution; solutions to several-destination Hamiltonian path and SAT problems (Adelman/Lipton); several-bit digital logic circuits based on strand displacement (Soloveichik/Bruck) See, Zielinski, Science (2017); Adelman, Scientific American (1998); Qian, Science (2011).

This EXAMPLE 5: First to perform small molecule computing based upon volumes/concentrations; developing reaction-based computation; inherently parallel chemical computation; CAD-directed robotic liquid handling.

FT-ICR mass spectrometry. Two liquid-handling systems (Labcyte Echo 550 acoustic droplet liquid handler and Andrew Alliance 1000G pipetting robot) were installed.

Optimized libraries of molecules for MS/LC detection; Currently growing the library.

Demonstration of perceptron. The demonstration was show in the EXAMPLES above.

Mitigation of possible risks: (1) Use of heteroatoms to synthesize Ugi molecules to reduce a risk of too many isomers. Completed computational study of mass and non-mass dimension capacities. (2) Smaller mixtures with non-mass dimensions to reduce a risk of too many isomers. Completed computational study of mass and non-mass dimension capacities. (3) Direct storage of mixtures on MALDI plates to reduce risk from fluid handling speeds of 100 Mmb/day (the Labcyte Echo can handle >750,000 transfers/day). Engaged in discussions with supplier about direct transfers to MS, parallelization. (4) Storage of pre-formed mixture libraries; parallel fluid transfers; specialized robotics to reduce risk from fluid handling speeds of 100 Mmb/day. Used volume/concentration-based computing strategies. (5) Careful preliminary studies of reaction networks; optical strategies, to reduce the risk of reaction-based computation. Used volume/concentration-based computing strategies.

Molecular data storage concept. Using a library of M molecules provides 2^{M} possible un-ordered mixtures. When one creates N independent mixtures, there are (2^{M})^{N} possible states (unique data values). This implies log₂((2^{M})^{N})=M×N bits of information, with the presence/absence of each molecule in each mixture representing one bit of data.

Arrayed MALDI mass spectrometry. One MALDI plate can contain individual library elements, data mixtures, intermediate compounds, and calibration standards.

Data mixture generation. When data[i, j]==1, then mixture j should include library compound i. The digital data is mapped onto chemical mixtures, and the software produces an automation script for the robotic liquid handler. Benefits: (1) natural error tolerance; (2) spreads data across multiple compounds and multiple mixtures; and (3) only local data scrambling (not global).

Mass spectrometry mixture analysis. The inventors mapped a 640 bit dataset to N=14 mixtures using an M=48 compound library (a subset of “Library 2”). In the first of these mixtures (column 1), the inventors wrote 22 ones and 26 zeros. Monoisotopic masses of the 22 expected present molecules were calculated. When present, these molecules usually appear with multiple isotopes and ions. The inventors have another list of twenty-six expected absent molecules. Using some very simple criteria, this EXAMPLE 5 is at 70-80% accuracy in the first datasets. Improved software and more detailed statistics are in progress.

Summary. In this EXAMPLE 5, the inventors synthesized three combinatorial Ugi libraries, with 102, 140, and 140 molecules, respectively. (Total: 382). The inventors wrote two different datasets, each 640 bits, into mixtures of Ugi compounds. (Total: 1.28 Kb). Each dataset was diluted, copied, and its mass spectrum measured multiple times. Simple metrics indicate 70-80% raw readout accuracy. More detailed statistical analyses and software tools are continuing. With the Echo liquid handler, one can scale up storage capacities by two-three orders of magnitude.

### Example 6

### Theory of Information Storage in Molecular Mixtures

Foundations of molecular information capacity. The invention provides a chemical perceptron, being the implementation of a perceptron in an artificial (simulated) chemistry. The invention provides a mathematical framework for quantifying chemical memory.

For more information, see Rosenstein et al, Principles of Information Storage in Small-Molecule Mixtures arXiv:1905.02187 (May 6, 2019), incorporated by reference.

When more potential states are available to a given system, it becomes less likely that one state can be realized. The information capacity of a system accounts for (i) the number of possible states and (ii) the likelihood of confusing one state for another. When a chemical system has Ω identifiable states, then its information capacity (C, in bits) has an upper bound of:

$$C \leq {log}_{2} Ω \qquad [ Equation M ]$$

Because each molecule can be defined only by its chemical identity, those skilled in the molecular computing art can quantify the amount of information represented in a chemical mixture by answering the three following questions:
(1) What is the set of unique molecules which could be present?
(2) Which of these unique molecules is present?
(3) How many copies of each unique molecule are present?

Compare to EXAMPLE 3, discussion of “marbles”. This formulation provides for the precise quantification of any type of molecular memory. This formulation is extensible to cases which include multiple rotational, vibrational, or electronic states of molecules within mixtures.

### Ordered Polymers

Nucleic acids have four canonical bases, so the number of possible N-monomer strands is M=4^{N}. When only one of the M molecules may be present, then Ω=M and the identity of the molecule represents 2^{N} bits.

Similarly, proteins with N monomers drawn from an alphabet of twenty amino acids carry log₂ 20^{N}≈4.3N bits. The information capacity of a single polymer molecule is therefore expressed as:

$$C \leq {log}_{2} M = N {log}_{2} B \qquad [ Equation N ]$$

where B is the number of different monomers.

Although information is often mapped independently onto substructures (monomers) within a molecule, it is the identity of the whole molecule that holds log₂ M bits. Those skilled in the molecular computing art understands that when one nucleotide in a nucleic acid polymer changes, the resulting nucleic acid polymer is a different molecule with different genetic information. This understanding is important for generalizing theories of information storage to more diverse non-polymeric molecules.

Unordered Molecular Mixtures. For an unordered mixture of up to Q molecules, when exactly Q molecules are drawn from a library of size M (with potential duplication), then the total number of possible combinations is (M+Q−1)/(M−1). Feller, An Introduction to Probability Theory and Its Applications (John Wiley and Sons, Inc, 1960). When between 0 and Q molecules are selected, then:

$$Ω = {\sum }_{q = 0}^{Q} ( \begin{matrix}M + Q - 1 \\ M - 1\end{matrix} ) = \frac{Q + 1}{M} ( \begin{matrix}M + Q \\ M - 1\end{matrix} ) \qquad [ Equation O ]$$

The capacity of the system is, therefore:

$${C}_{1} ( M , Q ) \leq {log}_{2} [ \frac{Q + 1}{M} ( \begin{matrix}M + Q \\ M - 1\end{matrix} ) ] \qquad [ Equation P ]$$

When there is no duplication among the Q selections, then:

$$Ω = \text{?} ( \begin{matrix}M \\ q\end{matrix} \text{?} \qquad [ Equation Q ]$$

$$\text{?} \text{indicates text missing or illegible when filed}$$

so that the capacity is:

$${C}_{2} ( M , Q ) \leq {log}_{2} [ {\sum }_{q = 0}^{Q} ( \begin{matrix}M \\ q\end{matrix} ) ] \qquad [ Equation R ]$$

When all molecules may be present (Q=M) without duplication, this capacity becomes:

$${C}_{2} ( M , M ) \leq {log}_{2} [ {\sum }_{q = 0}^{M} ( \begin{matrix}M \\ q\end{matrix} ) ] = M {log}_{2} 2 \qquad [ Equation S ]$$

which are simply M bits.

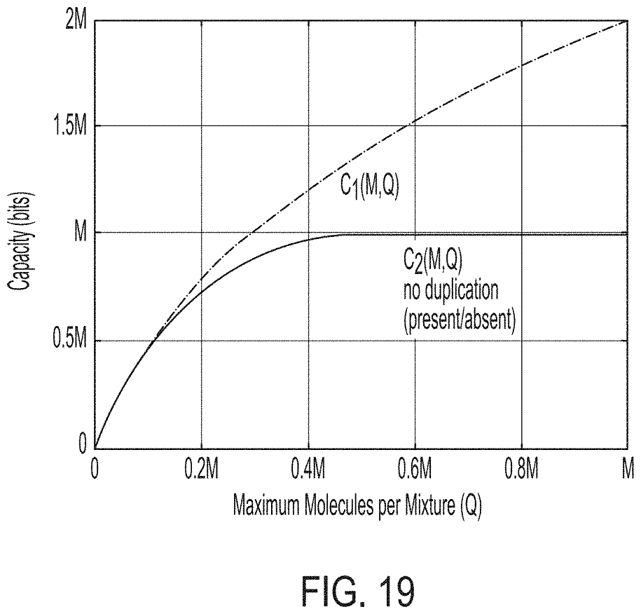

C₁ is the larger of these capacities and provides an upper bound on all memory schemes in unordered mixtures. Making use of C₁ requires that one knows the exact concentration (count) of each unique molecule. C₂ represents the reduced capacity when duplication carries no information, which is also equivalent to classifying each unique molecule as absent or present above some concentration threshold. Representative curves in FIG. 19 show that, without duplication, there are diminishing returns in information capacity as Q approaches M.

In practice, many copies of each unique molecule are likely present in a mixture. Rather than counting molecules, one can specify that each of the M molecules may exist at one of L distinguishable concentrations. Thus, the capacity becomes:

$${C}_{3} ( M , L ) \leq {C}_{2} ( M , M ) \times {log}_{2} ∠ = M {log}_{2} ∠ \qquad [ Equation T ]$$

which reduces to [Equation S] when L=2.

[Equation T] also applies when there are L potential states of each of the M library molecules, which may include chemical modifications or electronic, vibrational, or rotational states. L is the number of states, not the number of dimensions. To reach this upper bound, each molecule's L states is independent. When the states only describe ensembles, the capacity multiplier is less than log₂ L.

Molecular data addressing. There are practical advantages to re-introducing ordering and hierarchy to correspond to concepts of ‘addressing’ within the data. The choice of chemical addressing scheme can affect information density, the total capacity, and possibilities for random access.

Spatial addressing. Storing information across a set of independent chemical pools (such as in standard microwell plates) increases capacity linearly with the number of independent wells (W). Because the wells are physically separated, the same library of M potential molecules can be reused in each well. In the limit of very small Q, spatial addressing also describes existing chemical microarrays. Schena et al., Science 270(5235), 467-470 (October 1995); Schirwitz et al., Biointerphases, 7(1), 47 (2012). Also, in the limit of very small Q, spatial addressing describes two-dimensional molecular memory. Green et al., Nature, 445:414 (January 2007); Liu et al., Nature, 347:658 (October 1990).

Sparse data mixtures and address-payload coding. Another concept involves the subdivision of M library molecules into groups of size S, and production of sparse mixtures which contain exactly one molecule from each subgroup. A mixture with sparsity S thus contains M/S molecules. Because each molecule represents an exclusive choice among S possibilities, the total capacity is:

$${C}_{4} ( M , S ) \leq ( M / S ) {log}_{2} S \qquad [ Equation U ]$$

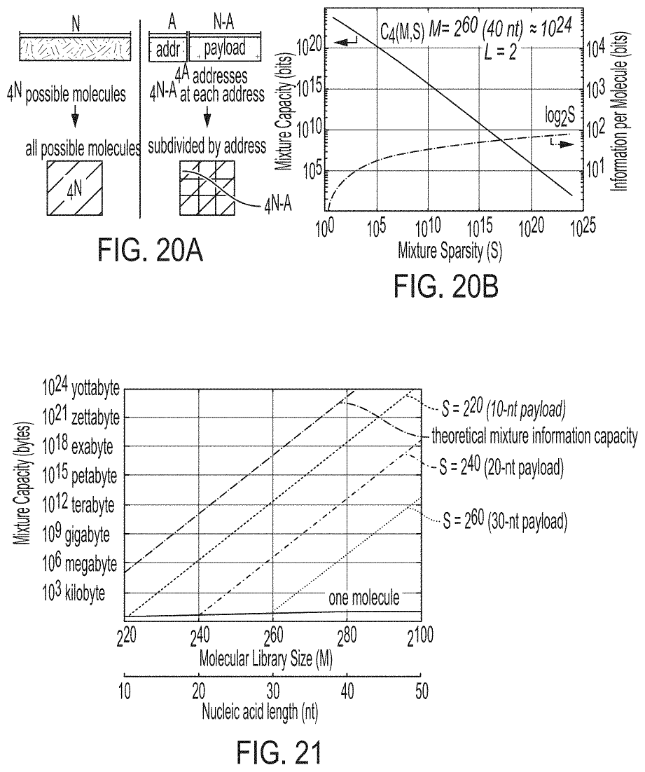

This C₄ is less than both C₁ and C2. This sparse mixture is identical to an address-payload DNA data representation. Bornholt et al., A DNA-Based archival storage system. In Proceedings of the Twenty-First International Conference on Architectural Support for Programming Languages and Operating Systems, ASPLOS '16, pages 637-649 (New York, NY, USA, 2016). ACM. See, FIG. 20(a). By assigning A positions in the digital sequence as an ‘address’ and the remaining N-A positions as a ‘payload,’ the library of M=4N digital sequences has been subdivided using sparsity S=4N−A, and exactly one digital sequence is included from each of the 4A addresses. This approach has previously been shown to be a productive strategy given constraints on DNA synthesis length. Church, Gao & Kosuri, Science 337(6102), 1628 (September 2012); Organick et al., Nature Biotechnology, 36, 242 (February 2018).

Enforced sparsity reduces the number of valid mixture states (0), by disallowing mixtures which contain more than one molecule from the same address space. The information conveyed per molecule increases, but the overall mixture capacity is reduced.

Capacity. As shown in FIG. 20(b), the maximum per-molecule information density occurs for maximum sparsity, but the maximum total mixture capacity is achieved with the minimum sparsity. The maximum mixture capacity is reached when each molecule represents only an address, with no payload.

In theory, a library consisting of short DNA oligomers of length N=40 could theoretically be used to either select one molecule conveying 80 bits or to create one unordered molecular mixture which represents 151 zettabytes (151×10²¹ bytes) of data, which is on the scale of all the digital information produced in the entire world per year. See, FIG. 21. See also, Cisco, The Zettabyte Era: Trends and Analysis (2016); Zhirnov et al., Nature Materials, 15, 366 (March 2016). When only single copies of each molecule were present (or absent), this hypothetical data set would weigh only a few pounds.

Long DNA synthesis and long-read nucleotide sequencing are real bottlenecks for some biological applications. Jain et al., Nature Biotechnology, 36, 338 (January 2018); Kosuri & Church, Nature Methods 11(5), 499-507 (2014). By contrast, mixtures of short polymers can represent any fathomable amount of digital data.

Energy constraints of molecular memory. Any implementation of molecular memory faces constraints in both synthesizing the library and creating the data mixtures. Given library size (M), mixture size (Q), and the number of independent mixtures (W), what constitutes an optimal design?Consider the costs of representing the same information in different configurations. For a mixture of polymers, where the marginal energy per monomer incorporation is ϵ, then W mixtures of Q unique molecules with length N would require a total energy of:

$$E = ε WQN \qquad [ Equation V ]$$

Accordingly, [Equation U] becomes:

$$C \leq Q {log}_{2} ( M / S ) = Q ( {log}_{2} M - {log}_{2} ( M / S ) ) \qquad [ Equation W ]$$

For very sparse mixtures (including single molecules), the second term is negligible. Substituting M=B^{N}, the energy per bit (Eb) becomes:

$${E}_{b} = E / C \approx ε / ( {log}_{2} B ) \qquad [ Equation X ]$$

Accordingly, for very sparse mixtures of polymers, there are energy benefits from increasing monomer diversity (B), although the scaling is sublinear. For dense binary mixtures (large Q), which may contain many unique compounds, [Equation X] indicates that C=M per well. In many datasets, one can also approximate Q=M/2. Thus:

$${E}_{b} = E / C \approx ε N / 2 \qquad [ Equation Y ]$$

This [Equation Y] implies that the optimal strategy is to produce mixtures using the simplest molecules (smallest N) capable of yielding mixtures with the desired capacity.

Across multiple dense mixtures, there can be many duplicated syntheses. When the entire library is synthesized ahead of time, the synthesis cost can be amortized, and the energy constraint may be better described by a physical mixing or fluid handling cost (γ):

$$M / 2 = γ C / 2 \qquad [ Equation Z ]$$

Thus, the energy per bit is a constant:

$${E}_{b} = E / C \approx γ N / 2 \qquad [ Equation AA ]$$

This [Equation AA] reveals no clear opportunity for the optimization of writing dense molecular mixtures.

To minimize the sizes of both the pre-synthesized library and the array of mixtures, one can optimize for min(M+W) while maintaining C=MW. Geometrically this is a minimum perimeter problem, satisfied by:

$$W \approx M \approx \sqrt{C} \qquad [ Equation AB ]$$

This [Equation AB] indicates that, for dense mixtures, one optimum occurs when the data mixtures' spatial diversity and molecular diversity are similar.

In summary, a library of M unique molecules can produce a binary mixture representing up to M bits of information. See, [Equation S]. Even among small organic molecules, there are potentially more than 1060 unique compounds. Bohacek et al., Medicinal Research Reviews 16(1), 3-50, (September 1996). Within this space, there are many potential targets for gigabyte-scale small-molecule libraries.

Diversified small-molecule memory. Combinatorial chemistries are regularly used in pharmaceutical pipelines to test the space of potential drug candidates [21, 44]. One of the most scalable strategies for generating functional group diversity is using multicomponent reactions (MCRs). Malinakova, Reports in Organic Chemistry, pages 75-90 (2015). Multicomponent reactions which include the Hantzsch, Biginelli, Passerini, and Ugi reactions, are chemical transformations in which three or more reactants combine, mostly independent of the order in which they are added, to form a single, multicomponent product. Because there are hundreds to thousands of different commercially-available possibilities for each reactant, Multicomponent reactions can generate extremely large libraries.

The readout options in unexplored chemical spaces are not as mature as those for DNA, but a single unambiguous measurement of each molecule need not necessarily be present. The goal is to recover the encoded information, which can be designed to tolerate some chemical ambiguity and errors.

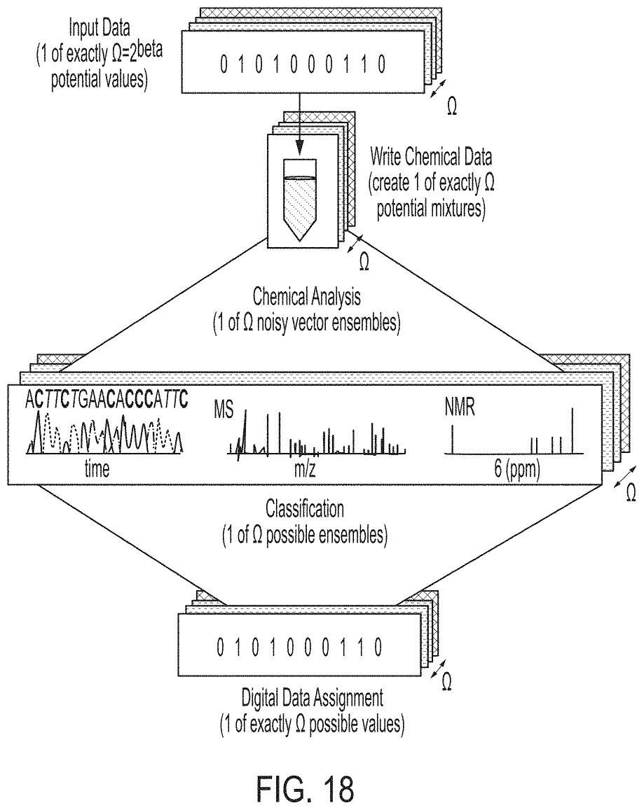

Reading Molecular Memories; Detection Signal Spaces. Depending on the chemical library, mass spectrometry, optical spectroscopy, NMR, or chromatography may all be leveraged to analyze molecular mixtures, and thereby read the data. The detection signal space is typically larger than the chemical mixture space, but the critical goal is to uniquely identify each of the 0 potential mixtures, as shown in FIG. 18.

A one-to-one correspondence between detection signal space and the molecule in the library is not necessary. Users of the Oxford Nanopore platform showed that chemical structure can be reliably decoded from extremely complex signals when the signals are repeatable and training datasets are available. Rang et al., Genome Biology, 19(1), 90, (2018). Statistical approaches which identify correlated variables and reduce dimensionality can be used to disambiguate signals from data mixtures of non-genomic compounds. Aeron et al., IEEE Transactions on Information Theory 56(10), 5111-5130 (2010).

Capacity under detection limits. Detection errors that mistake one mixture for another are likely to occur, but when these errors are probabilistic, then there are many ways to encode data so that retrieval is asymptotically error-free. Cover & Thomas, Elements of Information Theory. 2nd edition (Wiley, 2012); Polyanskiy et al., IEEE Transactions on Information Theory 56(5), 2307-2359 (2010). The upper limit for the capacity of a memory system can be described by its ‘confusion matrix,’ which quantifies the probabilities of mistaking one of the Ω mixtures for another. FIG. 22(a) shows the confusion matrix for a library of M=2 molecules, which can form Ω=4 possible mixtures. When Pᵢ≠P_{c} and assume worst case equiprobable confusion (P_{ij(i≠j)}=1−P_{c}/Ω−1), then:

$${C}^{′} = {log}_{2} Ω + {P}_{c} {log}_{2} {P}_{c} + ( 1 - {P}_{c} ) {log}_{2} ( 1 - {P}_{c} / Ω - 1 ) \qquad [ Equation AC ]$$

When there is never any confusion (P_{c}=1), the capacity reaches its maximum of log₂ Ω bits. When Ω is large, one can approximate:

$${C}^{′} \approx {P}_{c} {log}_{2} Ω - {H}_{B} ( {P}_{c} ) \qquad [ Equation AD ]$$

where H_{B}(⋅) is the binary entropy function. Cover & Thomas. Elements of information theory (Wiley, 2^{nd} edition, 2012).

Thus, the information capacity scales linearly with the probability of correctly identifying the mixture (P_{c}).

Channel coding and error correction. From the capacity expression in [Equation AC], those skilled in the molecular computing art tolerate some errors in identifying mixtures while minimizing errors in the data assignments. It is well-known in the molecular computing art that by spreading data across digital sequences of binary inputs (‘codewords’) of length Nc, the probability of errors after decoding can be made vanishingly small when the number of valid codewords |c| satisfies:

$$( {log}_{2} \vert c \vert ) / {N}_{c} < {C}^{′} \qquad [ Equation AE ]$$

where C′ is the capacity of the system (in bits) which incorporates expected error rates.

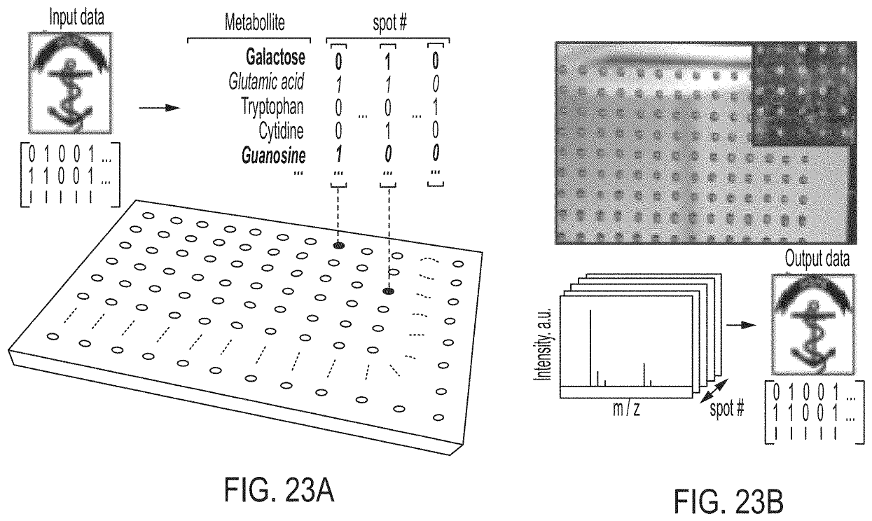

To encode ten bits of information using a library of M=twenty molecules, one can designate only |c|=210 binary mixtures as ‘valid’ out of the Ω=220 mixtures which are possible. Because |c|<Ω, channel coding can be thought of as another form of strategic sparsity, although it constrains the valid states in more sophisticated ways than limiting the number of molecules present. When analysis noise and errors result in an invalid mixture state, the decoder can classify it as the ‘nearest’ valid codeword, by some metric. This workflow is shown in FIG. 23(b).

Successful DNA memory demonstrations used Reed-Solomon codes and fountain codes, which are robust error correcting codes (ECC). Erlich & Zielinski, Science 355(6328), 950-954 (March 2017). Modern communications systems offer more practical methods for constructing near-capacity codes. Berrou et al., in, Proceedings of ICC '93 IEEE International Conference on Communications, vol. 2, pages 1064-1070 (May 1993). A recent system is “noise guessing,” where a codebook is constructed with random binary codewords, and upon detection, a finite series of maximum likelihood noise sequences are applied to the channel output sequentially. Duffy et al., arXiv, (2) (2018) This new “channel-centric” method is both efficient and capacity-achieving in the limit of large N_{c}.

### Example 7

### Writing Synthetic Metabolomes I

The synthetic metabolome for this EXAMPLE is a diverse set of 36 components including vitamins, nucleosides, nucleotides, amino acids, sugars, and metabolic pathway intermediates.

TABLE 6
SYNTHETIC METABOLOME LIBRARY
Synthetic metabolome library
List of compounds considered. The shown mass is the
monoisotopic mass, as found on PubChem. Kim et al.,
Nucleic Acids Res. 44(D1):D1202-13 (Jan
4, 2016) PubMed PMID: 26400175]

| Key | Name | Description | CID | Mass |
|---|---|---|---|---|
| aa | cis-Aconitic acid | acid | 643757 | 174.016 |
| cm | Creatine monohydrate | ADP to ATP recycler | 80116 | 149.08 |
| es | Sodium ethyl sulfate | alcohol metabolite | 23680278 | 147.981 |
| gm | Glutamine | amino acid | 738 | 146.069 |
| mt | Methionine | amino acid | 6137 | 149.051 |
| hd | Histidine | amino acid | 6274 | 155.069 |
| pa | Phenylalamine | amino acid | 8140 | 165.079 |
| la | L-(+)-Arginine | amino acid | 6322 | 174.112 |
| ts | Tyrosine | amino acid | 6057 | 181.074 |
| tp | Tryptophan | amino acid | 6305 | 204.09 |
| ga | N-Acetyl-L-glutamic acid | arginine intermediate | 70914 | 169.064 |
| dr | D-(−)Ribose | carbohydrate | 5311110 | 150.053 |
| ip | Imidazolepropionic acid | histidine metabolite | 7063 | 140.059 |
| pp | 4-Hydroxyphenylpyruvic acid | keto acid | 979 | 180.042 |
| ad | [symbol] diphosphate sodium | energy recycler | 8022 | 427.029 |
| gl | D-(+)-Galactose | monosaccharide | 8036 | 180.063 |
| td | Thymidine | nucleoside | 5789 | 242.09 |
| cd | Cytidine | nucleoside | 6175 | 243.086 |
| ud | Uridine | nucleoside | 6029 | 244.07 |
| da | 2′-Deoxyadenosine | nucleoside | 13830 | 251.102 |
| mm | 5-Methylaridine | nucleoside | 445408 | 258.085 |
| as | Adenosine | nucleoside | 60961 | 267.097 |
| dm | 2′-Deoxyadenosine monohydrate | nucleoside | 9549172 | 269.112 |
| go | [symbol] | nucleoside | 6802 | [symbol] |
| gh | 2′-Deoxyguan [symbol] hydrate | nucleoside | 16218597 | 285.107 |
| ct | Cytidine 5′-triphosphate NaCl | nucleoside | 16219171 | [symbol] |
| gp | D-Glucose 6-phosphate sodium salt | pathway inhibitor | 23792133 | 252.012 |
| na | NADP Disodium | pathway inhibitor | 2734411 | 787.039 |
| dc | 2′-Deoxycytidine | pyrimidine metab. | 13711 | 227.091 |
| du | 2′-Deoxyuridine | pyrimidine metab. | 13712 | 228.075 |
| ds | Dissodium succinate | salted acid | 9 [symbol] | 161.99 |
| sc | Trisodium Citrate Dihydrate | salted acid | 71474 | 293.994 |
| so | Sorbitol | sugar alcohol | 5780 | 182.079 |
| th | Thiamine hydrochloride | vitamin | 8282 | 336.058 |
| rf | Roboflavin | vitamin | 493570 | 376.138 |
| pq | Phylloquinone | vitamin | 5284607 | 450.35 |

[symbol]

indicates data missing or illegible when filed

Chemical preparation. Reagent grade samples of 36 distinct metabolic compounds shown in TABLE 6 were diluted in dimethyl sulfoxide (anhydrous), each to a nominal concentration of 25 mm. Several metabolites were initially dissolved in a small fraction (up to <25%) of alternative solvent (de-ionized water with or without 0.5M or 1 hydrochloric acid) to facilitate solvation in dimethyl sulfoxide. 10 μL of each compound was aliquoted into a 384-well low dead volume microplate from Labcyte Inc., San Jose, CA, USA.

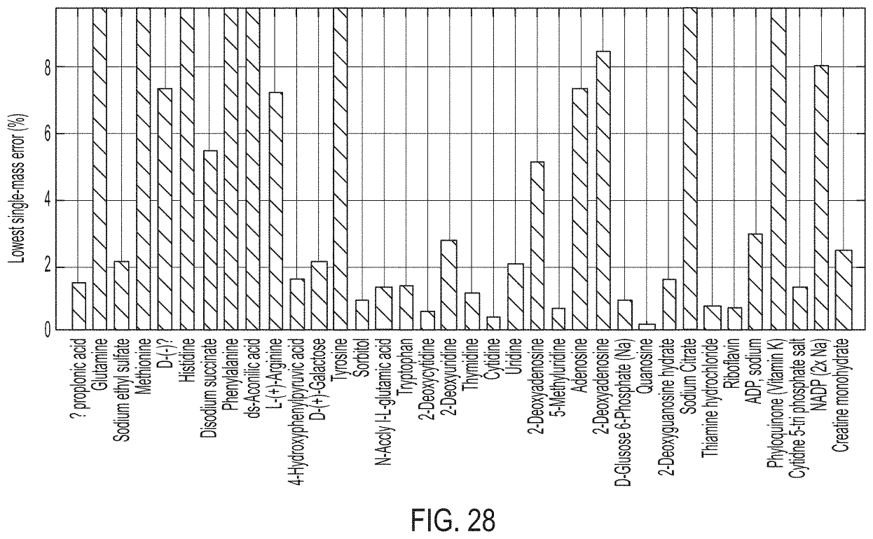

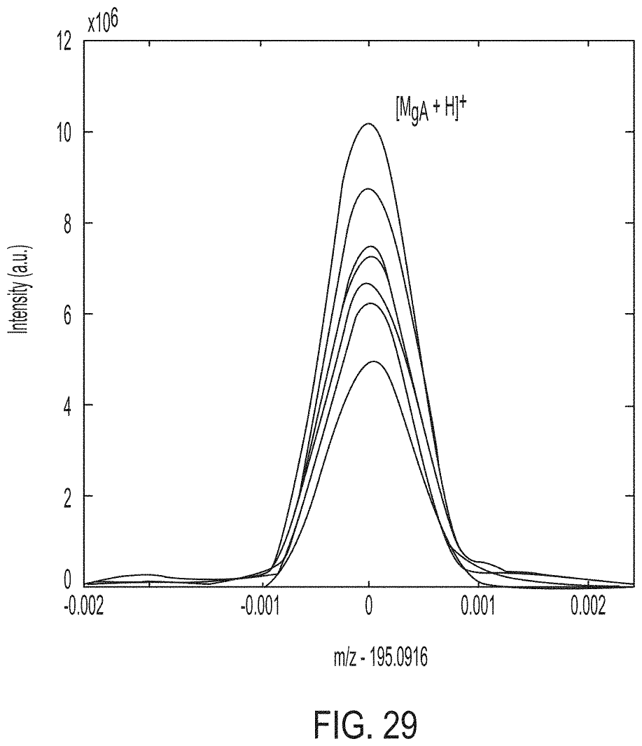

The read accuracy of each metabolite was found from a 50.4 kbit data plate written using combinatorial mixtures of all 36 metabolites, See, FIG. 28.

Data mixture preparation. The inventors then proceeded to assay the spots using Matrix Assisted Laser Desorption Ionization (MALDI) mass spectrometry (MS).

The chemical mixtures were prepared on a 76×120 mm² stainless steel MALDI plate. To write data with the synthetic metabolome, the inventors used an acoustic liquid handler (Echo 550, Labcyte) to transfer purified metabolic solutions in 2.5 nL increments from the library well-plate onto pre-defined locations on a steel MALDI plate. The nominal droplet transfer volume is 2.5 nL but to reduce variability one can use two droplets (5 nL) per compound. The destinations of the droplets are programmed to match a standard 2.25 mm pitch 1536-spot (32×48) target. This produces a spatial array of different mixtures of metabolites. The presence or absence of each compound in each mixture encodes one bit of information, and thus the total data capacity of a data plate is equal to the size of the metabolome library multiplied by the number of spots on the plate.

After evaporating the solvent, each data plate contains up to 1536 dried spots on a 2.25 mm pitch. See, FIG. 23(b).

After spotting the compounds to the MALDI plate, a MALDI matrix material was added to each location. The inventors selected the matrix 9-Aminoacridine for its compatibility with metabolite libraries, its low background in the small molecule regime, and its support for both positive and negative ion modes. The MALDI plate, containing droplets with both matrix and metabolite mixtures, is left to dry and crystallize overnight (˜10 hours).

Once dried, the plate can be stored in a humidity controlled cabinet or analyzed by MALDI-FT-ICR mass spectrometry.

To prescreen each compound in the synthetic metabolome, a 50.4 kbit data plate was written using combinatorial mixtures of all thirty-six metabolites. See, the chart in FIG. 27.

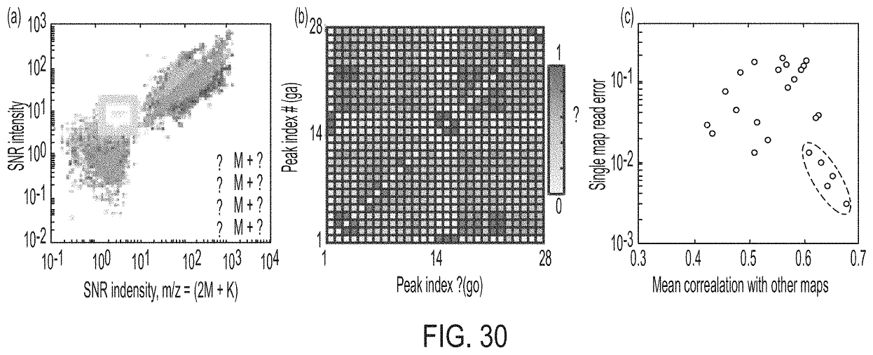

Ion cyclotron mass spectrometry of metabolite mixtures. The inventors used a Fourier-transform ion cyclotron resonance (FT-ICR) mass spectrometer (SolariX 7T, Bruker) to assay the array of crystallized mixtures. An FT-ICR mass spectrometer uses a strong magnetic field to excite ions into a periodic orbit, which enables a much finer mass resolution than time-of-flight (ToF) instruments. In these assays, the mass resolution was typically <0.001 Da. See FIG. 30.

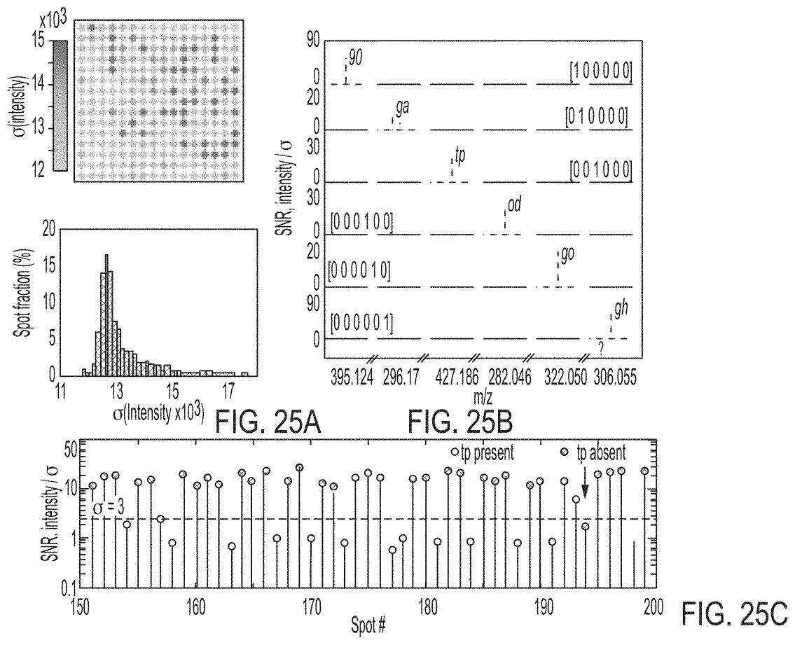

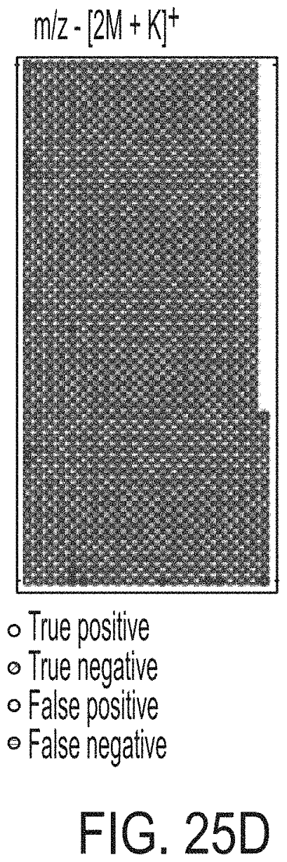

FIG. 25(a) shows one positive-ion MALDI-FT-ICR mass spectrum for a spot that included a guanosine (go) and 9-aminoacridine (9A) matrix. Protonated matrix adducts are identified at peaks 1 and 6 (blue), along with several adducts of guanosine-labeled (2: Na, 3: K, 4: 2K−H and 5: isopropyl alcohol (IPA)+H). The mass intensities vary by adduct and species. In FIG. 25(a), the intensity of the first peak (protonated matrix at m/z=195.0916±0.001) is shown graphically across 1024 locations. The protonated matrix is identified in 1020 out of 1024 spots (≈99.6%). The signal-to-noise ratio of each peak is a complex function of the sample preparation, analyte, and adduct.

### Example 8

### Writing Synthetic Metabolomes II

The inventors wrote more than 100 kbits of image data into synthetic metabolomes. This number is conservative.

TABLE 7
A list of all image data sets written and read with number
of repeats. Cumulatively, more than 100 kbits was written
into synthetic metabolomes

| Description | bits | R/W repetitions | net kbits |
|---|---|---|---|
| RI Flag 1781 | 8,904 | 3× | 26.7 |
| Cat drawing | 17,424 | 4× | 60.7 |
| Ibex print | 6,142 | 2× | 12.3 |
| All image data | | | 108.7 |

### Example 9

### Mass Analysis of Data Plates

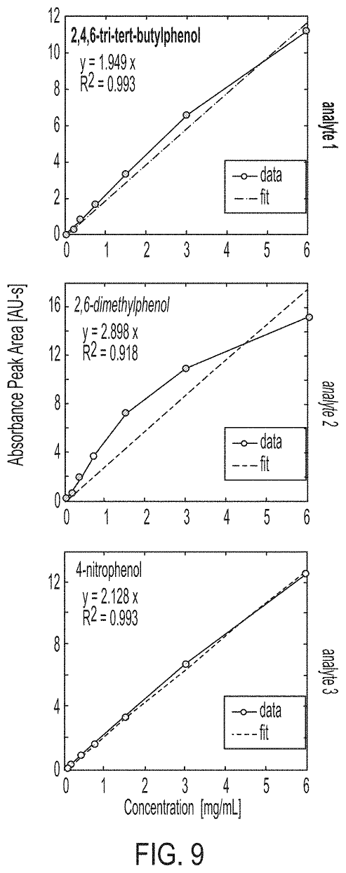

The inventors selected a subset of 6 metabolites, which were used to encode a 6142-pixel binary image of a Nubian ibex into an array 1024 mixtures. See, FIG. 9. After pseudo-randomly reshuffling bits, to spread the distribution of possible errors, the inventors mapped the data onto the presence or absence of six compounds: sorbitol (so), glutamic acid (ga), tryptophan (tp), cytidine (cd), guanosine (go) and 2-deoxyguanosine hydrate (gh). The plate was written and then assayed using FT-ICR MS.

A Fourier-transform ion cyclotron resonance (FT-ICR) mass spectrometer (SolariX 7T, Bruker) was used to analyze the crystallized metabolite data mixtures. The exact resolution is a function of the measurement time allocated per spectrum. For these assays, the inventors typically used 0.5-1 sec, yielding a resolution of <0.001 Da (see supplemental figure S2). The instrument is run in MALDI mode (laser power ˜22%) and is configured to serially measure the mass spectrum of each mixture on the 48×32 grid. Acquisition for a full plate takes <2 hours.

FIG. 25(a) shows a spatial map and histogram of the spectral background noise observed in 240 independent spots. Spectral noise varies because of crystallization differences and small positioning errors. Before further analysis, the inventors divided each spectrum by its 6, which provides a more direct comparison of signal strength at multiple locations. The peaks of interest after normalization for the six metabolites are shown in FIG. 25(b). The first row is a spot whose data contains the six bits [1 0 0 0 0 0]. So, only the m/z peak associated with the first metabolite, sorbitol, is present. Similarly, five other ‘one-hit’ patterns are shown that can be decoded without error.

To decode the mass spectra into binary data, the inventors chose a threshold of 3σ as the intensity required to declare the presence of a metabolite. For the tryptophan [2Mtp+K]⁺ mass shown in FIG. 25(c), this threshold yields a 96% correct classification.

This detection scheme can also be visualized by position on the plate, as shown in FIG. 25(d). The clustering of errors at the edges of the plate suggests that small misalignments between the MALDI laser positions and the droplet spotting locations were a source of error.

Statistical analysis of data plates. The analysis in FIG. 25(d) shows that there are masses which can statistically identify the metabolite contents. In practice, one compound can be associated with multiple peaks, of varying signal-to-noise ratios and usefulness. For a given metabolome, those skilled in the molecular computing art attempt to identify which m/z peaks are most appropriate to identify each library element.

Each high-resolution FT-ICR mass spectrum contains ˜2×10⁶ m/z points. By calculating the ensemble average of all mass spectra from the entire plate, the inventors restricted the search to peaks present in this ensemble spectrum (as averaging over spots with exactly the contents), which yields 1444 candidate peaks.

Those skilled in the molecular computing art can test each of these candidate peaks against the encoded dataset, to determine how accurately its intensity predicts the encoded data. See, FIG. 9(a).

Although the inventors identified these peaks without chemical bias, many features can be attributed to known adducts. FIG. 9(b) shows a histogram of the associated adduct masses. Adduct masses were calculated by automated subtraction of integer multiples of the monoisotopic mass of each metabolite from its identifying peak masses. H, Na, Na—H and K adducts are all frequently observed.

FIG. 9(c) shows the number of peaks achieving detection accuracy in the range of 70-100%. Except for sorbitol, there are at least ten peaks that identify each metabolite with >97% accuracy. Selecting the best performing peak for each metabolite, and applying a detection threshold of 2.5σ, was sufficient to recover data at about 2% cumulative read/write error. See, FIG. 9(e). FIG. 9(f)-(g) shows the corresponding input and output data images are shown in FIG. 4f-g. The simplicity and success of this analysis are encouraging.

### Example 10

Decoding Data from Multiple Peaks Using Logistic Regression

Although multiple m/z features yield similar decoding accuracy, only one peak was selected per metabolite. By assuming that the errors are not correlated (see FIG. 30), the inventors improved the method of the invention by using multiple m/z peaks per metabolite. Using techniques like those for the 6 kb ibex image in FIG. 26, these peaks were encoded a 17,424-bit image of a cat using 1,452 spots containing data mixtures from a 12-metabolite library. See, FIG. 27(a). MALDI-MS analysis of the plate took approximately 90 minutes. The inventors used this data to extend the decoding scheme to incorporate multiple m/z features.

After identifying the set of statistically discriminating peaks, the inventors performed a logistic regression using between 1 and 16 of the best-performing peaks. Those metabolites whose single-mass classification began at >99% showed minimal improvements with increasing numbers of features. Sorbitol (so) error rates fell more significantly from 20% to 4% with multi-peak regression. See, FIG. 27(b).

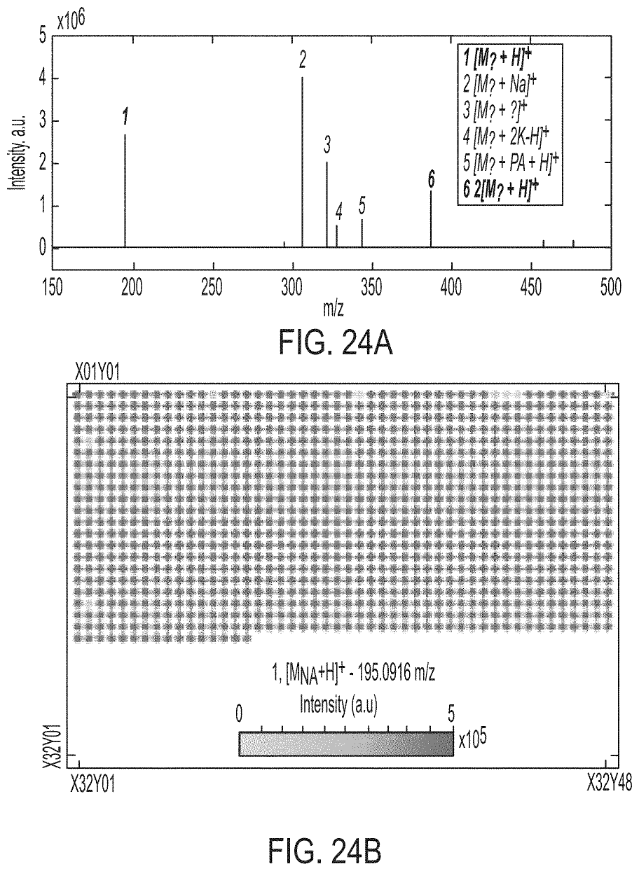

Multi-mass linear regression achieved an accuracy of 97.7% for the whole cat image. See, FIG. 27(c). Cumulative read error rates for the data in FIGS. 24A-24B and FIGS. 25A-25D are shown as a function of the number of masses used in the logistic regression. An overall error rate <0.5% was achievable from the ibex data set using 16-peak logistic regression.

The inventors presented several kilobyte-scale data sets encoded into synthetic metabolomes using robotic liquid handling, followed by recovery of the data by mass spectrometry. Statistically discriminating m/z features were used to classify the metabolite mixtures and recover the data at 98-99.5% accuracy. Typical write speeds were 5 bits/sec, and aggregate read speeds were 11 bits/sec.

The inventors performed assays where the cumulative concentration of all metabolites was typically 25 mM per spot. When a similar concentration is spread across the whole human metabolome (—125,000 elements, with half present on average), then each metabolite is present at 0.4 μM concentration.

The method of the invention can be performed by assaying with MALDI mass spectroscopy. Sub-zeptomole mass spectrometry and nanomolar concentration detection were available for nearly two decades. Belov et al., Anal. Chem. 72(10), 2271-2279 (2000); Tang et al., J. Bact. 189, 940-949 (2007). Therefore, μM detection of a whole metabolome can be demonstrated, and typical whole metabolome profiling identifies on the order of 10,000 ion peaks. Lu, Annu. Rev. Biochem. 86, 277{304 (2017).

Due consideration of interconversion of metabolites in the analysis will, therefore, reduce errors.

### Example 11

### Molecular Information Storage

Small molecules have several compelling advantages for both storage and computation. They do not require polymerization or enzymatic steps. They can resist cellular digestion and extreme environmental conditions. Some are cheap to synthesize. Small molecules have higher information capacity than DNA. In principle, they could store information at densities greater than 4×10¹⁸ bytes/mm³. This exceeds the theoretical storage density of DNA by up to two orders of magnitude.

This EXAMPLE focuses on classes of small molecules that can: (1) store large amounts of information with little degradation over time; (2) realize computations that can be embedded in the target applications; and (3) be detected in time and space with high resolution.

Several classes of small molecule classes are being tested, including acids and bases, inorganic catalysts and redox operations, stereoisomers, and multicomponent mixtures. Molecular computing processes can thus be tested theoretically and computationally. These include computing on analog/fractional values; Boolean logic; thresholding and majority logic; and autocatalytic reactions.

This EXAMPLE spans end-to-end the tasks of encoding data with small molecules, computing, and reading out results. The diversity in form and function of small molecules opens new possibilities for computing. The research results can be validated by applying them to a variety of impactful applications. These include image and signal processing; parallel pattern recognition; neural computation and machine learning; and hyperdimensional computing.

An overarching goal of this EXAMPLE is to devise in situ computing capabilities, where sensing, computing, and actuating occur at the molecular level, with no interfacing with external electronics.

This EXAMPLE has three synergistic thrusts. The first emphasizes testing and analysis; the second algorithmic development; and the third validation.

Thrust I: Small molecules for information encoding to test a variety of small-molecule classes from different domains of chemistry. The inventors establish theoretically and experimentally the information density of these classes for molecular storage. The inventors identify the reaction mechanisms suitable for in situ computation. The classes of molecular compounds include:

Acids and bases: Ubiquitous and easy to work with, acids and bases are complementary, a useful property that the inventors use for digital logic.

Inorganic catalysts and redox operations: Inorganic molecules are key reactants in autocatalytic reactions, which one can use for their natural thresholding properties in classification tasks. See EXAMPLE 1 above.

Stereoisomers share the same chemical formula but differ in their atomic arrangement. Examples are enantiomers: pairs of molecules that are mirror images of each other. The invention uses the relative concentrations of the two forms for fractional encodings and analog computation. Enantiomers are pairs of stereoisomers that are mirror images of each other. Enantiomers can be created using molecules with chiral carbons, i.e., carbon atoms bonded with four different chemical groups and possess a tetrahedral structure. Two enantiomers of the molecule carvone exist in nature. The R conformation is found in spearmint. The S conformation is found in caraway seeds. The two forms have distinct odors.

Multicomponent molecular mixtures: By encoding information in the presence or absence of diverse libraries of small molecules, molecular mixtures can store far more information than pure samples of single polymer sequences. See Walker et al. (eds), From Matter to Life: Information and Causality (Cambridge University Press, 2017).

Thrust II: Robust computing with small molecules to devise computing processes using the small molecule classes outlined in Thrust I above. The inventors used chemical reaction networks (CRNs) as a formalism. See FIG. 65. Since molecules can react in a highly parallel fashion, parallelism in the computation is a theme throughout. The inventors can investigate the following molecular computing paradigms:

Computing on analog/fractional values tests a paradigm for computing on molecular concentrations: a so-called fractional representation. See Soeken et al., IEEE Trans. Comput. Aided Des. Integr. Circuits Syst., 36(11), 1842-1855 (2017). Building on the theory of stochastic logic, one can implement complex math functions (polynomials, exponentials, logarithms, and hyperbolic tangents) with simple and efficient chemical reaction networks. See FIG. 65.

Thresholding, majority logic, and neural computation applies the complementarity of chemical species to implement a variety of forms of computation: parity, majority, thresholding, and neural computation. A “dual-rail” representation with acid and bases, as well as with stereoisomers, is a key concept.

Autocatalytic reactions for nonlinear computation use the nonlinearity of autocatalytic reactions to implement thresholding operations for neural computation.

Spanning these themes is the software tool, MolLink, which enables interdomain compilation and synthesis. MolLink enables one to compile programs into target chemistries, minimizing their cross-reactivity. It also provides simulation, verification, and visualization functions.

Thrust III: In situ molecular Processing: Building upon the first two thrusts, the inventors test uses of small molecule storage and computing. The goal is to devise in situ computing capabilities, where sensing, computing, and actuating occur at the molecular level, with no interfacing at all with external electronics, such as the following applications:

Image processing and classification to implement a full-scale molecular image classifier using neural network algorithms. Performing the requisite image processing in situ, in molecular form, eliminates data transfer bottlenecks. The inventors use conceptual topics from Thrust II: autocatalytic reactions for thresholding; complementarity for Boolean operations; and concentration-based molecular computation for arithmetic. One can quantify the accuracy of image processing in terms of the signal-to-noise ratio and the structural similarity index.

Machine learning to test a common data representation for integrating sensing, computing, and actuation in situ: hyperdimensional random vectors. Data is represented by long random vectors of integer or Boolean values. One can deploy this paradigm for machine learning, using the randomness of molecular mixtures for encoding, which can naturally map to large vector representations.

Rather than representing information in linear molecular sequences, one can store data in disordered mixtures of small molecules which can be identified by their molecular structures. To scale this approach to large amounts of data, the inventors created large libraries of unique compounds through automated multicomponent reactions. FIG. 31 shows an example of the encoding and readout approach.

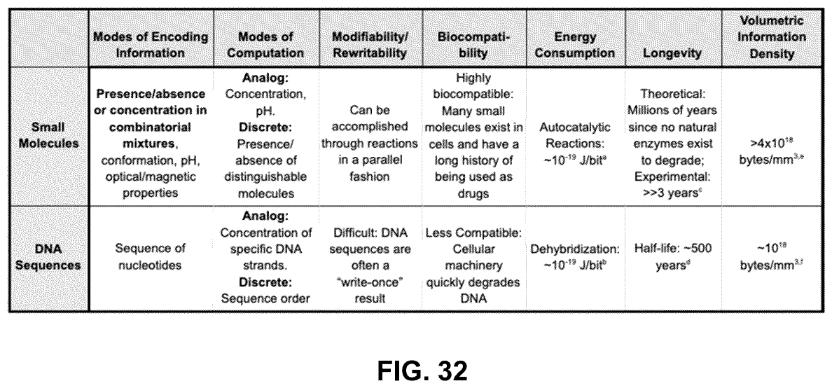

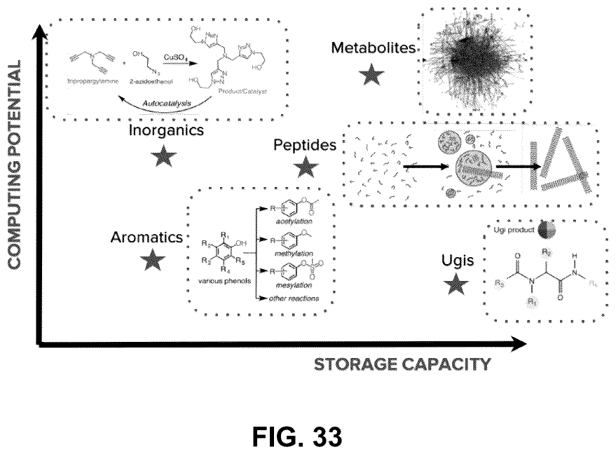

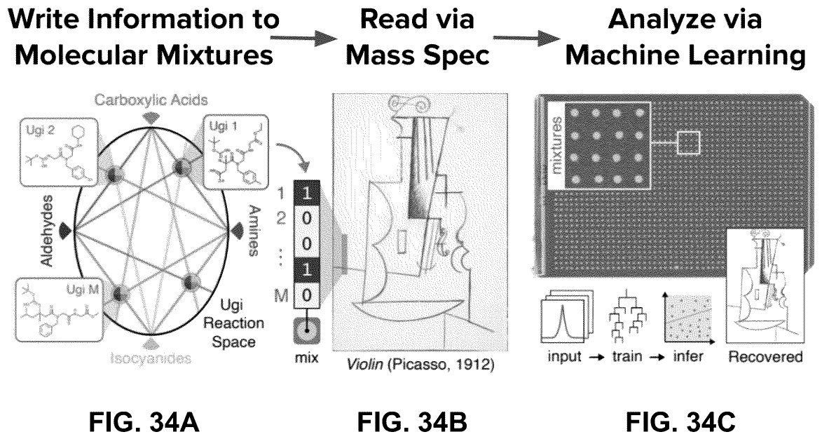

Small molecule reactions often occur spontaneously, if they are exergonic reactions, or with single-digit kcal/mol energy input, if they are endergonic reactions at room temperature. In principle, this makes them up to seven orders of magnitude more energy-efficient than electronics. FIG. 32 compares storage and compute metrics for DNA and small molecule systems.

### Example 12

### Molecular Informatics Updates

The purpose of this is EXAMPLE is to provide updated results concerning the practice of the invention disclosed in the EXAMPLES above. The goal of the invention disclosed in the EXAMPLES above is to (1) to store abstract digital data by taking advantage of small molecule chemical diversity; (2) to develop leading-edge synthesis and analysis techniques that can scale to billions of molecules/day; and (3) to establish scalable strategies for solution-phase information processing using small-molecule reactions. Using small molecules, information can be represented by combinations of chemical identity/formula/structure, chemical concentration, mixture composition, time, location, and energetic state (rotational, vibrational, electronic, magnetic). A chemical ensemble in storage having a static and unique system state can be measured as a unique spectral state. Moreover, a chemical ensemble in a reaction-based state can also be measured as a unique spectral state. The ongoing assays to test data storage includes (1) sparse mapping for higher data capacity with the same experimental throughput; (2) coding and redundancy for accurate data recovery; (3) improvements towards zero-characterization libraries; (4) on-demand synthesis in data write flow instead of pre-synthesis. In addition to single-peak identification of spectra, the invention also provides multipeak regressions that improve accuracy and combinatorically increases capacity.

Some themes of this EXAMPLE include:

Defining the space of opportunities for representing information using the continuum from precisely-specified molecules to imprecisely-specified mixtures. (1) Explicit molecular identity: DNA; proteins; and purified Ugis. (2) Unspecified molecular identity: Nominally one substance, but not necessarily purified, so that one does not know the readout signature ahead of time. (3) Specified mixtures: Active control over the relative proportions of multiple species per library component. (4) Unspecified mixtures: Natural samples that are known to contain many species, but not controlled. Mixtures may correspond to other contextual states or environmental states.

Defining the space of opportunities for representing information using the spectrum from precisely-specified molecules to imprecisely-specified mixtures. The opportunities include explicit molecular identity and explicit molecular identity, such as DNA; proteins; and purified Ugis.

Defining the space of opportunities for representing information using the spectrum from precisely-specified molecules to imprecisely-specified mixtures. Unspecified molecular identity: Nominally one substance, but not necessarily purified, so that one does not know the readout signature ahead of time.

TABLE 8

| | | | |
|---|---|---|---|
| ga | N-Acetyl-L-glutamic acid | arginine intermediate | 70914 |
| dr | D-(−)Ribose | carbohydrate | 5311110 |
| ip | Imidazolepropionic acid | histidine metabolite | 7063 |
| pp | 4-Hydroxyphenylpyruvic acid | keto acid | 979 |
| ad | [symbol] diphosphate sodium | energy recycler | 8022 |
| gl | D-(+)-Galactose | monosaccharide | 8036 |
| td | Thymidine | nucleoside | 5789 |
| cd | Cytidine | nucleoside | 6175 |
| ud | Uridine | nucleoside | 6029 |
| da | 2′-Deoxyadenosine | nucleoside | 13830 |
| mm | 5-Methylaridine | nucleoside | 445408 |
| as | Adenosine | nucleoside | 60961 |
| dm | 2′-Deoxyadenosine monohydrate | nucleoside | 9549172 |
| go | [symbol] | nucleoside | 6802 |
| gh | 2′-Deoxyguan [symbol] hydrate | nucleoside | 16218597 |
| ct | Cytidine 5′-triphosphate NaCl | nucleoside | 16219171 |
| gp | D-Glucose 6-phosphate sodium salt | pathway inhibitor | 23792133 |
| na | NADP Disodium | pathway inhibitor | 2734411 |
| dc | 2′-Deoxycytidine | pyrimidine metab. | 13711 |
| du | 2′-Deoxyuridine | pyrimidine metab. | 13712 |
| ds | Dissodium succinate | salted acid | 9 [symbol] |
| sc | Trisodium Citrate Dihydrate | salted acid | 71474 |
| so | Sorbitol | sugar alcohol | 5780 |
| th | Thiamine hydrochloride | vitamin | 8282 |
| rf | Roboflavin | vitamin | 493570 |
| pq | Phylloquinone | vitamin | 5284607 |

[symbol]

indicates data missing or illegible when filed

See also, TABLE 6.

Defining the space of opportunities for representing information using the spectrum from precisely-specified molecules to imprecisely-specified mixtures. Using specified mixtures, one can achieve active control over the relative proportions of multiple species per library component.

Defining the space of opportunities for representing information using the spectrum from precisely-specified molecules to imprecisely-specified mixtures. An under-represented category. Using specified mixtures, one can achieve active over the relative proportions of multiple species per library component. Traditional DNA data encodes one base per position. For composite DNA data encoding, one position might be 25% A, 0% C, 25% G, 50% T. See Anavy et al., Nature Biotechnology (2019).

Also, scaling up information density can use deeper reagent sequences, rather than a larger set of starting materials.

Determining differences in the speeds of molecular kinds (DNA, small molecule, etc.). Molecular computing approaches may have the same dimensionality, but these are not the same as silicon. The elements of the search processes that persons having ordinary skill in the molecular computing art can measure include kinetics (time to successful search reaction) and thermodynamics (free energy dissipated). See Lakin, Bioinformatics (2011).

Continued testing of the optimal space in which to encode data. Work is continuing on how small molecules are clustered in the chemical libraries that have been created. New interconnections arise, whose spectral networks could have different features and scalings. The different relationships in spectral space can lead to improved molecular fingerprinting assays. See Grzybowski et al., Nature Chemistry (2009). The techniques of the invention can be used to understand the structure (interconnectedness, scales) of those spaces. See FIGs.

So far, the inventors synthesized mixtures of Ugi molecules representing >1,000,000 bits of data, the most reported in small molecules.

The inventors developed new time-dependent storage techniques that can increase capacity, while using the same amount of resources.

The inventors demonstrated volumetric and chemical perceptrons and used them for image processing. See FIGS. 3A-3D and FIG. 66.

In addition to the explicit mixtures from pre-synthesized molecular libraries that the inventors created in the EXAMPLES above, persons having ordinary skill in the molecular computing art can use the time-order of reactive components to store additional information in relative concentrations of products. In addition to the single-peak identification of spectra disclosed in the EXAMPLES above, persons having ordinary skill in the molecular computing art can measure and compute multipeak regressions that substantially improve accuracy and combinatorically increase capacity.

Computation risks and mitigation. See also EXAMPLE 11. For scaling molecular computation to storage capacity, computational scaling is limited by cross-reactivity, reaction speed in solution. In mitigation: The initial use of metabolic pathways evolved to cofunction, so development of techniques that require fewer molecular than in silico operations is possible.

For marrying storage and computing media, the stability required for storage is inconsistent with the malleability needed for computation. In mitigation, one can use metabolite computation or use of multistability.

For computation speed, the reaction-based, classical molecular computation is slower and limited by reaction times. In mitigation, one can encode more complex operations into each reaction, exploration of degrees of freedom that may be more quickly manipulated.

### Example 13

### Repurposing Waste Chemicals for Sustainable and Durable Molecular Data Storage

Molecular data systems have been proposed as a path to meet some of the world's ever-growing demands for information storage while reaching greater information density, durability, and sustainability than electromagnetic memory. However, existing molecular storage methods are limited in cost and information capacity by practical scaling challenges associated with chemical synthesis. In this work, the inventors demonstrate that data storage can be achieved with chemicals requiring no explicit synthesis, purification, or prior knowledge of molecular structure. The inventors encoded digital data using chemical waste sources containing mixtures of unknown byproducts. This work highlights a path for molecular data storage to use cost-free chemical waste while avoiding complicated synthesis or purification. For any chemical information system to succeed and scale, it must overcome the synthesis, purification, and cost bottlenecks associated with all reported demonstrations, spanning from DNA to synthetic polymers, to other families of small molecules. Ceze, Nivala, & Strauss, Nature Rev. Genet. 20, 456-466 (2019); Lee et al., Nature Commun., 10, 2383 (2019); Rutten, Vaandrager, Elemans, & Nolte, Encoding information into polymers. Nature Rev. Chem., 2, 365-381 (2018); Nagarkar et al., ACS Cent. Sci., 7, 1728-1735 (2021); Cafferty et al., ACS Cent. Sci., 5, 911-916 (2019).

Any discussion of molecular information begins with DNA, which is a biologically natural candidate for synthetic molecular data systems. DNA could in theory achieve one million times greater information density than current electronic technology. Ceze, Nivala, & Strauss, Nature Rev. Genet. 20, 456-466 (2019).

But although the chemical synthesis of DNA has been used and improved upon for decades, DNA oligomer synthesis and purification is still material-intensive. ATDBio, Solid-phase oligonucleotide synthesis. DNA oligomer synthesis and purification results in low yields and producing significant waste. These challenges are inherent to the serial nature of long polymers. Even if the yield of a single base incorporation is 99%, the yield of a 150-mer would be only 22%. To reduce such losses, DNA synthesis chemistries commonly use at least 20× excess of phosphoramidites and tetrazole-based activator, as well as an excess of solvents to wash between each serial synthesis step. ATDBio, Solid-phase oligonucleotide synthesis. Material waste from DNA synthesis includes the protecting group, dimethoxytrityl, which is 35% of the weight of each phosphoramidite; tetrazole, which is explosive; acetonitrile, amidites, and pyridine, among others. Sanghvi, Ravikumar, Scozzari, & Cole, Pure Appl. Chem., 73, 175-180 (2001). In addition to costing money and time, from an environmental and economic perspective it is valuable to understand how much of the input material ends up in the final product and how much ends up in waste streams.

Another theoretically valuable feature of DNA is its durability. However, many environmental factors can cause DNA degradation or reactivity, which could cause information loss. These factors include pH, ionizing radiation and ultraviolet light exposure, salt concentration of the medium, presence of nucleases, and hydrolysis, among others. Branzei & Foiani, Nature Rev. Mol. Cell Biol., 9, 297-308 (2008); Friedberg, Nature, 421, 436-440 (2003). Hydrolysis is the dominant mechanism for instability, and it can lead to information loss through depurination, deamination, and backbone cleavage. To maintain the integrity of data stored in DNA, it needs to be maintained in carefully controlled environments, and dried, frozen, or encapsulated. These treatments limit the potential commercial markets and can reduce the information density by orders of magnitude. Matange, Tuck, & Keung, Nature Commun. 12, 1358 (2021).

To work around these limitations, one can explore non-genomic molecules for information storage. Alternative sequence-defined polymers offer different synthesis paths and a larger library of monomers, which allows for a greater information density in the same polymer length. Lutz, Macromolecules, 48, 4759-4767 (2015). Demonstrations of synthetic polymers have used oligo(triazole amides) (Amalian, Trinh, Lutz & Charles, Anal. Chem., 88, 3715-3722 (2016)), oligourethanes (Barnes, Chem., 7, 1417-1419 (2021)), poly(phosphodiester)s (Al Ouahabi, Charles & Lutz, J. Am. Chem. Soc. 137, 5629-5635 (2015)), poly(alkoxyamine amide)s (Roy et al., Nature Commun. 6, 7237 (2015)), and poly(1-lactic-co-glycolic acid)s (PLGAs) (Lee et al. Sci. Adv. 8, eab18614 (2022)), among others.

While synthetic polymers offer greater chemical diversity and theoretically greater data density than DNA, synthesizing and reading long polymer chains is its own significant hurdle. While this is an active area of research, the upper limit of de novo sequencing of digitally encoded polymers is on the order of 77 units. Al Ouahabi, Amalian, Charles & Lutz, Nature Commun., 8, 967 (2017). Without further advances, these challenges may mean that the theoretical advantages of synthetic polymers are unachievable in practice.

Small non-polymeric molecules can also be used to encode digital information. Previously, the inventors demonstrated the use of synthetic metabolite mixtures to store digital information. Kennedy et al., PLoS One, 14, e0217364 (2019). Molecular data storage can be used to achieve secret messaging on common objects. Kennedy et al., Science Reports, 11, 13960 (2021). In the work that used metabolites to store data, the inventors showed that digital data could be encoded in the presence or absence of vitamins, nucleotides, amino acids, sugars, and metabolic pathway intermediates. A similar encoding scheme was used by others to encode digital data using mixtures of oligopeptides and fluorescent dyes. Nagarkar et al., ACS Cent. Sci., 7, 1728-1735 (2021); Cafferty et al., ACS Cent. Sci., 5, 911-916 (2019).

The inventors further extended these methods by encoding larger digital datasets in organic small molecules using combinatorial chemistry with multicomponent Ugi products and applied sparse encoding schemes for redundancy and improved error tolerance. Arcadia et al., Nature Commun. 11, 691 (2020).; Rosenstein et al., IEEE Trans. NanoBioscience, 19, 378-384 (2020).

While these studies have established the concept of small molecule-based data storage, they usually still require the synthesis of a starting chemical library. Library synthesis can be time-consuming, and depending on the molecules chosen, it can also be cost-prohibitive for scaling to larger datasets.

In this work, the inventors demonstrate that molecular data storage can be achieved with no synthesis or purification steps and that data can even be stored using compounds available from waste sources at no material cost. This is a general approach that can work with sources whose exact chemical makeup is unknown to the user. An overview of the data storage process is shown in FIG. 47, highlighting the ease and scalability of the process. A digital image was encoded using complex mixtures of unknown waste chemicals. These waste sources were organic synthesis byproducts and toxicology research byproducts, which were later shown to include per- and poly-fluoroalkyl substances (PFAS), among other compounds. Rather than creating new waste streams, this work suggests a circular system where waste chemicals can be re-purposed for information storage. In addition to providing improved cost efficiency and resource efficiency, given appropriate chemical inputs it can also encode data using highly durable compounds whose stability and lifetime exceed that of DNA.

Turning chemical waste into digital data. The inventors encoded data using chemicals diverted from waste streams. Several waste sources were obtained from two academic laboratories. One laboratory was developing organic synthesis methodology. Roy et al., J. Am. Chem. Soc. 145, 277-287 (2023). Another laboratory was testing the developmental effects of exposure to environmental contaminants. Biechele-Speziale et al., NeuroToxicology, 97, 109-119 (2023). Unlike most other molecular data storage systems, prior knowledge of the chemical makeup of the source materials was not required for their use. A variety of waste samples were used to test the complexity limits of the system. No purification of the waste samples was performed. The samples were diluted in dimethyl sulfoxide. A Matrix Assisted Laser Desorption Ionization (MALDI) matrix was added to the mixtures.

Encoding information in small molecule libraries was demonstrated in the inventors' previous work using the presence or absence of each library element to represent binary values of “1” and “0”. Arcadia et al. Nature Commun. 11, 691 (2020). In this EXAMPLE, the inventors used seven waste samples as library elements, and each mixture encoded up to seven bits of information.

FIG. 48 shows the method of encoding a 3,249-pixel digital image. To provide redundancy and support error correction, the digital image was processed with a Rate 1/3 Turbo code (Step b) and a known permutation matrix (Stepc). To assist with recovery of the data, a training set of all 2⁷=128 enumerated binary mixtures was concatenated with the encoded dataset (FIG. 48 at ‘d’). The whole dataset, including the training and test data, was rearranged as a 1521×7 matrix, where each column corresponded to a unique library element (one of the seven waste mixtures). Each row of the matrix was mapped to a unique location on a standard metal MALDI target data plate. For each element of the matrix, if the value was 1, an acoustic liquid handler (Echo 550, Beckman Coulter) was instructed to dispense 30 nL of the appropriate waste mixture to the designated location. If the value was 0, no transfer was performed. This process resulted in 1521 mixtures of subsets of the seven sources. In each mixture the presence (1) or absence (0) of each waste source encoded the data. The mixtures were dried overnight, leaving crystalline spots behind. This process is scalable to thousands of unique mixtures per data plate, and hundreds of library elements. Arcadia et al. Nature Commun. 11, 691 (2020).

Reading back data from the encoded waste mixtures. To recover the digital data from the chemical samples, each mixture on the data plate was analyzed with a Fourier transform ion cyclotron (FT-ICR) MALDI mass spectrometer in positive ion mode. Each spectrum contained a varying number of peaks based on the complexity of the mixture. The training set of 2⁷=128 distinct combinations of the library elements was used to train supervised learning algorithms to identify the presence of each library element in each location on the data plate.

The mass spectra from the training data set were averaged, and important features for each library element were identified relative to the average. These features were used in the random forest regression model to generate classifiers for each library element. The classifiers were then used to make soft decisions about the presence or absence of each library element within a spot, and a threshold was applied to these decisions. If the features exceeded a threshold value that was determined by the regression model, the unique element was recorded as present and was assigned the binary value of “1,” and otherwise was declared as absent and was assigned the value “0.”

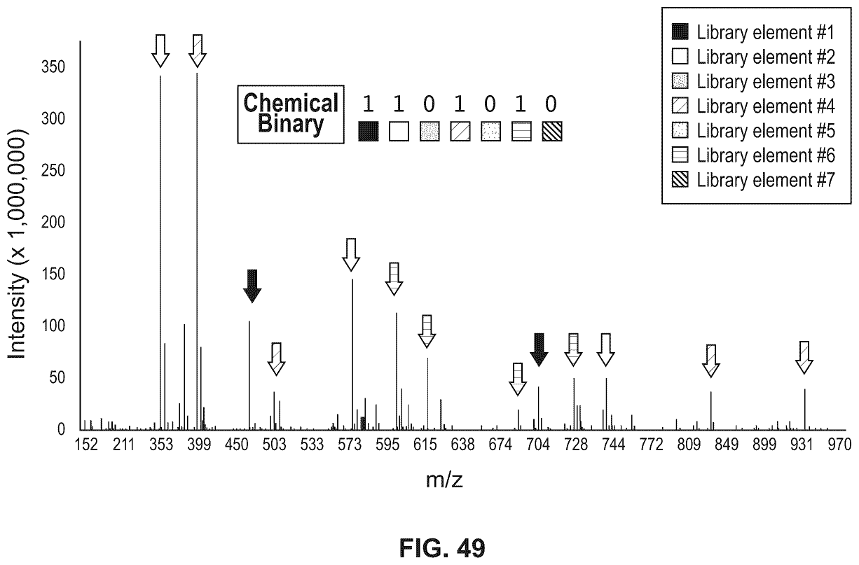

FIG. 49 shows an example of a spectrum obtained during the analysis. The spectrum contains hundreds of unique features. These highlighted features belong to the library element #1, #2, #4, and #6 that encodes for the following seven bits of information: “1101010”.

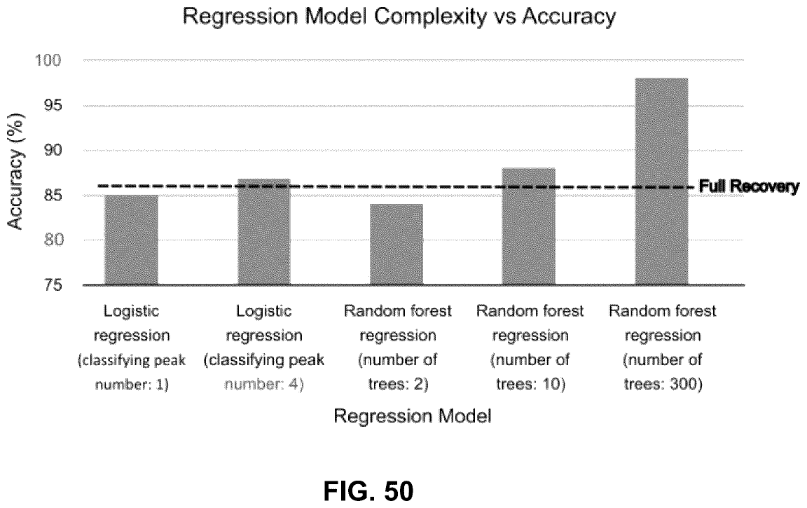

To interpret the spectra, supervised learning was used. The inventors tested two common regression models, logistic regression and random forest regression, at varying complexity to determine the model and level of complexity required to achieve full recovery of the encoded data. See FIG. 50. Seven classifier models were trained, one binary classifier for each library element. Due to the complexity of the library mixtures, using one peak per classifier was not enough. However, even a simple logistic regression with four peaks achieved 90% raw accuracy, which was enough to achieve 100% recovery after Turbo decoding. See FIG. 4. Random forest regression showed a similar improvement when increasing the number of trees from 2 to 10. See FIG. 50. The random forest model with 2 trees was not enough to recover the data. Using 10 trees resulted in 8% error that was fully recovered after Turbo decoding. See FIG. 4. Because the random forest model resulted in a higher accuracy than the logistic model, it was used to interpret the mass spectra for the encoded dataset. To further decrease the error rate, a random forest model with 300 trees was used and resulted in an error rate of 1.78%. See FIG. 50.

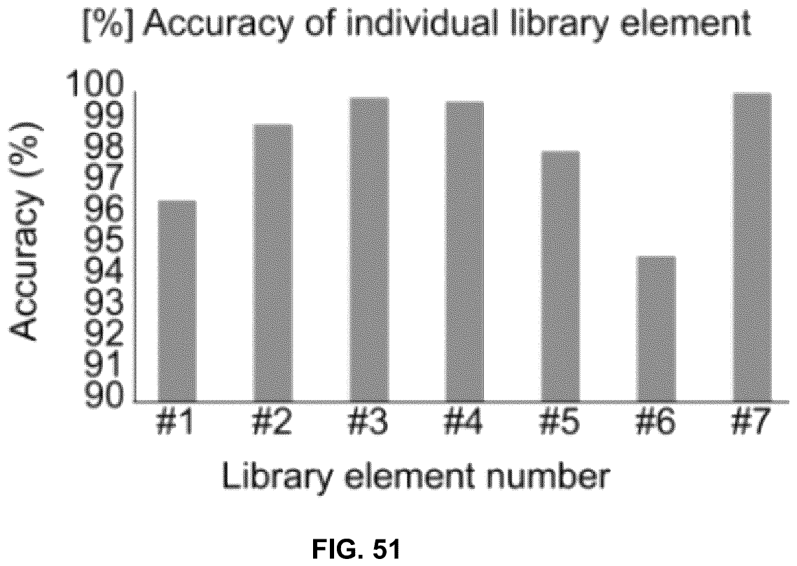

Recovery of data. The raw error rate of the total test dataset, including redundancy added for error correction, was less than 2%. Each of the chemical library elements demonstrated performance with over 94% accuracy. See FIG. 51. However, between each library element, there were significant differences. The total error from library element 7 was 0.07%, while the error from library element 6 was 5.31%. There were spatial trends in the accuracy, with errors overrepresented near the left edge of the plate, where 2% of the mixtures were responsible for 17% of the total errors.

This error rate could be because of a mechanical error in the liquid handler or a slight misalignment of the library plate that led to insufficient or improper transfer of the library elements to the destination plate. The error could arise from misalignment of the plate in the mass spectrometer which could have resulted in insufficient ionization of the spots in that column. Before error correction, the raw data recovery was 98.3% accurate. Based on simulations, the Rate 1/3 Turbo code corrected up to 14% raw error. After Turbo decoding, the inventors achieved 100% recovery of the encoded image. See FIG. 48, step h. Table 10 (below) shows example MS instrument parameters for positive and negative ESI of chemical library analysis.

TABLE 10
Detailed instrument parameters for both negative and positive ESI of chemical library
analysis

| Polarity | Negative and Positive Electrospray Ionization |
|---|---|
| Chromatography | |
| Injection Volume | 20 μL |
| Analytical Column | Thermo Hypersil Gold Vanquish C18 column. |
| | (100 mm × 2.1 mm x 1.9 um) |
| Column Temperature | 40º C. |
| Mobile Phase A | 2 mM ammonium acetate in 5% acetonitrile |
| Mobile Phase B | 2 mM ammonium acetate in 100% acetonitrile |
| Solvent Gradient | 2% B for 0.2 min, increase to 30% B until 4 min |
| | using a gradient curve of 6, increase to 55% B until |
| | 7 min using a gradient curve of 8, increase to 55% |
| | B until 9 min using a gradient curve of 8, increase to |
| | 75% B until 9 min using a gradient curve of 8, |
| | increase to 98% B until 10 min using a gradient |
| | curve of 5, hold at 98% B until 11 min using a |
| | gradient curve of 6, and decrease over 1 min to the |
| | initial conditions for equilibration and hold for 3 min |
| Total Run Time | 15 minutes |
| Source Settings | |
| Sheath Gas | 40 (arbitrary units) |
| Aux Gas | 10 (arbitrary units) |
| Sweep Gas Flow Rate | 2 (arbitrary units) |
| Capillary Temperature | 320° C. |
| Funnel RF level | 40 |
| Aux. gas heater temperature (° C.) | 350° C. |
| Spray Voltage | 2.7 kV |
| Full Scan Parameters | |
| Resolution | 120,000 |
| AGC target | 3 × 10⁶ |
| Maximum dwell time | 100 milliseconds |
| Scan range | 100-1500 m/z |
| Data-dependent (dd) MS² Parameters | |
| Resolution | 15,000 |
| AGC target | 2 × 10⁵ |
| Maximum dwell time | 100 milliseconds |
| Loop count | 8 |
| Top N | 8 |
| Isolation window | 1 m/z |
| Normalized Collison Energy (NCE) | Stepped NCE: 20, 30, 40 |
| dd Settings | |
| Minimum AGC target | 5 × 10³ |
| Dynamic Exclusion | 10 s |
| Inclusion | on |
| If idle | pick others |

### List of Embodiments

Specific compositions and methods of the invention have been described. The detailed description in this specification is illustrative and not restrictive or exhaustive. The detailed description does not intend to limit the disclosure to the precise form described. Other equivalents and modifications besides those already described are possible without departing from the inventive concepts described in this specification, as persons having ordinary skill in the computational art will recognize. When the specification or claims recite method steps or functions in an order, alternative embodiments may perform the functions in a different order or concurrently. The inventive subject matter should not be restricted except in the spirit of the disclosure.

All terms should be interpreted in the broadest possible manner consistent with the context when interpreting the disclosure. Unless otherwise defined, the technical and scientific terms used in this specification have the same meaning as commonly understood by persons having ordinary skill in the computational art. This invention is not limited to the particular methods, protocols, and reagents described in this specification and can vary in practice. The invention is defined only by the claims.

When a range of values is provided, each intervening value, to the tenth of the unit of the lower limit, unless the context dictates otherwise, between the upper and lower limit of that range and any other stated or intervening value in that range of values.

### Other Embodiments

The contents of all references cited herein are incorporated by reference in their entireties. In case of conflict, the present application, including any definitions herein, will control.

Having thus described in detail preferred embodiments of the present invention, other embodiments will be evident to those skilled in the molecular computing art. The foregoing detailed description is illustrative and not restrictive. The spirit and scope of the present invention are not limited to the above examples but are encompassed by the following claims.

Among other embodiments, the invention provides:

A method for computing with chemicals, the method comprising the steps of: encoding an abstract digital data into a plurality of liquid volumes of a plurality of chemicals to obtain a dataset; translating the dataset into a chemical form; creating the data set using spectrometry, spectroscopy, or a combination of both assay methods; querying the dataset by performing a volumetric operation to obtain a perceptron; and analyzing the perceptron for identifying chemical structure, concentration, or another characteristic of at least one of the chemicals, thereby developing a chemical computational language.

The method described above, wherein the abstract digital data comprises a binary computer language.

The method described above, wherein translating further comprises assembling a library of chemicals in the dataset.

The method described above, wherein volumetric operation is performed robotically.

The method described above, wherein volumetric operation further comprises a programmed standard volumetric transfer.

The method described above, wherein the plurality of liquid volumes of the plurality of chemicals are a mixture of different chemical molecules, and optionally, wherein the abstract digital data comprises presence or absence of chemical molecules in the mixture.

The method described above, wherein spectrometry comprises mass spectrometry.

The method of described above, wherein spectroscopy comprises at least one of: ultraviolet-visible spectroscopy, Rydberg spectroscopy, Infrared spectroscopy, fluorescence spectroscopy, and absorption spectroscopy.

A method for molecular computing using a chemical perceptron, the method comprising the steps of: preparing a plurality of distinct mixtures of molecules to obtain a chemical data set, wherein the mixtures of molecules are an input unit of the perceptron; writing the data set on an array and applying an operation to the data set for transduction of the input unit; combining the input unit by an operation to obtain an operation product; and detecting a threshold of the operation product, thereby obtaining product of the chemical perceptron.

The method described above, wherein the array is a micro-well plate or a MALDI plate.

The method described above, further comprising applying a chemical multiply accumulate operation to obtain the mathematical equivalent of the perceptron, and optionally wherein the chemical multiply accumulate operation is z=Lᵢwᵢ·xᵢ+b, where z is the output of the multiply accumulate operation, Wᵢ is the weight of a species, xᵢ is the initial amount of the species, and b is the bias.

A chemical perceptron comprising: a plurality of analytes; an array spectrum; a fluid handling robot; a computer; and a molecule quantifier or a molecule identifier.

The perceptron described above, wherein the molecule quantifier or molecule identifier is at least one selected from: a high performance liquid chromatography (HPLC), and a mass spectrometer, and optionally wherein the array spectrum is at least one selected from a micro-well plate, and a MALDI plate.

A method for obtaining an output of a linear classification operation, the method comprising the steps of: encoding binary data into a chemical composition of a plurality of liquid samples; receiving an input of binary data; performing multiplication operation by a plurality of fractional volume transfers of the liquid samples into a plurality of micro-wells corresponding to the input; pooling the liquid samples to obtain an output; and analyzing the concentration of the chemicals in the output by a HPLC, thereby obtaining the output for the linear classification operation.

The method described above, further comprising the step of scaling a classifier weight corresponding to maximum available volume in the micro-wells, and optionally wherein the classifier weight corresponds to amount of the plurality of fractional volume transfers of the liquid samples.

The method described above, further comprising performing the plurality of fractional volume transfers by a robot.

The method described above, wherein the liquid samples are nonreactive.

The method described above, further comprising performing parallel computing to obtain the output for the linear classification operation.

A method for coding information with a mixture of product molecules, the method comprising the steps of: mapping of a plurality of each pixels on an array corresponding to a plurality of known organic chemical entity molecules each in a known location within the array to obtain a pixel map; reacting a selected subset of the molecules corresponding to the pixel map thereby synthesizing the mixture of product molecules; and analyzing the mixture of product molecules to identify the product molecules.

The method described above, wherein the reacting step further comprises performing an Ugi reaction to obtain an Ugi product molecule, and optionally further comprising the step of creating a new Ugi product molecule, or optionally wherein the plurality of known organic chemical entity molecules comprise a chemical scaffold.

The method described above, wherein the plurality of known organic chemical entity molecules comprise reaction groups, optionally wherein the reacting step further comprises substituting the reaction groups.

The method described above, wherein the reacting step further comprises changing pH of at least one of the plurality of known organic chemical entity molecules.

A method for computing with chemicals, the method comprising the steps of: encoding digital data into a plurality of chemicals to obtain a dataset and translating the dataset into a chemical form; reading the data set using spectrometry and/or spectroscopy and querying the dataset by performing an operation to obtain a perceptron; and analyzing the perceptron for identifying chemical structure, concentration, or another characteristic of at least one of the chemicals, thereby developing a chemical computational language.

The method described above, wherein the operation further comprises at least one of a volumetric transfer or a chemical reaction, optionally further comprising the step of measuring a rate constant and/or an equilibrium constant of the chemical reaction, or optionally wherein the chemical reaction further comprises an Ugi reaction to obtain at least one Ugi product molecule.

The method described above, further comprising the step of synthesizing a new chemical.

The method described above, wherein digital data comprises a computer language.

The method described above, wherein the plurality of chemicals further comprises a plurality of liquid volumes.

The method described above, wherein the plurality of chemicals are a mixture of different chemical molecules, and optionally wherein the digital data comprises presence or absence of chemical molecules in the mixture.

The method described above, wherein spectrometry comprises mass spectrometry.

The method described above, wherein spectroscopy comprises at least one of: ultraviolet-visible spectroscopy, Rydberg spectroscopy, Infrared spectroscopy, fluorescence spectroscopy, and absorption spectroscopy.

The method described above, wherein the plurality of chemicals comprise reaction groups, and optionally wherein reacting further comprises substituting the reaction groups.

The method described above, wherein reacting further comprises changing pH of at least one of the plurality of chemicals.

An information storage system, comprising a solid surface with plurality of addressable locations, wherein each addressable location comprises a mixture of small molecules, and each mixture contains one set of small molecules per addressable location.

The information storage system described above, wherein the small molecules are metabolomic elements.

The information storage system of described above, wherein the solid surface is a MALDI plate.

The information storage system described above, wherein the addressable locations comprise at least 1024 independent mixture spots.

The information storage system described above, wherein the addressable locations comprise thousands of spatially arrayed nanoliter spots.

The information storage system described above, wherein the storage system comprises more than 100 kbits of data.

The information storage system described above, wherein the storage system comprises a gigabyte of data.

A method of storing information in a plurality of metabolomic elements, comprising the steps of converting a format of information into a plurality of digital sequences; converting the plurality of digital sequences into a plurality of corresponding metabolomic elements using one bit per metabolomic element, and storing the plurality of corresponding metabolomic elements on a solid surface, where the location of a metabolomic element is an addressable location.

The method described above, wherein the converting the plurality of digital sequences into a plurality of corresponding metabolomic elements Is performed using robotic liquid handling.

A method of retrieving a format of information from a plurality of metabolomic elements encoding digital sequences of the format of information, comprising the steps of assaying a solid surface comprising a set of metabolomic elements; where the location of a metabolomic element is an addressable location; converting the metabolomic elements to digital sequences; and converting the digital sequences to a format of information.

The method of described above, wherein the assay method is mass-spectroscopy, and optionally wherein the mass-spectroscopy is MALDI mass spectroscopy.

The method described above, wherein the retrieving a format of information from a plurality of metabolomic elements results in an information recovery at >99% accuracy.

The method described above, further comprising the step of visualizing the format of information.

The method described above, further comprising the step of mitigating errors in the converting of the metabolomic elements to digital sequences.

The method of described above, wherein the mitigating errors comprises logistic regression analysis.

The method described above, wherein the converting the digital sequences to a format of information is performed using one m/z peak selected per metabolomic element.

The method described above, wherein the converting the digital sequences to a format of information is performed using multiple m/z peaks selected per metabolomic element.

A chemical perceptron, comprising the mathematical framework described herein for quantifying chemical memory.

The chemical perceptron described above, further comprising autocatalytic thresholding.

### REFERENCES

Persons having ordinary skill in the molecular computing art can rely on the following patents, patent applications, scientific books, and scientific publications for enabling methods:

### Patent Citations

U.S. Pat. No. 10,626,016 (Doona et al.), Method and composition of humidity-controlled generation of chlorine dioxide in polymers and superabsorbent hydrogels, issued Apr. 21, 2020.
US20060191319A1 (Kurup), Electronic nose for chemical sensing, published Aug. 31, 2006.
US20140200716A1 (Perez-Mercader et al.), Chemically-operated Turing machine, published July 17, 201
WO1997007440A1 (University of Southern California), Molecular computer, published Feb. 27, 1997.
WO2007128804A2 (Siemens Aktiengesellschaft), Biomolecular arithmetic unit, published Nov. 15, 2007.

### Non-Patent Citations

A ‘molecular thumb drive’ stores big files in small droplets, Nature 571, 148-149 (Jul. 7, 2019).
Adleman, Molecular computation of solutions to combinatorial problems, Science, 266(5187), 1021-1024 (1994).
Aires-de-Sousa, Hemmer, & Gastinger, Prediction of ¹H NMR chemical shifts using neural networks. Anal. Chem., 74(1), 80-90 (2002).
Alberts, Molecular Biology of the Cell (Garland Science, 2017).
Allentoft et al., The half-life of DNA in bone: Measuring decay kinetics in 158 dated fossils, in Proceedings of the Royal Society B: Biological Sciences (2012).
Amarú, Gaillardon, & de Micheli, Majority-inverter graph: A novel data-structure and algorithms for efficient logic optimization, in 2014 51st ACM/EDAC/IEEE Design Automation Conference (DAC) (IEEE, 2014), pp. 1-6.
Anavy et al., Data storage in DNA with fewer synthesis cycles using composite DNA letters. Nature Biotechnology, 37, 1229-1236 (2019).
Andreasson & Pischel, Molecules for security measures: From keypad locks to advanced communication protocols, Chem. Soc. Rev., 47(7), 2266-2279 (2018).
Aneshansley, Eisner, Widom, & Widom, Biochemistry at 100° C.: Explosive secretory discharge of bombardier beetles (Brachinus), Science, 165(3888), 61-63 (1969).
Anirban, Molecular data storage, Naked Scientists (Jul. 7, 2019).
Arcadia et al., Leveraging autocatalytic reactions for chemical-domain image classification, Chemical Science, Royal Society of Chemistry, 12(15), 5464-5472 (2021).
Arcadia et al., Multicomponent molecular memory, Nature Communications, 11, 691 (2020).
Arcadia et al., Parallelized linear classification with volumetric chemical perceptrons, in, Proceedings of the IEEE Conference on Rebooting Computing (ICRC) (IEEE, 2018)
Arcadia, Reyes, & Rosenstein, In situ nanopore fabrication and single-molecule sensing with microscale liquid contacts, ACS Nano, 11(5), 4907-4915 (2017).
Ashkenasy & Ghadiri, Boolean logic functions of a synthetic peptide network, J. Am. Chem. Soc., 126(46), 11140-11141 (2004).
Aubin, Choudhury, & Jerch, Electrolytic vascular systems for energy-dense robots, Nature, 571, 51-57 (2019).
Awal & Epstein, Post-canard symmetry-breaking and other exotic dynamic behaviors in identical coupled chemical oscillators, Physical Review E, 101(4), 042222 (2020).
Awal, Bullara & Epstein, The smallest chimera: Periodicity and chaos in a pair of coupled chemical oscillators, Chaos: An Interdisciplinary Journal of Nonlinear Science, 29(1), 013131 (2019).
Badr & Epstein, Size controlled synthesis of Cu₂O nanoparticles via reaction-diffusion, Chemical Physics Letters, 669, 17-21 (2017).
Bai et al., Achieving biopolymer synergy in Systems Chemistry, Royal Chemical Society Reviews, 47, 5444-5456 (2018).
Banda et al., Online learning in a chemical perceptron. Artificial Life, 19(2), 195-219 (Spring 2013).
Banda et al., Training an asymmetric signal perceptron through reinforcement in an artificial chemistry. Journal of the Royal Society Interface, 11(93) (April 2014).
Berrou & Glavieux, Near optimum error correcting coding and decoding: turbo-codes, in IEEE Transactions on Communications, 44(10), 1261-1271 (IEEE, October 1996).
Bishop, Pattern Recognition and Machine Learning (Springer, 2006).
Bloom, The functional significance of neurotransmitter diversity, American Journal of Physiology-Cell Physiology, 246(3), C184-C194 (1984).
Blum & Reymon, 970 million druglike small molecules for virtual screening in the chemical universe database GDB-13, J. Am. Chem. Soc., 131(25), 8732-8733 (2009). Dataset GDB-13 enumerates all <=13-atom molecules of C, N, O, S, Cl.
Bornholt et al., A DNA-based archival storage system, ACM SIGOPS Operating Systems Review, 50(2), 637-649 (2016).
Boukis & Meier, Data storage in sequence-defined macromolecules via multicomponent reactions. European Polymer Journal, 104, 32-38 (2018).
Boukis et al., Multicomponent reactions provide key molecules for secret communication, Nature communications, 9(1), 1-9 (2018).
Bourbo et al., Self-assembly and self-replication of short amphiphilic beta-sheet peptides, Orig. Life Evol. Biosph., 41(6), 563-567 (2011).
Bullara, Y. De Decker and I. R. Epstein, On the possibility of spontaneous chemo-mechanical oscillations in adsorptive porous media, Philosophical Transactions of the Royal Society A: Mathematical, Physical and Engineering Sciences, 376(2135), 20170374 (2018).
Bush et al., The nanopore mass spectrometer, Rev. Sci. Instrum., 88(11) (2017).
Cabrita, Dobson, & Christodoulou, Protein folding on the ribosome, Curr. Opin. Struct. Biol., 20(1), 33-45 (2010).
Cafferty et al., Storage of information using small organic molecules, ACS Central Science, 5, 911-916 (2019).
Carmean et al., DNA data storage and hybrid molecular-electronic computing, Proceedings of the IEEE, 107(1), 63-72 (2019).
Cereto-Massague et al., Molecular fingerprint similarity search in virtual screening. Methods, 71, 58-63 (January 2015). Fingerprints capture one of many ways to represent molecules.
Ceze, Nivala, & Strauss, Molecular digital data storage using DNA, Nature Reviews Genetics, 20(8), 456-466 (2019).
Chen et al., Design of multi-phase dynamic chemical networks, Nature Chem., 9(8), 799-804 (2017).
Chen, Doty, & Soloveichik, Deterministic function computation with chemical reaction networks, Natural Computing, 13(4), 517-534 (2014).
Chen, Solanki, & Riedel, Parallel pairwise operations on data stored in DNA: Sorting, shifting, and searching, in 27th International Conference on DNA Computing and Molecular Programming (DNA 27). 205, 11:1-11:21(2021).
Cheraiet et al., A simple and eco-sustainable method for the O-Boc protection/deprotection of various phenolic structures under water-mediated/catalyst-free conditions, Green Chemistry Letters and Reviews, 6(3), 211-216 (2013).
Cherry & Qian, Scaling up molecular pattern recognition with DNA-based winner-take-all neural networks, Nature, 559(7714), 370 (2018).
Chinellato et al., Dynamical Response of Networks under External Perturbations: Exact Results, Journal of Statistical Physics, 159(2), 221-230 (2015.
Chotera et al., Functional Assemblies Emerging in Complex Mixtures of Peptides and Nucleic Acid-Peptide Chimeras, Chem. Eur. J., 24, 10128-10135 (2018).
Chuang, Gershenfeld, & Kubinec, Experimental implementation of fast quantum searching, Phys. Rev. Lett., 80(15), 3408-3411 (1998).
Church, Gao & Kosuri, Next-generation digital information storage in DNA, Science, 337(6102), 1628-1628 (September 2012).
Collier et al., Electronically configurable molecular-based logic gates, Science, 285(5426), 391-394 (1999).
Colquhoun & Lutz, Information-containing macromolecules, Nature Chemistry, 6, 455-456 (2014).
Concepcion, House, Papanikolas, & Meyer, Chemical approaches to artificial photosynthesis, Proc. Natl. Acad. Sci. U.S.A., 109(39), 15560-4 (2012).
Cook et al., Programmability of chemical reaction networks, in Algorithmic Bioprocesses, Condon et al., eds. (Springer, 2009), pp. 543-584.
Courbariaux & Bengio, Binarynet: Training deep neural networks with weights and activations constrained to +1 or −1. (2016).
Courbariaux et al., Binarized Neural Networks: Training deep neural networks with weights and activations constrained to +1 or −1. arXiv:1602.02830 (Mar. 17, 2016).
Dahlberg, The functional role of ribosomal RNA in protein synthesis, Cell, 57(4), 525-9 (1989).
de Silva & McClenaghan. Molecular-scale logic gates, Chemistry, 10(3), 574-586 (2004).
de Silva, Molecular logic gates, American Cancer Society (2012).
Dombroski et al., Implementing parallel arithmetic via acetylation and its application to chemical image processing, Proceedings of the Royal Society A, 477, 20200899 (Apr. 28, 2021).
Dombroski et al., Principles of information storage in small-molecule mixtures, in IEEE Transactions on NanoBioScience (IEEE 2020).
Dömling & Ugi, Multicomponent reactions with isocyanides. Angewandte Chemie International Edition, 39(18), 3168-3210 (2000).
Duncan et al., Applications of MALDI mass spectrometry in clinical chemistry, Clinical Chemistry 62(1), 134-143 (Nov. 19, 2015).
Earnest, Cole, & Luthey-Schulten, Simulating biological processes: stochastic physics from whole cells to colonies. Rep. Prog. Phys., 81, 052601 (2018).
Elbaz et al., DNA computing circuits using libraries of DNAzyme subunits, Nature Nanotechnology, 5, 417 (2010).
Epstein & Gao, Photo-controlled waves and active locomotion, Chemistry-A European Journal, 23(47), 11181-11188 (2017).
Erlich & Zielinski. DNA Fountain enables a robust and efficient storage architecture, Science, 355(6328), 950-954 (2017).
Feller, An Introduction to Probability Theory and Its Applications, Volume I. (Wiley, third edition, 1968).
Finkel & Kolter, DNA as a nutrient: novel role for bacterial competence gene homologs, Journal of Bacteriology, 183(21), 6288-6293 (2001).
Foulon, Liu, Rosenstein, & Rubenstein, A language for molecular computation. Chem, 5(12), 3017-3019 (Dec. 12, 2019).
Fu et al., Mixing linear SVMs for nonlinear classification, IEEE Transactions on Neural Networks, 21(12), 1963-1975 (2010).
Gamero-Castano & Fernandez De La Mora, Direct measurement of ion evaporation kinetics from electrified liquid surfaces, The Journal of Chemical Physics, 113(2), 815-832 (2000).
Gaskins, Pruc, Epstein & Dolnik, Multifold increases in Turing pattern wavelength in the chlorine-dioxide-malonic acid reaction-diffusion system, Physical Review Letters, 117(5), 056001 (2016).
Gaskins, Soohoo, Dolnik, & Epstein, Birth and death of invading standing waves in the BZ-AOT reaction-diffusion system, Israel Journal of Chemistry 58(6-7), 776-780 (2018).
Gaskins, Soohoo, Dolnik, & Epstein, Turing-Hopf front invasion: Rings and shells, Physical Review E, 98(4), 040201 (2018).
Gassend, Velasquez-Garcia, Akinwande, & Martinez-Sanchez, A microfabricated planar electrospray array ionic liquid ion source with integrated extractor, J. Microelectromech. Syst., 18(3), 679-694 (2009).
Gavins et al., Live cell PNA labelling enables erasable fluorescence imaging of membrane proteins, Nature Chem., 13(1), 15-23 (2021).
Gentili, Gotoda, Dolnik, & Epstein, Analysis and Prediction of Aperiodic Hydrodynamic Oscillatory Time Series by Feed-Forward Neural Networks, Fuzzy Logic and a Local Nonlinear Predictor, Chaos: An Interdisciplinary Journal of Nonlinear Science, 25(1), 013104 (2015).
Gershenfeld & Chuang, Bulk spin-resonance quantum computation, Science, 275(5298), 350-356, 1997.
Gibson & Cowan, On the decision regions of multilayer perceptrons, Proceedings of the IEEE, 78(10), 1590-1594 (1990).
Goelet et al., The long and the short of long-term memory—a molecular framework, Nature, 322(6078) 419 (1986).
Goldman et al., Towards practical, high-capacity, low-maintenance information storage in synthesized DNA, Nature, 494(7435) 77 (2013).
González-Ochoa et al., Effects of stochastic time-delayed feedback on a dynamical system modeling a chemical oscillator, Physical Review E, 97(5), 052214 (2018).
Goodwin, Mehta, & Lynn, Digital and analog chemical evolution, Acc. Chem. Res., 45(12), 2189-2199 (2012).
Gordon, Luu, & Lynn, Capturing nested information from disordered peptide phases, Peptide Science, e24215 (2020).
Gorecki, Yoshikawa, & Igarashi, On chemical reactors that can count, J.
Phys. Chem. A, 107, 1664-1669 (2003).
Gosselin & Weber, Rydberg fingerprint spectroscopy: A new spectroscopic tool with local and global structural sensitivity, J. Phys. Chem. A, 109, 4899-4904 (2005).
Green et al., Two-dimensional arrays containing single compounds per grid position can encode digital data by photochemical or electrochemical means. Nature, 445, 414 (January 2007)
Grover, Hsieh, & Lynn, Systems analysis for peptide systems chemistry, Life (Basel), 9(3), 55 (2019).
Grzybowski et al., The ‘wired’ universe of organic chemistry. Nature Chemistry, 1, 31-36 (2009).
Gupta et al., Deep learning with limited numerical precision. CoRR, abs/1502.02551 (2015).
Hasty, McMillen, & Collins, Engineered gene circuits, Nature, 420, 224 (2002).
Heckel, Mikutis, & Grass. A characterization of the DNA data storage channel, Scientific Reports, 9(1) (2019).
Heider & Barnekow, DNA watermarks: A proof of concept, BMC Molecular Biology, 9, 1, 1-10 (2008).
Hjelmfelt et al., Chemical implementation of neural networks and Turing machines”, Proceedings of the National Academy of Sciences, 88(24), 10983-10987 (1991).
Hopper, Molnar, & Wagner, From weak to strong watermarking, IACR Theory of Cryptography Conference, pp. 362-382 (2007).
Hordijk & Steel, Autocatalytic networks at the basis of life's origin and organization, Life, 8(4) (2018).
Horváth & Epstein, Pulse-coupled Belousov-Zhabotinsky oscillators with frequency modulation, Chaos: An Interdisciplinary Journal of Nonlinear Science, 28(4), 045108 (2018).
Horváth, Epstein, & Kustin, Mechanism of the ferrocyanide-iodate-sulfite oscillatory chemical reaction, The Journal of Physical Chemistry A, 120(12), 1951-1960 (2016).
Horváth, Kutner, Chavis Ill, & Epstein, Pulse-coupled BZ oscillators with unequal coupling strengths, Physical Chemistry Chemical Physics, 17(6), 4664-4676 (2015).
Horváth, Kutner, Zeng, & Epstein, Phase-frequency model of strongly pulse-coupled Belousov-Zhabotinsky oscillators, Chaos: An Interdisciplinary Journal of Nonlinear Science, 29(2), 023128 (2019).
Hsieh et al., Multi-step conformation selection in amyloid assembly, J. Am. Chem. Soc., 139(47), 17007-17010 (2018).
Hsieh, Lynn, & Grover, Kinetic model for two-step nucleation of peptide assembly, J. Phys Chem B, 121(31), 7401-7411 (2017).
Iribarne & Thomson, On the evaporation of small ions from charged droplets, J. Chem. Phys., 64(6), 2287-2294 (1976).
Jiang et al., IEEE Design and Test of Computers 21-31 (May/June 2012).
Jiang, Salehi, Riedel, & Parhi, Digital logic with molecular reactions, in 2013 IEEE/ACM International Conference on Computer-Aided Design (ICCAD) (IEEE, 2013), pp. 721-727.
Jiang, Salehi, Riedel, Parhi, Discrete-time signal processing with DNA, ACS Synth. Biol., 2(5), 245-254 (2013).
Kaminaga, Vanag, & Epstein, A reaction-diffusion memory device, Angewandte Chemie International Edition, 45(19):3087-3089 (May 5, 2006)
Kanerva, Hyperdimensional computing: An introduction to computing in distributed representation with high-dimensional random vectors, Cogn. Comput., 1(2), 139-159 (2009).
Keifer & Jarrold, Single-molecule mass spectrometry, Mass Spectrometry Reviews, 36(6), 715-733 (2017).
Kennedy et al., Spatiotemporal information preservation in turbulent vapor plumes. Applied Physics Letters, 112(26), 264103 (June 2018).
Kennedy et al., Encoding information in synthetic metabolomes, PLoS ONE, 14(7), e0217364 (2019).
Kennedy et al., Secret messaging with endogenous chemistry. Scientific Reports, 11 (2021).
Kissel, Regenscheid, Scholl, & Stine, Guidelines for media sanitization, NIST Special Publication (NIST 2014), pp. 800-88.
Koch et al., A DNA-of-things storage architecture to create materials with embedded memory, Nature Biotechnology, 38(1), 39-43 (2020).
König et al., Photoeditable macromolecular information, Nature Communications, 10(1), 1-9 (2019).
Konow et al., Turing patterns on radially growing domains: Experiments and simulations, Physical Chemistry Chemical Physics, 21(12), 6718-6724 (2019).
Kraft et al., Autocatalytic, bistable, oscillatory networks of biologically relevant organic reactions, Nature, 537 (2016).
Kunig, Ehrt, Dömling, & Brunschweiger. Isocyanide multicomponent reactions on solid-phase-coupled DNA oligonucleotides for encoded library synthesis, Organic Letters, 21(18), 7238-7243 (2019).
Kuwano & Kusano, Benzyl protection of phenols under neutral conditions: Palladium-catalyzed benzylations of phenols, Organic Letters, 10(10), 1979-1982 (2008).
Lakin, Youssef, Cardelli, & Phillips, Abstractions for DNA circuit design, J. Royal Soc. Interface, 470-486 (2012).
LeCun et al., Gradient-based learning applied to document recognition. Proceedings of the IEEE, 86(11), 2278-2324 (1998).
Li et al., Design of asymmetric peptide bilayer membranes, J. Am. Chem. Soc., 138 (10), 3579-3586 (2016).
Li et al., Kinetic analysis of nanostructures formed by enzyme-instructed intracellular assemblies against cancer cells, ACS Nano, 12(4), 3804-3815 (2018).
Liang & Lynn, Achieving synergistic biopolymer functions using systems chemistry, Atlas of Science Commentary (Oct. 24, 2018).
Liang, Hsieh, Li, & Lynn, Conformational evolution of polymorphic amyloid assemblies, Current Opinion of Structural Biology, ACS Chem Reviews, 51, 135-140 (2018).
Lin et al., A supramolecular aggregation-based constitutional dynamic network for information processing, Chemical Science, 11(35), 9617-9622 (2020).
Lin et al., Neural networks with few multiplications. CoRR, abs/1510.03009 (2015).
Lopez et al., DNA assembly for nanopore data storage readout, Nature Communications, 10(1), 1-9 (2019).
Luo et al., Light-modulated Intermittent wave groups in a diffusively fed reactive gel, Angewandte Chemie International Edition, 128(16), 5072-5075 (2016).
Machinek, Ouldridge, & Haley, Programmable energy landscapes for kinetic control of DNA strand displacement, Nature Communications, 5, 5324 (2014).
Maciejowska et al., Spontaneous pulsation of peptide microstructures in an abiotic liquid system, Journal of Chromatographic Science, 54(8), 1301-1309 (2016).
Magnasco, Chemical kinetics is Turing universal, Physical Review Letters, 78, 1190-1193 (1997).
Maguire et al., Dynamic environments as a tool to preserve desired output in a chemical reaction network, Chemistry-A European Journal, 26(7), 1676-1682 (2020).
Malinakova, Reports in Organic Chemistry, pages 75-90 (2015).
Marchetti & Levine, Biomimetic catalysis. ACS Catalysis, 1(9), 1090-1118 (2011).
Marshall et al., Fourier transform ion cyclotron resonance mass spectrometry: A primer. Mass Spectrometry Reviews, 17(1), 1-35 (1998).
Martens et al., Multifunctional sequence-defined macromolecules for chemical data storage, Nature Communications, 9(1), 1-8 (2018).
Martin et al., Encoding information into polymers, Nature Reviews Chemistry, 2(11), 365-381 (2018).
Mateos et al., Determination of phenols, flavones, and lignans in virgin olive oils by solid-phase extraction and high-performance liquid chromatography with diode array ultraviolet detection, Journal of Agricultural and Food Chemistry, 49(5), 2185-2192 (2001).
McMullen, Araujo, Winter, & Stein, Osmotically driven and detected DNA translocations, Scientific Reports, 9, 1-10 (2019).
McMullen, de Haan, Tang, & Stein, Buckling causes nonlinear dynamics of filamentous viruses driven through nanopores, Physical Review Letters, 120, 078101 (2018).
McMullen, de Haan, Tang, & Stein, Stiff filamentous virus translocations through solid-state nanopores, Nature communications, 5, 1-10 (2014).
McMullen, Tang, & Stein, Nanopore measurements of filamentous viruses reveal a sub-nanometer-scale stagnant fluid layer, ACS Nano, 11, 11669-11677 (2017).
Minsky & Papert, Perceptrons: An Introduction to Computational Geometry, (MIT Press, 1969).
Minsky, Computation: Finite and Infinite Machines (Prentice-Hall, 1967).
Minsky, Papert, & Bottou, Perceptrons: An Introduction to Computational Geometry (MIT Press, 2017).
Montedoro et al., Simple and hydrolyzable phenolic compounds in virgin olive oil. 1. Their extraction, separation, and quantitative and semiquantitative evaluation by HPLC, Journal of Agricultural and Food Chemistry, 40(9), 1571-1576 (1992).
Morrison & Boyd, Organic Chemistry (Allyn & Bacon, 1966).
Murashige et al., Comparisons of O-acylation and Friedel-Crafts acylation of phenols and acyl chlorides and Fries rearrangement of phenyl esters in trifluoromethanesulfonic acid: Effective synthesis of optically active homotyrosines, Tetrahedron, 67(3), 641-649 (2011).
Muroga, Threshold Logic and its Applications (John Wiley & Sons, Inc., 1971).
Nagao et al., Modulation of Turing patterns in the CDIMA reaction by ultraviolet and visible light, The Journal of Physical Chemistry A, 123(5), 992-998 (2019).
Najafi et al., A reconfigurable architecture with sequential logic-based stochastic computing, J. Emerg. Technol. Comput. Syst., 13(4), 57:1-57:28, (June 2017).
Najafi, Jenson, Lilja, & Riedel, Performing stochastic computation deterministically, IEEE Tran. on Very Large Scale Integration (VLSI) Systems (2019).
National Science Foundation Public Affairs, Researchers report progress on molecular data storage system (Feb. 11, 2020).
Nielsen et al., Genetic circuit design automation, Science, 352(6281) (2016).
Nitschke, Molecular networks come of age, Nature, 436 (2009).
Omosun et al., Catalytic diversity in self-propagating peptide assemblies, Nature Chemistry, 9(8), 805-809 (2017).
Orbán, Kurin-Csörgei, & Epstein, pH-regulated chemical oscillators, Accounts of Chemical Research, 48(3), 593-601 (2015).
Orbán, Kurin-Csörgei, Rábái, & Epstein, Mechanistic studies of oscillatory copper(II) catalyzed oxidation reactions of sulfur compounds, Chem. Eng. Sci. 55(2), 267-273 (2000).
Ouk et al., O-methylation of phenolic compounds with dimethyl carbonate under solid/liquid phase transfer system, Tetrahedron Letters, 43(14), 2661-2663 (2002).
Papoulis, Probability, Random Variables, and Stochastic Processes. (McGraw-Hill, New York, Third edition, 1991).
Parsons et al., Group Intelligence: An Active Learning Exploration of Diversity in Evolution, J. Chem. Ed. 94, 6, 717-721 (2017).
Paz, Kirzhner, Nevo, & Korol, Coevolution of DNA-interacting proteins and genome ‘dialect’, Molecular Biology and Evolution, 23(1), 56-64 (2006).
Petrov, Gáspár, Masere, & Showalter. Controlling chaos in the Belousov-Zhabotinsky reaction, Nature, 361, 240 (1993).
Pevzner, Tang, & Waterman. A Eulerian path approach to a fragment assembly, Proceedings of the National Academy of Sciences, 98(17), 9748-9753 (2001).
Progress on molecular data storage system, ScienceDaily (Feb. 4, 2020).
Qian & Riedel, The synthesis of robust polynomial arithmetic with stochastic logic, in 2008 45th ACM/IEEE Design Automation Conference (IEEE, 2008), pp. 648-653.
Qian et al., An architecture for fault-tolerant computation with stochastic logic, IEEE Transactions on Computers, 60(1), 93-105 ((IEEE, 2011).
Qian, Digital yet deliberately random: Synthesizing logical computation on stochastic bit streams, Ph.D. dissertation (University of Minnesota, 2011).
Qian, Riedel, & Rosenberg, Uniform approximation and Bernstein polynomials with coefficients in the unit interval, European Journal of Combinatorics, 32(3), 448-463 (2011).
Qian, Riedel, Zhou, & Bruck, Transforming probabilities with combinational logic, IEEE Transactions on Computer-Aided Design of Integrated Circuits and Systems (to appear) (2011).
Qian, Winfree, & Bruck, Neural network computation with DNA strand displacement cascades, Nature, 475(7356), 368-372 (2011).
Rastegari et al., Xnor-net: Imagenet classification using binary convolutional neural networks. CoRR, abs/1603.05279 (2016).
Reece, Campbell Biology (Benjamin Cummings/Pearson, 2011).
Reif & Tate, On threshold circuits and polynomial computation, SIAM Journal on Computing, 21, 118-123 (1987).
Ren et al., Autonomous reciprocating migration of an active material, Proceedings of the National Academy of Sciences, 114(33), 8704-8709 (2017.
Ren et al., Chemomechanical origin of directed locomotion driven by internal chemical signals, Sci. Adv., 6, eaaz9125 (2020).
Ren et al., Experimental, numerical, and mechanistic analysis of the nonmonotonic relationship between oscillatory frequency and photointensity for the photosensitive Belousov-Zhabotinsky oscillator, Chaos: An Interdisciplinary Journal of Nonlinear Science, 25(6), 064607 (2015).
Ren et al., Programmed locomotion of an active gel driven by spiral waves, Angewandte Chemie International Edition, 59(18), 7106-7112 (2020).
Ren et al., Retrograde and direct wave locomotion in a photosensitive self-oscillating gel, Angewandte Chemie International Edition, 128(46), 14513-14517 (2016).
Rengifo et al., Amyloid scaffolds as alternative chlorosomes, Org. Biomol. Chem., 15, 7063-7071 (2017).
Rengifo et al., Liquid like phases preorder peptides for supramolecular assembly, ChemSystemsChem, 2, 6, e2000007 (2020).
Rha et al., Electrostatic Complementarity Drives Amyloid/Nucleic Acid Co-Assembly, Angewandte Chemie International Edition, 59(1), 358-363 (2020).
Rose et al., Computing with chemicals: Perceptrons using mixtures of small molecules, in 2018 IEEE International Symposium on Information Theory (ISIT) (Vail, CO, June 2018), pp. 2236-2240.
Rose et al., Computing with chemicals: Perceptrons using mixtures of small molecules, IEEE International Symposium on Information Theory (IEEE, 2018), pp. 1-8.
Rosenblatt, The perceptron: A probabilistic model for information storage and organization in the brain. Psychological Review, 65(6), 386 (1958).
Rosenstein et al., Principles of information storage in small-molecule mixtures. arXiv:1905.02187 (May 6, 2019),
Rosenstein et al., Principles of information storage in small-molecule mixtures, in IEEE Transactions on NanoBioScience (2020).
Rovelli, Wandering towards a goal: How Can mindless mathematical laws give rise to aims and intention, Aguirre, Foster, & Merali (eds.), (Springer International Publishing, 2018), pp 17-27.
Roy et al., Design and synthesis of digitally encoded polymers that can be decoded and erased, Nature Communications, 6(1), 1-8 (2015).
Salehi, Liu, Parhi, & Riedel, Computation of mathematical functions using DNA via fractional via fractional coding, Nature Scientific Reports, 8(8312) (2018).
Salehi, Parhi, & Riedel, Chemical reaction networks for computing polynomials, ACS Synth. Biol. 6, 1, 76-83 (2017).
Salehi, Riedel, & Parhi, Asynchronous discrete-time signal processing with molecular reactions, 2014 48th Asilomar conference on signals, systems, and computers, 1767-1772 (2014).
Salehi, Riedel, & Parhi, Chemical reaction networks for computing polynomials, ACS synthetic biology, 6(1), 76-83 (2017).
Salehi, Riedel, & Parhi, Computing polynomials using chemical reaction networks, IEEE Globecom Symposium (IEEE, 2016).
Salehi, Riedel, & Parhi, Computing polynomials with positive coefficients using stochastic logic by double-NAND expansion, ACM Great Lakes Symposium on VLSI (2017).
Salehi, Riedel, & Parhi, Discrete-time signal processing with DNA, ACS synthetic biology, 2(5), 245-254 (2013.
Salehi, Riedel, & Parhi, Markov chain computations using molecular reactions, Digital Signal Processing (DSP), 2015 IEEE International Conference on, 689-693 (IEEE, 2015).
Salehi, Riedel, & Parhi, Molecular computation of complex Markov chains with self-loop state transitions, Asilomar Conference on Signals, Systems and Computers (2017).
Salehi, Riedel, & Parhi, Molecular sensing and computing systems, IEEE Transactions on Molecular, Biological and Multi-Scale Communications, 1(3), 249-264 (I EEEE, 2015).
Sarkar, Selvakumar, Motiei, & Margulies. Message in a molecule, Nature Communications, 7, 11374 (May 2016).
Sauro & Kim, Synthetic biology: It's an analog world, Nature, 497(7451), 572-3(2013.
Saxena et al., Biopolymer as matrix for nano-encapsulation of urease enzyme—a model protein and its application in urea detection, Journal of Colloid and Interface Science, 490, 452-461 (2017).
Schmidhuber, Deep learning in neural networks: An overview, Neural Networks, 61, 85-117 (2015).
Scott, Ribozymes, Curr. Opin. Struct. Biol., 17(3), 280-6 (2007).
Scully, Data can now be stored inside the molecules that power our metabolism, New Scientist (Jul. 3, 2019).
Sefkow & Kaatz, Selective protection of either the phenol or the hydroxy group in hydroxyalkyl phenols, Tetrahedron Letters, 40(36), 6561-6562 (1999).
Semenov et al., Autocatalytic cycles in a copper-catalyzed azide-alkyne cycloaddition reaction, J. Am. Chem. Soc., 40, 32, 10221-10232 (2018).
Sementilli et al., Non-canonical, polynuclear copper centers in extended amyloid arrays (2021).
Senum & Riedel, Rate-Independent Constructs for Chemical Computation, PLoS One, 6(6), e21414 (2011).
Service, DNA Could Store All of the World's Data in One Room, Science, aal0852 (2017).
Shepherd et al., Multigait soft robot, Proceedings of the National Academy of Sciences, 108(51), 20400-20403 (2011).
Showalter & Epstein, From chemical systems to systems chemistry: Patterns in space and time, Chaos: An Interdisciplinary Journal of Nonlinear Science, 25(9), 097613 (2015).
Siu, Bruck, Kailath, & Hofmeister, Depth efficient neural networks for division and related problems, IEEE Trans. Inform. Theory, 39, 3, 946-956 (1993).
Smith-Carpenter et al., On the emerging codes for chemical evolution, in From Matter to Life: Information and Causality: Next Steps, Cambridge University Press, 97-113 (2017).
Smith, Mowles, Mehta, & Lynn, Looked at life from both sides now, Life, 4(4), 887-902 (2014).
Soai, Kawasaki, & Matsumoto, Asymmetric autocatalysis of pyrimidyl alkanol and its application to the study on the origin of homochirality, Accounts of Chemical Research, 47(12), 3643-3654 (2014).
Soai, Shibata, Morioka, & Choji, Asymmetric autocatalysis and amplification of enantiomeric excess of a chiral molecule. Nature, 378(6559), 767-768 (1995).
Soeken, Amarú, Gaillardon, & de Micheli: Exact synthesis of majority-inverter graphs and its applications, IEEE Trans. Comput. Aided Des. Integr. Circuits Syst., 36(11), 1842-1855 (2017).
Soloveichik, Seelig, & Winfree. DNA as a universal substrate for chemical kinetics, Proceedings of the National Academy of Sciences, 107, 5393-5398 (2010).
Song et al., Fast and compact DNA logic circuits based on single-stranded gates using strand-displacing polymerase, Nature Nanotechnology, 14(11), 1075-1081 (2019).
Spraggins et al., Next-generation technologies for spatial proteomics: Integrating ultra-high speed MALDI-TOF and high mass resolution MALDI FTICR imaging mass spectrometry for protein analysis Proteomics 6(11-12), 1678-89 (2016).
Srinivas et al., On the biophysics and kinetics of toehold-mediated DNA strand displacement, Nucleic Acids Res., 41(22), 10641-58 (2013).
Steinbock, Kettunen, & Showalter, Chemical wave logic gates, The Journal of Physical Chemistry, 100(49), 18970-18975 (1996).
Stender, Williams, & Coull, PNA fluorescent in situ hybridization (FISH) for rapid microbiology and cytogenetic analysis, Methods Mol. Biol. 1050, 167-178 (2014).
Swenson & Heemstra, Peptide nucleic acids harness dual information codes in a single molecule, Chem. Communications (Cambridge) 56(13), 1926-1935 (2020).
Tabatabaei et al., DNA punch cards: Encoding data on native DNA Sequences via nicking, Nature Communications, 11(1), 1-10 (2010).
Taga & Bassler, Chemical communication among bacteria, Proceedings of the National Academy of Sciences, U.S.A., 100(suppl. 2), 14549-14554 (2003).
Tan et al., Directing peptide liquid-liquid phase transitions with dynamic chemical networks, Chemical Science (2021.
Tann et al., Flexible deep neural network processing, arXiv (2018).
Taran et al., Expanding the informational chemistries of life: Peptide/RNA networks, Phil. Trans. Royal Society A, 375, 20160356 (2017).
Taran, Patel, & Lynn, Small Molecules Reaction Networks that Model ROS Dynamics of the Rhizosphere, Chemical Communications, 55(25), 3602-3605 (2019).
Teng et al., Effect of reaction parameters on the wavelength of pulse waves in the Belousov-Zhabotinsky reaction-diffusion system, The Journal of Physical Chemistry A, 123(43), 9292-9297 (2019).
Thomas et al., Infochemistry and infofuses for the chemical storage and transmission of coded information. Proceedings of the National Academy of Sciences, U.S.A., 106(23), 9147-9150 (June 2009).
Tolley et al., An untethered jumping soft robot, IEEE/RSJ International Conference on Intelligent Robots and Systems (Chicago, IL, 2014), pp. 561-566.
Turing, The Chemical Basis of Morphogenesis, Phil. Trans. Roy. Soc. B, 237, 37-72, 1952.
Ugi et al., Multicomponent reactions in organic chemistry. Endeavour, 18(3), 115 122 (1994).
Ugi et al., The chemistry of isocyanides, their multicomponent reactions and their libraries. Molecules, 8(1), 53-66 (2003).
Voigt et al., Single-molecule chemical reactions on DNA origami, Nature Nanotechnology, 5(3), 200-203 (2010).
Walker, Davies, & Ellis (eds), From Matter to Life: Information and Causality (Cambridge University Press, 2017).
Walker, Lynn, & Chernoff, A standard model of Alzheimer's Disease?Science Translational Medicine, Prion, 12(5-6), 261-265 (2018).
Wang, Gao, & Epstein, Capillarity-induced propagation reversal of chemical waves in a BZ Self-oscillating Gel J. Phys. Chem. A, 124, 3530-3534 (2020).
Wehner, Truby, & Fitzgerald, An integrated design and fabrication strategy for entirely soft, autonomous robots, Nature, 536(7617), 451-455 (2016).
Wei, Grupp, Spada, & Swanson, Reliably erasing data from flash-based solid state drives, FAST, 11, 8 (2011).
Weintrop et al., Defining computational thinking for mathematics and science classrooms, J. Sci. Educ. Technol., 25(1), 127-147 (2016).
Werner et al., Molpro: A general-purpose quantum chemistry program package. WIRES Comput. Mol. Sci., 2(2), 242-253 (March/April 2012).
Wilson et al., Biomolecular assemblies: Moving from observation to predictive design, Chem. Rev. 118, 24, 11519-11574 (2018).
Wolfram, A New Kind of Science (Wolfram Media, 2002).
Wong & Huck, Photochemical control over oscillations in chemical reaction networks. J. Organic Chemistry, 139(43), 15296-15299 (Oct. 17, 2017).
Woods et al., Diverse and robust molecular algorithms using reprogrammable DNA self-assembly, Nature, 567(3) 366-372 (2019).
Yazdi, Gabrys, & Milenkovic, Portable and error-free DNA-based data storage, Scientific Reports, 7(1):1-6 (2017).
Zhang & Seelig, Dynamic DNA nanotechnology using strand-displacement reactions, Nature Chemistry, 3, 103 (2011).
Zhang & van Pelt, Chip-based nanoelectrospray mass spectrometry for protein characterization, Expert Review of Proteomics, 1(4), 449-468 (2004).
Zhirnov et al., Nucleic acid memory, Nature Materials, 15(4), 366-370 (2016).

We claim:

1. An information storage system, comprising:
a storage surface with a plurality of addressable storage locations, wherein each addressable storage location comprises a previously unknown molecule mixture of chemical waste or byproducts thereof, and wherein the molecule mixture, wherein each addressable storage location contains a set of molecules from the molecule mixture.

2. The information storage system of claim 1, wherein the molecule mixture further comprises fluorinated molecules including at least one of polyfluoroalkyl substances, highly stable fluorinated hydrocarbon compounds, per-fluoroalkyl substances, or persistent environmental contaminants, and/or comprises chemical contaminants, contaminant derivatives, perfluoro-1-octanesulfonic acid (PFOS), perfluoro-1-butanesulfonic acid (PFBS), perfluoro-1-hexanesulfonic acid (PFHxS), perfluoro nonanoic acid (PFNA), perfluorooctanoic acid (PFOA), perfluoroheptanoic acid (PFHpA), perfluorohexanoic acid (PFHxA), perfluoropentanoic acid (PFPeA), perfluorobutanoic acid (PFBA), 8:2 fluorotelomer alcohol (8:2 FTOH), 6:2 fluorotelomer alcohol (6:2 FTOH), 4:2 fluorotelomer alcohol (4:2 FTOH), or fluorotelomer-based acrylate or methacrylate esters.

3. The information storage system of claim 1, wherein the fluorinated molecules comprise at least one of polyfluoroalkyl substances or highly stable fluorinated hydrocarbon compounds, wherein the polyfluoroalkyl substances are synthetic organofluorine chemical compounds containing at least one fluorinated carbon atom, and wherein the highly stable fluorinated hydrocarbon compounds have strong carbon-fluorine bonds.

4. The information storage system of claim 3, wherein the polyfluoroalkyl substances include at least one of per-fluoroalkyl substances or poly-fluoroalkyl substances, wherein the per-fluoroalkyl substances are synthetic organofluorine chemical compounds in which all hydrogen atoms attached to carbon atoms are replaced by fluorine atoms, and wherein the poly-fluoroalkyl substances are synthetic organofluorine chemical compounds in which some, but not all, of the hydrogen atoms attached to carbon atoms are replaced by fluorine atoms.

5. The information storage system of claim 1, wherein the fluorinated molecules comprise persistent environmental contaminants, wherein the persistent environmental contaminants are resistant to environmental degradation through chemical, biological, and photolytic processes, have a potential for long-range transport, bioaccumulate in human and animal tissue, biomagnify in food chains, and have potentially significant impacts on human health and the environment.

6. The information storage system of claim 1, wherein the fluorinated molecules comprise at least one of perfluoro-1-octanesulfonic acid (PFOS), perfluoro-1-butanesulfonic acid (PFBS), perfluoro-1-hexanesulfonic acid (PFHxS), perfluoro nonanoic acid (PFNA), perfluorooctanoic acid (PFOA), perfluoroheptanoic acid (PFHpA), perfluorohexanoic acid (PFHxA), perfluoropentanoic acid (PFPeA), or perfluorobutanoic acid (PFBA), wherein PFOS, PFBS, PFHxS, PFNA, PFOA, PFHpA, PFHxA, PFPeA, and PFBA are synthetic organofluorine chemical compounds and persistent organic pollutants that are found in the environment, wildlife, and humans.

7. The information storage system of claim 1, wherein each addressable storage location is operable to be prompted by mass spectrometry, ultraviolet-visible spectroscopy, Rydberg spectroscopy, electromagnetic radiation spectroscopy, Infrared spectroscopy, fluorescence spectroscopy, or absorption spectroscopy.

8. A method of storing information, comprising:
providing a storage surface with a plurality of addressable storage locations; and
forming a molecule mixture at each addressable storage location, wherein the molecule mixture comprises a previously unknown molecule mixture of chemical waste or byproducts thereof, and wherein forming the molecule mixture comprises containing a set of molecules at each addressable storage location.

9. The method of claim 8, wherein forming the molecule mixture further comprises including chemical waste or byproducts thereof and fluorinated molecules including at least one of polyfluoroalkyl substances, highly stable fluorinated hydrocarbon compounds, per-fluoroalkyl substances, or persistent environmental contaminants and/or including chemical contaminants or contaminant derivatives in the molecule mixture.

10. The method of claim 8, wherein the fluorinated molecules comprise at least one of polyfluoroalkyl substances or highly stable fluorinated hydrocarbon compounds.

11. The method of claim 10, wherein the polyfluoroalkyl substances include at least one of per-fluoroalkyl substances or poly-fluoroalkyl substances.

12. The method of claim 8, wherein the fluorinated molecules comprise persistent environmental contaminants.

13. The method of claim 8, wherein the fluorinated molecules comprise at least one of perfluoro-1-octanesulfonic acid (PFOS), perfluoro-1-butanesulfonic acid (PFBS), perfluoro-1-hexanesulfonic acid (PFHxS), perfluoro nonanoic acid (PFNA), perfluorooctanoic acid (PFOA), perfluoroheptanoic acid (PFHpA), perfluorohexanoic acid (PFHxA), perfluoropentanoic acid (PFPeA), or perfluorobutanoic acid (PFBA).

14. A storage medium, comprising:
a storage surface with a plurality of addressable storage locations; and
a molecule mixture formed at each addressable storage location, wherein the molecule mixture comprises a previously unknown molecule mixture of chemical waste or byproducts thereof, and wherein each addressable storage location contains a set of molecules from the molecule mixture.

15. The storage medium of claim 14, wherein the molecule mixture further comprises chemical waste or byproducts thereof and fluorinated molecules including at least one of polyfluoroalkyl substances, highly stable fluorinated hydrocarbon compounds, per-fluoroalkyl substances, and/or persistent environmental contaminants, chemical contaminants or contaminant derivatives.

16. The storage medium of claim 14, wherein the fluorinated molecules comprise at least one of polyfluoroalkyl substances or highly stable fluorinated hydrocarbon compounds.

17. The storage medium of claim 16, wherein the polyfluoroalkyl substances include at least one of per-fluoroalkyl substances or poly-fluoroalkyl substances.

18. The storage medium of claim 14, wherein the fluorinated molecules comprise at least one of persistent environmental contaminants, perfluoro-1-octanesulfonic acid (PFOS), perfluoro-1-butanesulfonic acid (PFBS), perfluoro-1-hexanesulfonic acid (PFHxS), perfluoro nonanoic acid (PFNA), perfluorooctanoic acid (PFOA), perfluoroheptanoic acid (PFHpA), perfluorohexanoic acid (PFHxA), perfluoropentanoic acid (PFPeA), or perfluorobutanoic acid (PFBA).

19. The storage medium of claim 14, wherein the storage medium is capable of providing a method of storing information in a plurality of molecular mixtures, the method comprising the steps of:
(a) converting a format of information into a plurality of digital sequences;
(b) converting the plurality of digital sequences into a plurality of corresponding molecular mixtures using one bit per mixture, wherein the molecular mixtures comprise chemical waste or byproducts thereof; and
(c) storing the plurality of corresponding molecular mixtures on a solid surface, where the location of each molecular mixture is an addressable location on the storage medium.

20. The storage medium of claim 14, wherein the format of information is selected from the group consisting of text, image, video, and audio.
